(19) United States
(12) Patent Application Publication
(10) Pub. No.: US 2017/0222678 A1
(43) Pub. Date: Aug. 3, 2017

(54) BIOLOGICALLY COMPATIBLE MOBILE COMMUNICATION DEVICE

(71) Applicant: GEELUX HOLDINGS, LTD., Tortola (VG)

(72) Inventor: Marcio Marc ABREU, Bridgeport, CT (US)

(73) Assignee: GEELUX HOLDINGS, LTD., Tortola (VG)

(21) Appl. No.: 15/419,945

(22) Filed: Jan. 30, 2017

Related U.S. Application Data
(60) Provisional application No. 62/288,742, filed on Jan. 29, 2016.
(60) Provisional application No. 62/290,359, filed on Feb. 2, 2016.
(60) Provisional application No. 62/292,700, filed on Feb. 8, 2016.
(60) Provisional application No. 62/349,869, filed on Jun. 14, 2016.
(60) Provisional application No. 62/448,355, filed on Jan. 19, 2017.

(51) Int. Cl. H04B 1/3827; H01Q 1/24; H04M 1/02

(52) U.S. Cl. CPC H04B 1/3838; H04M 1/0249; H04M 1/0262; H01Q 1/245; H04M 1/035

(57) ABSTRACT

The embodiments of the present disclosure provide positions of one or more speakers and microphones that permit a user to orient the antenna and heat generating elements of a mobile communication device in a location that reduces exposure to RF and/or thermal energy or radiation, including orientations where the antenna of the mobile communication device is positioned further away from a brain of a user than an antenna of a conventional mobile communication device.

### CROSS-REFERENCE TO RELATED APPLICATIONS

This application claims the benefit of priority to U.S. Provisional Patent Application No. 62/288,742, filed on Jan. 29, 2016; U.S. Provisional Patent Application No. 62/290,359, filed on Feb. 2, 2016; U.S. Provisional Patent Application No. 62/292,700, filed on Feb. 8, 2016, U.S. Provisional Patent Application No. 62/349,869, filed on Jun. 14, 2016, and U.S. Provisional Patent Application No. 62/448,355, filed on Jan. 19, 2017, which are hereby incorporated by reference in their entirety.

### COLOR DRAWING NOTICE

The patent or application file contains at least one drawing executed in color. Copies of this patent or patent application publication with color drawing(s) will be provided by the Office upon request and payment of the necessary fee.

### TECHNICAL FIELD

This disclosure relates to biologically compatible mobile communication devices configured to minimize exposing one or more of a user's organs to radiation emitted from one or more components of the biologically compatible mobile communication device

### BACKGROUND

A conventional configuration for a mobile communication device includes a front face with a display, a speaker, and a microphone. The speaker is positioned near a top of the mobile communication device, and the microphone is positioned near the bottom of the mobile communication device. The speaker and the microphone are typically positioned on the front face along or toward a centerline or central line extending through the front face, with the speaker on one side of the display and the microphone on an opposite side of the display from the speaker.

### SUMMARY

This disclosure provides a biologically compatible mobile communication device configured to minimize exposing one or more of a user's organs to radiation emitted from one or more components of the biologically compatible mobile communication device, minimizing exposure to at least one of radiation sensitive organs or a combination of radiation sensitive organs including brain, eye, parotid gland, submandibular salivary gland, sublingual salivary gland, ear, and thyroid. Accordingly, this disclosure provides a biologically compatible mobile communication device configured to minimize exposing one or more of a user's organs to radiation emitted from one or more components of the biologically compatible mobile communication device, the biologically compatible mobile communication device comprising a housing, an audio port of the housing, and an antenna. The audio port is configured to be in contact with or in close proximity to one of the ears of the user, and the audio port is configured to transmit sound from a sound producing device positioned inside the housing. The antenna is positioned inside the housing. The housing includes at least one imaginary line that represents a maximum distance between two exterior points of the housing; the audio port is located closer to a first end of the at least one imaginary line than a second end of the at least one imaginary line; the antenna is located closer to the second end of the at least one imaginary line than the first end of the at least one imaginary line; and a separation distance between the audio port and the antenna is at least 70% of a total length of the at least one imaginary line.

This disclosure also provides a biologically compatible mobile communication device configured to minimize exposing one or more of a user's organs to radiation emitted from one or more components of the biologically compatible mobile communication device, the biologically compatible mobile communication device comprising a housing, an audio port, and an antenna. The housing has a top side, a bottom side, a left side, a right side, a front side, and a back side, wherein each of the top side and the bottom side has a width less than a length of each of the left side, the right side, the front side, and the back side. The audio port of the housing is configured to be in contact with or in close proximity to one of the ears of the user. The audio port is configured to transmit sound from a sound producing device positioned inside the housing. The antenna is positioned inside the housing. The audio port is located on the top side, or on one of the left side, the right side, the front side, and the back side at a distance spaced from the top side that is less than or equal to 15% of the length. The antenna is located at a distance spaced from the bottom side that is less than or equal to 15% of the length.

This disclosure also provides a biologically compatible mobile communication device configured to minimize exposing one or more of a user's organs to radiation emitted from one or more components of the biologically compatible mobile communication device, the biologically compatible mobile communication device comprising a housing, an audio port of the housing, and an antenna. The housing has a top side, a bottom side, a left side, a right side, a front side, and a back side, wherein each of the top side and the bottom side has a width less than a length of each of the left side, the right side, the front side, and the back side. The audio port is configured to be in contact with or in close proximity to one of the ears of the user, and wherein the audio port is configured to transmit sound from a sound producing device positioned inside the housing. The antenna is positioned inside the housing. The audio port is located on the bottom side, or on one of the left side, the right side, the front side, and the back side at a distance spaced from the bottom side that is less than or equal to 15% of the length. The antenna is located at a distance spaced from the top side that is less than or equal to 15% of the length.

This disclosure also provides a biologically compatible mobile communication device configured to minimize exposing one or more of a user's organs to radiation emitted from one or more components of the biologically compatible mobile communication device, the biologically compatible mobile communication device comprising a housing including an antenna and an audio port of the housing. The audio port is configured to be in contact with or in close proximity to one of the ears of the user. The audio port is configured to transmit sound from a sound producing device positioned inside the housing. The housing has a first side, a second side, a third side, a fourth side opposite the first side, a fifth side opposite the second side, and a sixth side opposite the third side. The audio port is located closer to a first intersection of the first side, the second side, and the third side, than to a second intersection of the fourth side, the fifth side, and the sixth side. The antenna is located closer to the second intersection than the first intersection.

This disclosure also provides a biologically compatible mobile communication device configured to minimize exposing one or more of a user's organs to radiation emitted from one or more components of the biologically compatible mobile communication device, the biologically compatible mobile communication device comprising a housing including an audio port and microphone of the housing. The audio port is configured to be in contact with or in close proximity to one of the ears of the user. Contrary to microphones of mobile communication devices of the prior art, which are configured to be in proximity to the mouth, the microphone of the present disclosure has a new configuration and it is configured in a manner to be preferably located away from the mouth and preferably not in close proximity to the mouth, in accordance with preferred embodiments of the present disclosure, to minimize radiation exposure to sensitive organs. The microphone or sound receiving device is configured to receive sound from a sound producing source. The housing has a first side, a second side, a third side, a fourth side opposite the first side, a fifth side opposite the second side, and a sixth side opposite the third side. The microphone can be positioned in any side or any face in an arrangement with an audio port to minimize radiation exposure while optimizing receiving sound from a user's mouth.

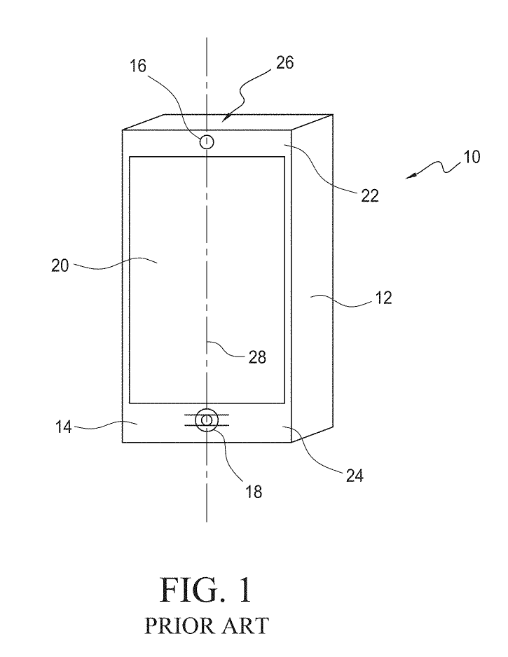

Embodiments of the present disclosure protect the sensitive organs that may be affected by radiation from mobile communication devices of the prior art including protecting the brain, eye, salivary glands, ear and thyroid. The eye can absorb electromagnetic radiation quickly and the wavelength used for cell phone signals can be absorbed by ocular tissues. Blood carries away heat, but several ocular structures are avascular including the lens and vitreous humor. Thus the heat absorbed by the eye is “trapped” inside these ocular tissues, and the heat absorbed by the eye does not get transmitted out of the eye. Furthermore, reports show increased risk of eye cancer, in particular uveal melanoma due to exposure to radiation of mobile communication devices of the prior art, published in the journal Epidemiology [Stang A, et al., The possible role of radiofrequency radiation in the development of uveal melanoma. Epidemiology 2001 Jan. 12(1):7-12]. When radio waves or heat from antenna and/or battery of devices of prior art (FIG. 1) pass through biological tissue they can alter and damage various biological tissues. Published reports of increased risk for eye damage, cataracts, retinal degeneration, eye cancer and blindness due to mobile communication devices of the prior art [Vignal R, et al. Effects of mobile phones and radar radiofrequencies on the eye. Pathol Biol (Paris). 2009 September; 57(6):503-8. doi: 10.1016/j.patbio.2008.09.003. Epub 2008 Nov. 25] are aligned with the personal clinical experience of the applicant, who is an ophthalmologist and eye surgeon. Eye damage and risk of blindness are protected by the multiple embodiments of the present disclosure.

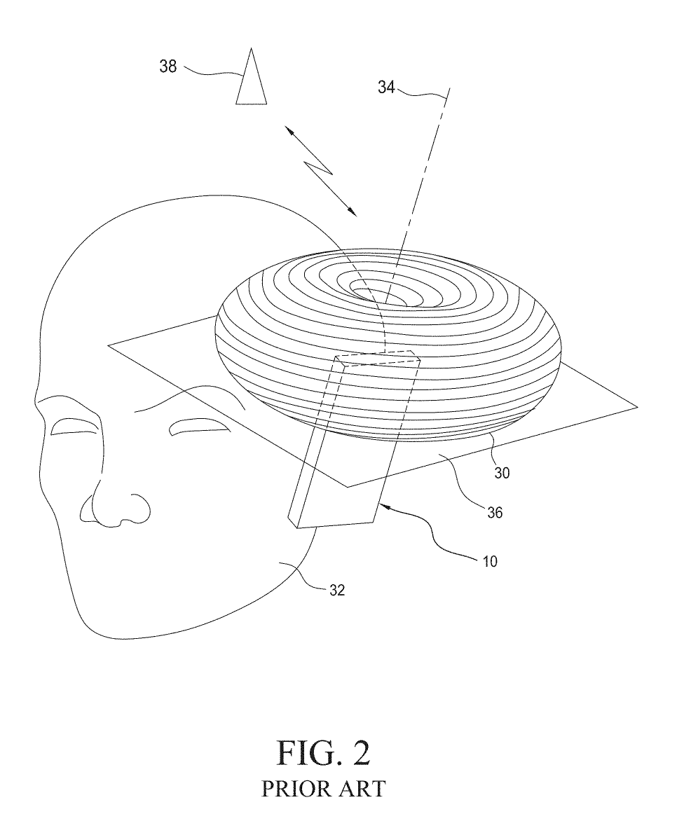

Presently disclosed inventions protect all sensitive organs that are associated with damage due to use of mobile communication devices of the prior art, such as the devices of FIGS. 1 and 2. Studies have shown an association of use of mobile communication devices of the prior art and development of brain cancer and gliomas [Grell K, et al., The Intracranial Distribution of Gliomas in Relation to Exposure from Mobile Phones: Analyses from the INTERPHONE Study. Am J Epidemiol. 2016 Dec. 1; 184(11):818-828. Epub 2016 Nov. 3]. Moreover, investigations show that the side of the cancer was associated with the reported side of placement of the mobile communication device of the prior art, and the association was independent of the cumulative call time and cumulative number of calls, indicating increased risk even during short term use of mobile communication devices of the prior art. Changes in thyroid and thyroid hormones have also been linked to use of mobile communication devices of the prior art [Mortavazi A, et al., Alterations in TSH and Thyroid Hormones following Mobile Phone Use. Oman Med J. 2009 October; 24(4): 274-278. doi: 10.5001/omj.2009.56 PMCID: PMC3243874]. Large population studies also have shown an association of use of mobile communication devices of the prior art and development of salivary gland cancer [Sadetzki S, et al. Cellular phone use and risk of benign and malignant parotid gland tumors—a nationwide case-control study. Am J Epidemiol. 2008 Feb. 15; 167(4):457-67. Epub 2007 Dec. 6]. Embodiments of the present disclosure provide configurations that minimize radiation exposure (including radio frequency energy, infrared energy, heat, microwave and electromagnetic energy) by mobile communication devices including embodiments with configurations involving at least one of the following components, namely speaker, microphone, antenna, processor, battery, charging port, and other radiation emitting components, or a configuration that combines at least two of those components.

Advantages and features of the embodiments of this disclosure will become more apparent from the following detailed description of exemplary embodiments when viewed in conjunction with the accompanying drawings.

A large amount of scientific data shows the risk of radiation associated with the use of mobile communication devices of the prior art, including increase in brain cancer of the temporal lobe [Pathophysiology. 2015 March; 22(1):1-13. doi: 10.1016/j.pathophys.2014.10.001. Epub 2014 Oct. 29.], which is exactly one of the sensitive organs protected by the biologically compatible mobile communication devices of the present disclosure.

Below is a sample of additional scientific data (to the other references and data provided) showing the disadvantages and limitations of the prior art that includes various types of cancer of the brain and ear, showing the need for the advantages of the configurations of the present invention, including, but not limited to, speaker-antenna, speaker-microphone, speaker-antenna-microphone, speaker-antenna-microphone-battery and the various combinations disclosed herein.
(1) Occup Environ Med. 2007 September; 64(9):626-32. Epub 2007 Apr. 4. Long-term use of cellular phones and brain tumours: increased risk associated with use for > or =10 years. Hardell L1, Carlberg M, Söderqvist F, Mild K H, Morgan L L.
(2) Eur J Cancer Prev. 2001 December; 10(6):523-9. Ionizing radiation, cellular telephones and the risk for brain tumours. Hardell L1, Mild K H, Påhlson A, Hallquist A.
(3) Eur J Cancer Prev. 2002 August; 11(4):377-86. Cellular and cordless telephones and the risk for brain tumours. Hardell L1, Hallquist A, Mild K H, Carlberg M, Påhlson A, Lilja A.
(4) Occup Environ Med. 2007 September; 64(9):626-32. Epub 2007 Apr. 4. Long-term use of cellular phones and brain tumours: increased risk associated with use for > or =10 years. Harden L1, Carlberg M, Söderqvist F. Mild K H, Morgan L L.
(5) Int J Oncol. 2013 December; 43(6):1833-45. doi: 10.3892/ijo.2013.21111. Epub 2013 Sep. 24. Case-control study of the association between malignant brain tumours diagnosed between 2007 and 2009 and mobile and cordless phone use. Hardell L1, Carlberg M, Söderqvist F, Mild K H.
(6) Int J Oncol, 2015 May; 46(5):1865-71. doi: 10.3892/ijo.2015.2908. Epub 2015 Feb. 25. Mobile phone radiation causes brain tumors and should be classified as a probable human carcinogen (2A) (review). Morgan LL1, Miller AB2, Sasco A3, Davis DL1.
(7) Int J Oncol. 2013 October; 43(4):1036-44. doi: 10.3892/ijo.2013.2025. Epub 2013 Jul. 22. Pooled analysis of case-control studies on acoustic neuroma diagnosed 1997-2003 and 2007-2009 and use of mobile and cordless phones. Hardell L1, Carlberg M, Söderqvist F, Mild K H.
(8) Surg Neurol. 2009 September; 72(3):205-14: discussion 214-5. doi: 10.1016/j.surneu.2009.01.019. Epub 2009 Mar. 27. Cell phones and brain tumors: a review including the long-term epidemiologic data. Khurana VG1, Teo C, Kundi M, Harden L, Carlberg M.
(9) Pathophysiology. 2009 August; 16(2-3): 113-22. doi: 10.1016/j.pathophys.2009.01.003. Epub 2009 Mar. 5. Epidemiological evidence for an association between use of wireless phones and tumor diseases. Harden L1, Carlberg M, Hansson Mild K.
(10) Pathophysiology. 2011 September; 18(4):325-3 doi: 10.1016/j.pathophys.2011.06.001. Epub 2011 Jul. 18. Case-control study on the use of mobile and cordless phones and the risk for malignant melanoma in the head and neck region. Hardell L1 Carlberg M, Hansson Mild K, Eriksson M.
(11) Pathophysiology. 2015 March; 22(1):1-13. doi: 10.1016/j.pathophys.2014.10.001. Epub 2014 Oct. 29. Mobile phone and cordless phone use and the risk for glioma—Analysis of pooled case-control studies in Sweden, 1997-2003 and 2007-2009. Hardell L1, Carlberg M2.
(12) Pathophysiology. 2013 April; 20(2):123-9. doi: 10.1016/j.pathophys.20:13.03.001. Epub 2013 May 7. Swedish review strengthens grounds for concluding that radiation from cellular and cordless phones is a probable human carcinogen. Davis DL1, Kesari S, Soskolne C L, Miller A B, Stein Y.
(13) Int J Oncol. 2008 May; 3(5):1097-103. Meta-analysis of long-term mobile phone use and the association with brain tumours. Harden L1, Carlberg M, Söderqvist F, Hansson Mild K.
(14) Bioelectromagnetics. 2011 February; 32(2):85-93. doi: 10.1002/bem.20616. Epub 2010 Oct. 28. A case-case study of mobile phone use and acoustic neuroma risk in Japan. Sato Y1, Akiba S, Kuho O, Yamaguchi N.

### BRIEF DESCRIPTION OF THE DRAWINGS

FIG. 1 shows a perspective view of a conventional mobile communication device.

FIG. 2 shows a view of the conventional mobile communication device of FIG. 1, showing a stylized radiation pattern.

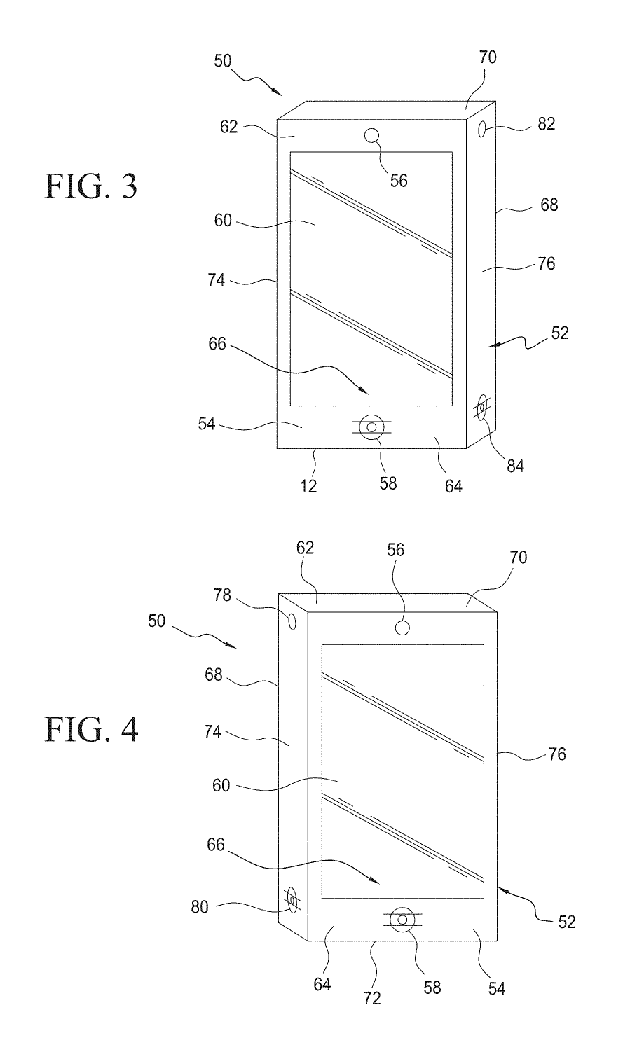

FIG. 3 shows a first perspective view of a mobile communication device in accordance with an exemplary embodiment of the present disclosure.

FIG. 4 shows a second perspective view of the mobile communication device of FIG. 3.

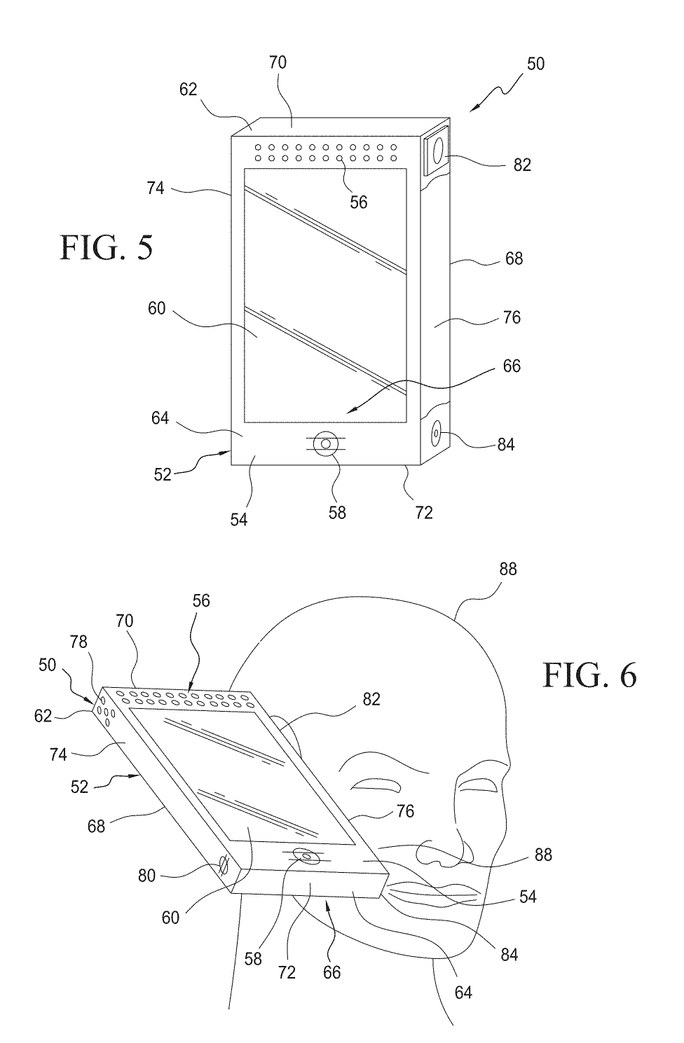

FIG. 5 shows a perspective view of the mobile communication device of FIG. 3 with portions of a housing or casing of the mobile communication device removed.

FIG. 6 shows a view of the mobile communication device of FIG. 3 being operated by a user.

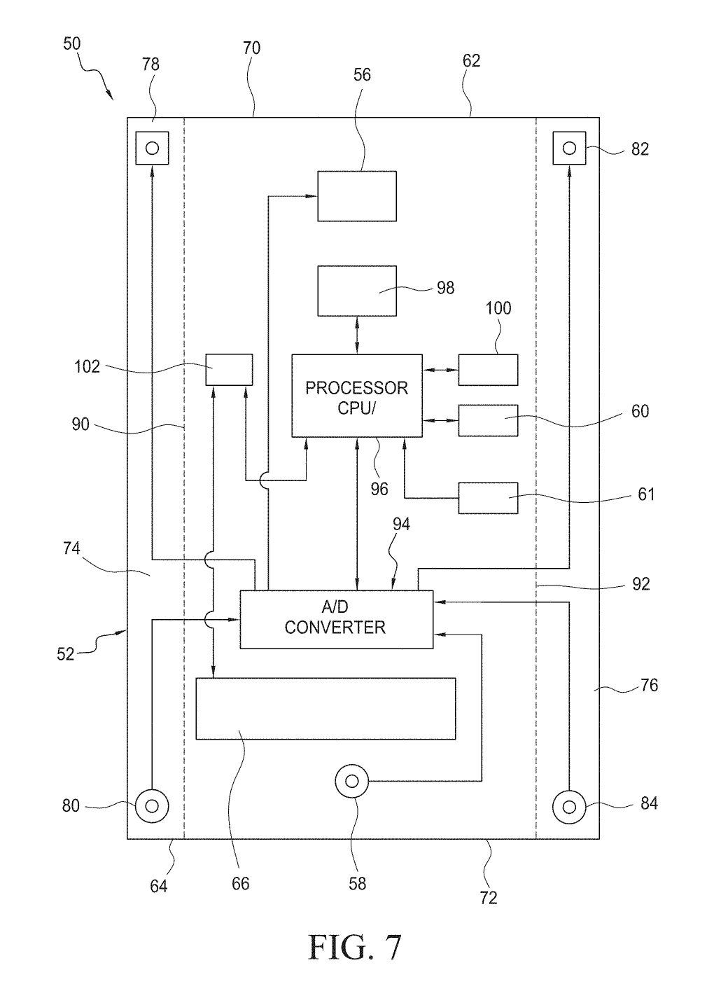

FIG. 7 shows a block diagram of the mobile communication device of FIG. 3.

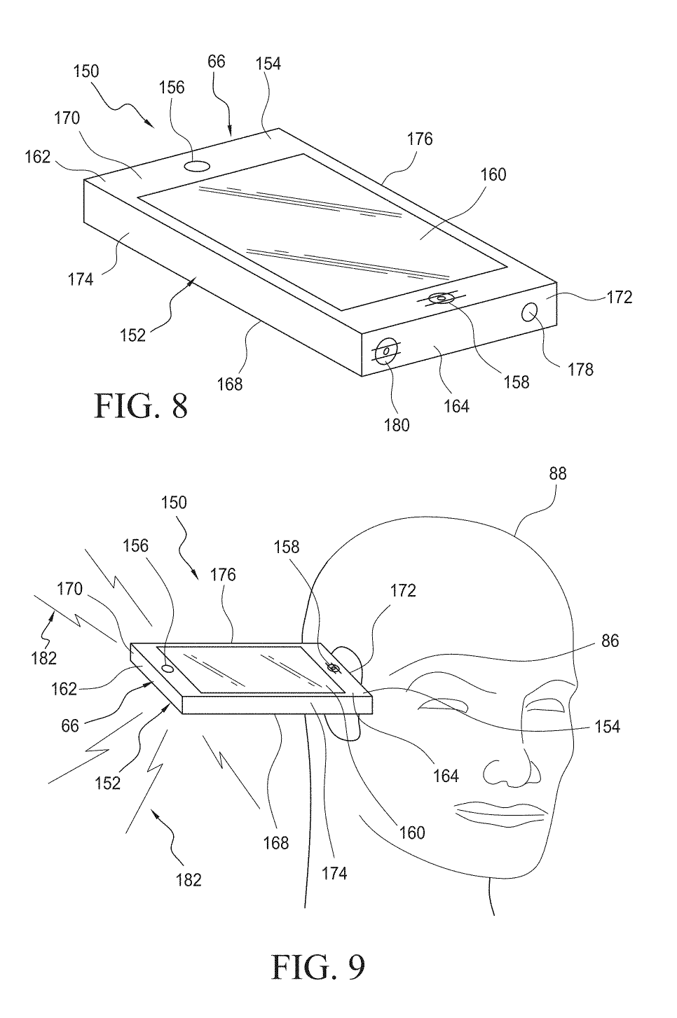

FIG. 8 shows a perspective view of a mobile communication device in accordance with an exemplary embodiment of the present disclosure.

FIG. 9 shows a view of the mobile communication device of FIG. 8 being operated by a user.

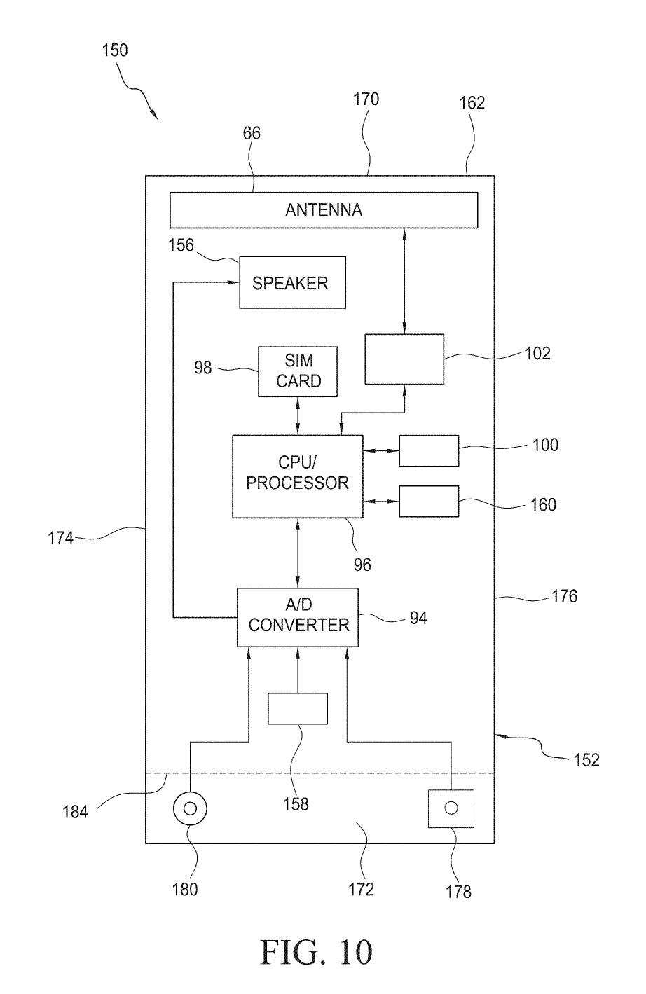

FIG. 10 shows a block diagram of the mobile communication device of FIG. 8.

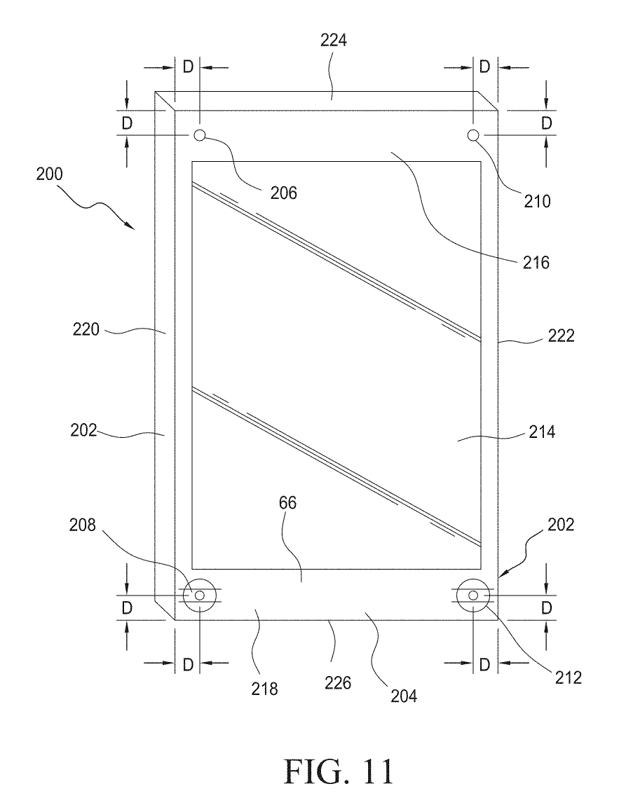

FIG. 11 shows a perspective view of a mobile communication device in accordance with an exemplary embodiment of the present disclosure.

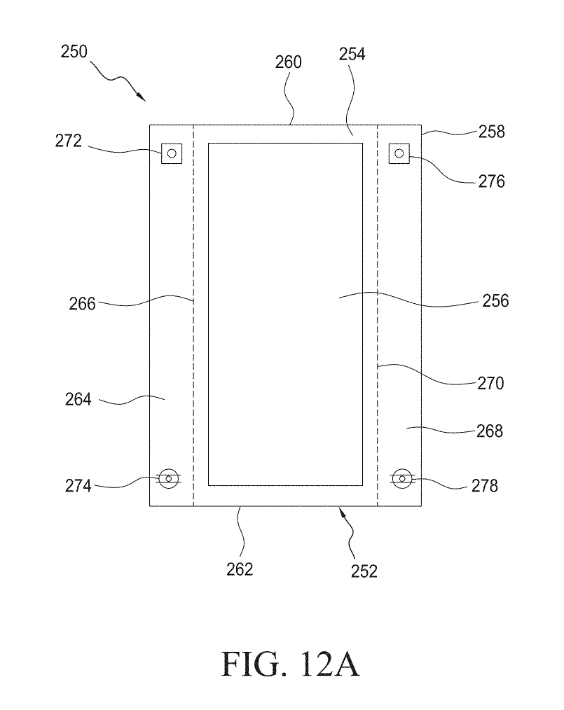

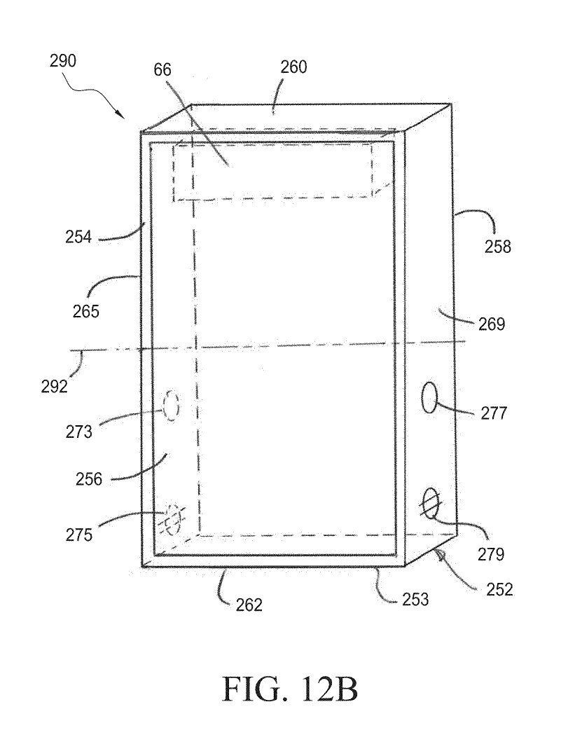

FIG. 12A shows a simplified block diagram of a mobile communication device in accordance with another exemplary embodiment of the present disclosure.

FIG. 12B shows a simplified block diagram of a mobile communication device in accordance with a further exemplary embodiment of the present disclosure.

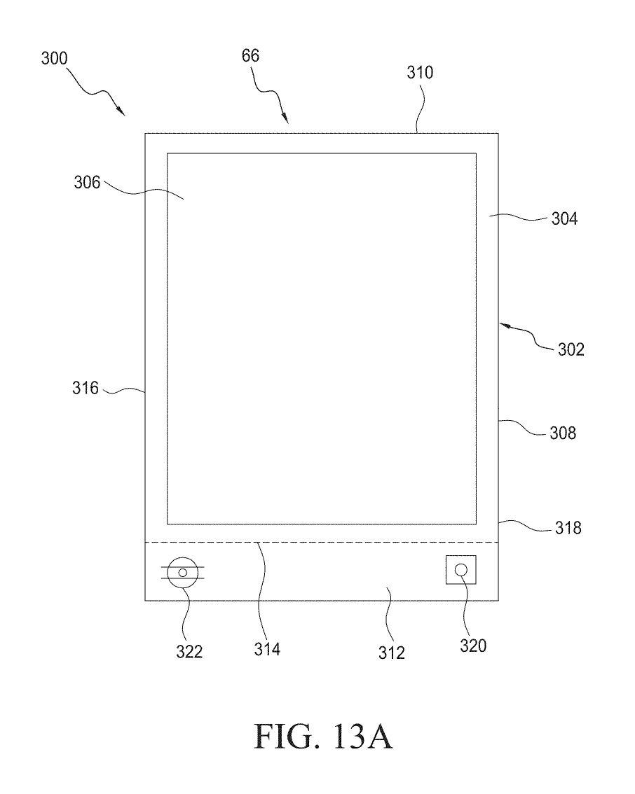

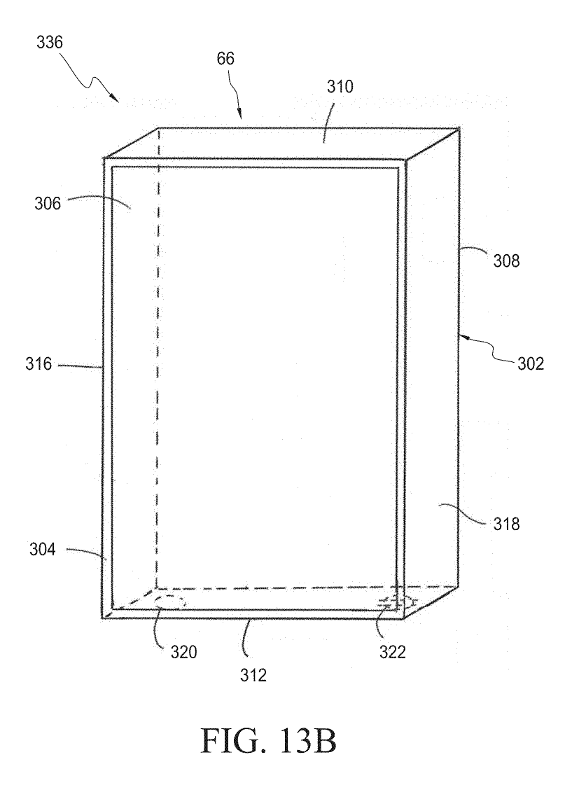

FIG. 13A shows a simplified block diagram of a mobile communication device in accordance with yet another exemplary embodiment of the present disclosure.

FIG. 13B shows a perspective view of a mobile communication device in accordance with yet another exemplary embodiment of the present disclosure.

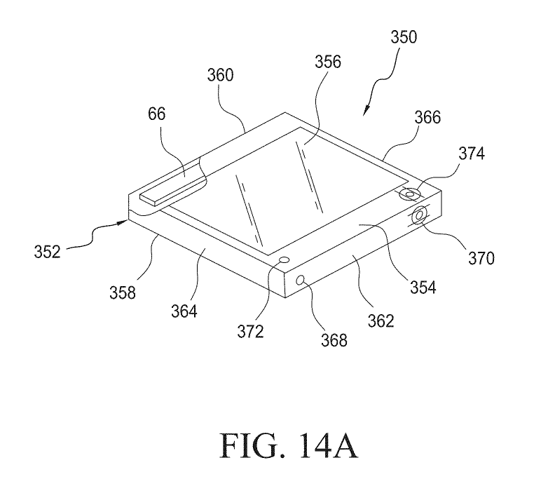

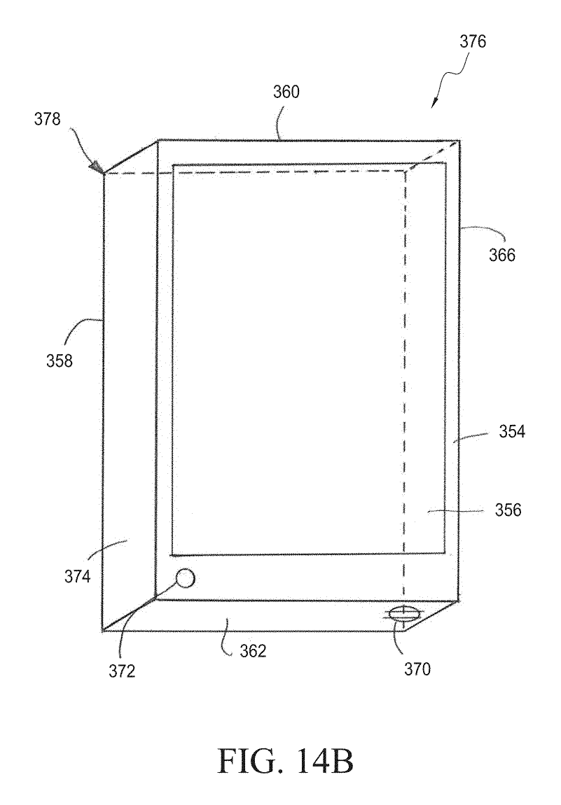

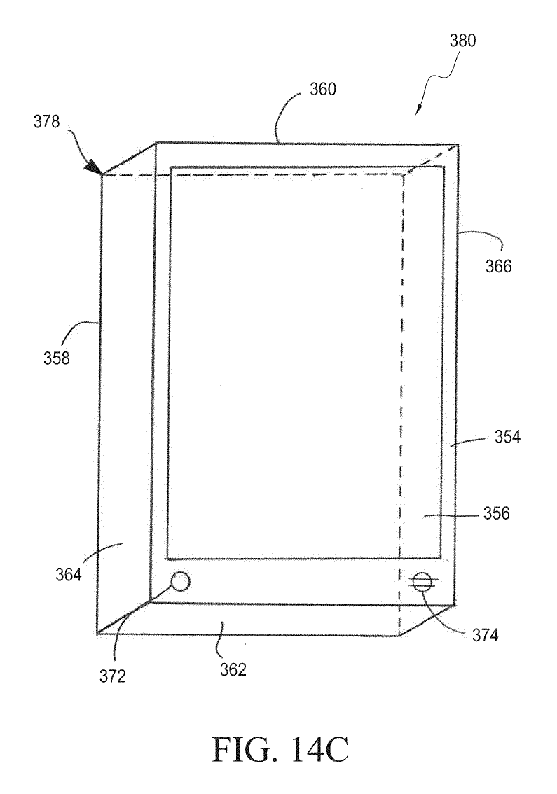

FIG. 14A shows a perspective view of a mobile communication device in accordance with a further exemplary embodiment of the present disclosure.

FIG. 14B shows a perspective view of a mobile communication device in accordance with a yet further exemplary embodiment of the present disclosure.

FIG. 14C shows a perspective view of a mobile communication device in accordance with a still yet further exemplary embodiment of the present disclosure.

FIG. 15 shows a view of a mobile communication device in accordance with another exemplary embodiment of the present disclosure being operated by a user.

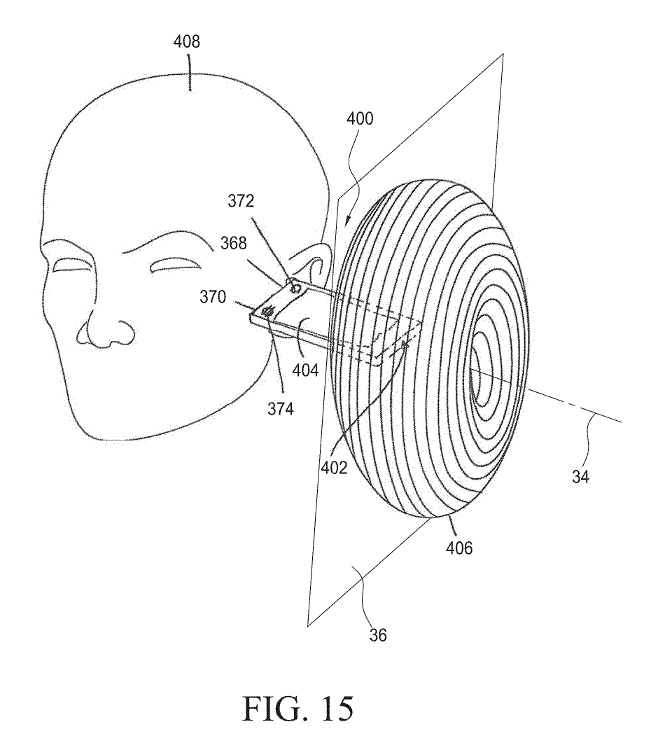

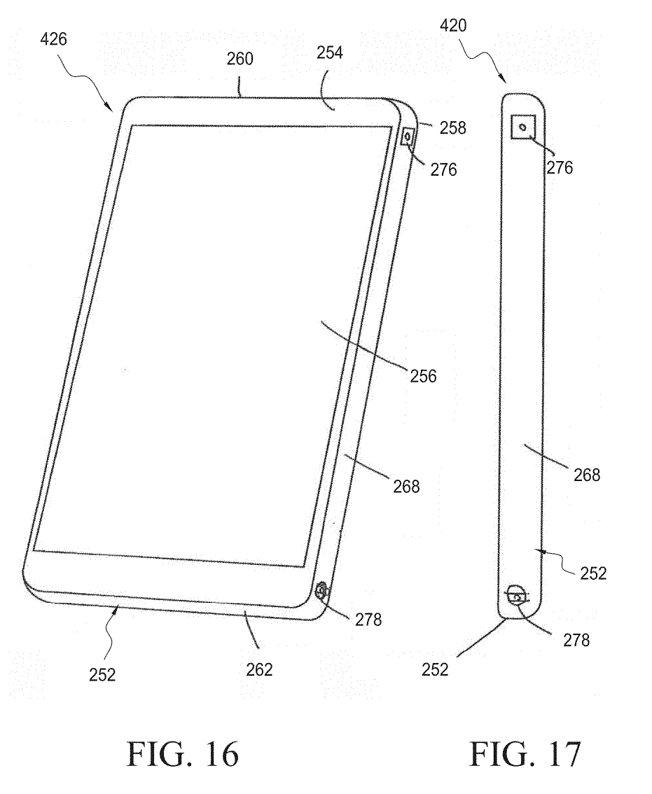

FIG. 16 shows a perspective view of a mobile communication device in accordance with yet another exemplary embodiment of the present disclosure.

FIG. 17 shows a side view of the mobile communication device of FIG. 16.

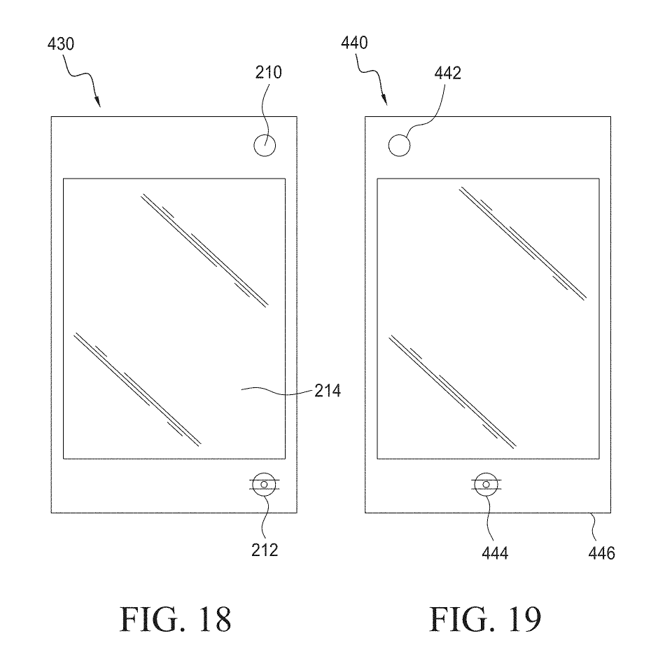

FIG. 18 shows a front view of a mobile communication device in accordance with an exemplary embodiment of the present disclosure.

FIG. 19 shows a front view of a mobile communication device in accordance with another exemplary embodiment of the present disclosure.

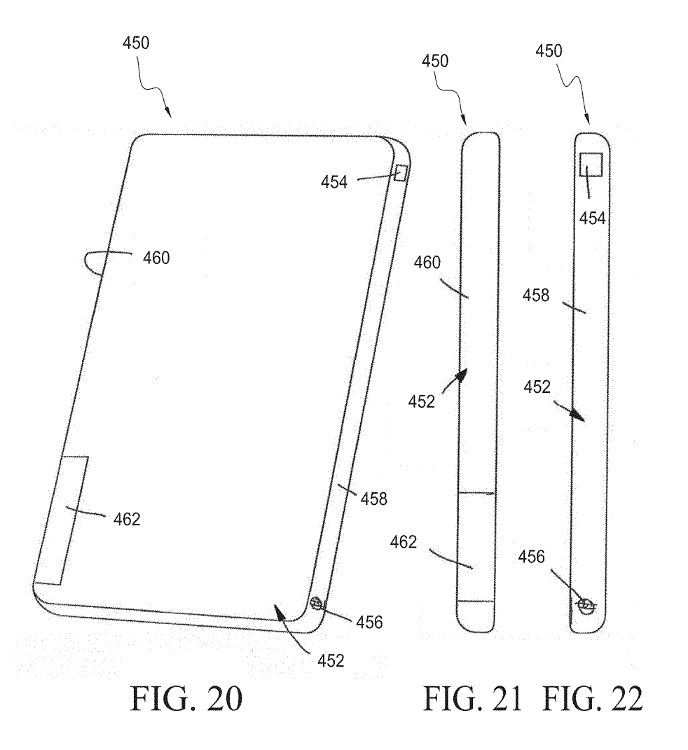

FIG. 20 shows a perspective view of a mobile communication device in accordance with an exemplary embodiment of the present disclosure.

FIG. 21 shows a first side view of the mobile communication device of FIG. 20.

FIG. 22 shows a second side view of the mobile communication device of FIG. 20.

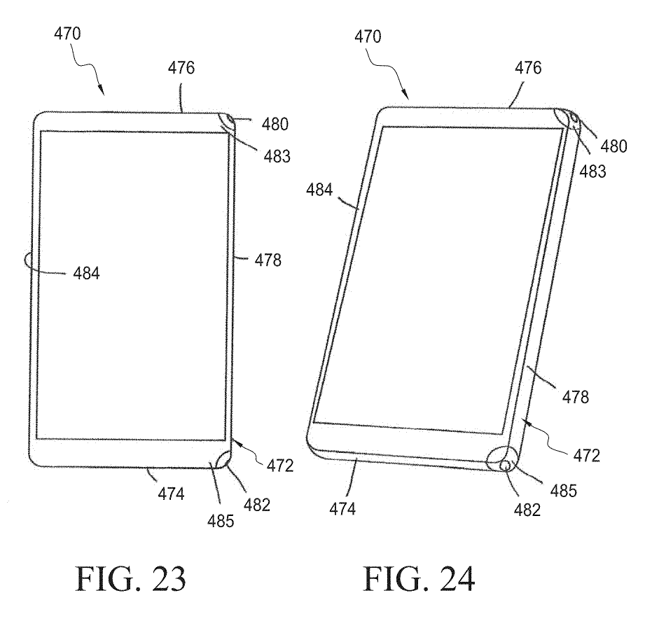

FIG. 23 shows a front view of a mobile communication device in accordance with a further exemplary embodiment of the present disclosure.

FIG. 24 shows a perspective view of the mobile communication device of FIG. 23.

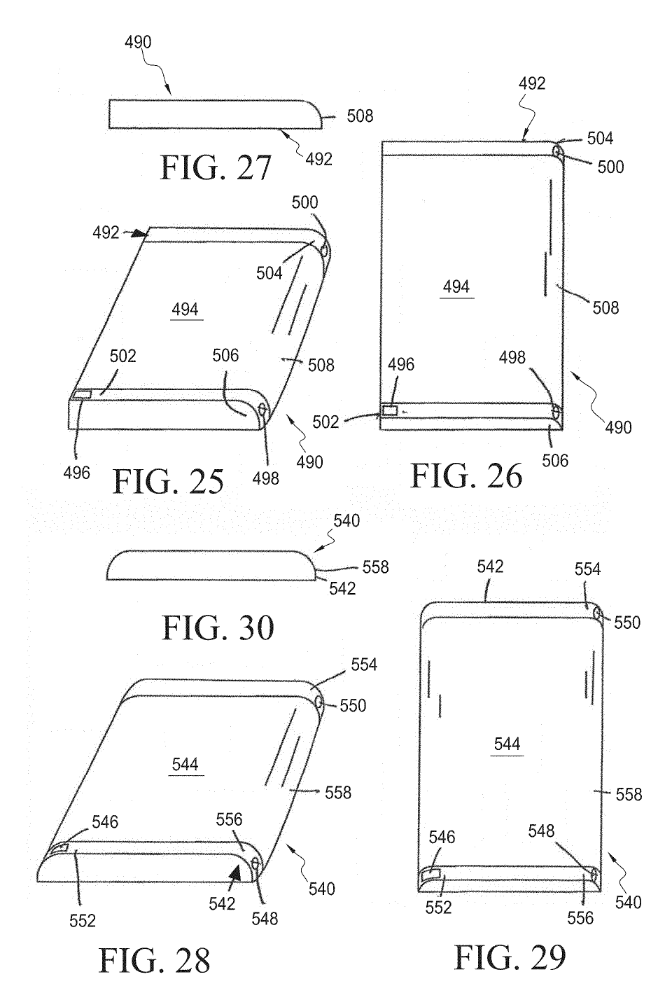

FIG. 25 shows a perspective view of a mobile communication device in accordance with still a further embodiment of the present disclosure.

FIG. 26 shows another perspective view of the mobile communication device of FIG. 25.

FIG. 27 shows a side view of the mobile communication device of FIG. 25.

FIG. 28 shows a perspective view of a mobile communication device in accordance with still a further embodiment of the present disclosure.

FIG. 29 shows another perspective view of the mobile communication device of FIG. 28.

FIG. 30 shows a side view of the mobile communication device of FIG. 28.

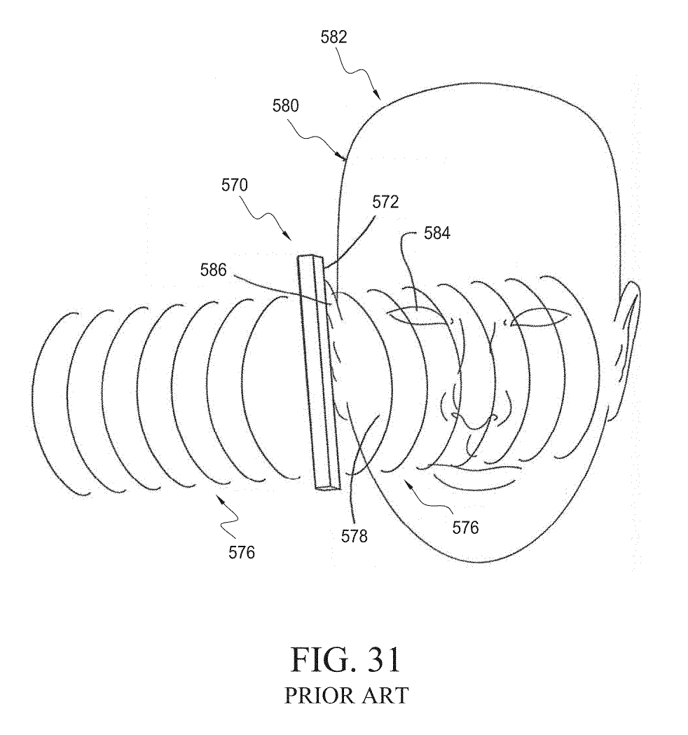

FIG. 31 shows a view of a conventional mobile communication device showing stylized thermal radiation.

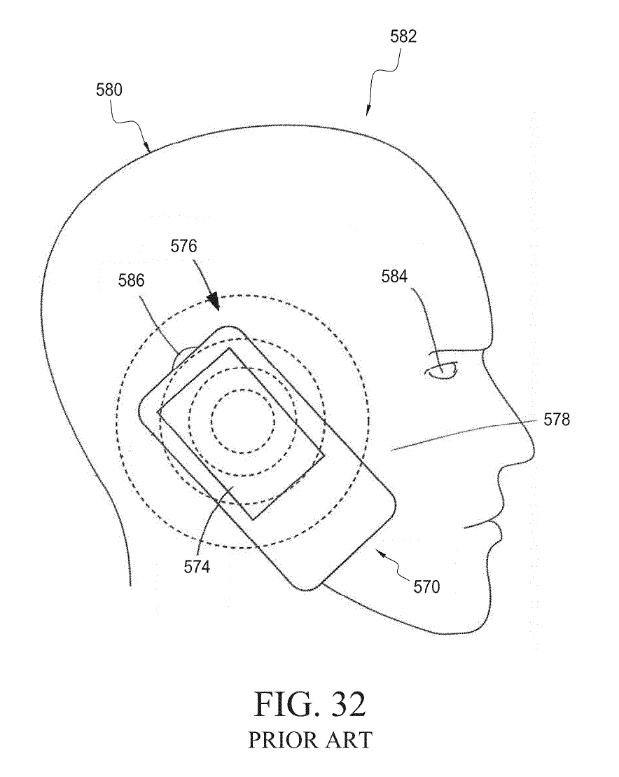

FIG. 32 shows a view of a back face of the mobile communication device of FIG. 31. The dashed lines represent heat energy.

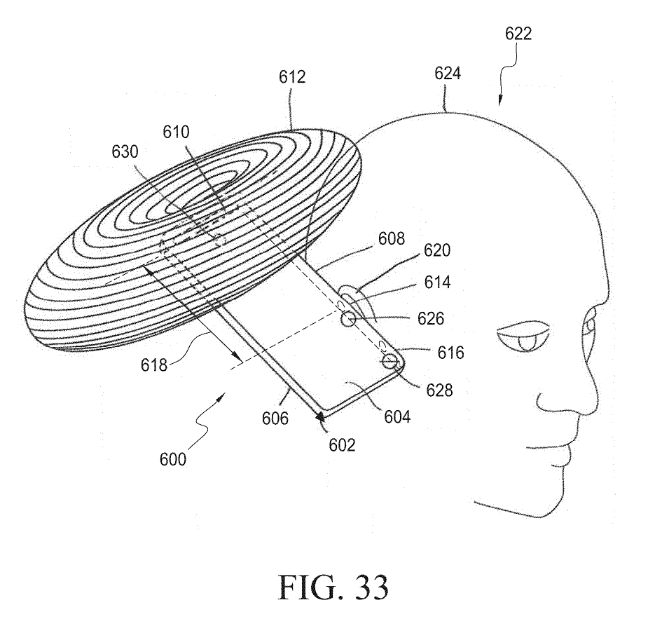

FIG. 33 shows a view of a mobile communication device in accordance with an exemplary embodiment of the present disclosure.

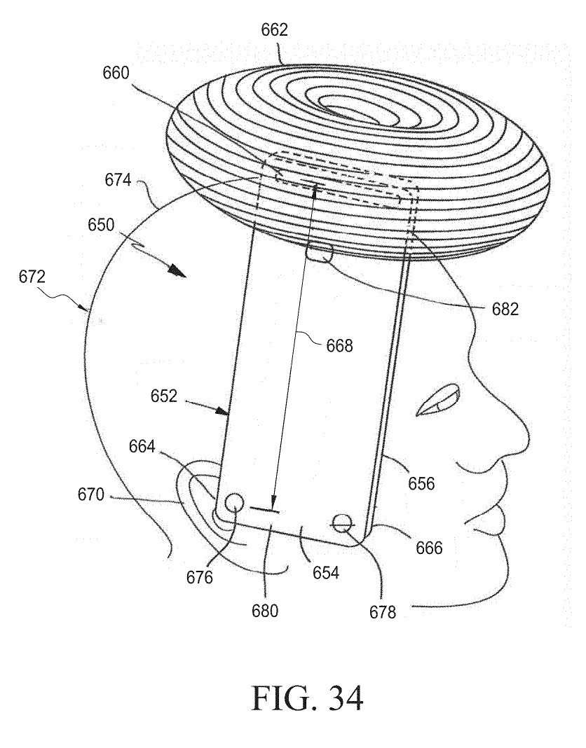

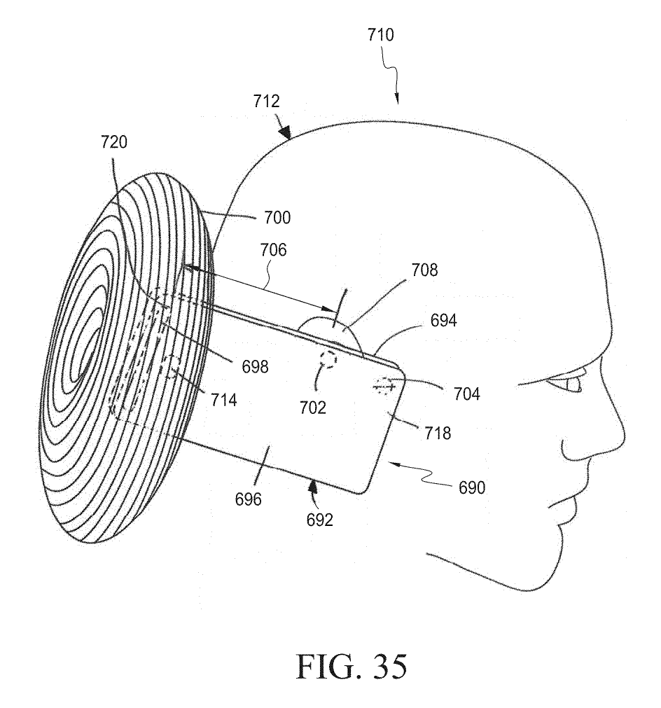

FIG. 34 shows a view of a mobile communication device in accordance with an exemplary embodiment of the present disclosure.

FIG. 35 shows a view of a mobile communication device in accordance with an exemplary embodiment of the present disclosure.

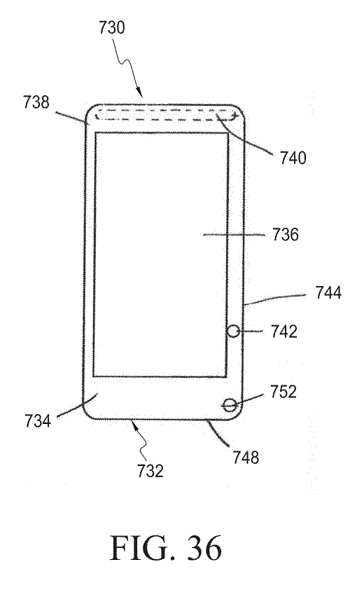

FIG. 36 shows a view of a mobile communication device in accordance with an exemplary embodiment of the present disclosure showing a speaker and microphone on a front or back face.

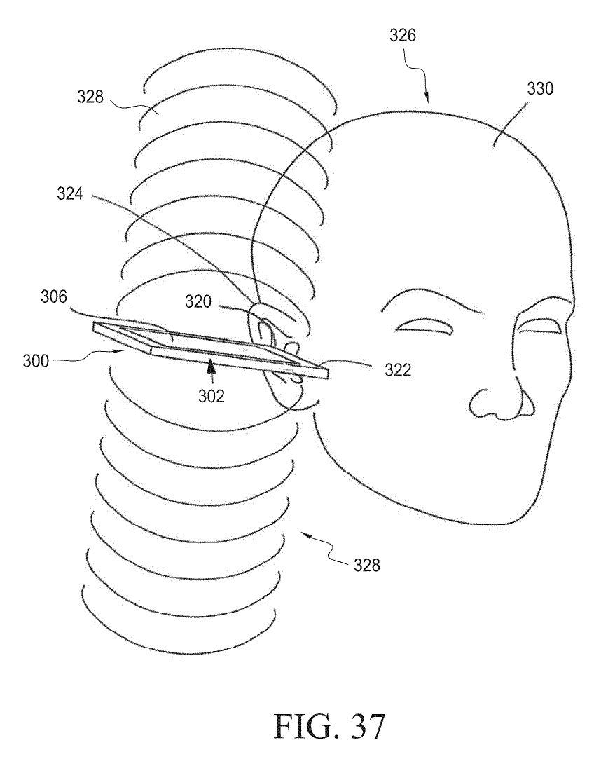

FIG. 37 shows a view of the mobile communication device of FIG. 13A showing stylized thermal radiation.

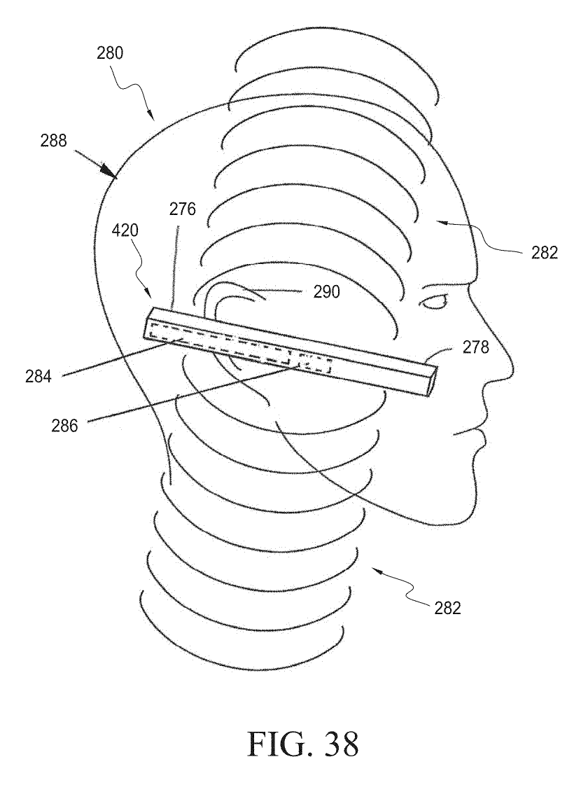

FIG. 38 shows a view of a mobile communication device in accordance with an exemplary embodiment of the present disclosure.

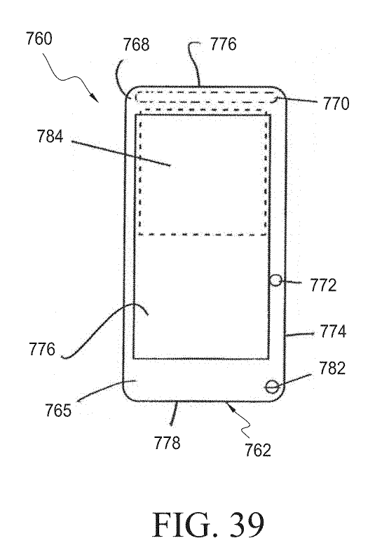

FIG. 39 shows a view of a mobile communication device in accordance with an exemplary embodiment of the present disclosure.

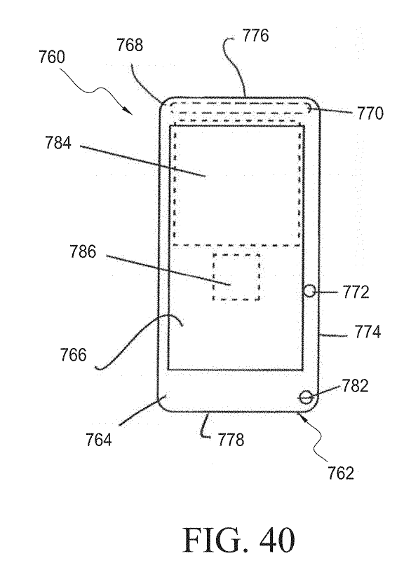

FIG. 40 shows another view of the mobile communication device of FIG. 39.

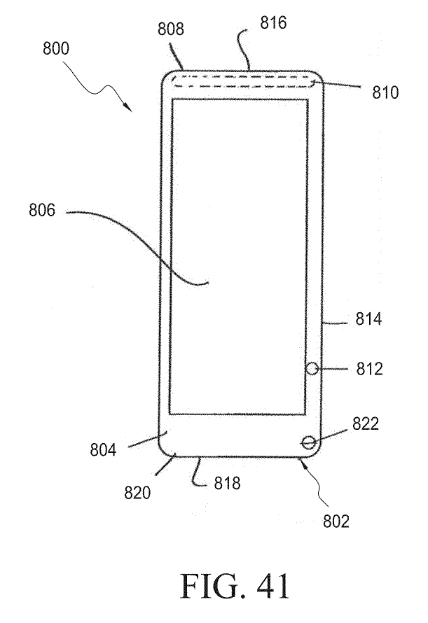

FIG. 41 shows another view of the mobile communication device of FIG. 40.

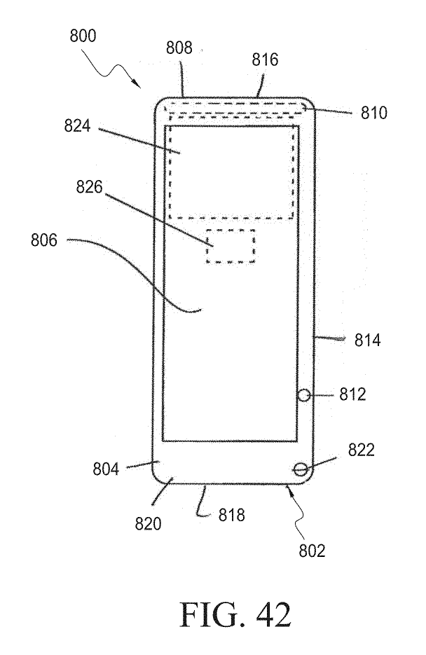

FIG. 42 shows a view of a mobile communication device in accordance with an exemplary embodiment of the present disclosure.

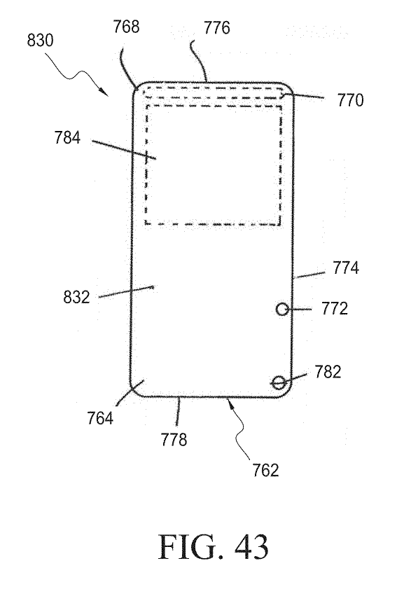

FIG. 43 shows a view of a mobile communication device in accordance with an exemplary embodiment of the present disclosure.

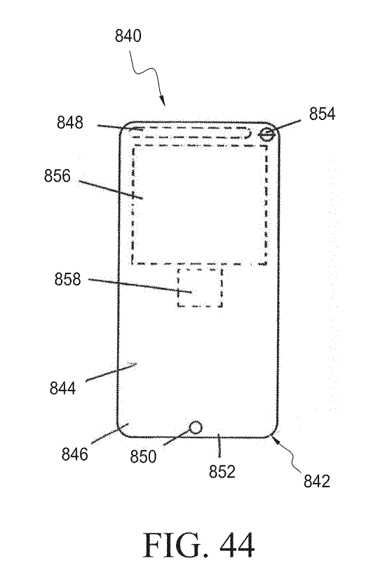

FIG. 44 shows a view of a mobile communication device in accordance with an exemplary embodiment of the present disclosure.

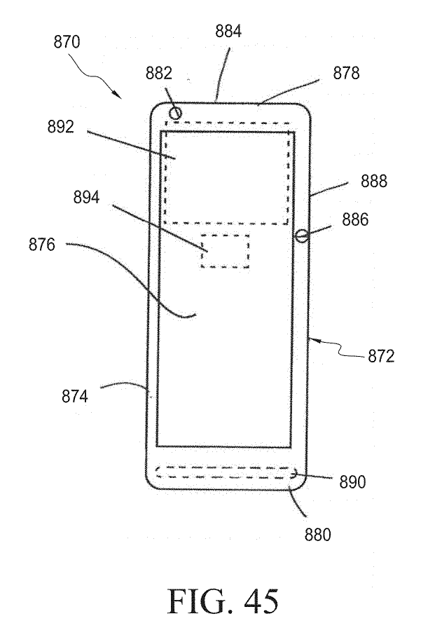

FIG. 45 shows a view of a mobile communication device in accordance with an exemplary embodiment of the present disclosure.

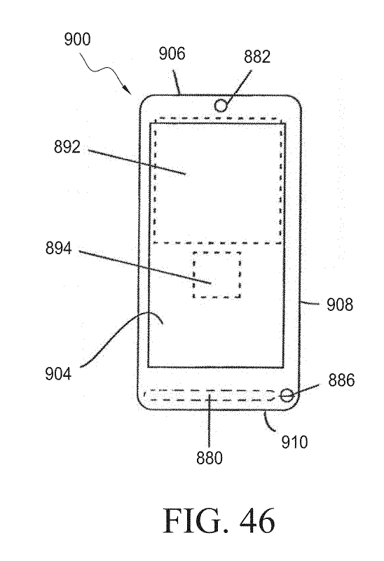

FIG. 46 shows a view of a mobile communication device in accordance with an exemplary embodiment of the present disclosure.

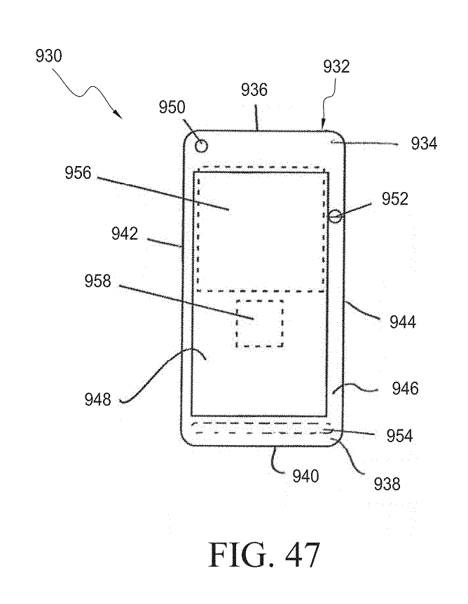

FIG. 47 shows a view of a mobile communication device in accordance with an exemplary embodiment of the present disclosure.

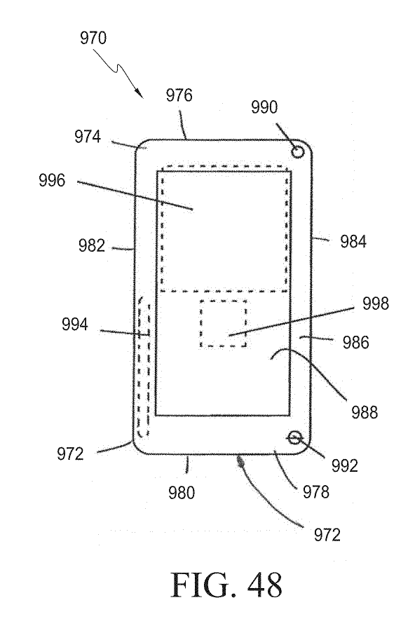

FIG. 48 shows a view of a mobile communication device in accordance with an exemplary embodiment of the present disclosure.

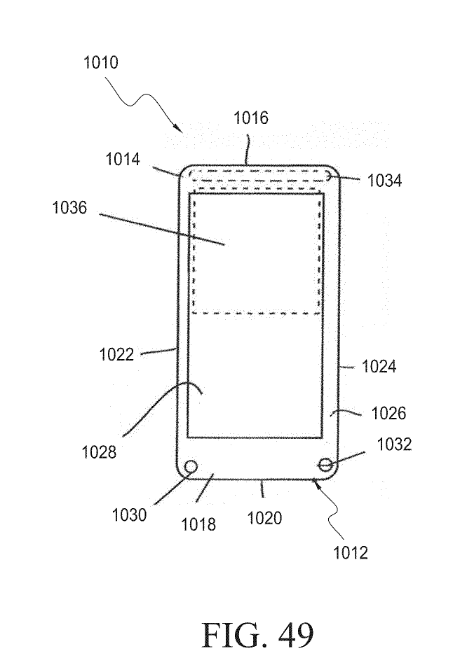

FIG. 49 shows a view of a mobile communication device in accordance with an exemplary embodiment of the present disclosure.

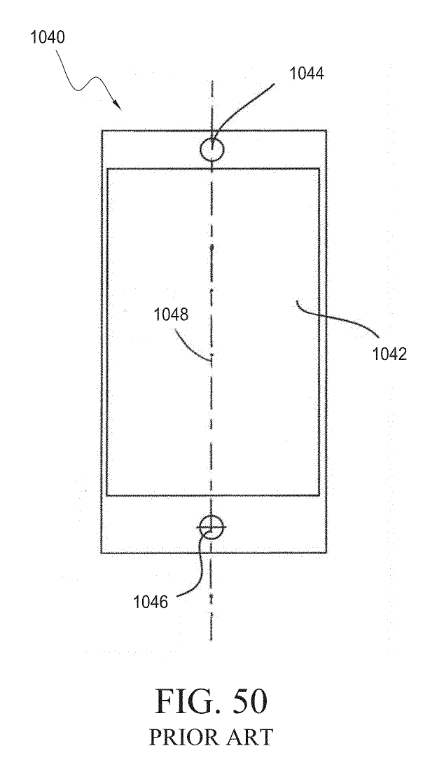

FIG. 50 shows a view of a conventional mobile communication device.

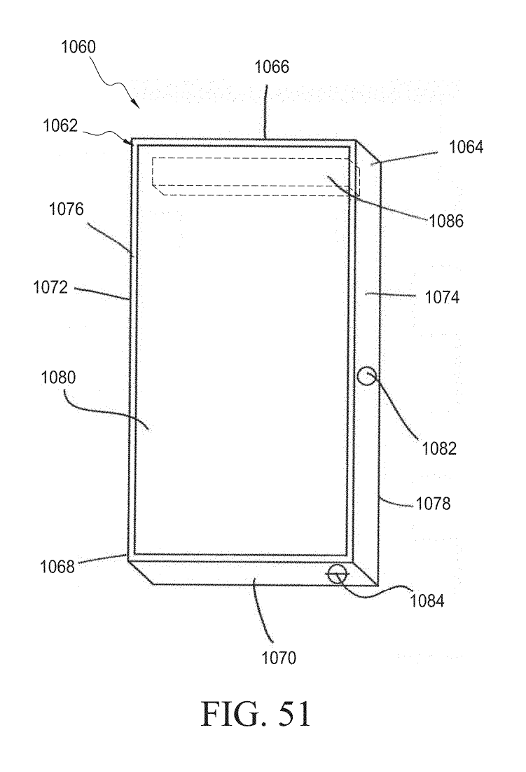

FIG. 51 shows a view of a mobile communication device in accordance with an exemplary embodiment of the present disclosure.

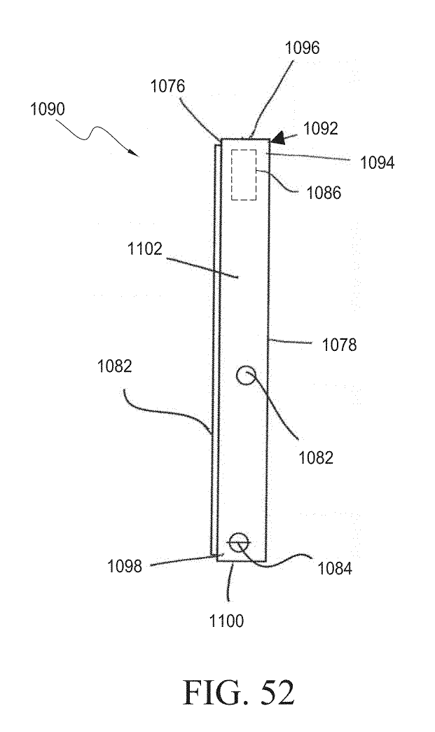

FIG. 52 shows a view of another mobile communication device in accordance with an exemplary embodiment of the present disclosure.

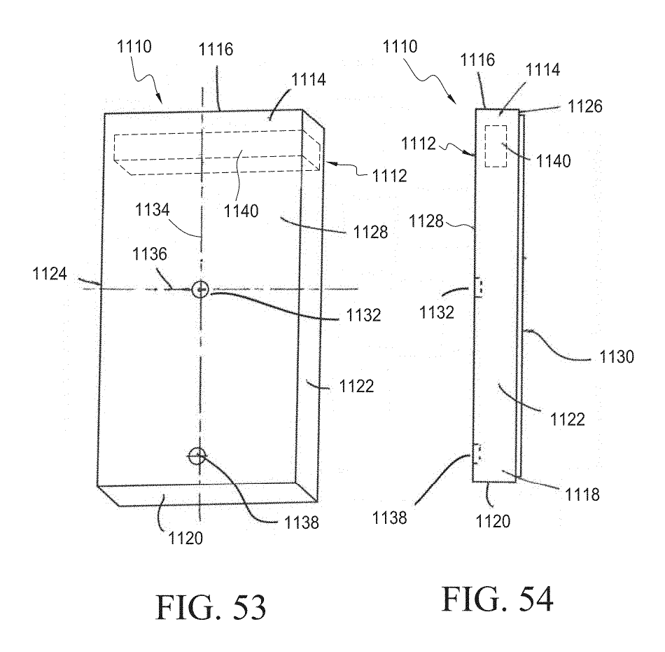

FIG. 53 shows a view of a further mobile communication device in accordance with an exemplary embodiment of the present disclosure.

FIG. 54 shows a side view of the mobile communication device of FIG. 53.

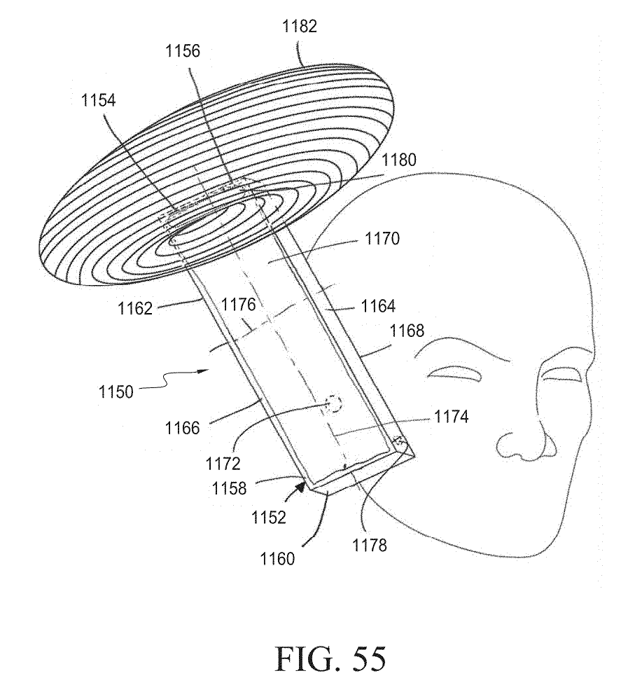

FIG. 55 shows a view of yet another mobile communication device in accordance with an exemplary embodiment of the present disclosure.

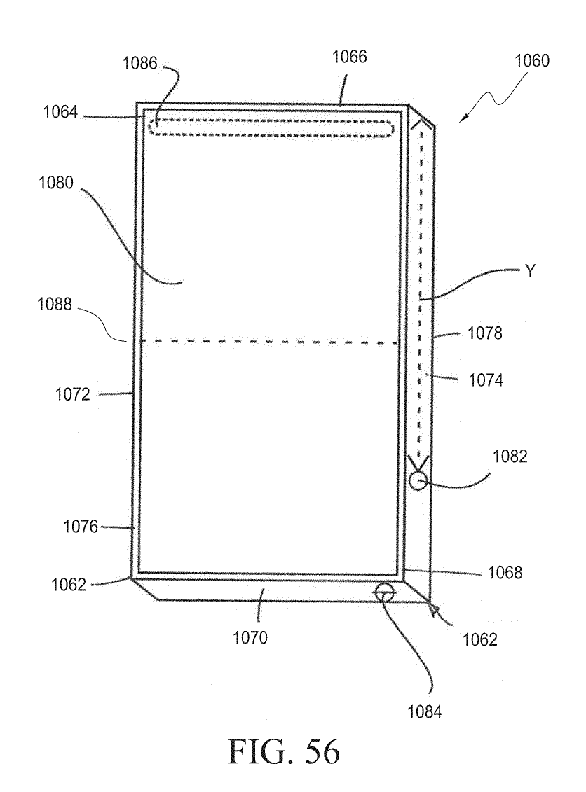

FIG. 56 shows a view of still another mobile communication device in accordance with an exemplary embodiment of the present disclosure.

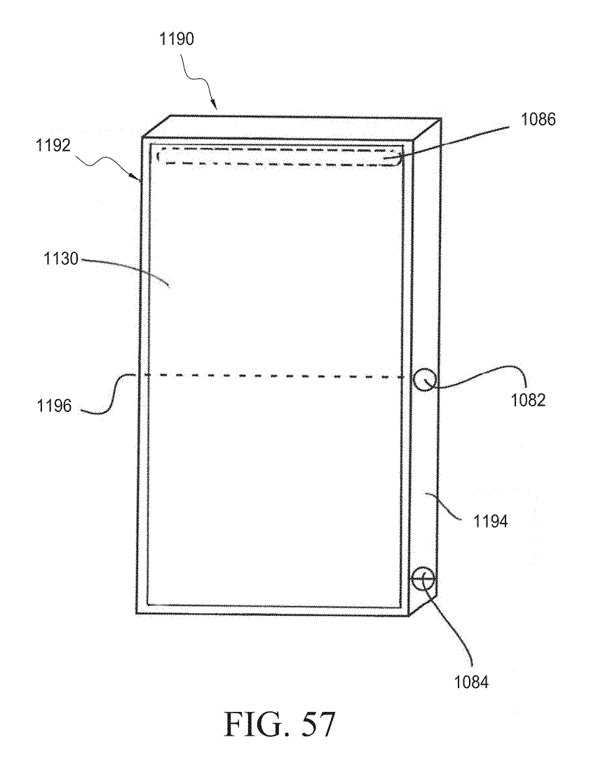

FIG. 57 shows a view of an even further mobile communication device in accordance with an exemplary embodiment of the present disclosure.

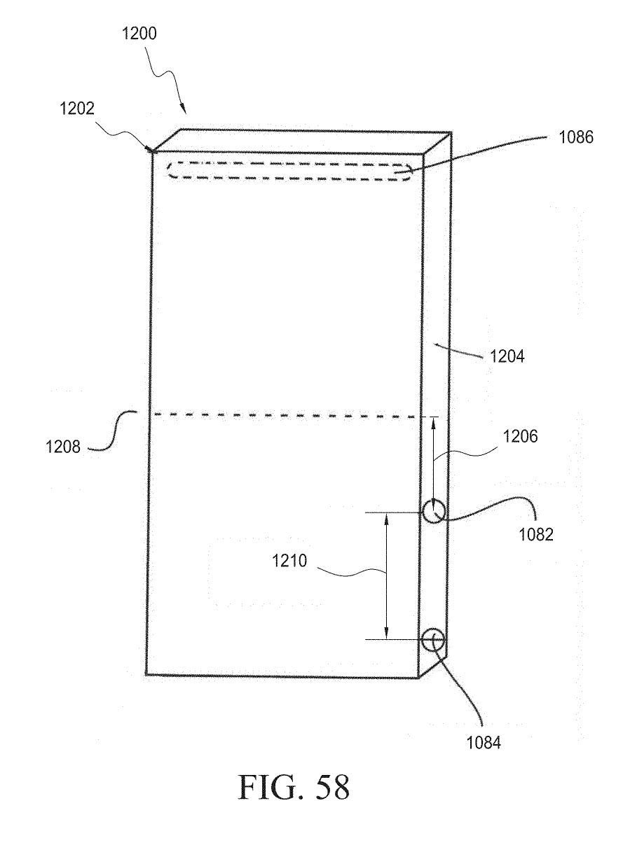

FIG. 58 shows a view of still yet another mobile communication device in accordance with an exemplary embodiment of the present disclosure.

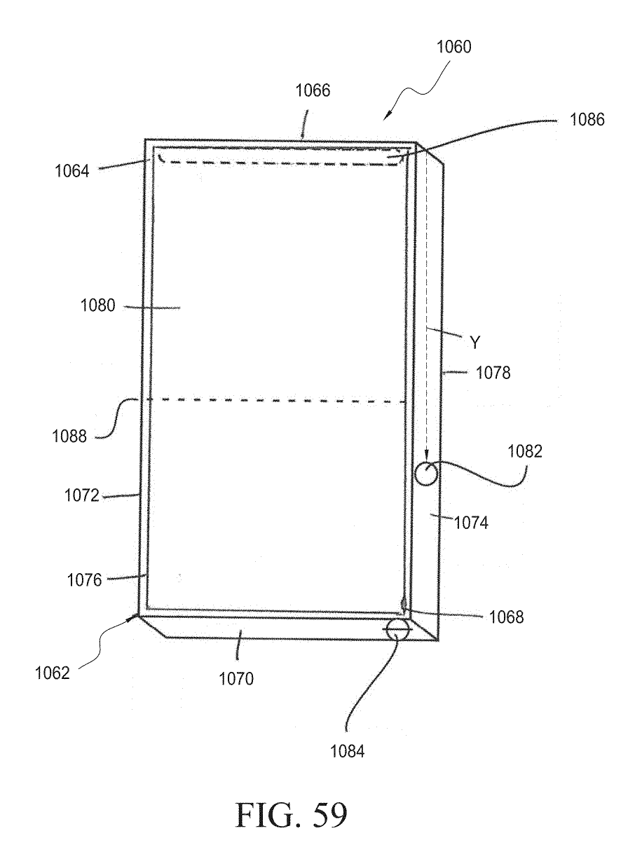

FIG. 59 shows a view of another mobile communication device in accordance with an exemplary embodiment of the present disclosure.

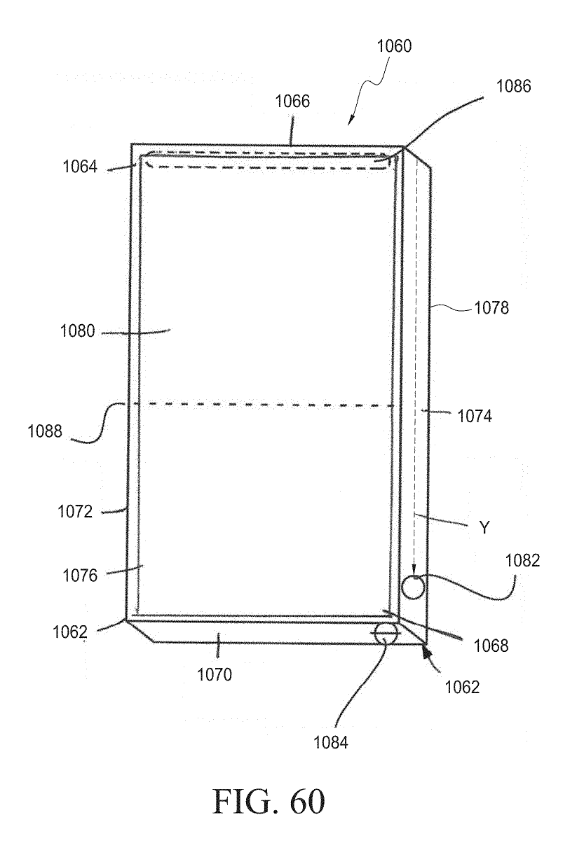

FIG. 60 shows a view of a mobile communication device in accordance with an exemplary embodiment of the present disclosure.

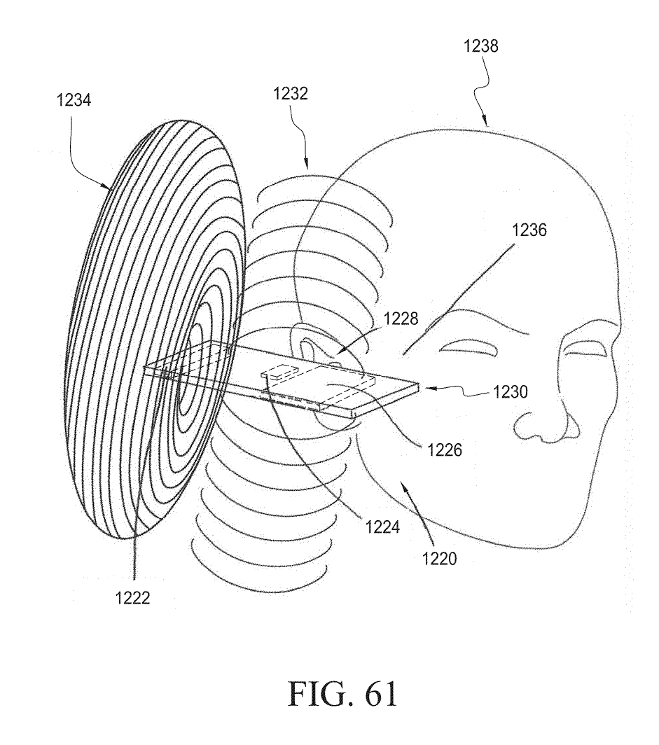

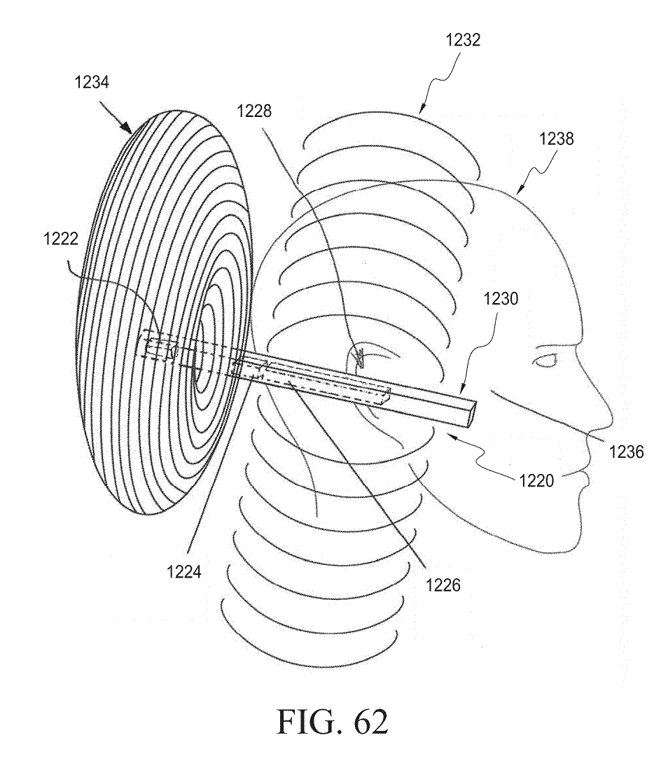

FIG. 61 shows a view of a mobile communication device in accordance with an exemplary embodiment of the present disclosure.

FIG. 62 shows another view of the mobile communication device of FIG. 61.

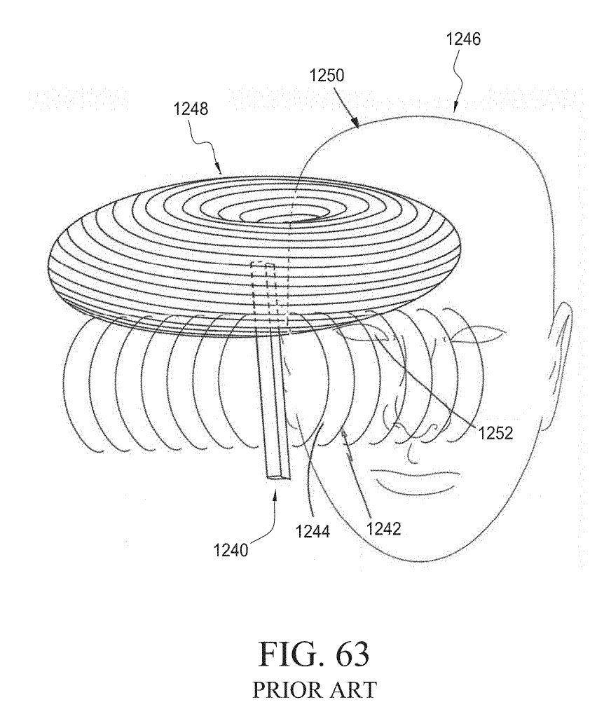

FIG. 63 shows a view of a conventional mobile communication device showing RF radiation and thermal radiation.

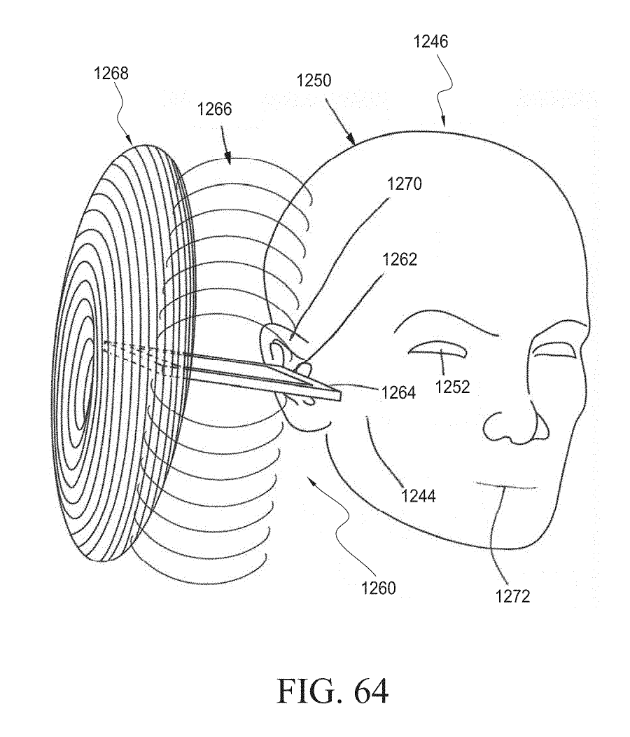

FIG. 64 shows a view of a mobile communication device in accordance with an exemplary embodiment of the present disclosure.

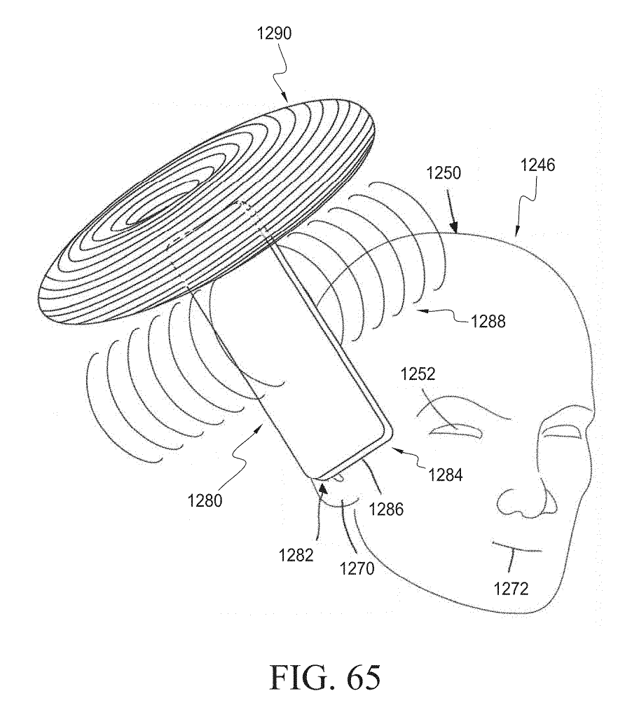

FIG. 65 shows a view of another mobile communication device in accordance with an exemplary embodiment of the present disclosure.

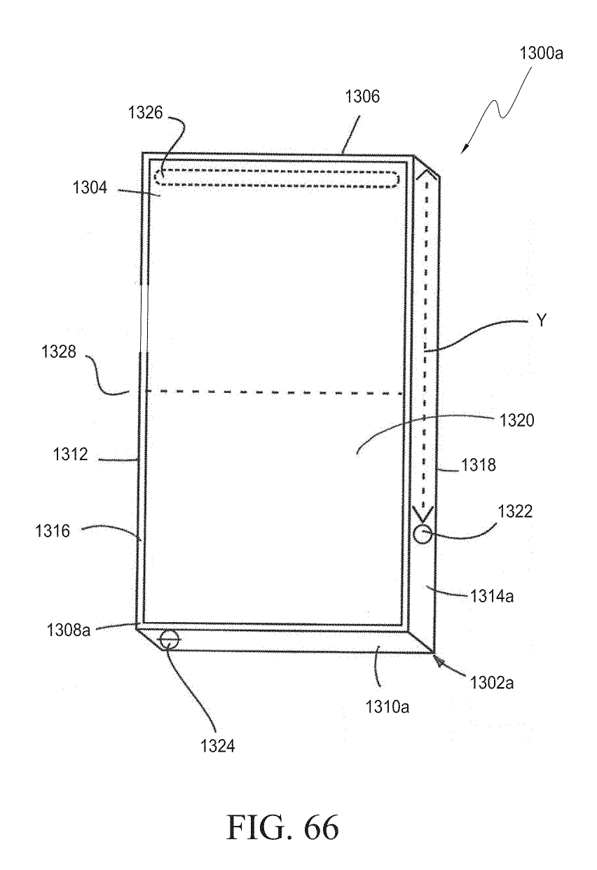

FIG. 66 shows a view of yet another mobile communication device in accordance with an exemplary embodiment of the present disclosure.

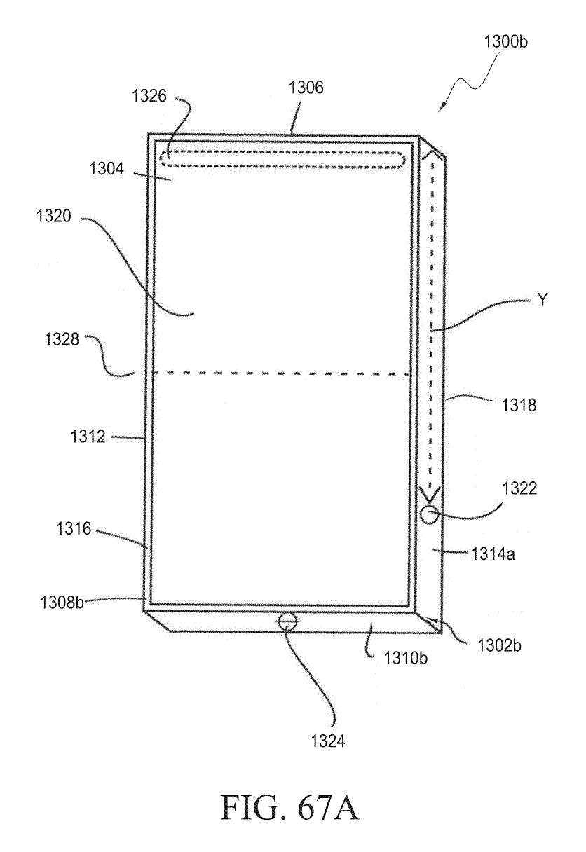

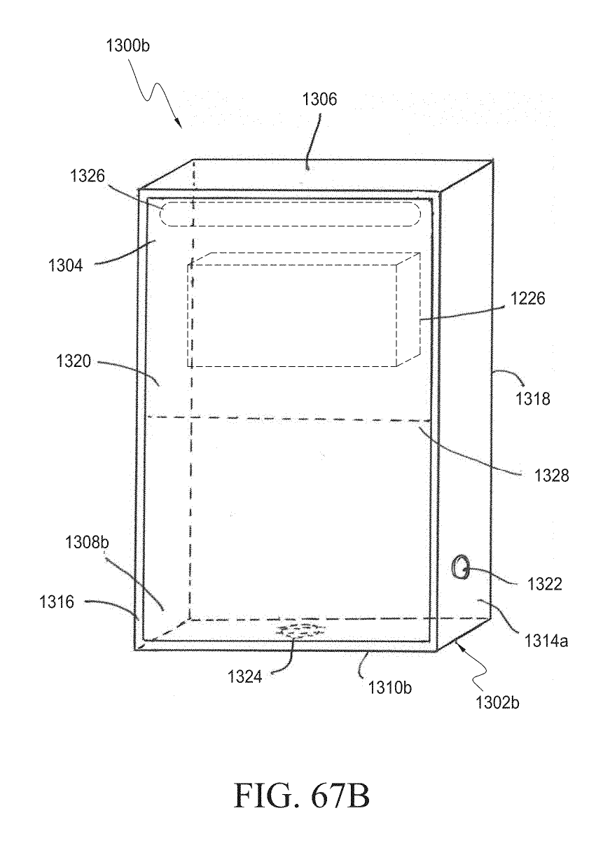

FIG. 67A shows a view of still another mobile communication device in accordance with an exemplary embodiment of the present disclosure.

FIG. 67B shows another view of the mobile communication device of FIG. 67A.

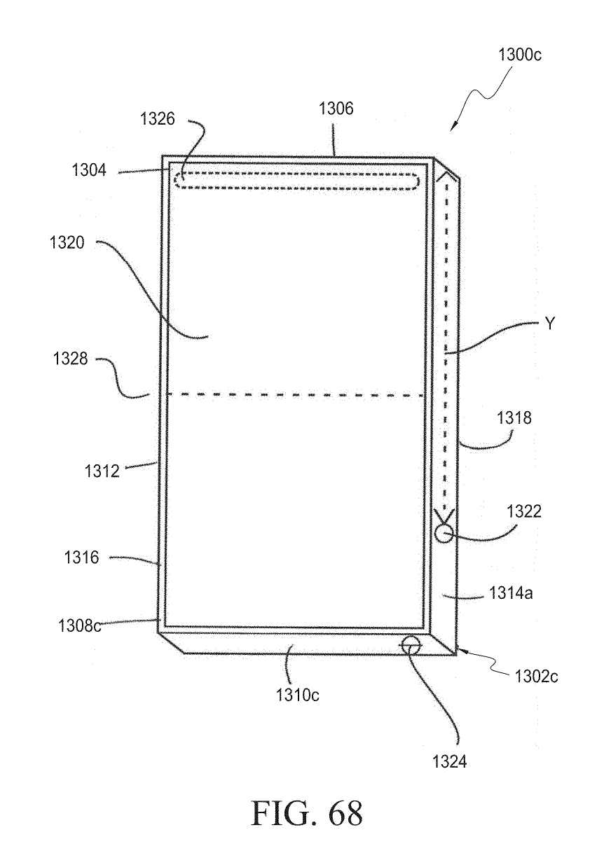

FIG. 68 shows a view of still yet another mobile communication device in accordance with an exemplary embodiment of the present disclosure.

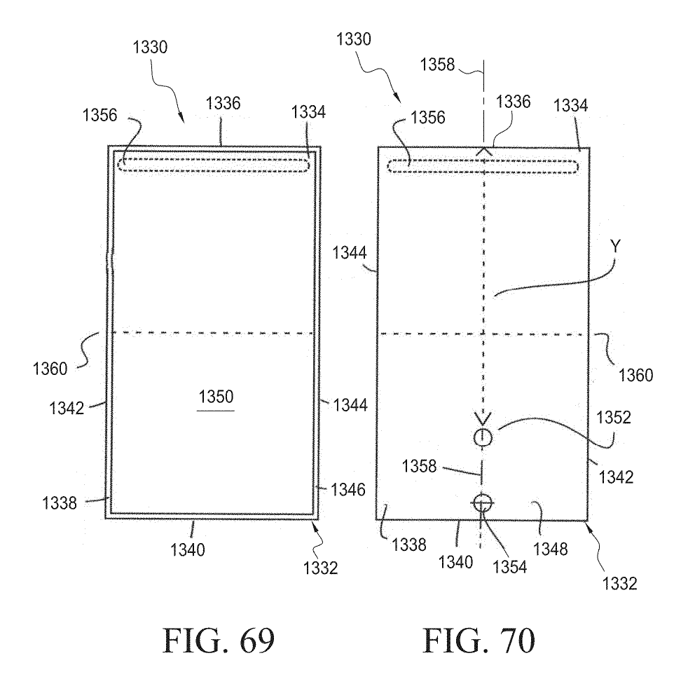

FIG. 69 shows a front view of an even further mobile communication device in accordance with an exemplary embodiment of the present disclosure.

FIG. 70 shows a back view of the mobile communication device of FIG. 69.

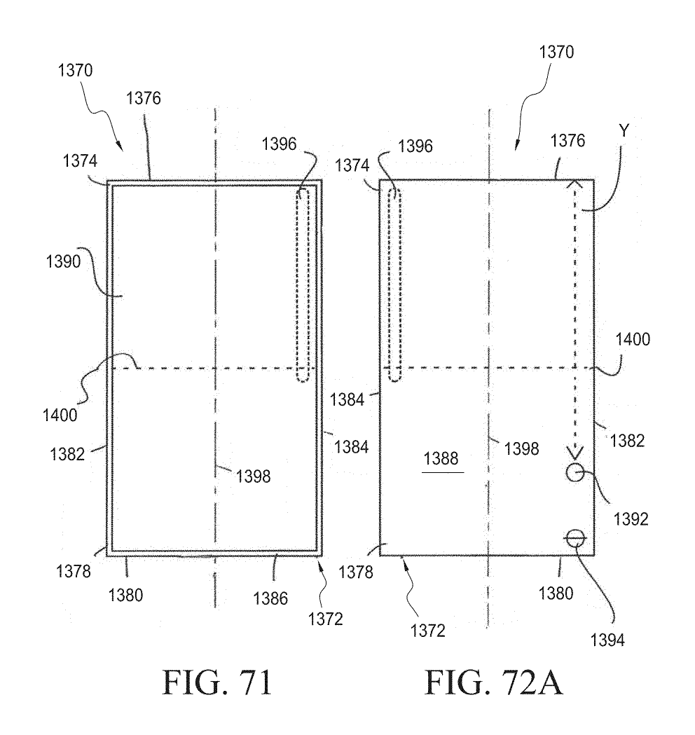

FIG. 71 shows a front view of a mobile communication device in accordance with an exemplary embodiment of the present disclosure.

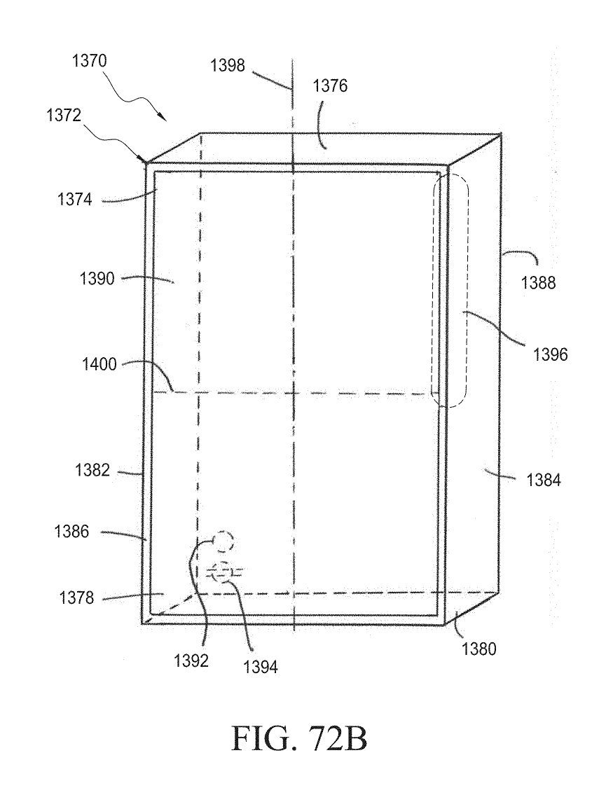

FIG. 72A shows a back view of the mobile communication device of FIG. 71.

FIG. 72B is an alternate view of a mobile communication device.

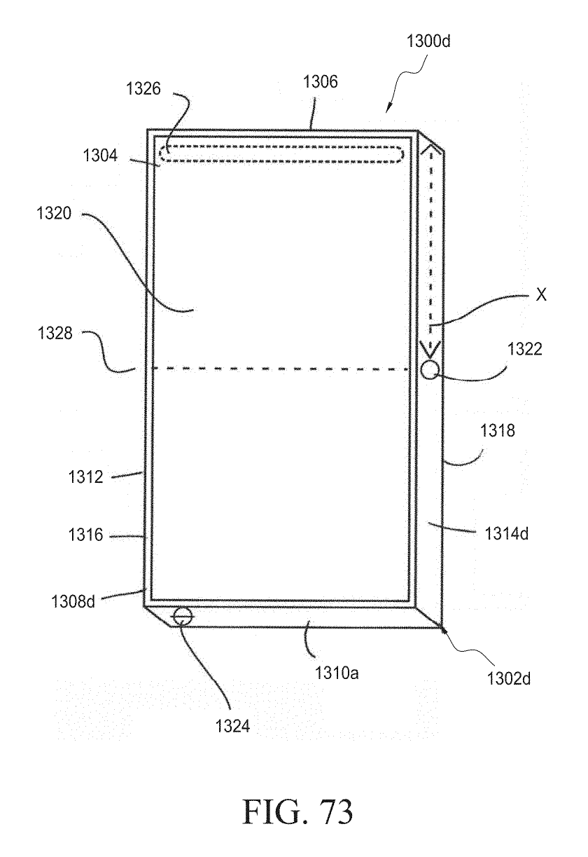

FIG. 73 shows a view of another mobile communication device in accordance with an exemplary embodiment of the present disclosure.

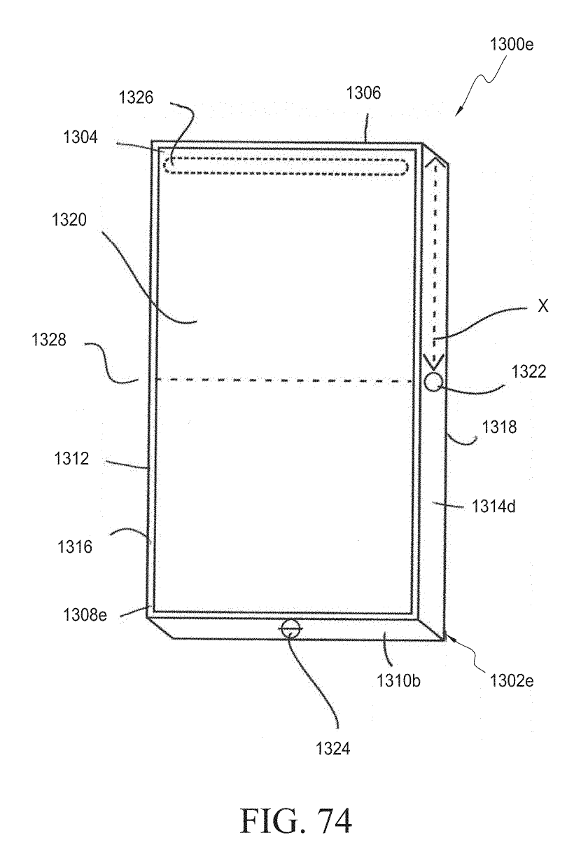

FIG. 74 shows a view of yet another mobile communication device in accordance with an exemplary embodiment of the present disclosure.

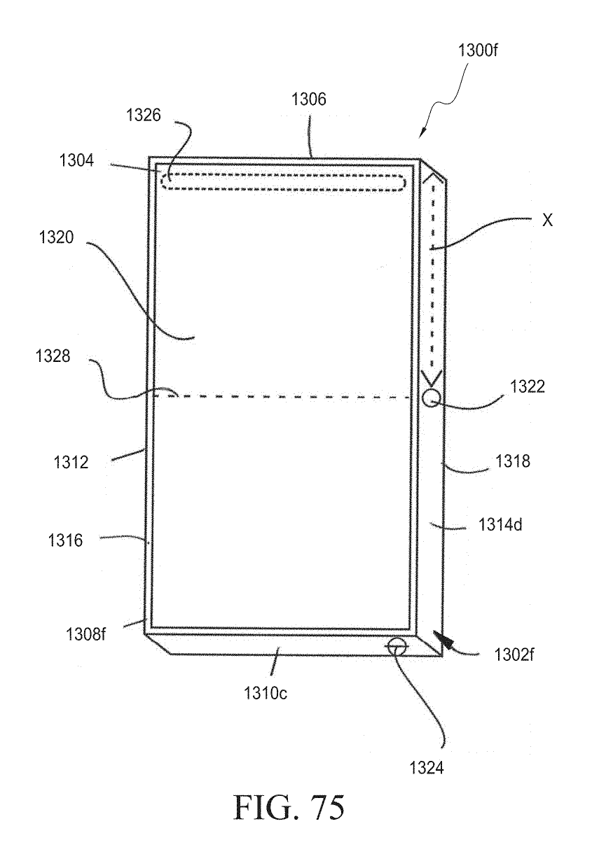

FIG. 75 shows a view of a still further mobile communication device in accordance with an exemplary embodiment of the present disclosure.

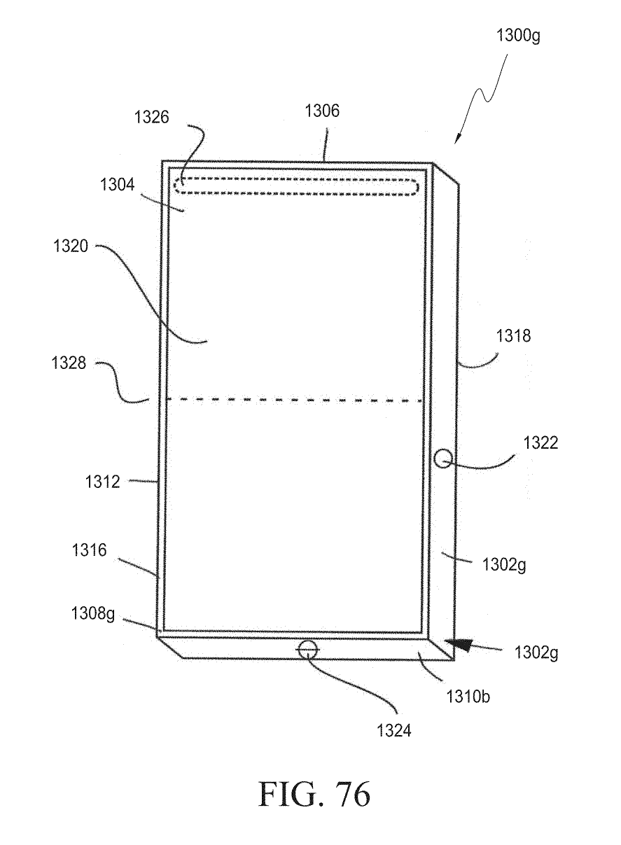

FIG. 76 shows a view of an even further mobile communication device in accordance with an exemplary embodiment of the present disclosure.

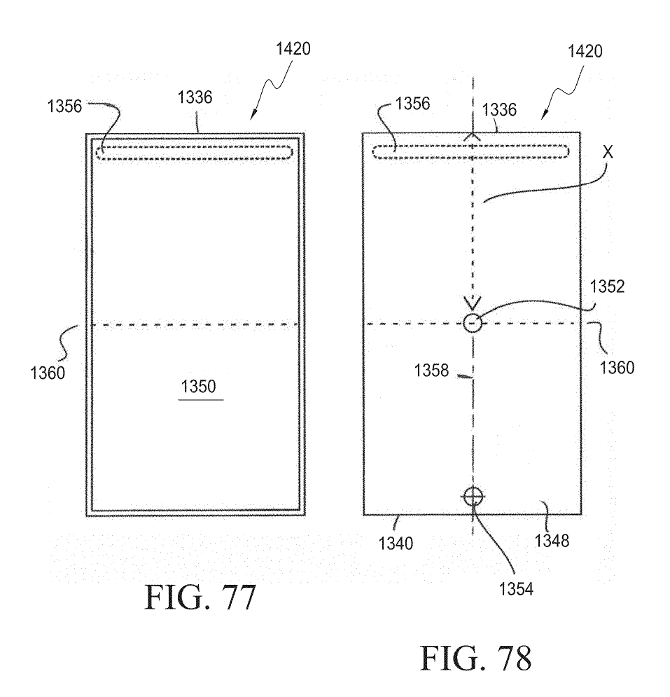

FIG. 77 shows a front view of still yet another mobile communication device in accordance with an exemplary embodiment of the present disclosure.

FIG. 78 shows a back view of the mobile communication device of FIG. 77.

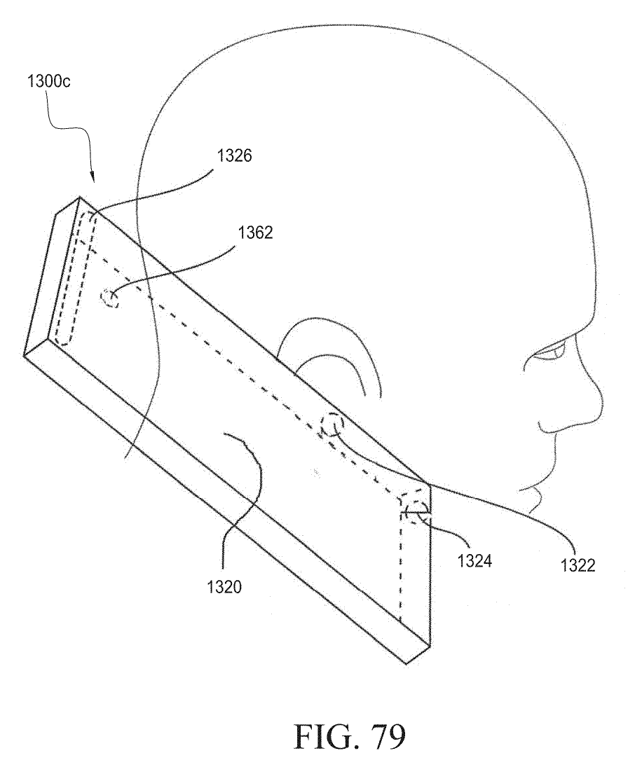

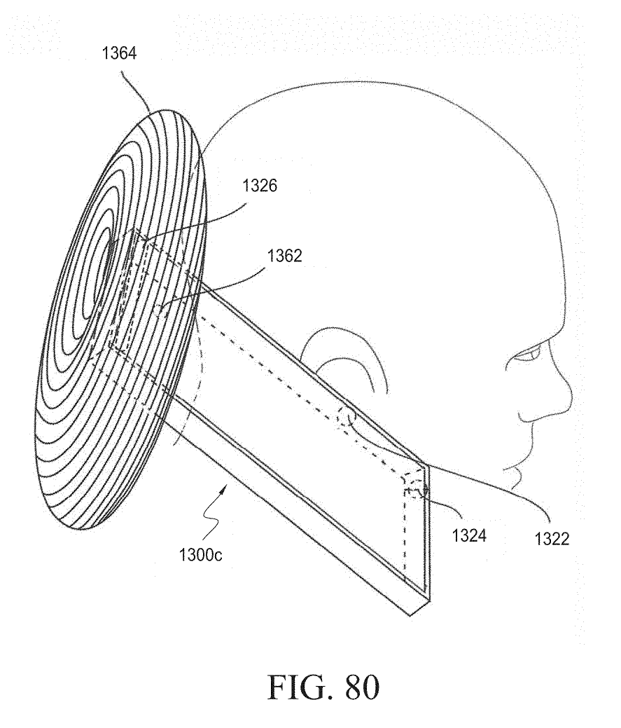

FIG. 79 shows a view of a mobile communication device in accordance with an exemplary embodiment of the present disclosure.

FIG. 80 shows a view of the mobile communication device of FIG. 79 showing a stylized RF radiation pattern.

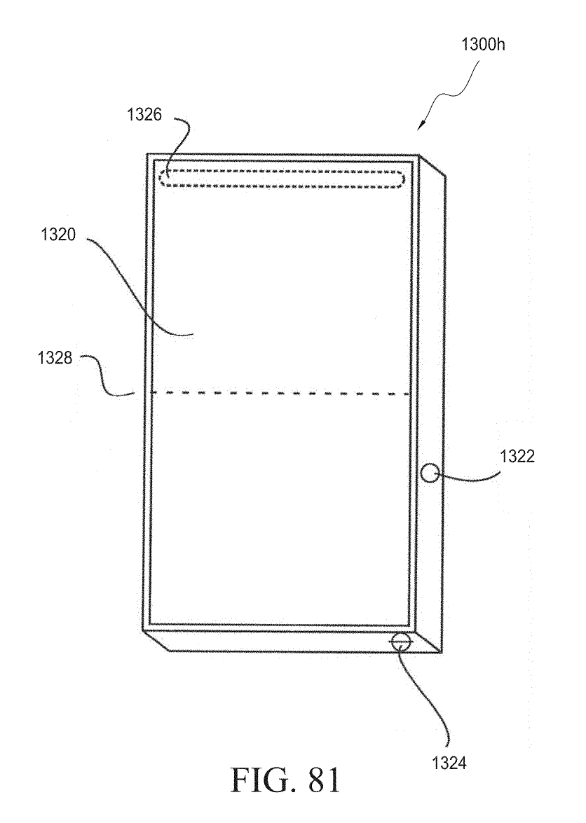

FIG. 81 shows another view of the mobile communication device of FIG. 79.

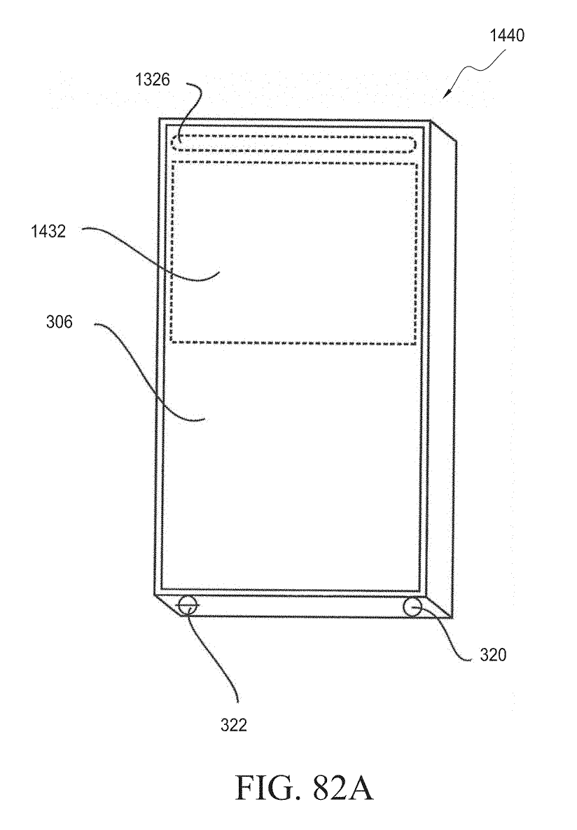

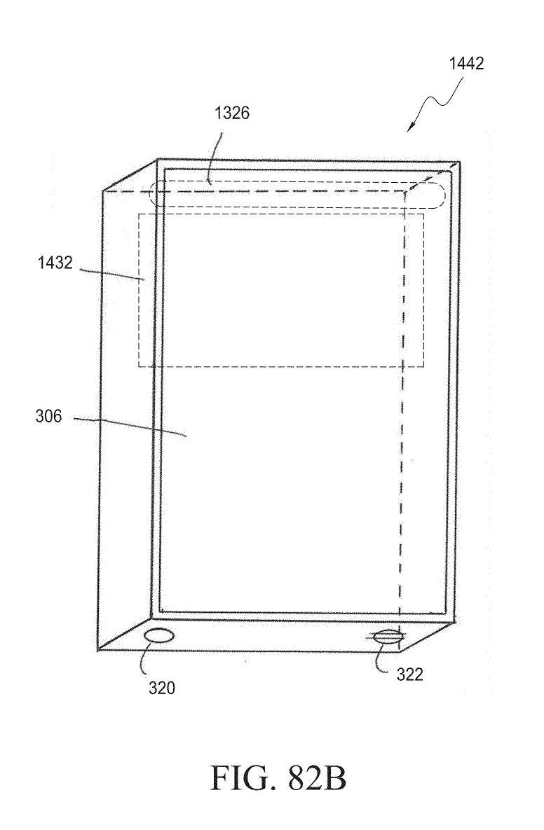

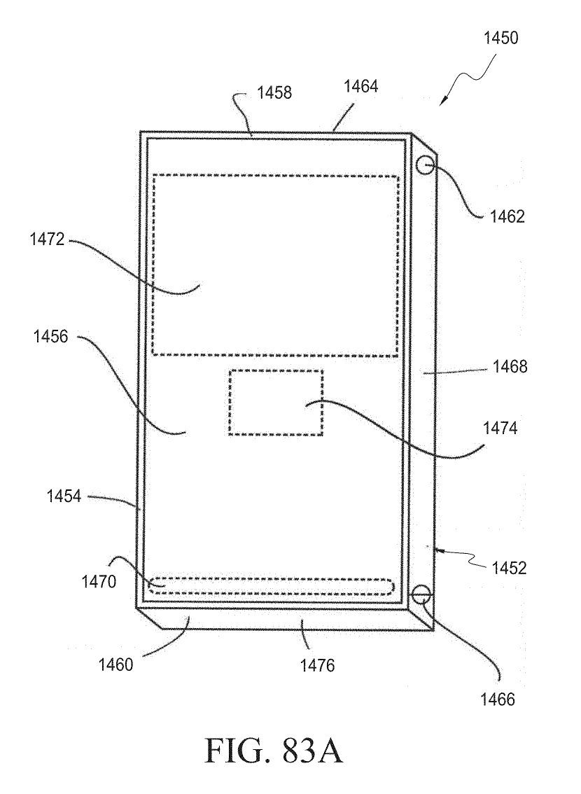

FIG. 82A shows a view of a mobile communication device in accordance with an exemplary embodiment of the present disclosure.

FIG. 82B shows a view of a mobile communication device in accordance with another exemplary embodiment of the present disclosure.

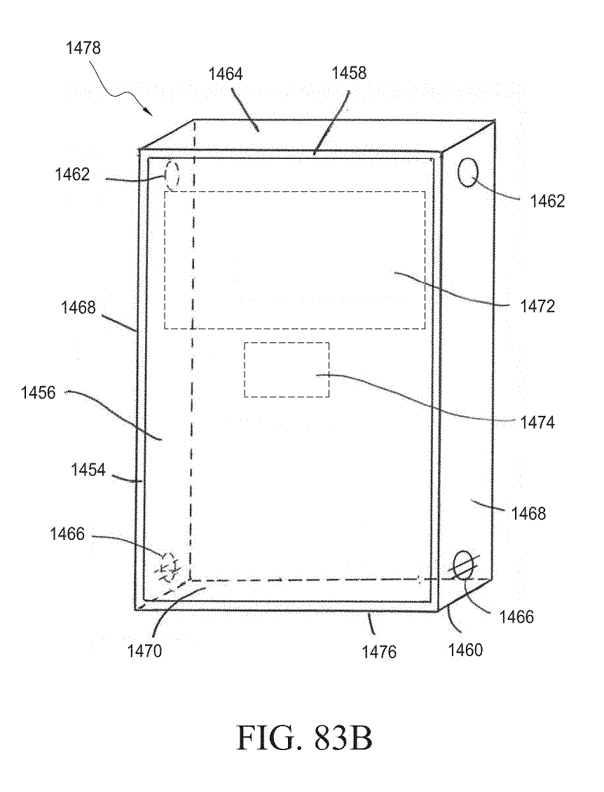

FIG. 83A shows a view of another mobile communication device in accordance with an exemplary embodiment of the present disclosure.

FIG. 83B shows a view of a further mobile communication device in accordance with an exemplary embodiment of the present disclosure.

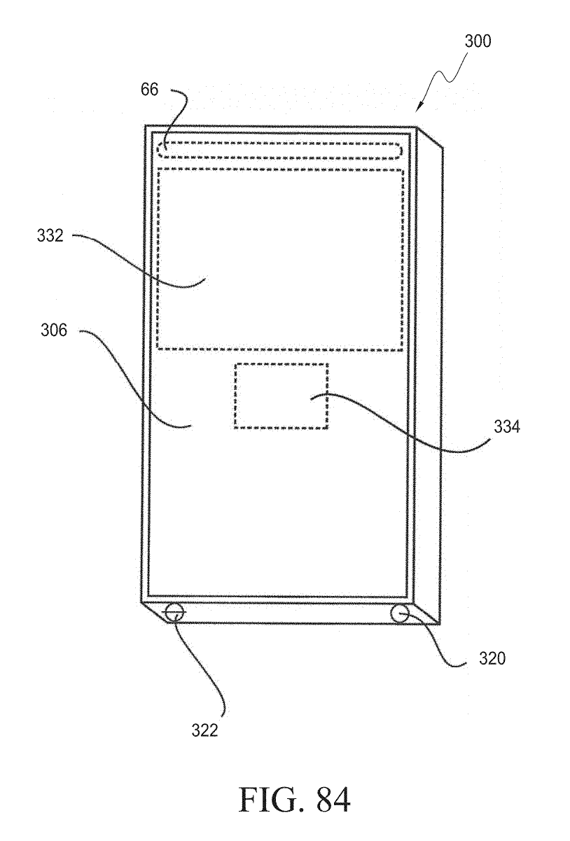

FIG. 84 shows a view of yet another mobile communication device in accordance with an exemplary embodiment of the present disclosure.

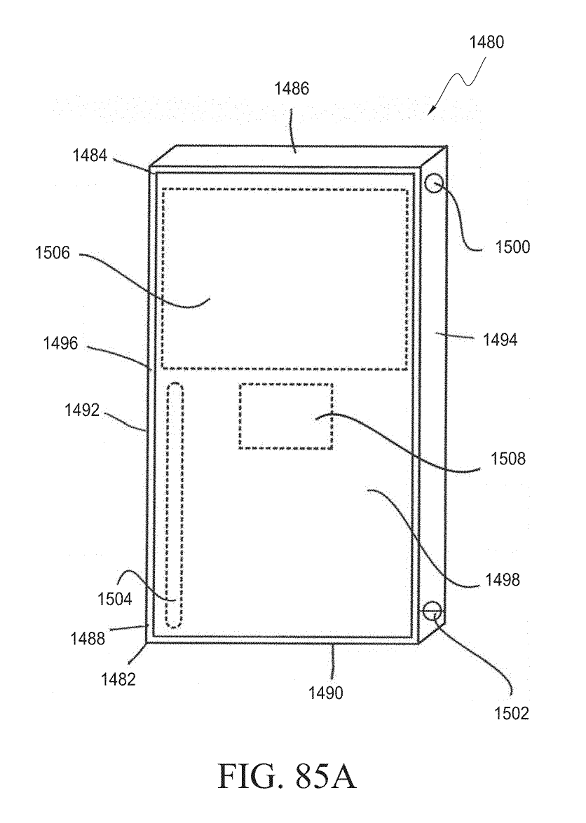

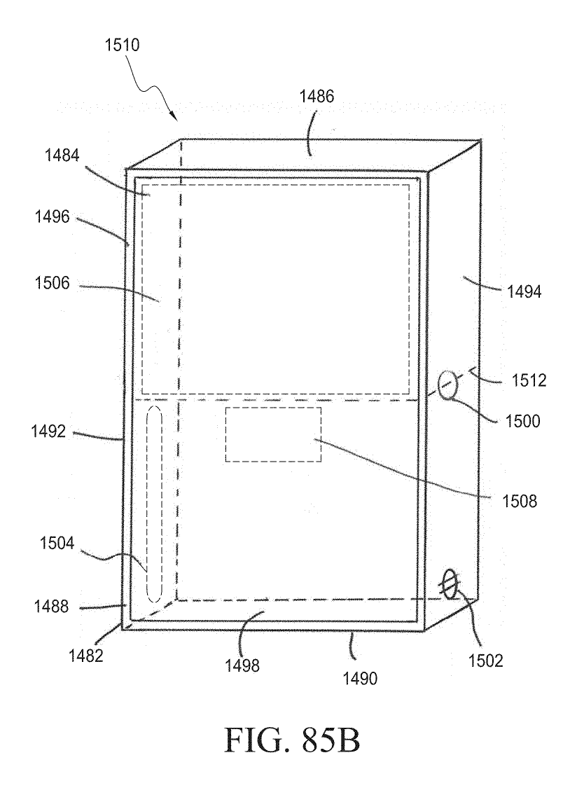

FIG. 85A shows a view of a further mobile communication device in accordance with an exemplary embodiment of the present disclosure.

FIG. 85B shows a view of a yet further mobile communication device in accordance with an exemplary embodiment of the present disclosure.

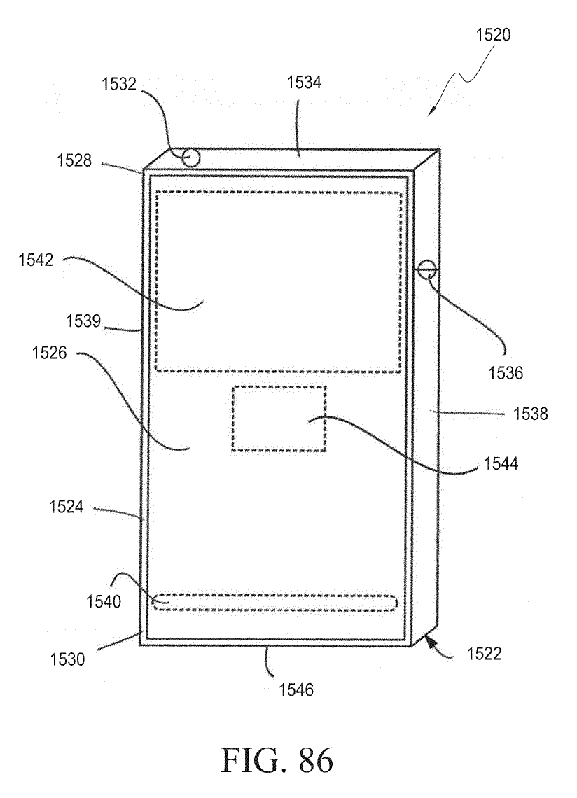

FIG. 86 shows a view of an even further mobile communication device in accordance with an exemplary embodiment of the present disclosure.

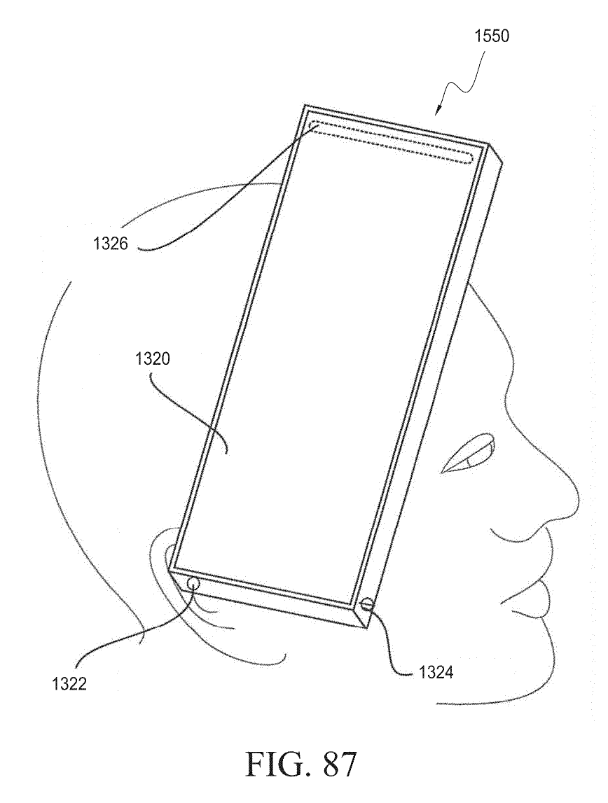

FIG. 87 shows a view of still another mobile communication device in accordance with an exemplary embodiment of the present disclosure.

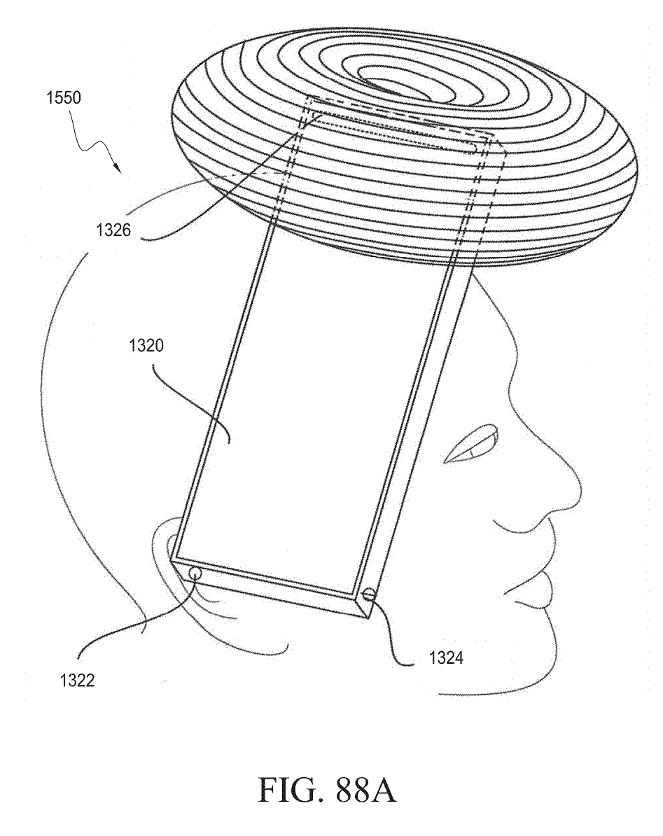

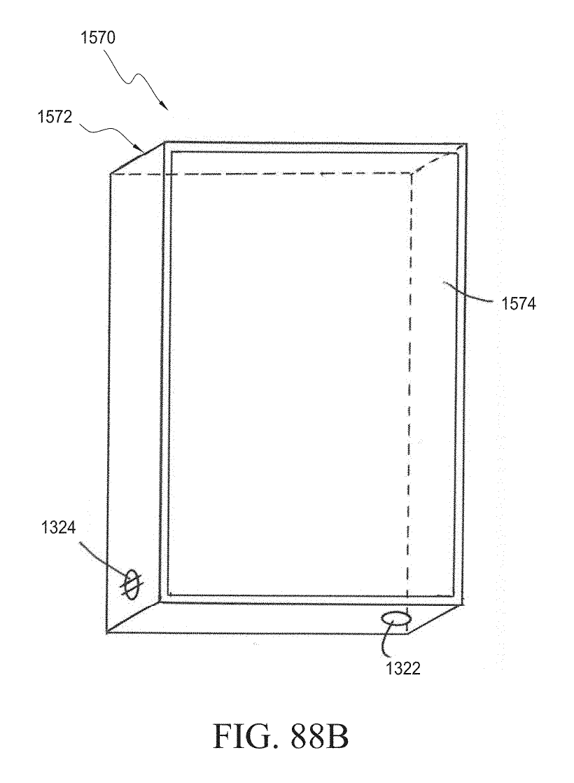

FIG. 88A shows a view of the mobile communication device of FIG. 87 showing a stylized RF radiation pattern.

FIG. 88B shows a view of a mobile communication device in accordance with an exemplary embodiment of the present disclosure.

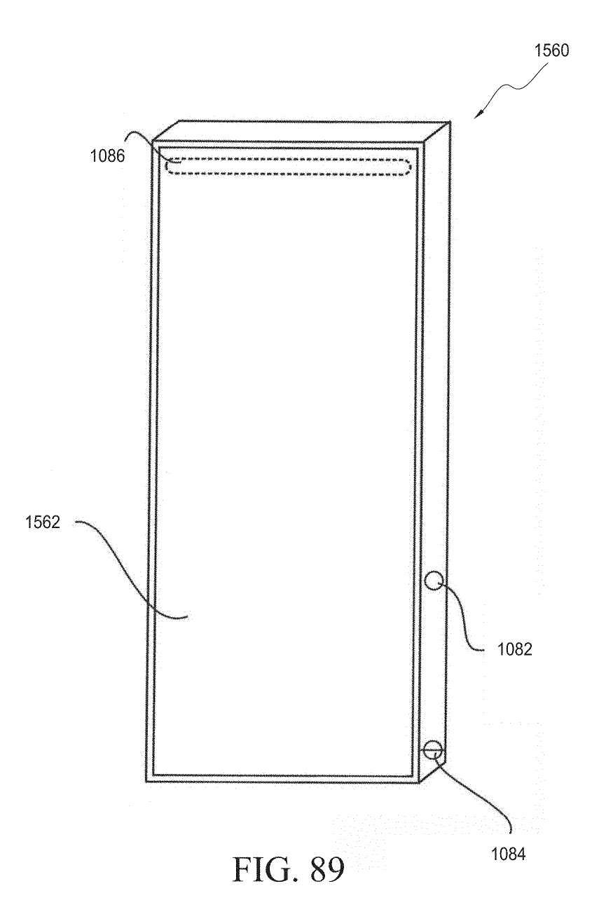

FIG. 89 shows a view of a mobile communication device in accordance with an exemplary embodiment of the present disclosure.

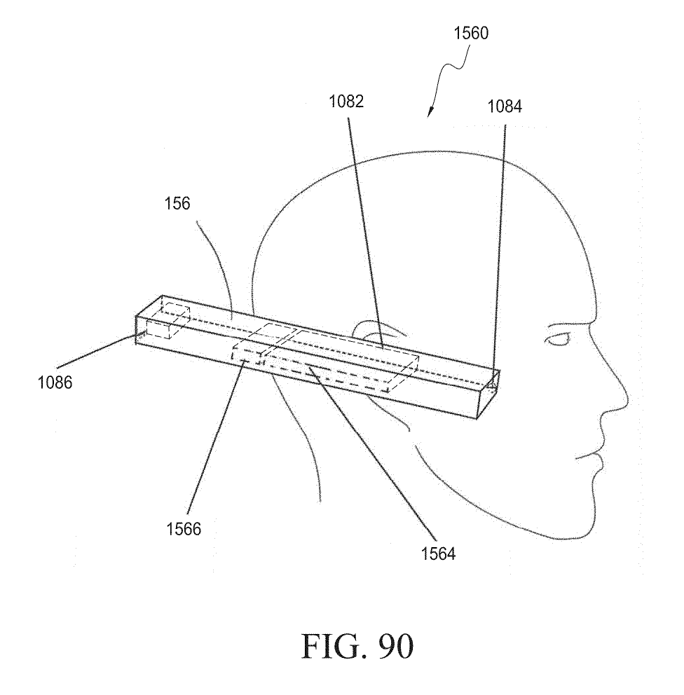

FIG. 90 shows a view of another mobile communication device in accordance with an exemplary embodiment of the present disclosure.

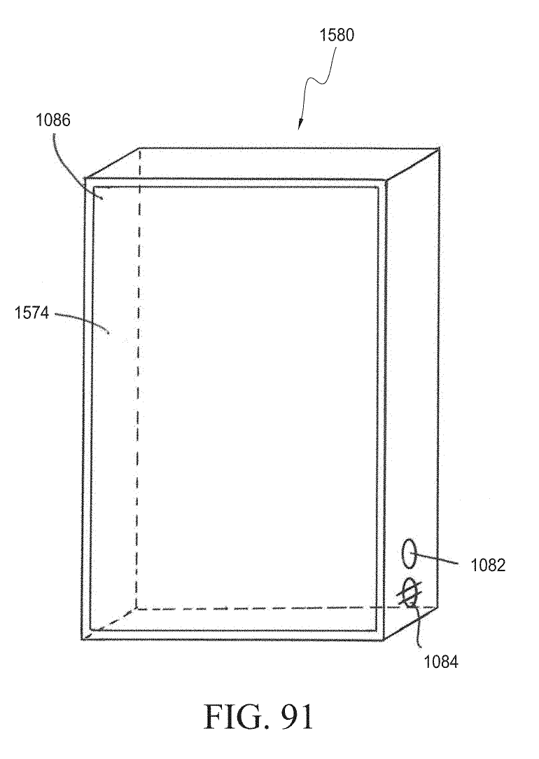

FIG. 91 shows a view of yet another mobile communication device in accordance with an exemplary embodiment of the present disclosure.

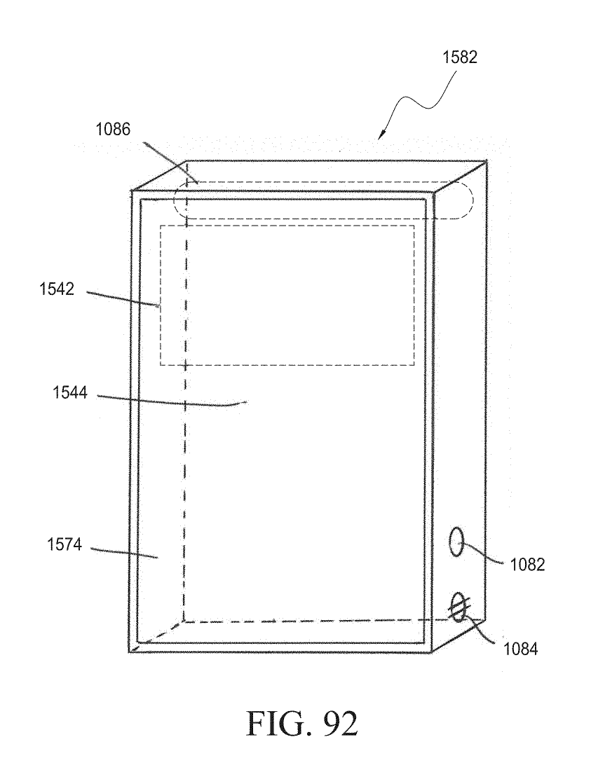

FIG. 92 shows a view of still yet another mobile communication device in accordance with an exemplary embodiment of the present disclosure.

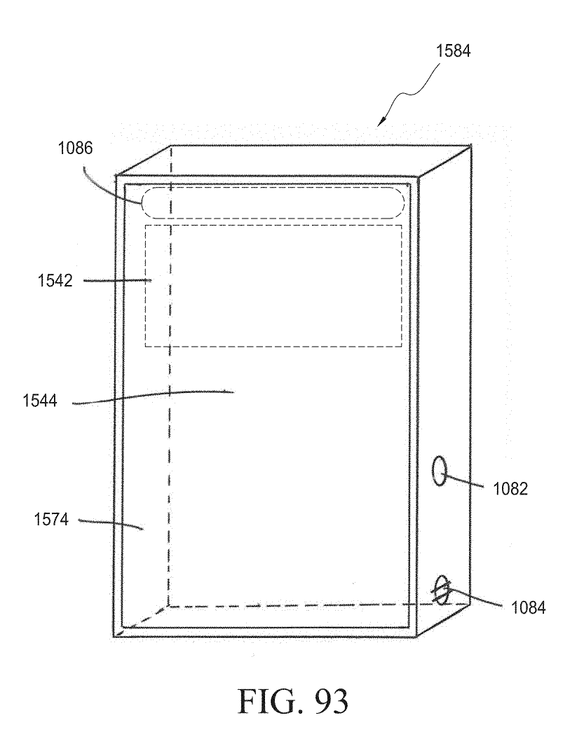

FIG. 93 shows a view of even yet another mobile communication device in accordance with an exemplary embodiment of the present disclosure.

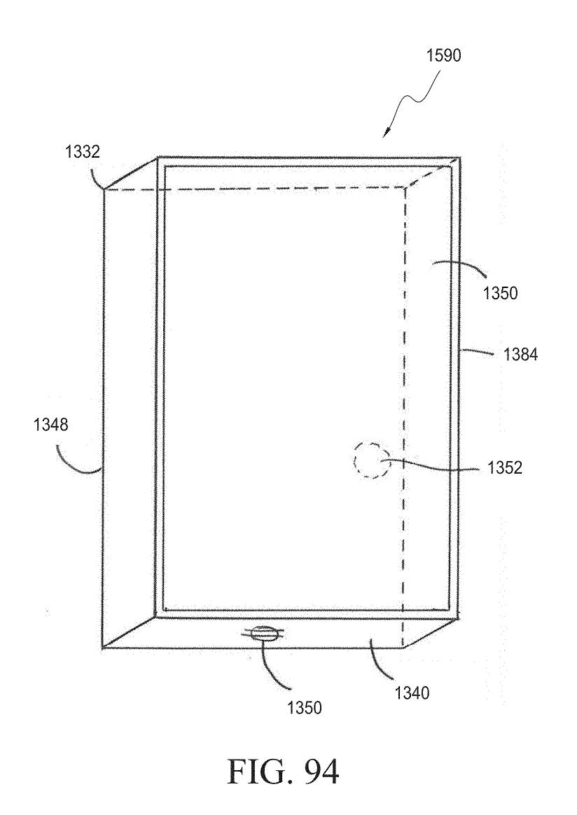

FIG. 94 shows a view of a mobile communication device in accordance with an exemplary embodiment of the present disclosure.

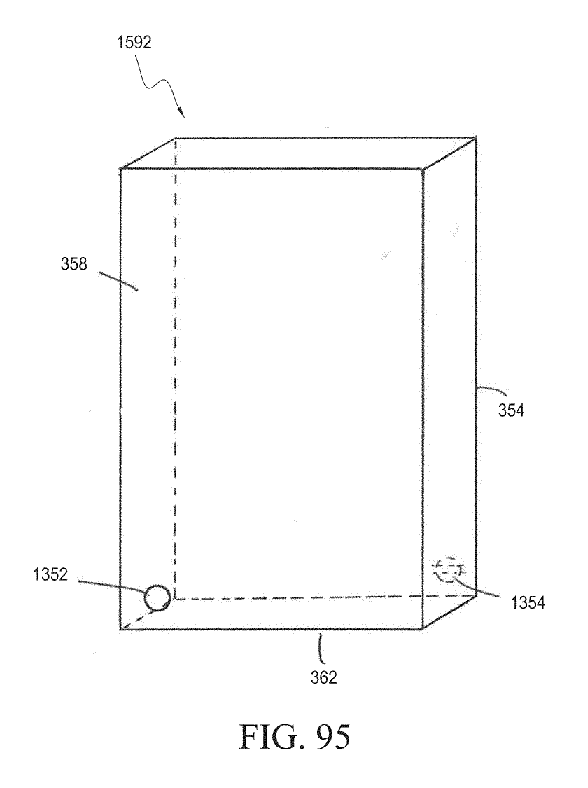

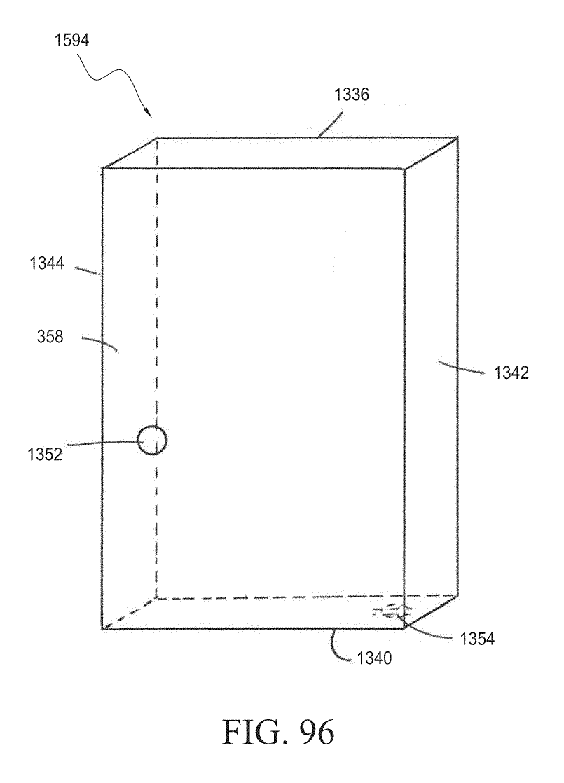

FIG. 95 shows a view of another mobile communication device in accordance with an exemplary embodiment of the present disclosure.

FIG. 96 shows a view of yet another mobile communication device in accordance with an exemplary embodiment of the present disclosure.

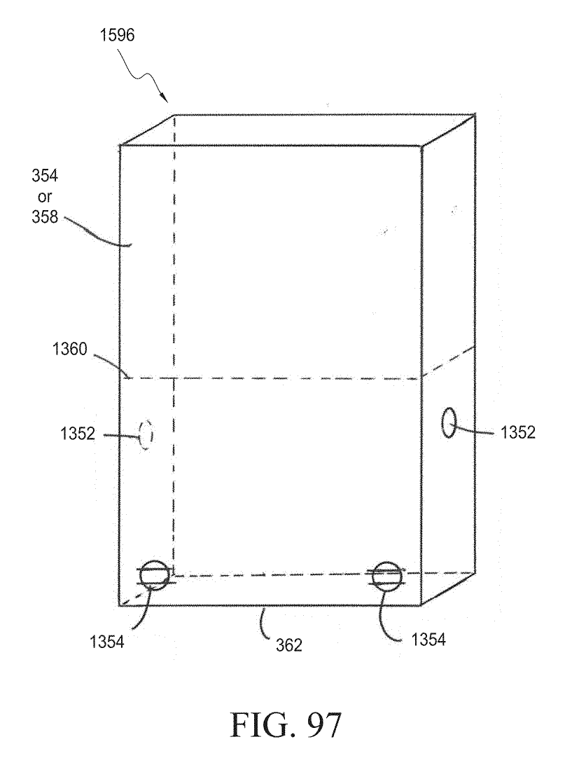

FIG. 97 shows a view of still yet another mobile communication device in accordance with an exemplary embodiment of the present disclosure.

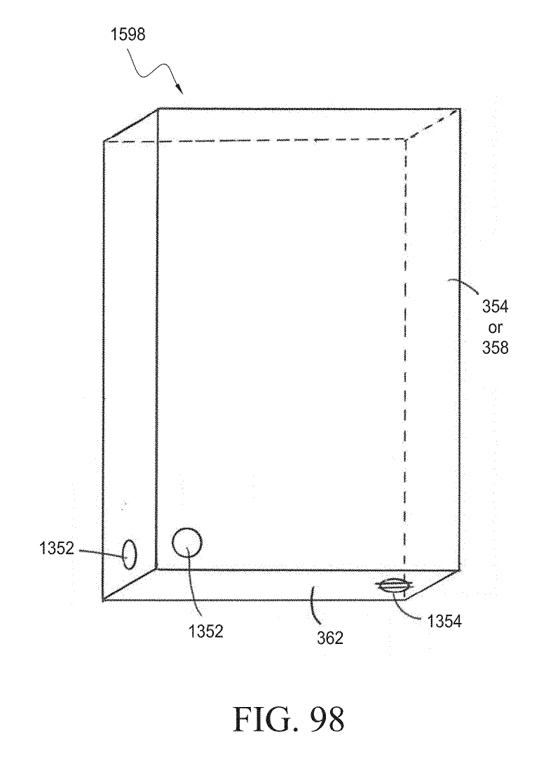

FIG. 98 shows a view of even yet another mobile communication device in accordance with an exemplary embodiment of the present disclosure.

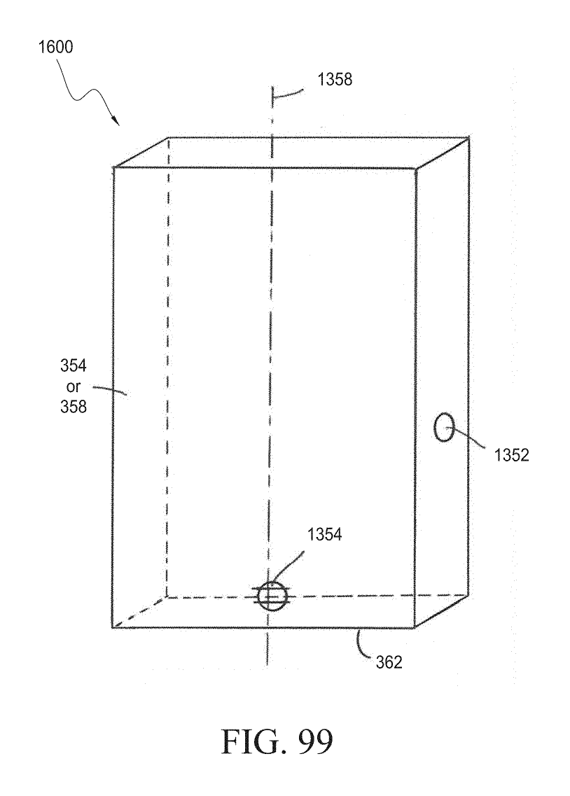

FIG. 99 shows a view of a further mobile communication device in accordance with an exemplary embodiment of the present disclosure.

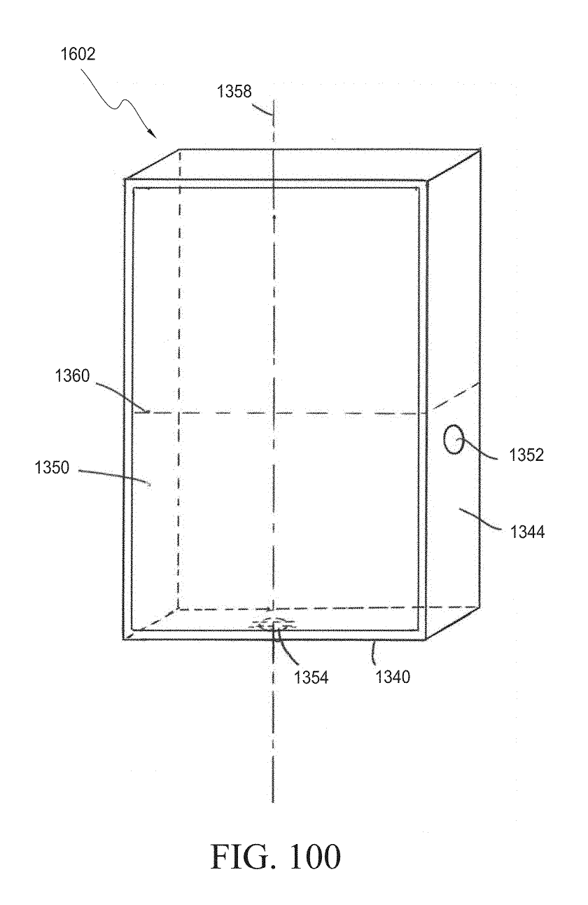

FIG. 100 shows a view of a yet further mobile communication device in accordance with an exemplary embodiment of the present disclosure.

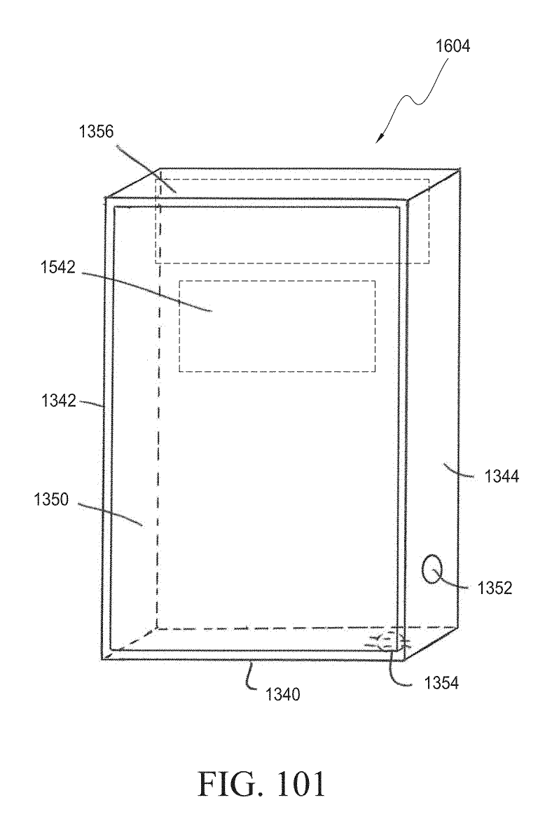

FIG. 101 shows a view of a still further mobile communication device in accordance with an exemplary embodiment of the present disclosure.

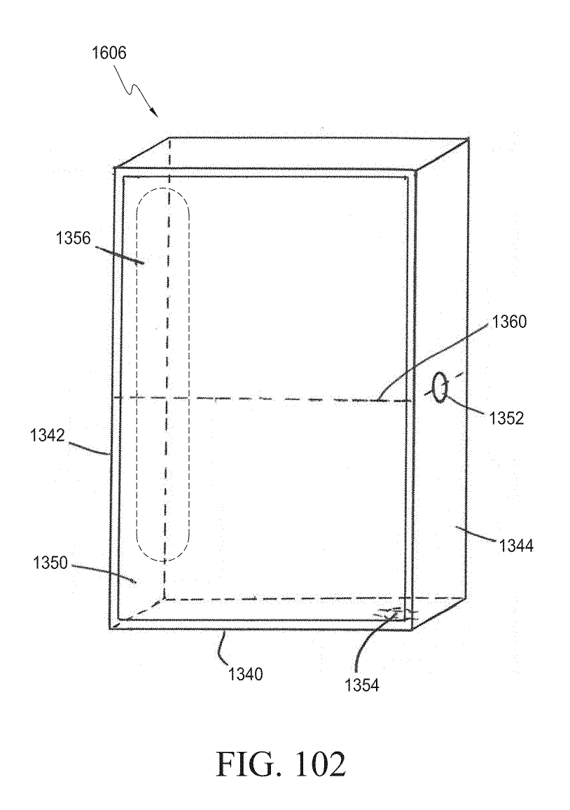

FIG. 102 shows a view of a mobile communication device in accordance with an exemplary embodiment of the present disclosure.

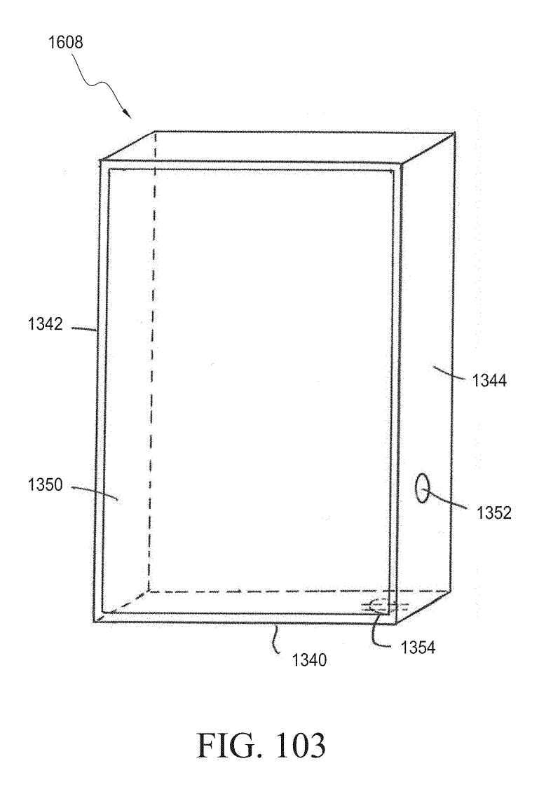

FIG. 103 shows a view of another mobile communication device in accordance with an exemplary embodiment of the present disclosure.

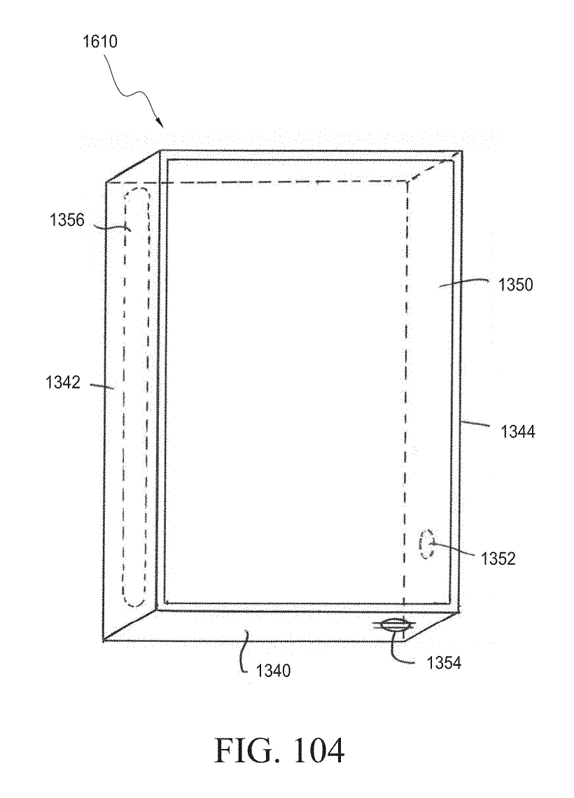

FIG. 104 shows a view of yet another mobile communication device in accordance with an exemplary embodiment of the present disclosure.

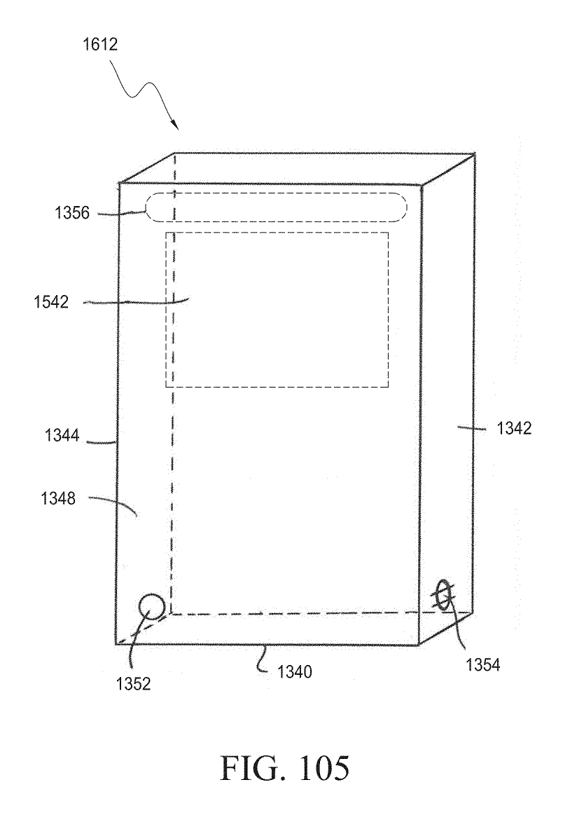

FIG. 105 shows a view of still yet another mobile communication device in accordance with an exemplary embodiment of the present disclosure.

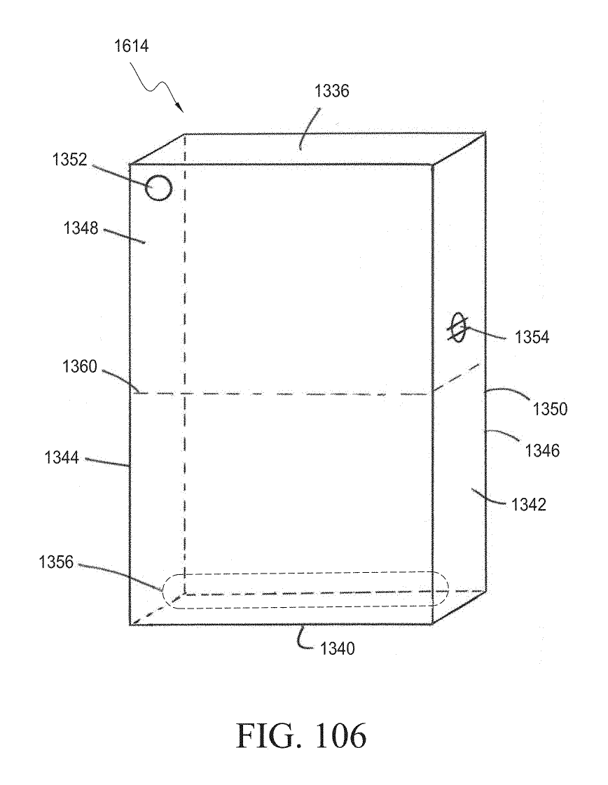

FIG. 106 shows a view of even yet another mobile communication device in accordance with an exemplary embodiment of the present disclosure.

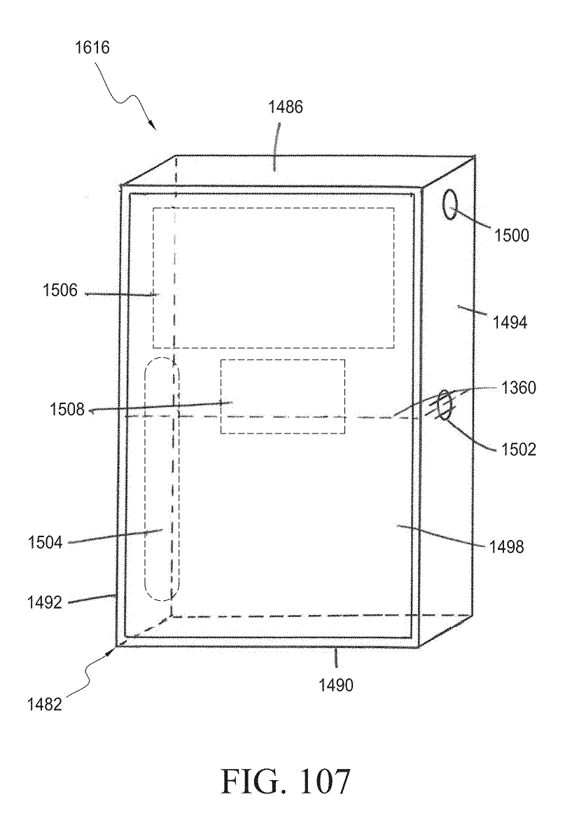

FIG. 107 shows a view of a further mobile communication device in accordance with an exemplary embodiment of the present disclosure.

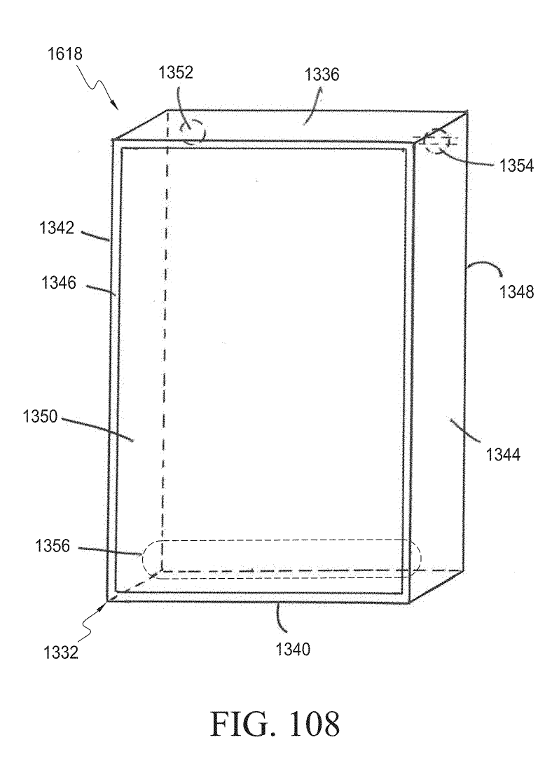

FIG. 108 shows a view of a yet further mobile communication device in accordance with an exemplary embodiment of the present disclosure.

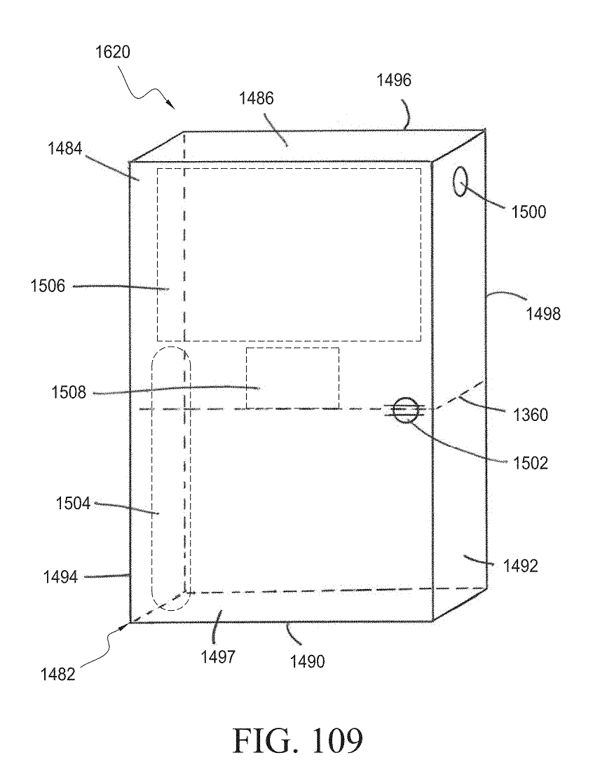

FIG. 109 shows a view of a still further mobile communication device in accordance with an exemplary embodiment of the present disclosure.

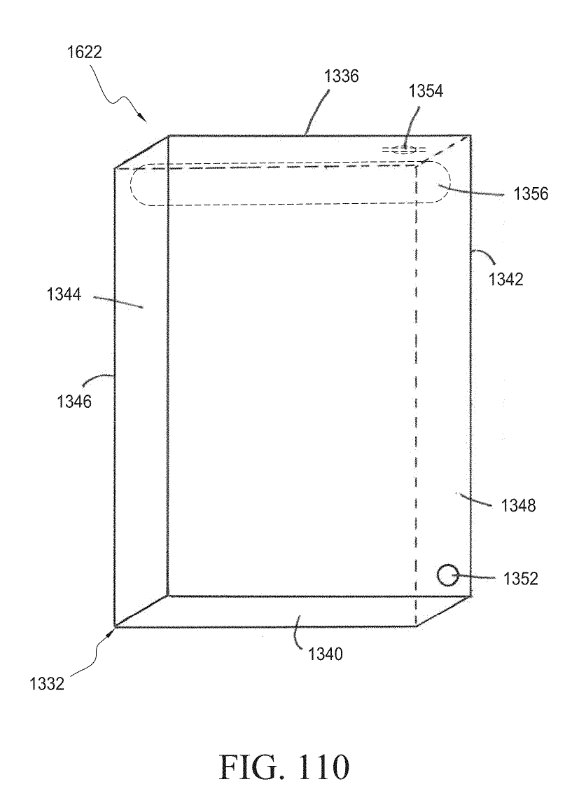

FIG. 110 shows a view of a mobile communication device in accordance with an exemplary embodiment of the present disclosure.

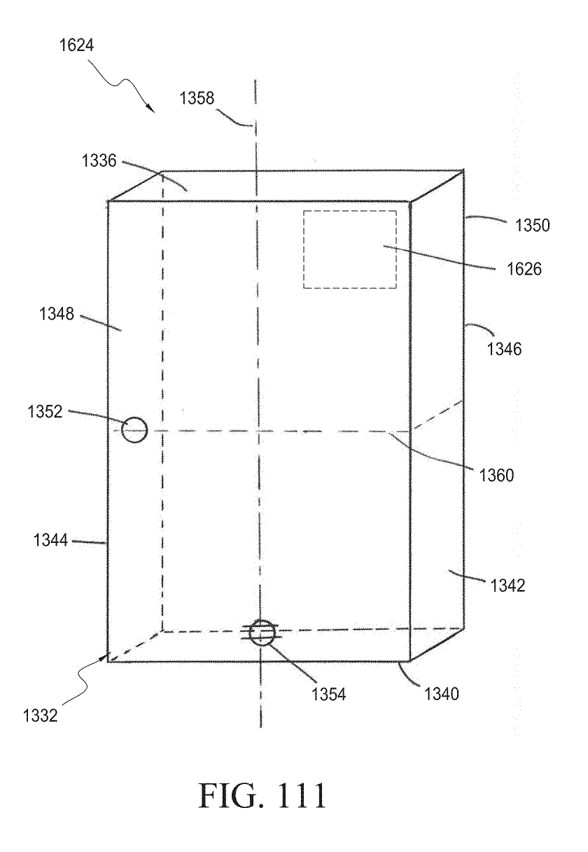

FIG. 111 shows a view of another mobile communication device in accordance with an exemplary embodiment of the present disclosure.

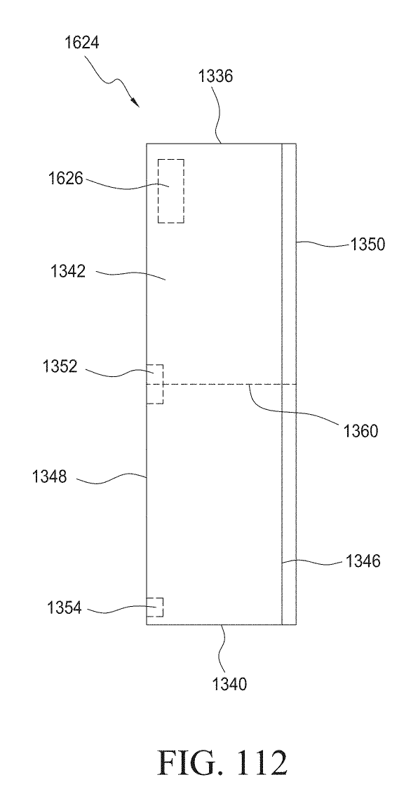

FIG. 112 shows a side view of the mobile communication device of FIG. 111.

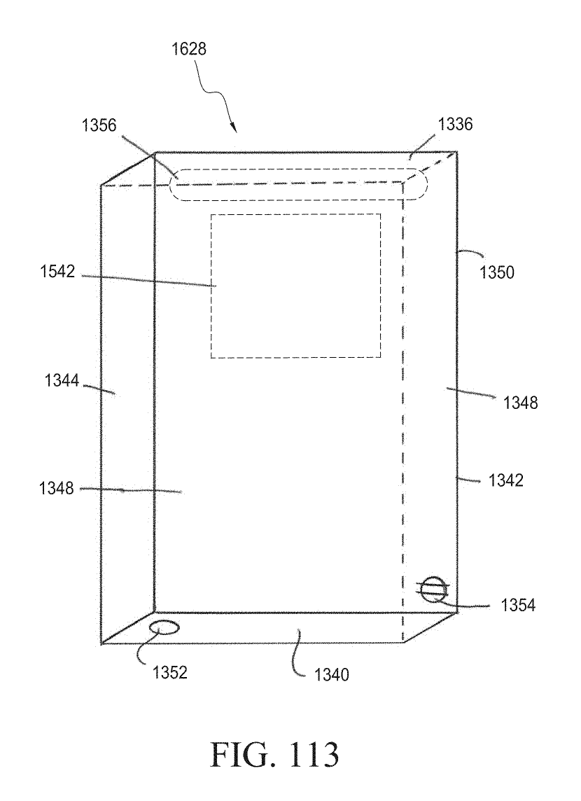

FIG. 113 shows a view of even yet another mobile communication device in accordance with an exemplary embodiment of the present disclosure.

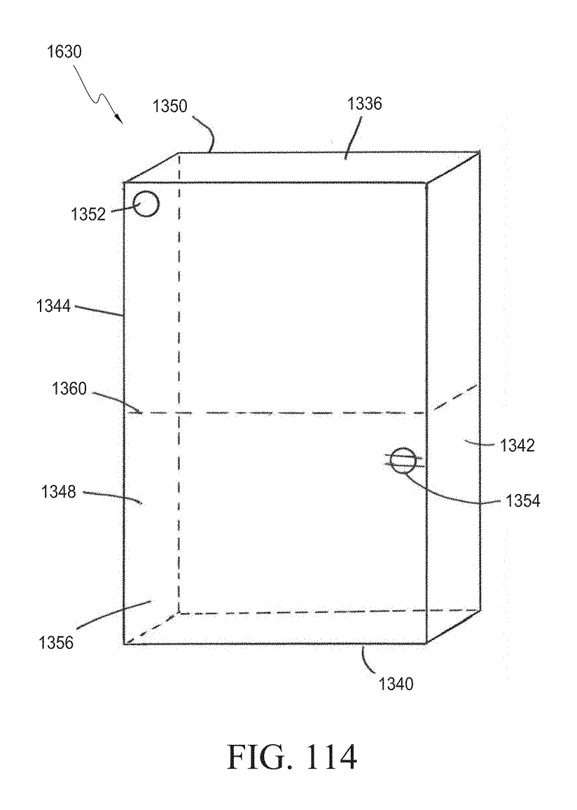

FIG. 114 shows a view of a further mobile communication device in accordance with an exemplary embodiment of the present disclosure.

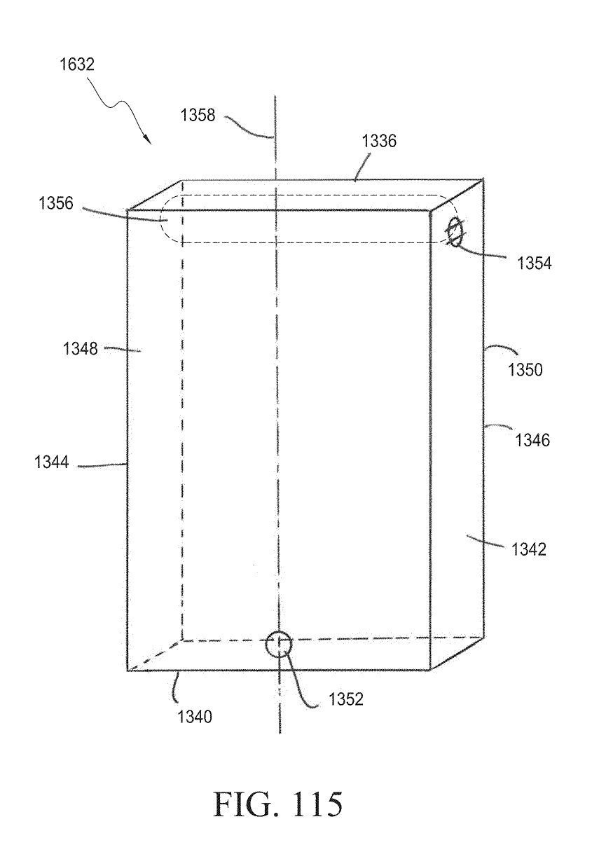

FIG. 115 shows a view of a yet further mobile communication device in accordance with an exemplary embodiment of the present disclosure.

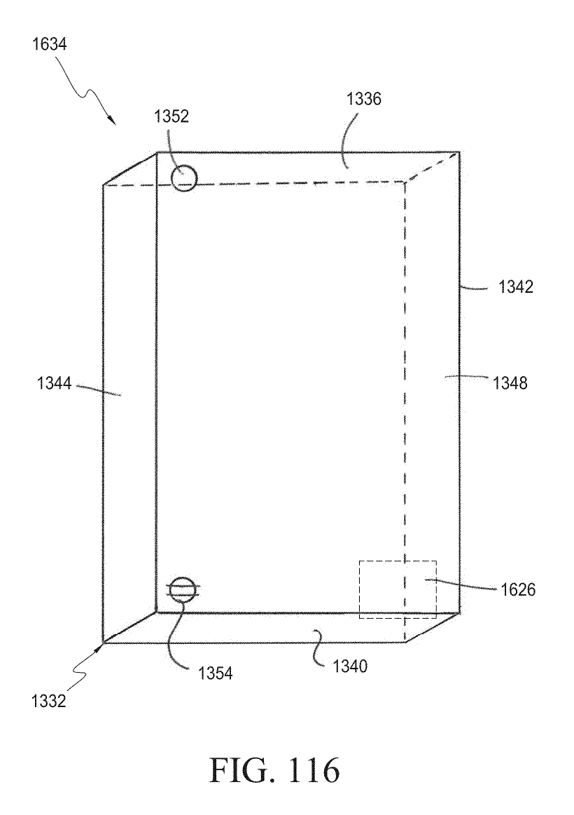

FIG. 116 shows a view of a still further mobile communication device in accordance with an exemplary embodiment of the present disclosure.

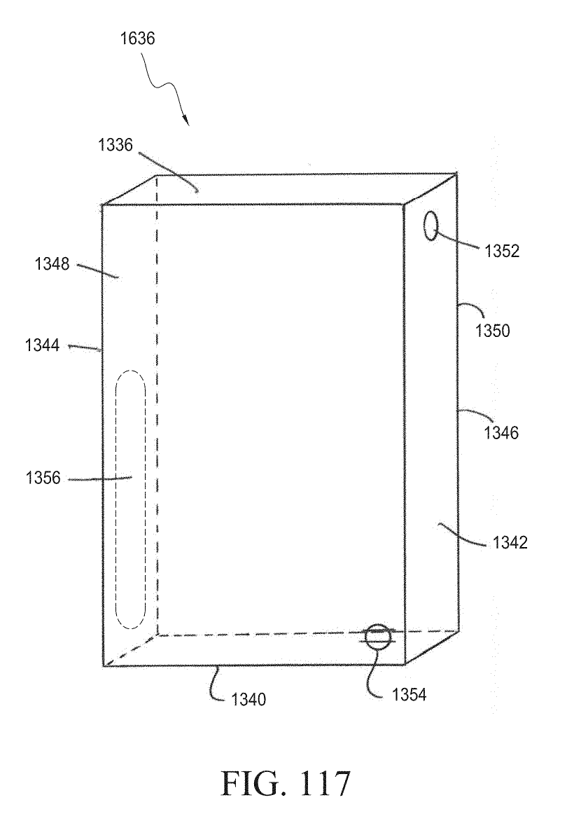

FIG. 117 shows a view of a mobile communication device in accordance with an exemplary embodiment of the present disclosure.

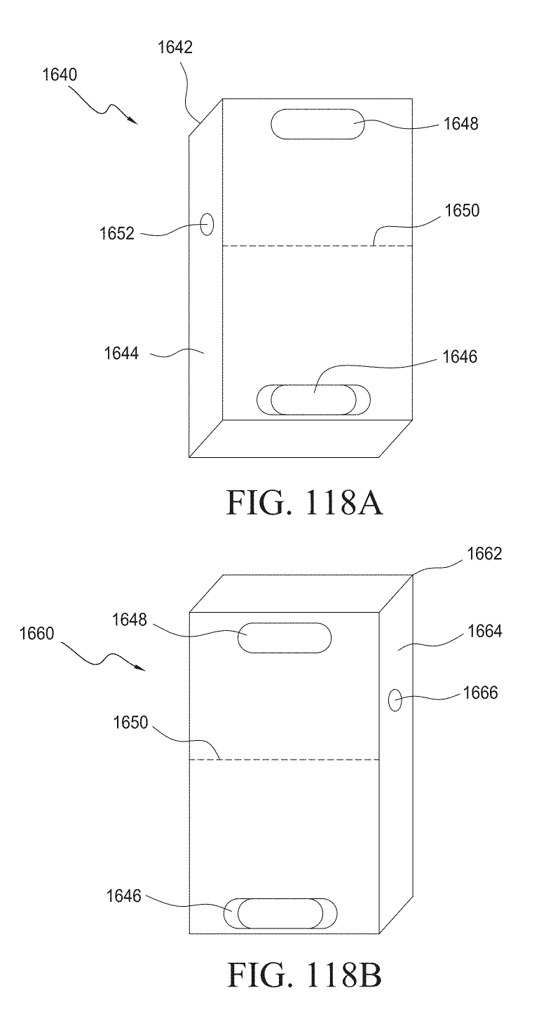

FIG. 118A shows a perspective view of one more mobile communication device in accordance with an exemplary embodiment of the present disclosure.

FIG. 118B shows a perspective view of a mobile communication device similar to, but different from, the mobile communication device of FIG. 118A in accordance with an exemplary embodiment of the present disclosure.

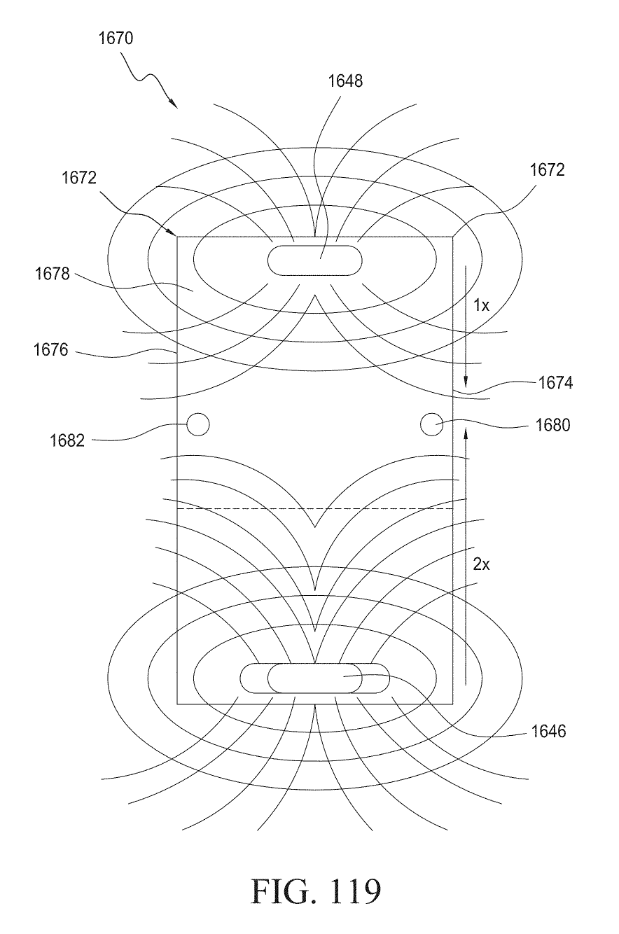

FIG. 119 shows a view of a mobile communication device similar to, but different from, the mobile communication devices of FIGS. 118A and 118B in accordance with an exemplary embodiment of the present disclosure.

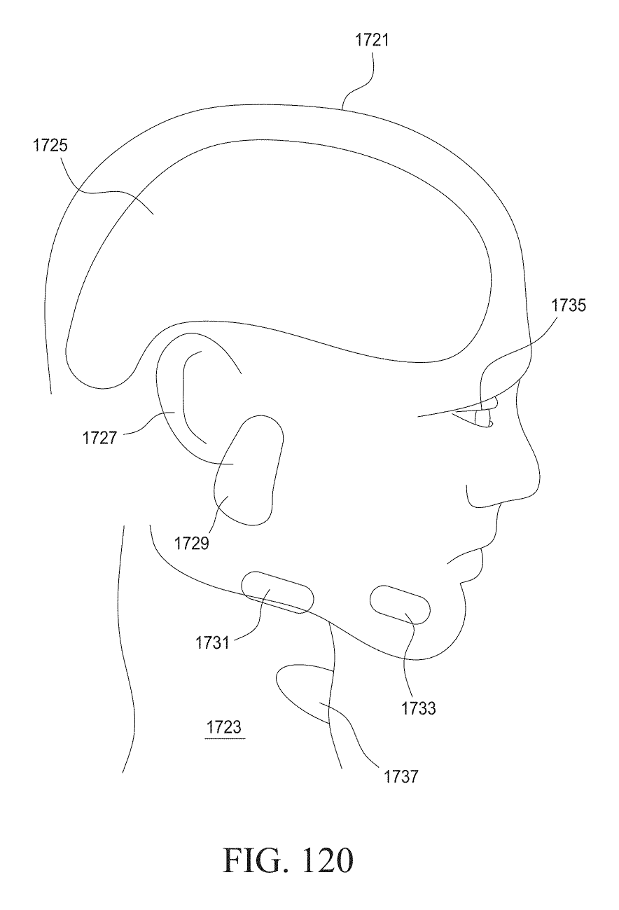

FIG. 120 shows a view of a head and neck with areas sensitive to radiation that are preserved by the use of the biologically-compatible mobile communication devices of the present disclosure.

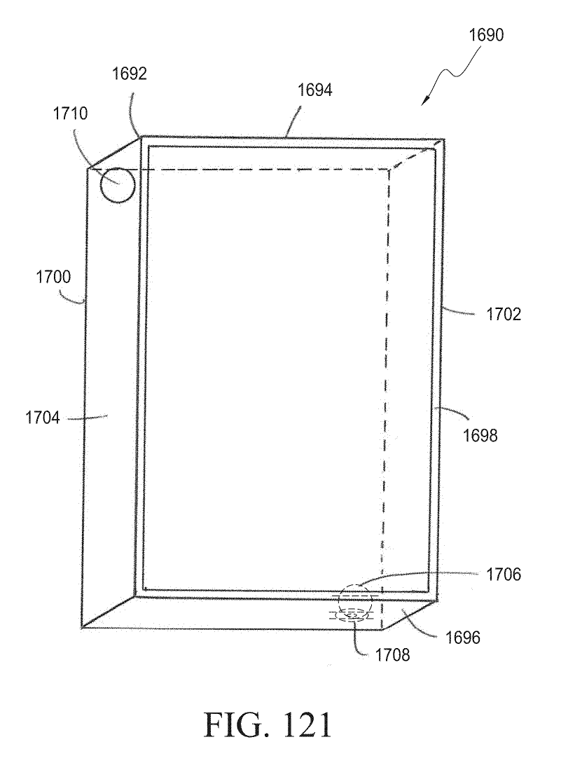

FIG. 121 shows a perspective view of a mobile communication device having a diagonal speaker-microphone arrangement in accordance with an exemplary embodiment of the present disclosure.

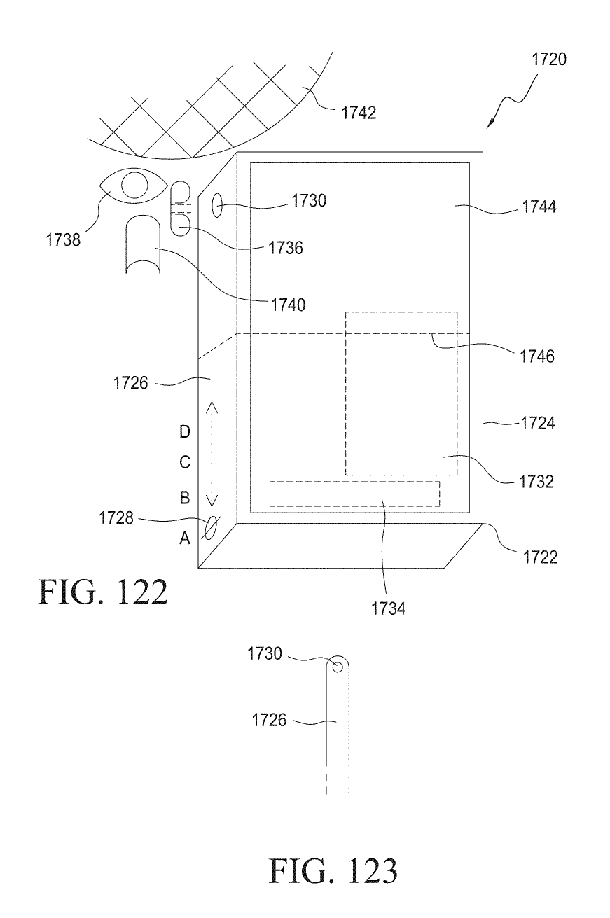

FIG. 122 shows a perspective view of a mobile communication device having an offset or asymmetrically positioned battery in accordance with an exemplary embodiment of the present disclosure.

FIG. 123 shows a side view of the mobile communication device of FIG. 122.

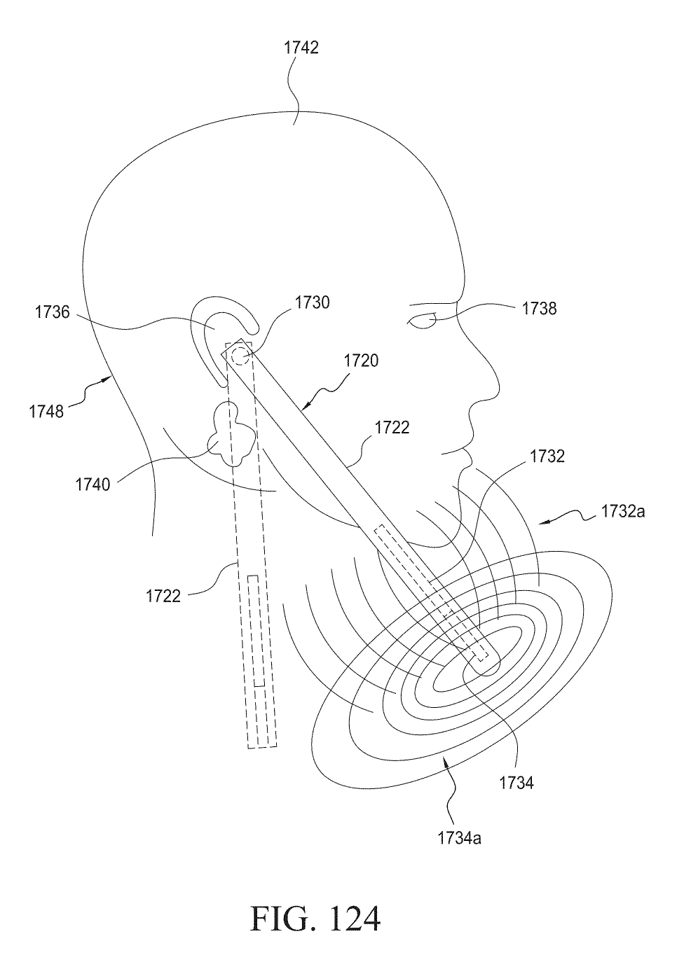

FIG. 124 shows a side view of the mobile communication device of FIGS. 122 and 123 positioned in two orientations adjacent to a user's head.

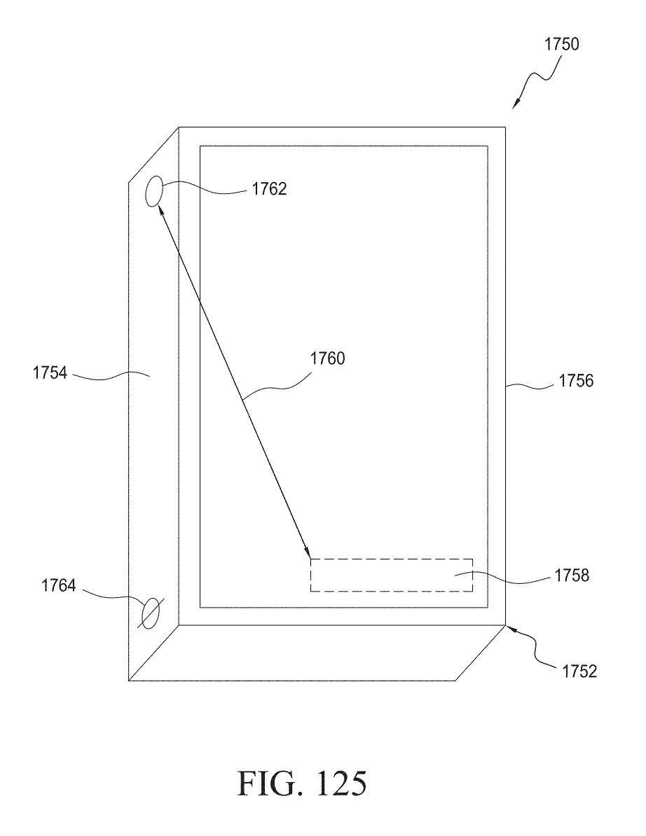

FIG. 125 shows a perspective view of a mobile communication device having an offset or asymmetrically positioned antenna in accordance with an exemplary embodiment of the present disclosure.

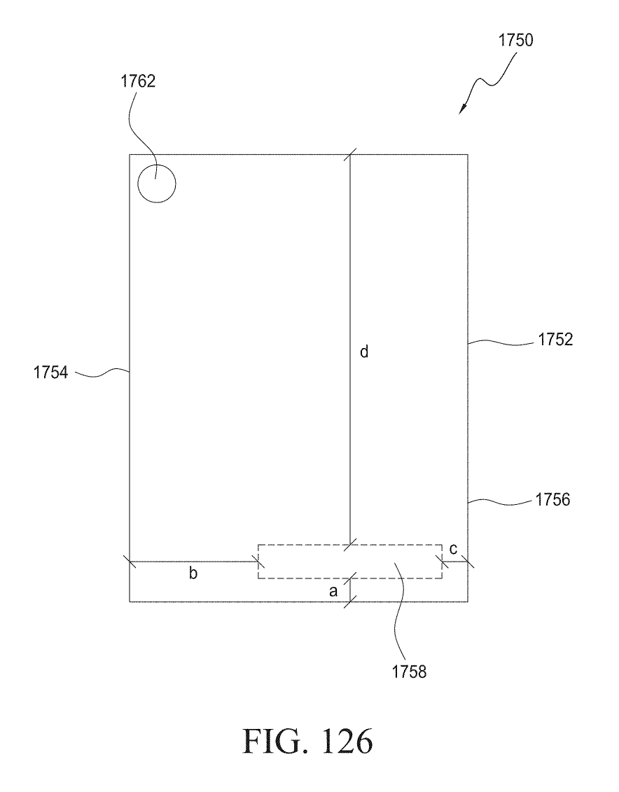

FIG. 126 shows a view of dimensional relationships for the offset or asymmetrically positioned antenna of FIG. 125 in accordance with an exemplary embodiment of the present disclosure.

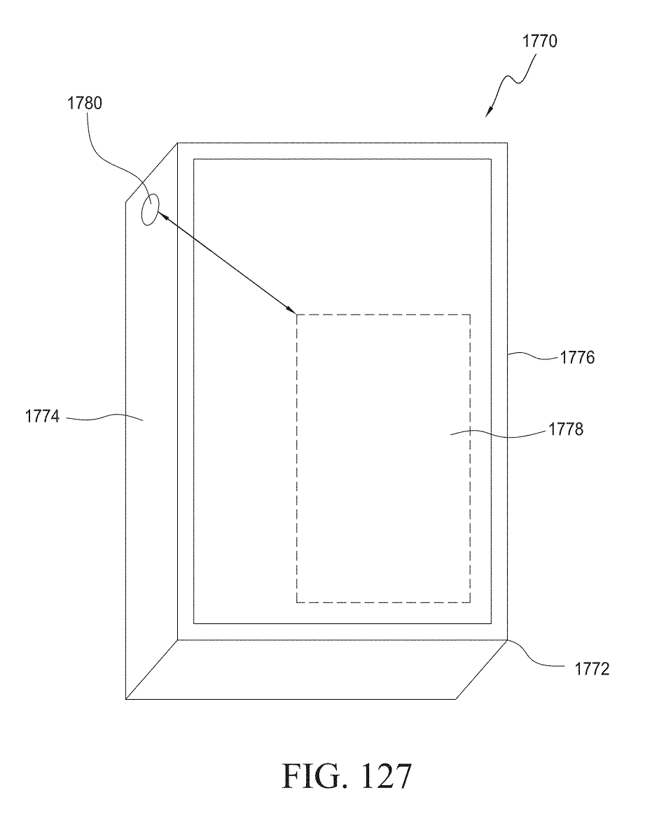

FIG. 127 shows a view of a diagonal relationship of an offset or asymmetrically positioned battery from a speaker in accordance with an exemplary embodiment of the present disclosure.

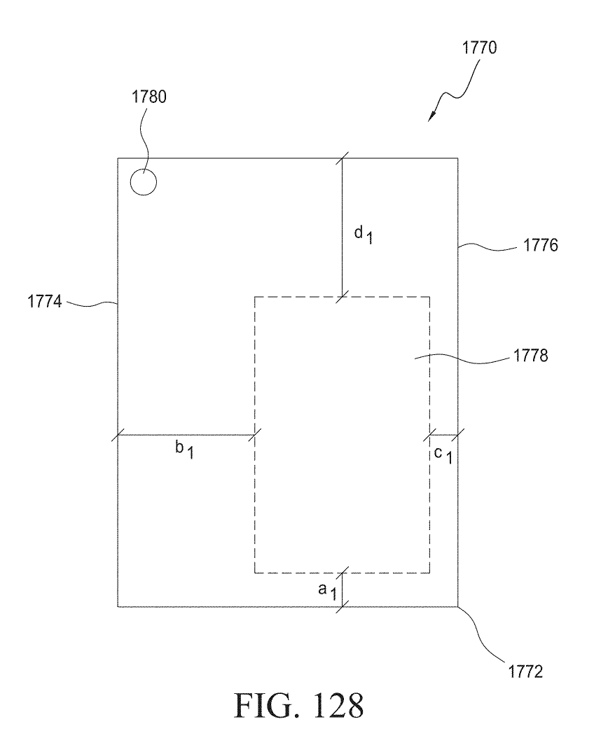

FIG. 128 shows a view of dimensional relationships for the offset or asymmetrically positioned battery of FIG. 127 in accordance with an exemplary embodiment of the present disclosure.

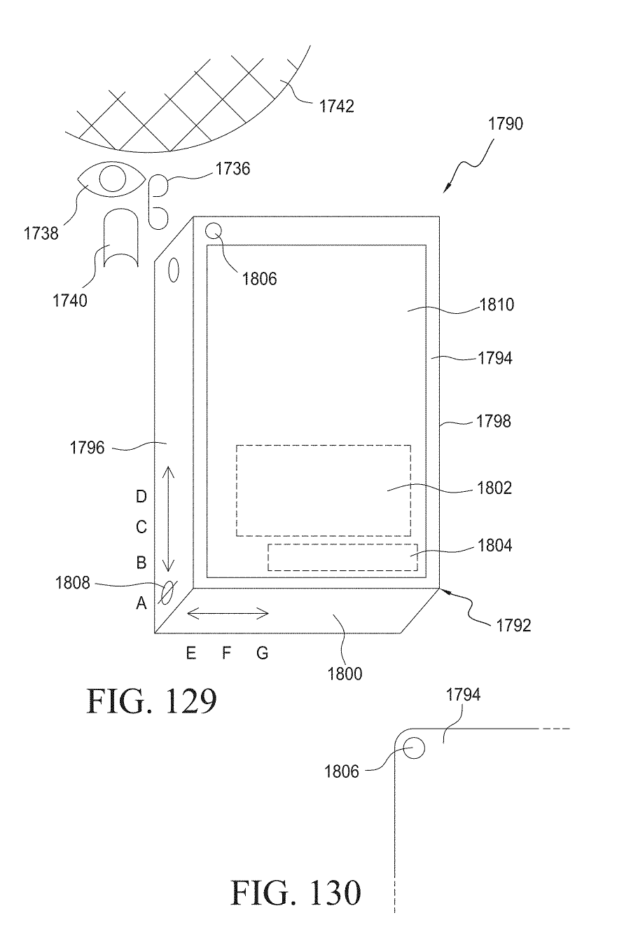

FIG. 129 shows a perspective view of mobile communication device and optional positions for a microphone in a mobile communication device having an offset or asymmetrically positioned antenna and battery in accordance with an exemplary embodiment of the present disclosure.

FIG. 130 shows a view of a corner of a mobile communication device showing a speaker in accordance with an exemplary embodiment of the present disclosure.

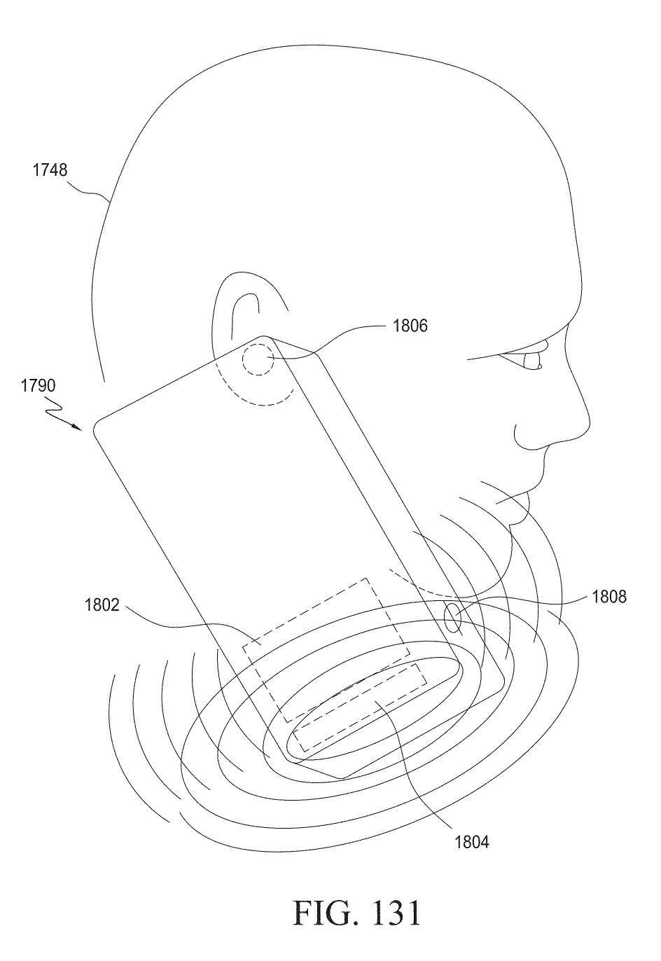

FIG. 131 shows a view of the mobile communication device of FIG. 129 positioned next to an ear of a user.

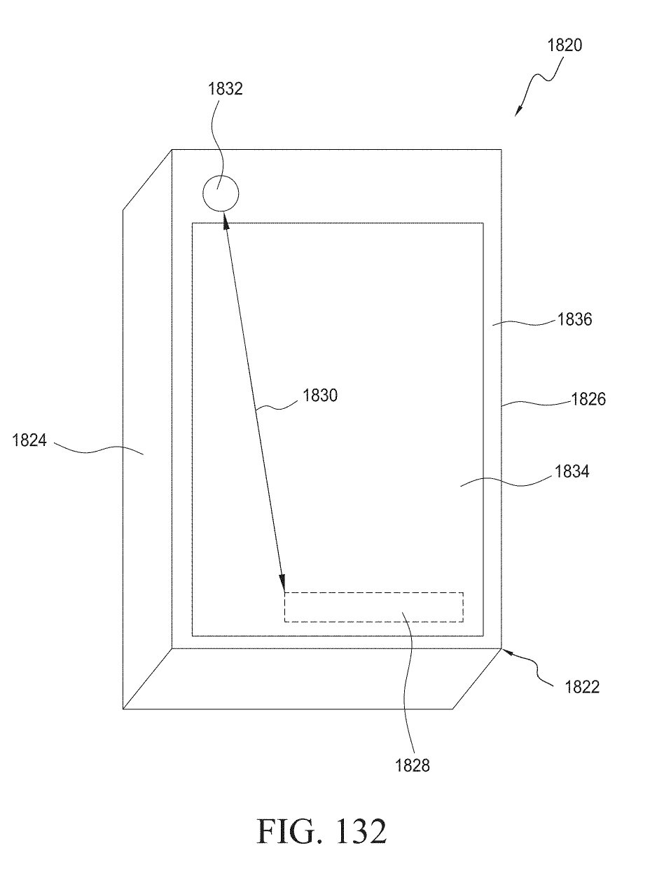

FIG. 132 shows a perspective view of mobile communication device and a diagonal position of an offset or asymmetrically positioned antenna with respect to a speaker in accordance with an exemplary embodiment of the present disclosure.

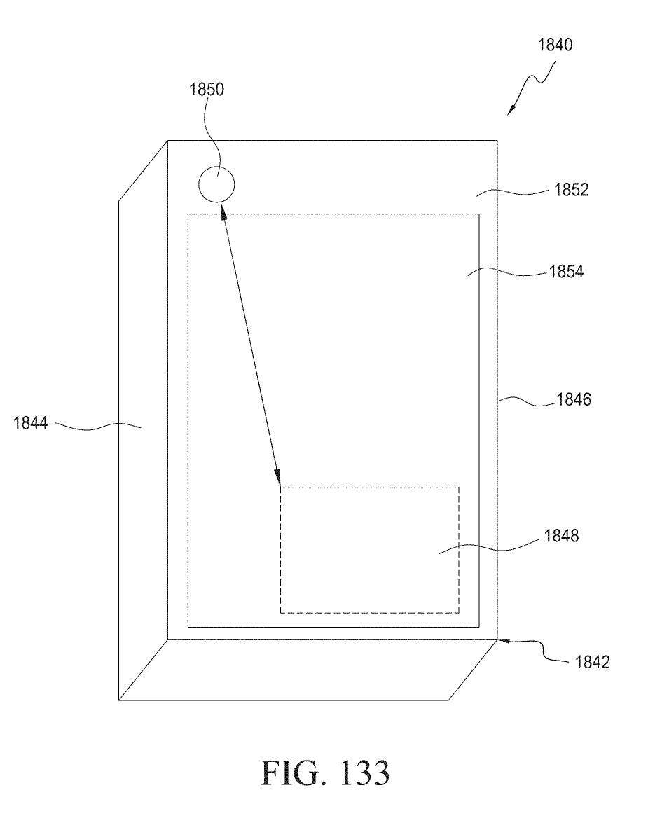

FIG. 133 shows a perspective view of mobile communication device and a diagonal position of an offset or asymmetrically positioned battery with respect to a speaker in accordance with an exemplary embodiment of the present disclosure.

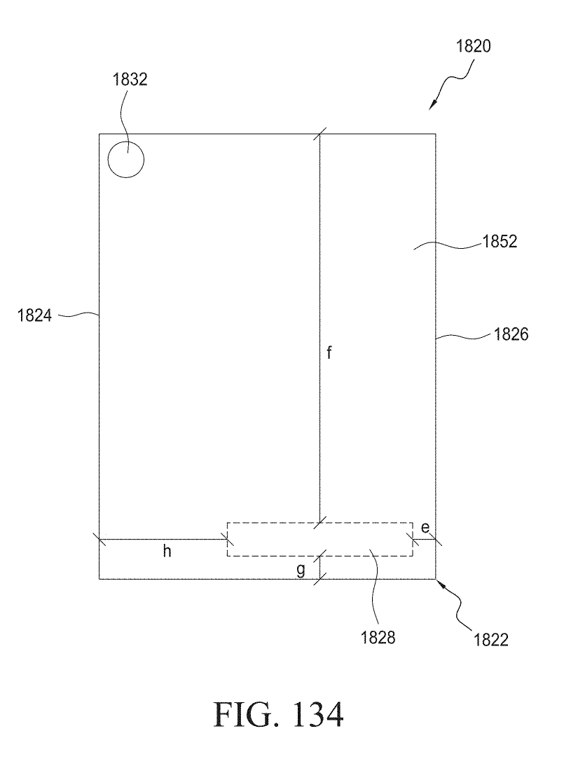

FIG. 134 shows a view of dimensional relationships for the offset or asymmetrically positioned antenna of FIG. 132 in accordance with an exemplary embodiment of the present disclosure.

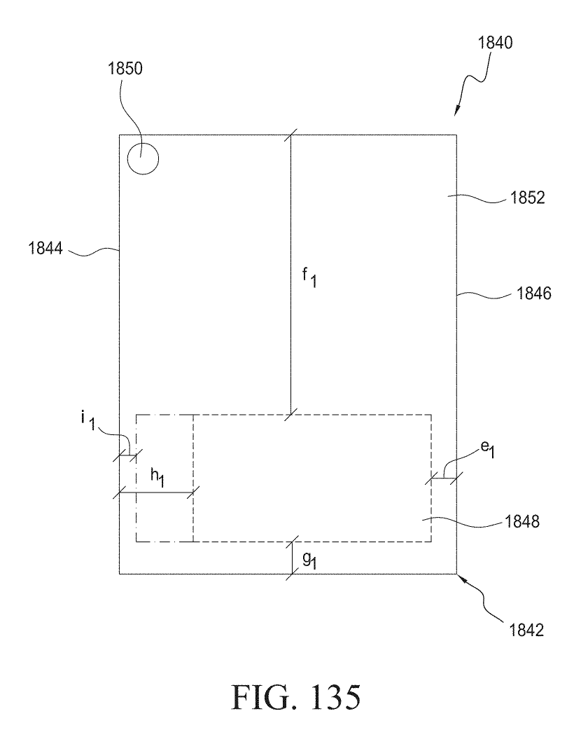

FIG. 135 shows a view of dimensional relationships for the offset or asymmetrically positioned battery of FIG. 133 in accordance with an exemplary embodiment of the present disclosure.

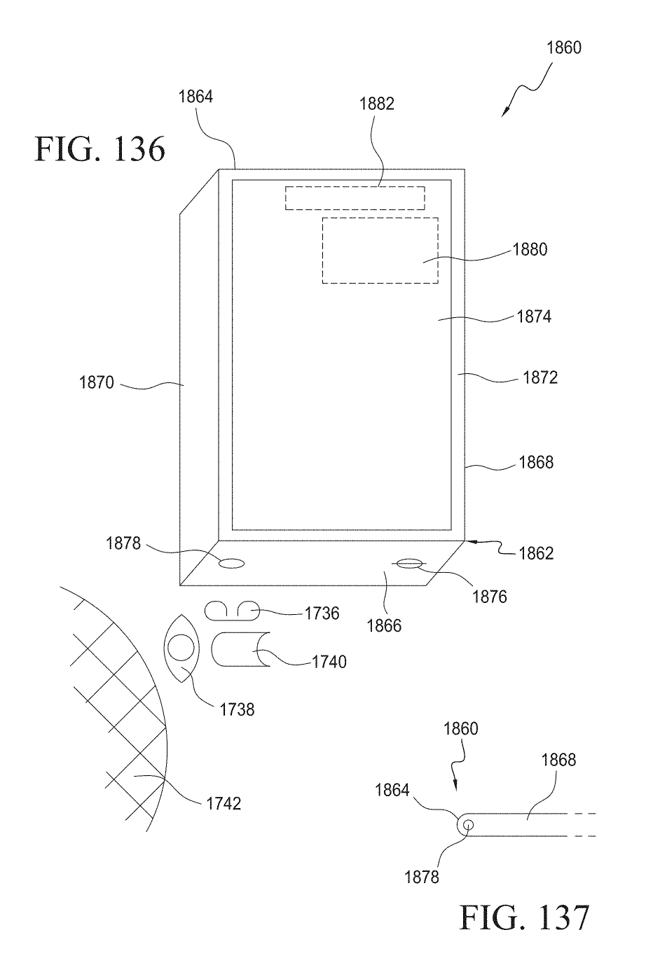

FIG. 136 shows a perspective view of a mobile communication device having an offset or asymmetrically positioned antenna and battery in accordance with an exemplary embodiment of the present disclosure.

FIG. 137 shows a side view of a mobile communication device in accordance with an exemplary embodiment of the present disclosure.

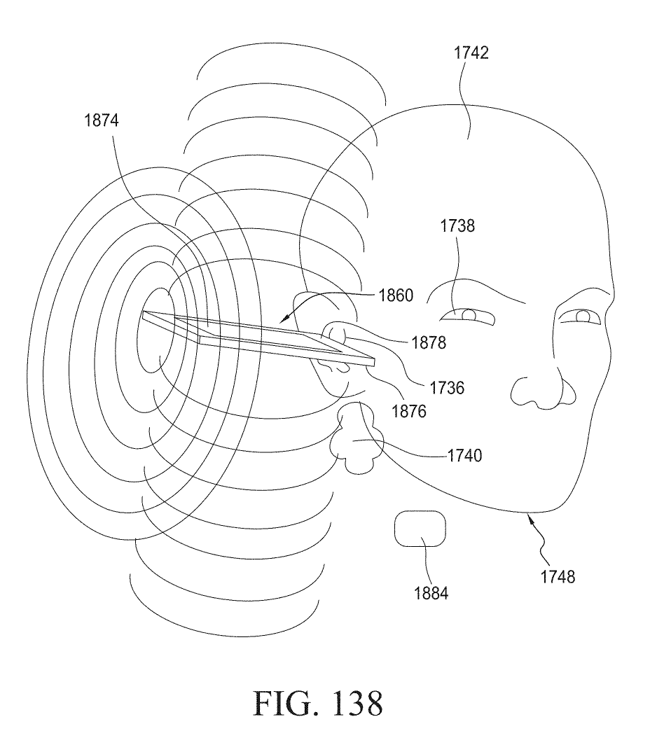

FIG. 138 shows a perspective view of the mobile communication device of FIG. 136 placed near a head of a user for use in communication in accordance with an exemplary embodiment of the present disclosure.

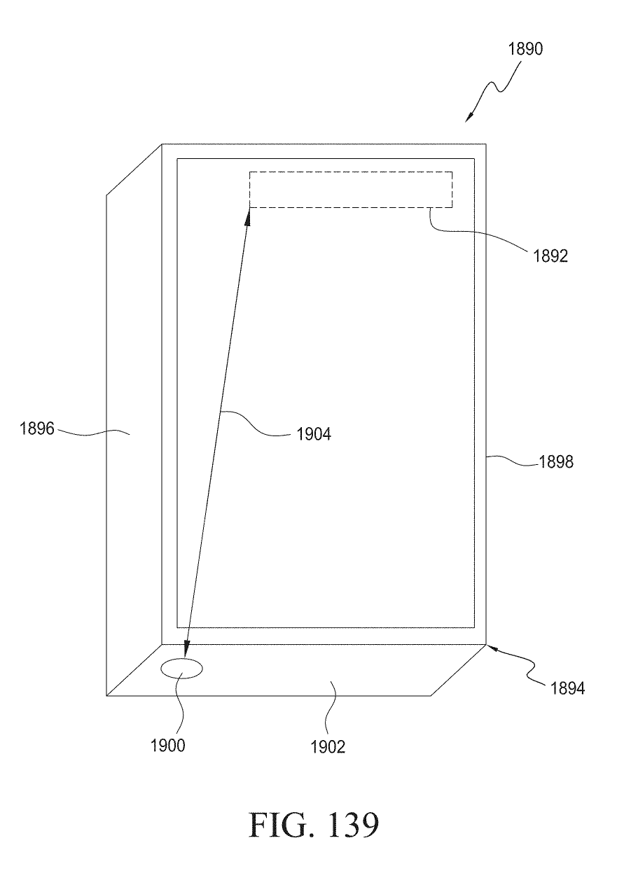

FIG. 139 shows a perspective view of a mobile communication device with a diagonal line to indicate a relationship of an offset or asymmetrically positioned antenna to a speaker of the mobile communication device in accordance with an exemplary embodiment of the present disclosure.

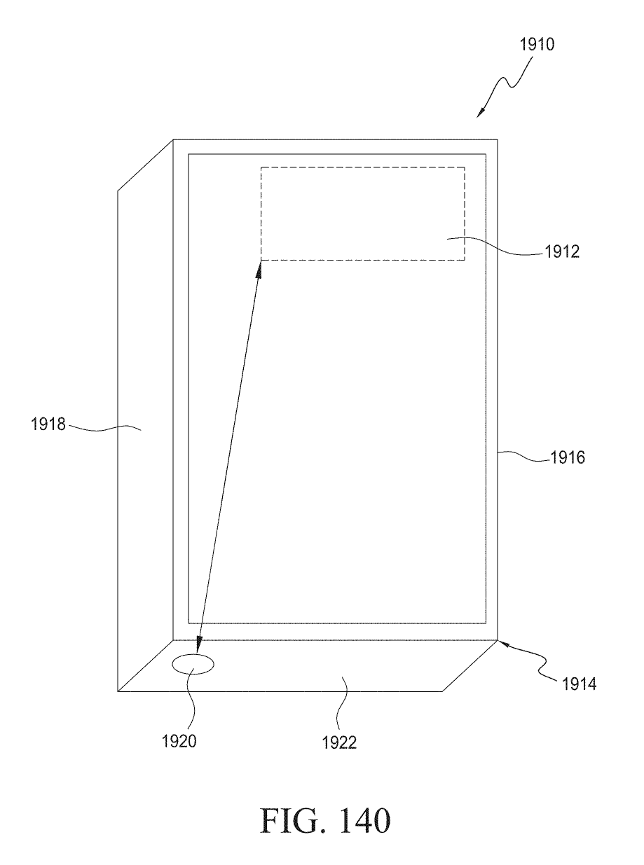

FIG. 140 shows a perspective view of a mobile communication device with a diagonal line to indicate a relationship of an offset or asymmetrically positioned battery to a speaker of the mobile communication device in accordance with an exemplary embodiment of the present disclosure.

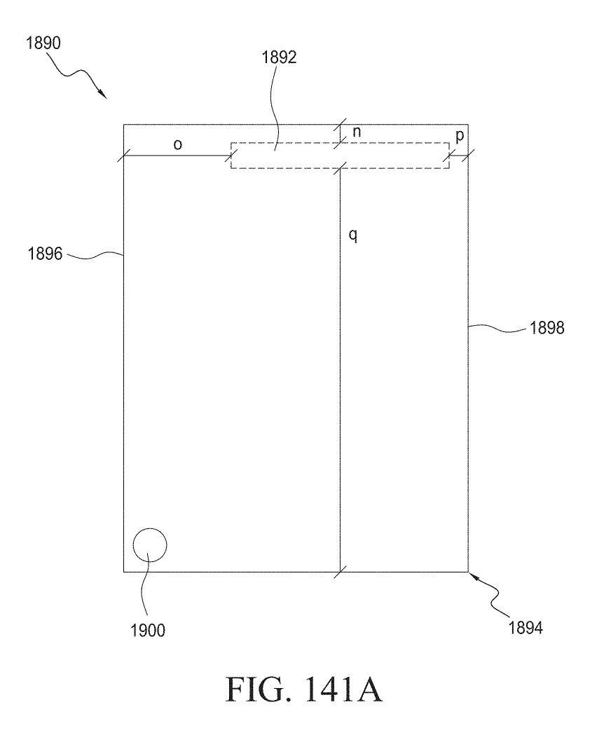

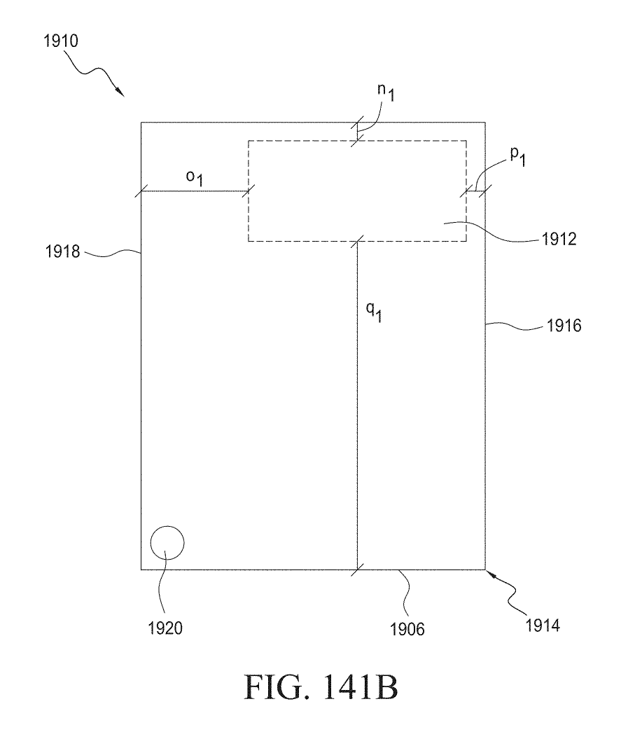

FIG. 141A shows a view of dimensional relationships for the offset or asymmetrically positioned antenna of FIG. 139 in accordance with an exemplary embodiment of the present disclosure.

FIG. 141B shows a view of dimensional relationships for the offset or asymmetrically positioned battery of FIG. 140 in accordance with an exemplary embodiment of the present disclosure.

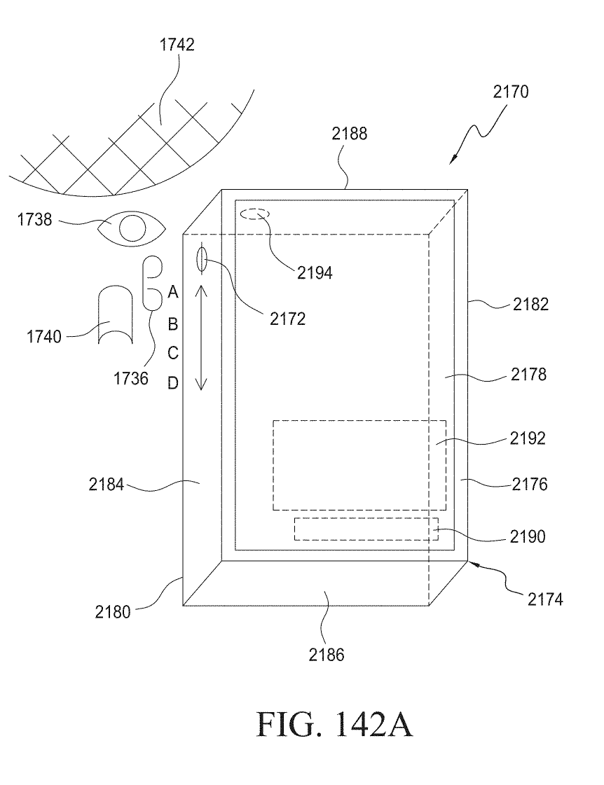

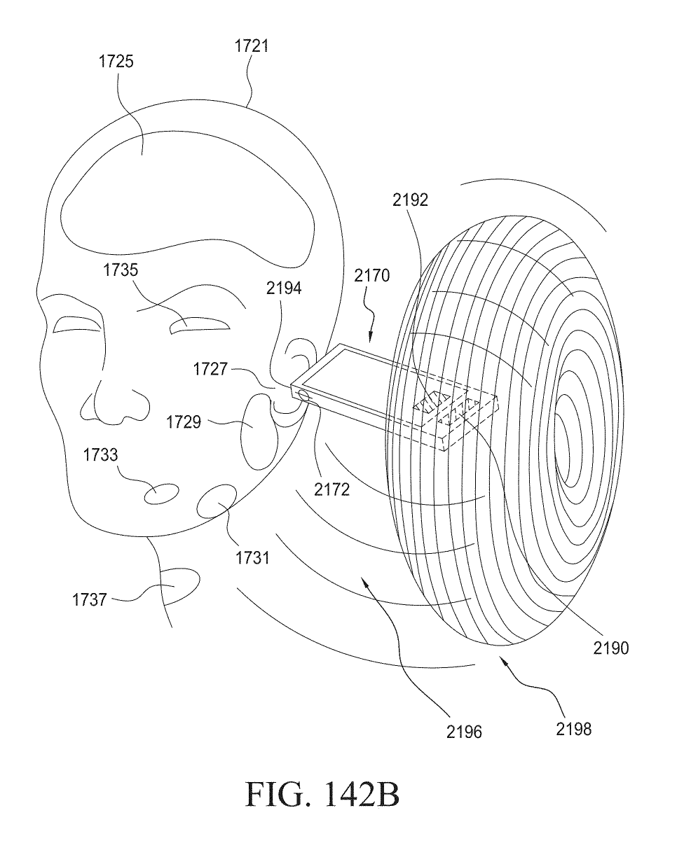

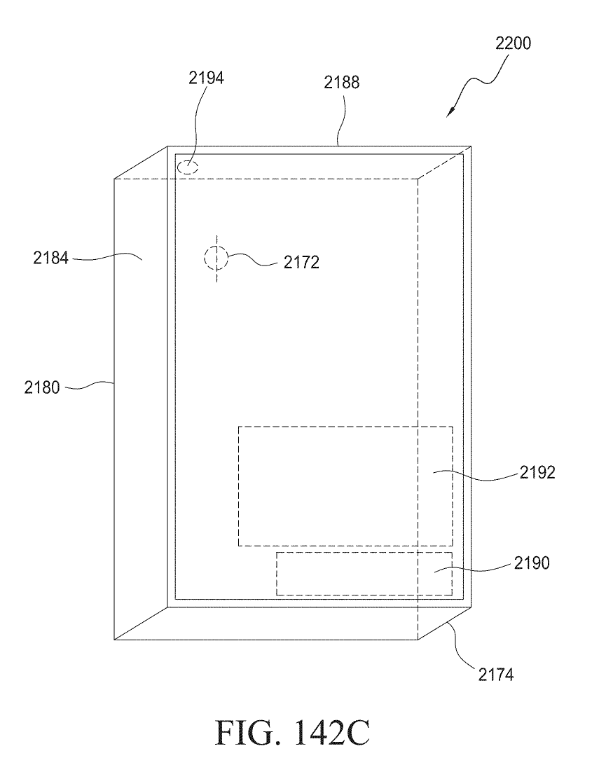

FIG. 142A shows a view of a mobile communication device including optional positions for a microphone in accordance with an exemplary embodiment of the present disclosure.

FIG. 142B shows a view of the mobile communication device of FIG. 142 positioned in use adjacent to a head of a user.

FIG. 142C shows a view of a mobile communication device in accordance with another exemplary embodiment of the present disclosure.

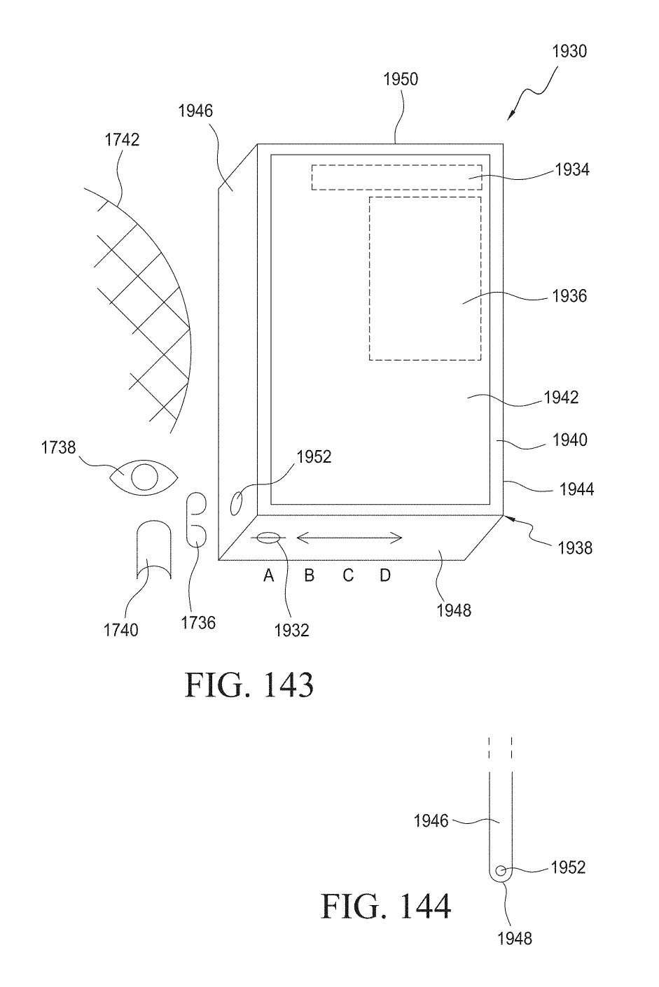

FIG. 143 shows a perspective view of a mobile communication device and optional positions for a microphone of the mobile communication device in accordance with an exemplary embodiment of the present disclosure.

FIG. 144 shows a side view of a speaker of the mobile communication device of FIG. 143.

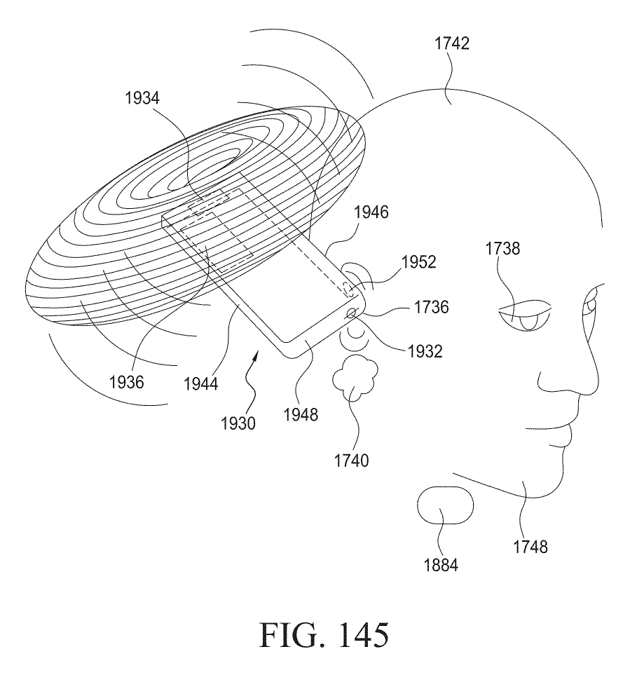

FIG. 145 shows a perspective view of the mobile communication device of FIG. 143 positioned at, near, close, alongside, or adjacent to an ear of a user.

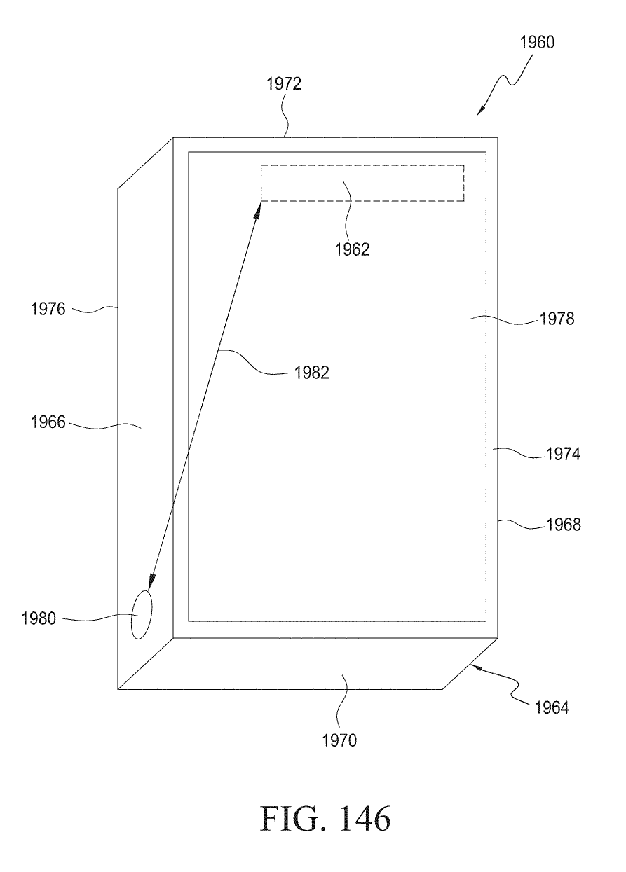

FIG. 146 shows a perspective view of a mobile communication device with a diagonal line between a speaker and an offset or asymmetrically positioned antenna in accordance with an exemplary embodiment of the present disclosure.

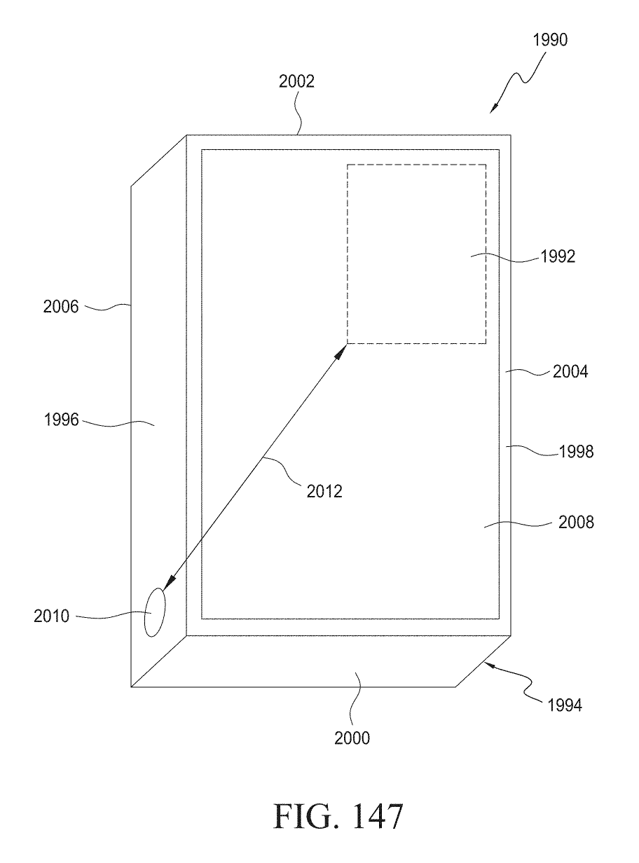

FIG. 147 shows a perspective view of a mobile communication device with a diagonal line between a speaker and an offset or asymmetrically positioned battery in accordance with an exemplary embodiment of the present disclosure.

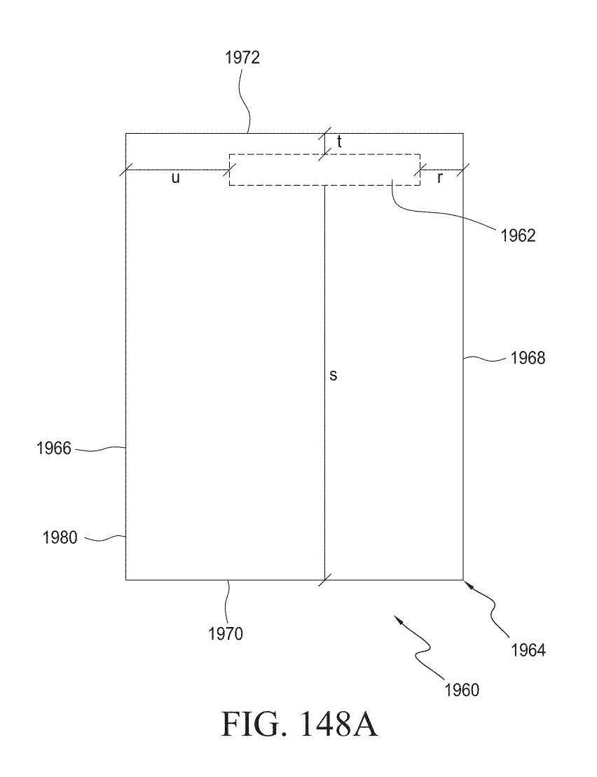

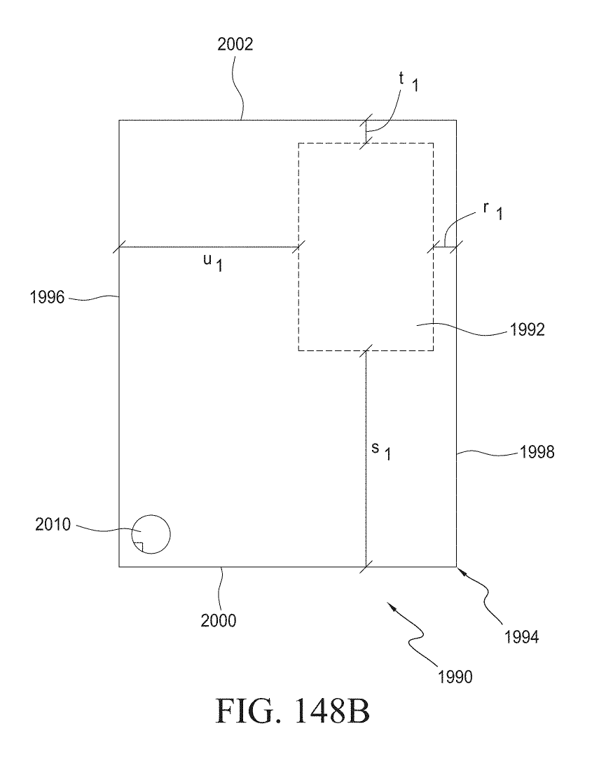

FIG. 148A shows a view of dimensional relationships for the offset or asymmetrically positioned antenna of FIG. 146 in accordance with an exemplary embodiment of the present disclosure.

FIG. 148B shows a view of dimensional relationships for the offset or asymmetrically positioned battery of FIG. 147 in accordance with an exemplary embodiment of the present disclosure.

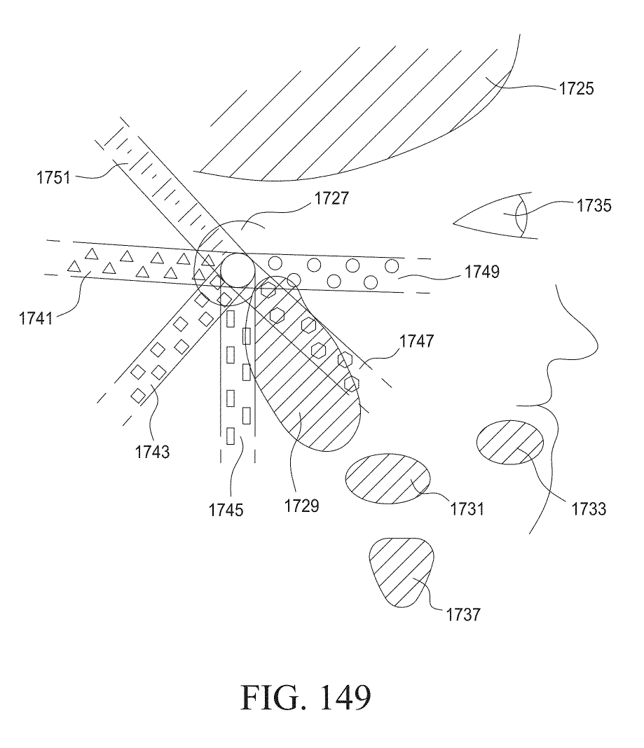

FIG. 149 shows a view of a human head including areas of the head sensitive to thermal and RF energy.

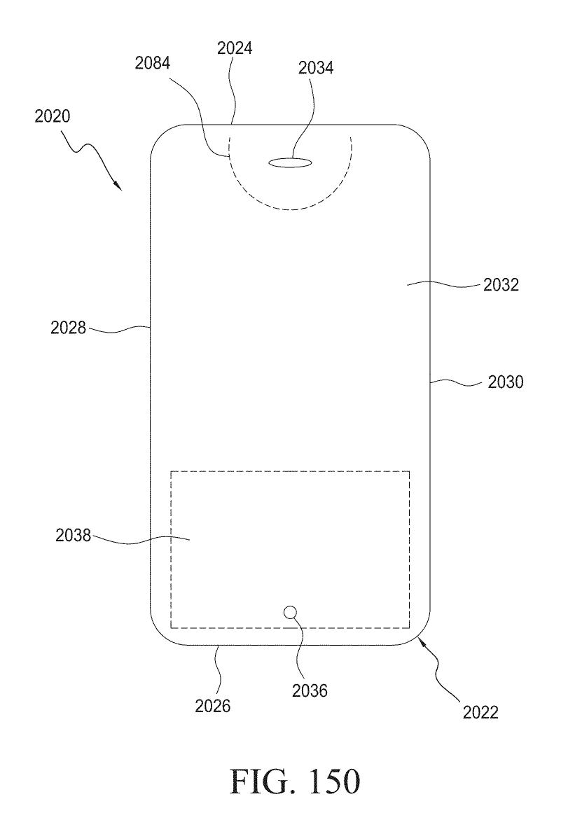

FIG. 150 shows a view of a mobile communication device having a conventional speaker and microphone configuration and an ideal position of a battery in accordance with an exemplary embodiment of the present disclosure.

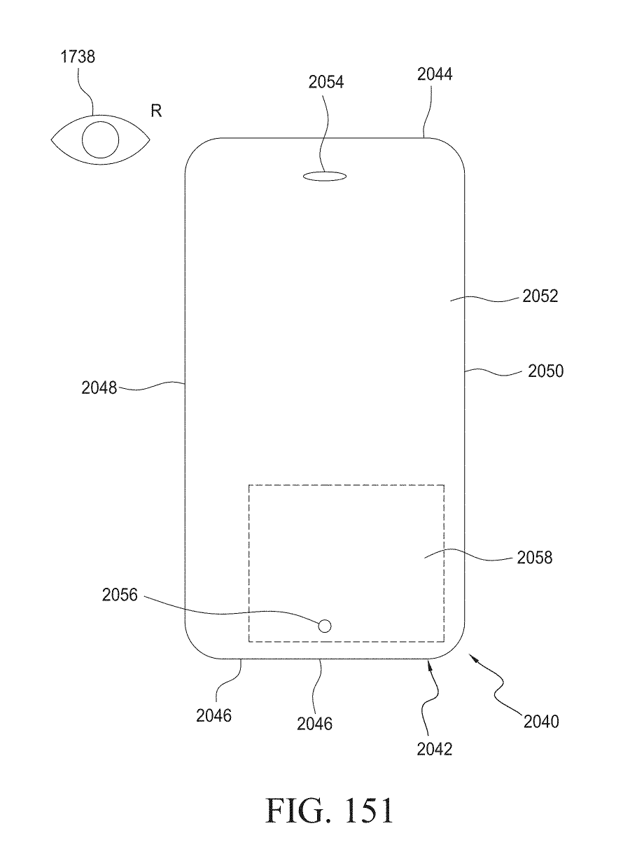

FIG. 151 shows a view of a mobile communication device having a conventional speaker and microphone configuration and an offset or asymmetrically positioned battery in accordance with an exemplary embodiment of the present disclosure.

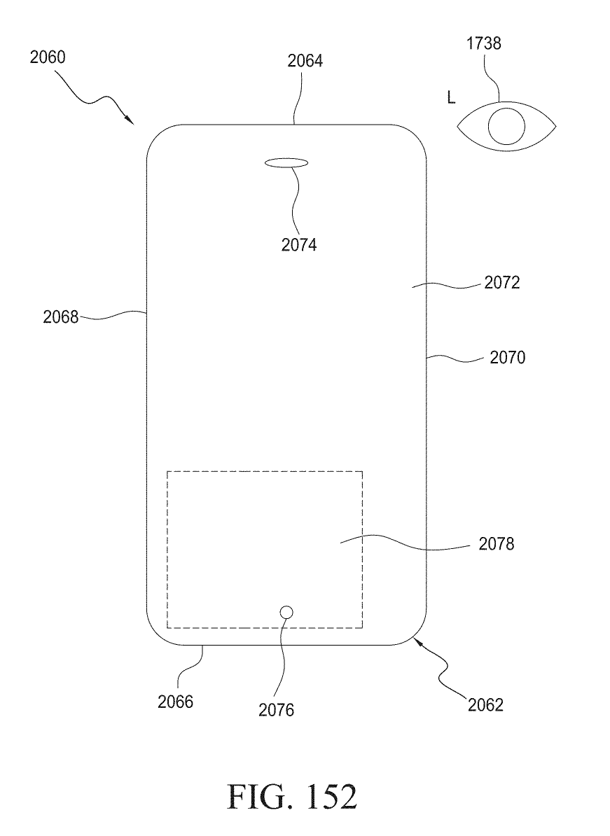

FIG. 152 shows a mobile communication device having a view of a conventional speaker and microphone configuration and an offset or asymmetrically positioned battery in accordance with an exemplary embodiment of the present disclosure.

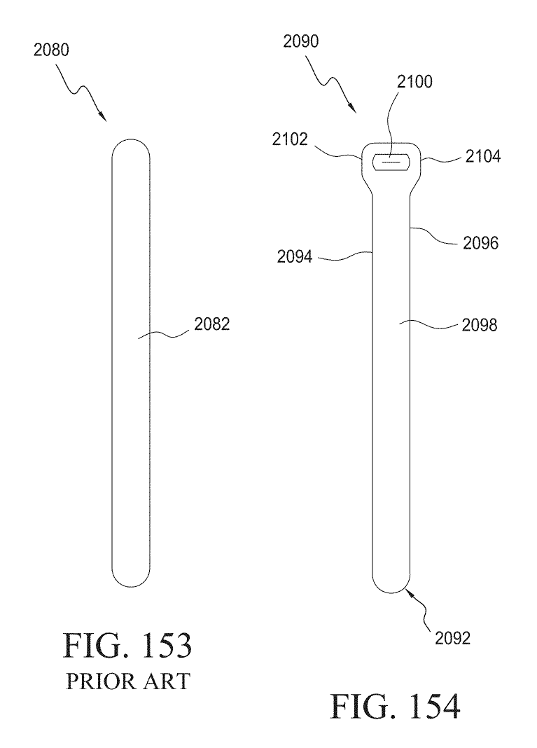

FIG. 153 shows a side view of a conventional cell phone.

FIG. 154 shows a side view of a mobile communication device in accordance with an exemplary embodiment of the present disclosure.

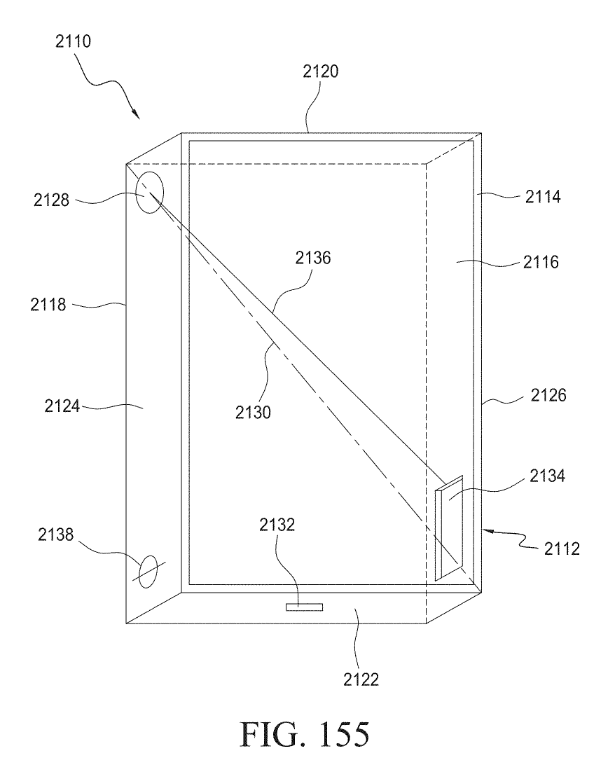

FIG. 155 shows a perspective view of a mobile communication device in accordance with an exemplary embodiment of the present disclosure.

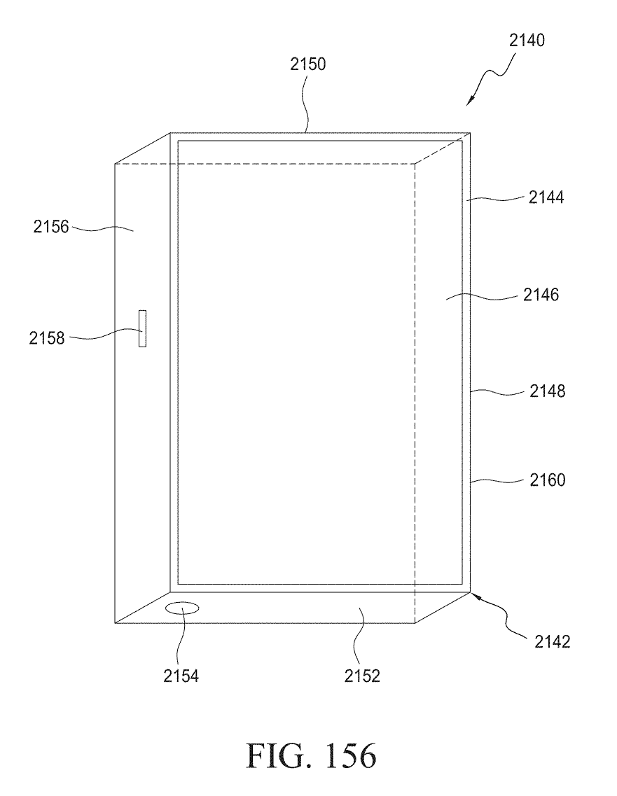

FIG. 156 shows a perspective view of a mobile communication device in accordance with an exemplary embodiment of the present disclosure.

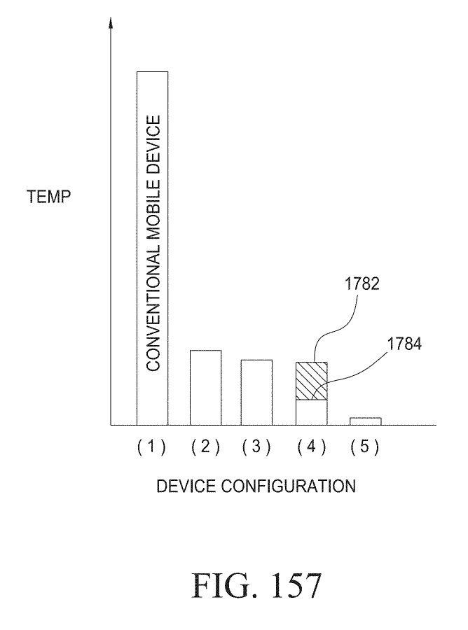

FIG. 157 shows a view of a graph indicating relative face temperatures with conventional mobile communication devices and with select mobile communication device embodiments as disclosed herein.

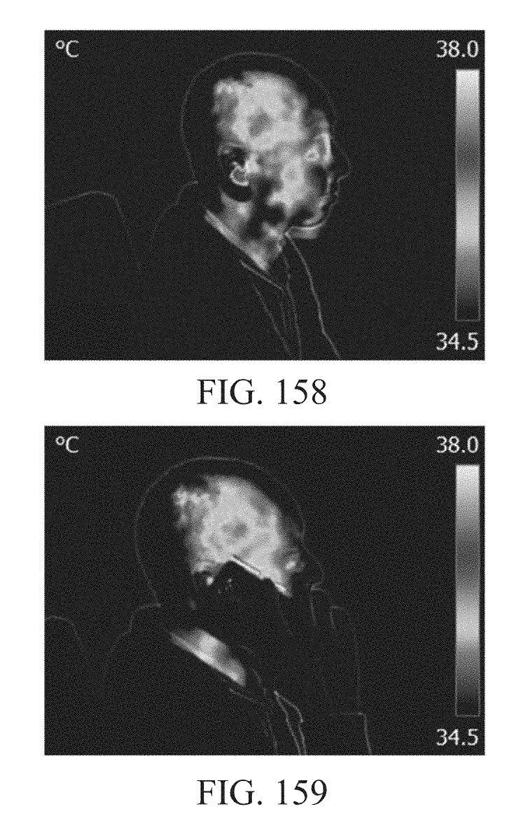

FIG. 158 shows a view of a human face at infrared wavelengths in room temperature conditions just prior to use of a conventional mobile communication device.

FIG. 159 shows a view of the human face of FIG. 158 at infrared wavelengths while using a conventional mobile communication device.

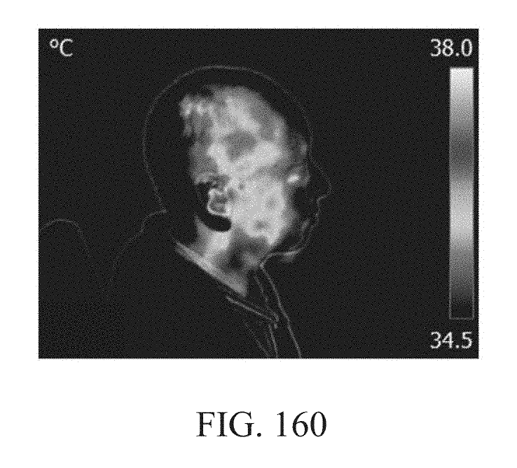

FIG. 160 shows a view of the human face of FIG. 159 at infrared wavelengths after using a conventional mobile communication device for about 15 minutes.

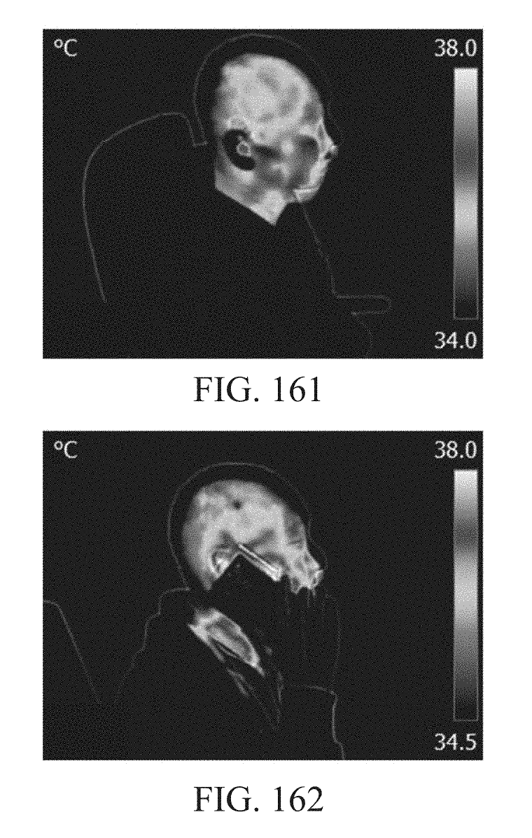

FIG. 161 shows a view of a human face at infrared wavelengths in room temperature conditions just prior to use of a conventional mobile communication device.

FIG. 162 shows a view of the human face of FIG. 161 at infrared wavelengths while using a conventional mobile communication device, near to an end of a 60 minute telephone call.

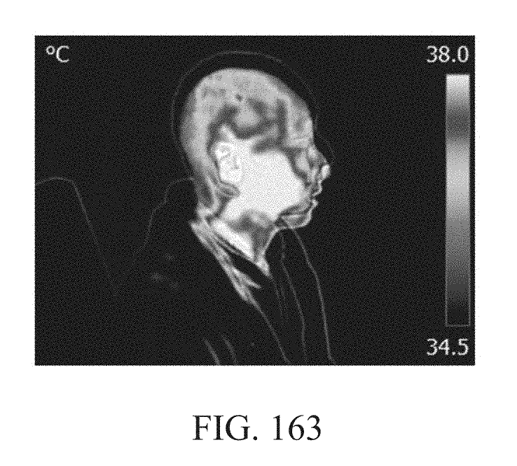

FIG. 163 shows a view of the human face of FIG. 162 at infrared wavelengths after using a conventional mobile communication device for about 60 minutes.

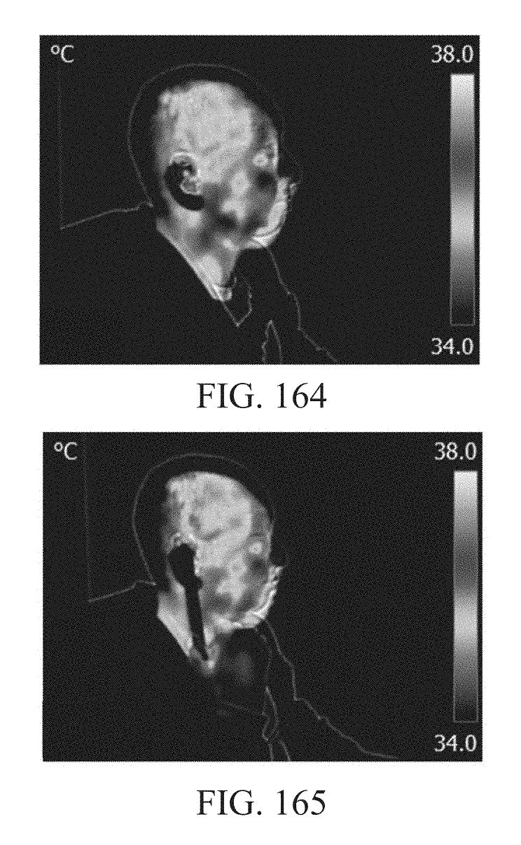

FIG. 164 shows a view of a human face of a user at infrared wavelengths in room temperature conditions just prior to use of a mobile communication device in accordance with an exemplary embodiment of the present disclosure.

FIG. 165 shows a view of the human face of FIG. 164 at infrared wavelengths while using a mobile communication device in accordance with an exemplary embodiment of the present disclosure near to an end of a 60 minute call, with the mobile communication device oriented approximately parallel to a longitudinal axis of the user.

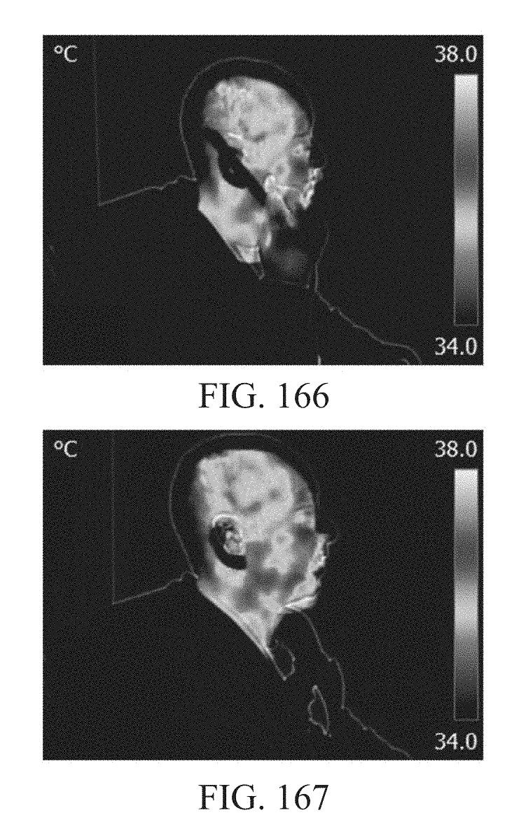

FIG. 166 shows a view of the human face of FIG. 165 at infrared wavelengths while using a mobile communication device in accordance with an exemplary embodiment of the present disclosure near to an end of an additional 30 minutes of use, with the mobile communication device oriented approximately 45 degrees with respect to a longitudinal axis of the user.

FIG. 167 shows a view of the human face of FIG. 166 at infrared wavelengths after using a mobile communication device in accordance with an exemplary embodiment of the present disclosure for about 90 minutes total minutes at the orientations of FIGS. 165 and 166.

### DETAILED DESCRIPTION

Mobile communication devices share common features. Referring to FIGS. 1 and 2, a conventional mobile communication device, indicated generally at 10, includes a housing or case 12 configured to contain various internal elements of mobile communication device 10. Housing 12 includes a front face 14, and located in or on front face 14 is a speaker 16, a microphone 18, and a display 20 positioned longitudinally between speaker 16 and microphone 18. Generally, the end or location of mobile communication device 10 where speaker 16 is located is considered a top 22 of mobile communication device 10, and thus is also the top of housing 12, and the end or location of mobile communication device 10 where microphone 18 is located is considered a bottom 24 of mobile communication device 10, and thus is also the bottom of housing 12. Speaker 16 and microphone 18 are located near a longitudinally extending centerline 28 to position speaker 16 near an ear of the user and to position microphone near a mouth of the user when mobile communication device 10 is positioned on a face of a user. Mobile communication device 10 further includes an antenna 26 for wireless communication. Antenna 26 can be, for example, a conventional dipole antenna. Antenna 26 is positioned at or near top 22, with at least a portion of antenna 26 being internal to housing 12 of mobile communication device 10. It should be understood that antenna 26 can be positioned in other areas of mobile communication device 10. It should be further understood that antenna 26 can be part of the case or other physical parts of mobile communication device 10.

While mobile communication devices 10 work well for their intended purpose, antenna 26 transmits radio frequency (RF) energy, including microwave frequencies, and it is believed that exposure to these types of energy may lead to tissue damage and potentially cancer. FIG. 2 shows mobile communication 10 held, typically with a hand, in a conventional manner near a head 32 of a user. Mobile communication device 10 emits a near field radiation pattern 30 that intersects with head 32 and brain tissues in head 32. In addition to potentially negative effects due to exposure to RF energy, the interaction of radiation pattern 30 has been shown by experimentation to heat brain tissues, and studies demonstrated that radiation from conventional mobile devices (shown in FIGS. 1 and 2) alters brain metabolism, which can be undesirable (Volkow N D et al. Effects of cell phone radiofrequency signal exposure on brain glucose metabolism. JAMA, 2011 Feb. 23; 305(8):808-13. doi: 10.1001/jama.2011. 186).

It should be noted that the speaker described throughout this disclosure is the speaker configured to be positioned adjacent, on, or in proximity to a human ear when holding the mobile communication device in a human hand while using the mobile communication device for listening to a received communication. While the term “speaker” is commonly used to refer a speaker with a volume output that requires proximity to the ear, other terms have been used to describe this speaker including receiver, earphone, and earpiece, and all such terms should be considered to be equivalent to the term “speaker” as used herein.

It should also be noted that a mobile communication device can include more than one speaker. One of these other speakers can be described as a speakerphone speaker, which can have a volume output that is unsuitable for placement of the mobile communication device adjacent or near the ear due to the risk of pain and/or ear damage, which is sometimes referred to as a loud speaker. Other speakers can be configured for specialized output, such as bass-emphasized output for playing music, though again with the speaker away from the ear. It should also be noted that in some cases a single speaker can serve multiple purposes. When the mobile communication device including such multi-function speaker is configured for interactive audio communication in a non-speakerphone mode, the audio output of the speaker is limited to reduce the risk of ear damage. Thus, any speaker having a maximum audio output suitable for placing the speaker adjacent to the ear without risk of hearing damage and/or without generating pain or discomfort should be considered as being the speaker described herein.

It should also be understood that while the term “speaker” is used to describe the audio output device, the actual speaker can be positioned internal to the casing of the mobile communication device, with output transmitted through, for example, an opening in the casing of the mobile communication device or through the structure of the casing. In addition, such output can include bone conduction capability. All audio output from the mobile communication device in the frequency range of 20 Hz to 20,000 Hz that is generated by the mobile communication device for emission from the mobile communication device is emitted from a device that can be described as a speaker, regardless of whether the method of transmission is via air, bone conduction, through the casing, etc. Another term for a portion of the casing where sound travels from the mobile communication device into surrounding air is port or audio port.

It should be noted that a conventional mobile communication device can use a dipole type antenna. A dipole antenna generates an RF energy or radiation pattern that can be described as a doughnut or toroidal shape, such as that shown in FIG. 2, with a center of the doughnut or toroid located at the dipole antenna. It should be understood that radiation in a doughnut or toroidal shape is synonymous with omnidirectional radiation or emission. However, as should be apparent from FIG. 2, such radiation or emission is not spherical, but tends to be oriented in a plane 36 that is perpendicular to an axis of rotation 34 of the toroid about the antenna with rapidly decreasing intensity above and below plane 36. As should be apparent from the disclosed embodiments, one benefit of certain mobile communication device embodiments is to position the omnidirectional output of a mobile communication device antenna such that plane 36 is non-intersecting with a user's brain. In some embodiments, plane 36 is parallel to a user's face and/or head, thus positioning the face or head in a location that can be described as offset from the plane of emission.

While some embodiments of the present disclosure provide positions of one or more speakers and microphones that permit a user to orient the antenna of a mobile communication device in a location that reduces exposure to RF energy, the present disclosure also provides speaker and microphone locations that yield expanded user flexibility in using mobile communication devices. Included among the disclosed embodiments are orientations where the speaker of the mobile communication device is positioned in locations diametrically opposed to, or as far as possible from, the antenna of the mobile communication device, and where the antenna is positioned further away from a brain of a user than antenna 26 of conventional mobile communication device 10 when the mobile communication device is in use and held, such as with a hand or other suitable holder, near the face of a user in a conventional manner.

Exposure to radio frequency (RF) energy, including microwave frequencies, and infrared frequencies by mobile communication devices of the prior art (as shown in FIGS. 1 and 2) may lead to tissue damage as shown by various reports and may impact neural cells in the brain (Volkow N D et al in 2011 in the Journal of the American Medical Association) in addition to Applicant's own experimental evidence as disclosed in FIGS. 158 to 167. The apparatus and methods of the present disclosure are configured to reduce such radiation effects and protect sensitive organs in a manner that damage could become biologically negligible. FIG. 120 shows the head 1721 and neck 1723 of a human being indicating radiation sensitive (referred to herein as “sensitive”) and target organs that may be damaged by radiation effects caused by mobile communication devices of the prior art, namely a brain 1725, an ear 1727, a parotid gland 1729, a submandibular salivary gland 1731, a sublingual salivary gland 1733, an eye 1735, and a thyroid 1737. The apparatus and methods of the present disclosure protect all those sensitive organs (1725, 1727, 1729, 1731, 1733, 1735, and 1737) against different types of radiation including radio frequency and thermal radiation.

Although the apparatus of the present disclosure greatly reduces radiation impinging on sensitive organs brain 1725, ear 1727, parotid gland 1729, submandibular salivary gland 1731, sublingual salivary gland 1733, eye 1735, and thyroid gland 1737, such protective benefit being exemplified by preferred embodiments shown in FIGS. 124, 138, 142A, and 145, in order to achieve a biologically negligible effect is necessary to identify any radiation effect on the various sensitive organs. Accordingly, FIG. 149 shows the sensitive organs in relation to six different embodiments of the present disclosure indicating any potential radiation effect, even if it is minimal. Each position shown (1741, 1743, 1745, 1747, 1749, and 1751) requires a specialized configuration that includes combining two or more of the following components, namely antenna, speaker, microphone, battery, processor, and charging port, to achieve organ protection and usability by mobile communication devices of the present disclosure. While all embodiments of the present disclosure reduce radiation effects, configuration 1 (triangle) 1741, exemplified by the embodiments of FIGS. 142A and 145, has negligible effect on all sensitive organs. The embodiment of FIG. 142A has the least effect on sensitive organs since antenna 2190 is located further from brain 1725 than antenna 1934 in the embodiment of FIG. 145; antenna 1934 of the embodiment of FIG. 145 is behind the brain and in closer proximity to the brain (occipital region) than antenna 2190 of FIG. 142A, which is further from the brain (temporal region). By way of illustration, but not of limitation, an antenna (center of a radiation toroid) of a biologically compatible device of the present disclosure measuring 16 cm in length with antenna 1934 positioned diametrically opposed to speaker 1952 shown in FIG. 145 will be on average about 2 cm from the brain (occipital region) for the configuration of FIG. 145 while antenna 2190 will be about 14 cm from the brain (temporal region) for the configuration of FIG. 142A. However, both embodiments avoid radiation interacting with all sensitive organs.

Configuration 2 (square) 1743 has the second best protective effect, but radiation may impinge upon thyroid gland 1737 and submandibular salivary gland 1731. Radiation from configuration 3 (rectangle) 1745 avoids most of parotid gland 1729 but radiation may impinge upon thyroid gland 1737, submandibular salivary gland 1731, and sublingual salivary gland 1733. Radiation from configuration 4 (hexagon) 1747 may impinge upon parotid gland 1729, submandibular salivary gland 1731, sublingual salivary gland 1733, and eye 1735. Radiation from configuration 5 (circle) 1749 may impinge upon parotid gland 1729, sublingual salivary gland 1733, and eye 1735. Radiation from configuration 6 (lines) 1751 may impinge upon brain 1751. It should be understood that all configurations 1 to 6 requires a specialized configuration that combines at least two of these parts: antenna, speaker, heat emitting parts (including battery and processor), microphone, and charging port in order to optimize safety features and usability, as described in this disclosure in multiple exemplary embodiments, and in accordance with the principles of the present disclosure. As disclosed herein, in sharp contrast to devices of the prior art, e.g., the device of FIG. 1, in which the microphone is positioned in proximity to the mouth or adjacent to the mouth, the present disclosure teaches an unusual and unexpected configuration in which the microphone is preferentially positioned away from the mouth because of recognition that a microphone positioned close to or in proximity to the mouth has deleterious effects, as described herein and shown in FIGS. 158-167.

A series of experiments were performed to identify effects of radiation by mobile communication devices of the prior art and to design and test configurations of the present disclosure that resolves partially or in its entirety the limitations and disadvantages of the prior art. Accordingly, FIGS. 158 to 160 show a user utilizing a mobile communication device of the prior art in the usual manner, as described below.

FIG. 158 shows baseline infrared thermal image of the right side of the face. FIG. 159 shows device of FIG. 1 being held during telephone call lasting about 15 minutes, and being utilized in the standard manner in which the audio port is positioned over the ear and the front face of the device is positioned against the ear with the screen being adjacent to or resting on the skin of ear and cheek of the user during the call, and the microphone being positioned adjacent to or in proximity to the mouth of the user. FIG. 160 shows an infrared thermal image of the user in FIG. 158 after the phone call shown in FIG. 159, which revealed that even during a short call radiation effects are evident and present in sensitive organ such as ear 1727, parotid gland 1729, submandibular salivary gland 1731, and sublingual salivary gland 1733, shown as yellow-red areas around the ear, and two separate red spots on the cheek corresponding to the regions of the salivary glands. During the call, as shown in FIG. 159, radiation effects are evident in the forehead and temporal skull region shown as a red streak, which reduces in intensity after the call is completed, as shown in FIG. 160.

FIG. 161-163 shows the radiation effects after a phone call lasting about 60 minutes. FIG. 161 shows a baseline infrared thermal image of the right side of the face. FIG. 162 shows the device of FIG. 1 being held during telephone call lasting about 60 minutes, and being utilized in the conventional manner in which the audio port is positioned over the ear and the front face of the device is positioned against the ear with the screen being adjacent to or resting on the skin of ear and cheek of the user during the call, and the microphone being positioned adjacent to or in proximity to the mouth of the user. FIG. 163 shows an infrared thermal image of the user in FIG. 161 after the phone call shown in FIG. 162, which revealed high intensity radiation effects with whitening of the cheek and ear (white representing the highest thermal radiation effect in the color bar scale) with the radiation effects extending toward the neck and intense radiation extending to the brain region (including temporal, frontal, and parietal areas) and in the ocular area (shown in red-white), reaching virtually all sensitive organs (brain, ear, the three salivary glands, eye and thyroid). During the call, at about 30 minutes, as shown in FIG. 162, strong radiation effects are already evident in the temporal and frontal regions of the skull as well as neck and ocular region, which maintain intensity in some regions and mostly increase in intensity even after the call is completed, as shown in FIG. 163.

In sharp contrast to radiation effects caused by devices of the prior art (shown in FIGS. 160 and 162), the apparatus of the present disclosure positioned with its side face resting against the skin and with the microphone positioned relatively distant from the mouth, as shown in FIGS. 164 and 165, produced minimal radiation effect. FIGS. 164-167 show the virtually non-existent radiation effects after a phone call lasting about 90 minutes using the configurations of the present disclosure. FIG. 164 shows a baseline infrared thermal image of the right side of the face. FIG. 165 shows apparatus 1720 of the present disclosure shown in FIG. 124 in dashed lines (and positioned in a vertical manner) and being held in accordance with the principles of the present disclosure during a telephone call lasting about 60 minutes, during which the headset in held perpendicular to the plane of the ear and side of the face, with only the side face of the device 1720 touching the skin, and the audio port being positioned over the ear, but the front face (and screen) of device 1720 being positioned away from the ear, and the microphone being also positioned away from the mouth of the user. After the first 60 minutes, the handset was repositioned to a 45 degree angle as shown in FIG. 166 (and further shown schematically in FIG. 124) for an additional about 30 minutes, for a total of about a 90 minute phone call. FIG. 166 shows some effect of the battery in the neck, presented as a red-yellow area in the neck, further supporting the embodiments of FIGS. 142A and 145 as preferred embodiments for avoiding radiation effects. A thermal radiation image of the user in FIGS. 165 and 166 after the phone call is shown in FIG. 167, which revealed minimal to virtually no radiation effects on all sensitive organs (brain, ear, the three salivary glands, eye, and thyroid). During the 90 minute call, as shown in FIGS. 165 and 166, minimal radiation effects are present. Despite a much longer call (90 min) with the configuration of the present disclosure minimal radiation effects were observed in comparison to a short (60 minute) call using device of the prior art which evidenced strong radiation effects with radiation impinging on all sensitive organs.

FIG. 121 shows a perspective view of a mobile communication device, indicated generally at 1690, having a diagonal speaker-microphone arrangement in accordance with an exemplary embodiment of the present disclosure. Mobile communication device 1690 includes a casing 1692, which includes a top or upper transversely extending side, face, or edge 1694, a bottom transversely extending side, face, or edge 1696, and a plurality of sides or faces extending between top or upper transversely extending side, face, or edge 1694 and bottom transversely extending side, face, or edge 1696 to connect top or upper transversely extending side, face, or edge 1694 to bottom transversely extending side, face, or edge 1696. Such sides or faces include a front face 1698, a back face 1700, a right longitudinally extending side 1702, and a left longitudinally extending side 1704. Mobile communication device 1690 also includes a speaker 1710 positioned on left longitudinally extending side 1704 at a location at, near, or close to an intersection between top or upper transversely extending side, face, or edge 1694 and left longitudinally extending side 1704. Mobile communication device 1690 also includes at least one of a microphone 1706 positioned on back face 1700 and a microphone positioned on bottom transversely extending side, face, or edge 1696, at, near, or close to an intersection of back face 1700, bottom transversely extending side, face, or edge 1696, and right longitudinally extending side 1702. Thus, speaker 1710 is diagonally positioned with respect to microphones 1706 and 1708. In an exemplary embodiment, mobile communication device 1690 includes only one of microphones 1706 and 1708, both of which are shown for explanatory purposes only.

FIG. 122 shows a perspective view of a mobile communication device, indicated generally at 1720, having an offset or asymmetrically positioned battery in accordance with an exemplary embodiment of the present disclosure. Mobile communication device 1720 includes a casing 1722, which includes a right longitudinally extending side 1724, a left longitudinally extending side 1726, a microphone 1728 positioned on left longitudinally extending side 1726 at a location between a transversely extending centerline 1746, which can be one of a plurality of locations A, B, C, and D, with A being the most preferred and D being the least preferred to minimize heat and radiation transmission into, for example, an ear 1736, an eye 1738, a parotid or salivary gland 1740, and/or a brain 1742 of a user 1748, particularly when a length of mobile communication device is at least 15 centimeters, and a speaker 1730 positioned near a top of casing 1722. Positioned within housing or casing 1722 is a battery 1732 positioned closer to right longitudinally extending side or face 1724 than to left longitudinally extending side or face 1726, and an antenna 1734 that is positioned near to a center of a transverse width of mobile communication device 1720. FIG. 123 shows a side view of an upper portion of mobile communication device 1720 showing the position of speaker 1730 at the upper most edge and adjacent to the most upper edge, an in accordance with the principle of the present disclosure, creating the longest distance between speaker 1730 and microphone 1728, located at the same plane of antenna 1734. FIG. 124 shows a side view of the mobile communication device of FIGS. 122 and 123 positioned in two preferred orientations adjacent to a user's head, namely housing or casing 1722 having an essentially vertical position virtually parallel to a longitudinal axis of a user's body (shown in dashed lines as housing or casing 1722) and housing or casing 1722 having a diagonal position about 45 degree angle (shown in solid lines) in relation to the axis of the user's body. The configuration of mobile communication device 1720 prevents radiation reaching the brain including radiation 1732a being emitted from battery 1732 and radiation 1734a being emitted from antenna 1734. However, thyroid 1737, submandibular salivary gland 1731, and sublingual salivary gland 1733 may be exposed to radiation 1732a and radiation 1734a. Microphone 1728 is located away from the mouth of the user. FIG. 138 shows a perspective view of mobile communication device 1860 placed near a head of a user for use in communication in accordance with an exemplary embodiment of the present disclosure, which positions heat and RF radiation a spaced distance perpendicularly away from the user, and particularly eye 1738, ear 1836, parotid gland 1740, submandibular salivary gland 1731, sublingual salivary gland 1733, brain 1742, and thyroid 1737. The embodiment of FIG. 138 is structured and positioned (circle) as device 1749 in FIG. 149, which is a configuration that minimizes radiation exposure to sensitive organs.

FIG. 125 shows a perspective view of a mobile communication device, indicated generally at 1750, having an offset or asymmetrically positioned antenna 1758 in accordance with an exemplary embodiment of the present disclosure. Device 1750 includes a casing 1752, a left side 1754, a right side 1756, a speaker 1762 positioned near a top of left side 1754, and a microphone 1764 positioned near a bottom of left side 1754. A diagonal line 1760 shows a preferred offset position of antenna 1758 that is toward right side 1756 and away from left side 1754, where speaker 1762 is positioned in device 1750, diametrically opposed to antenna 1758. Mobile communication device of FIGS. 122 and 124 includes configuration of FIGS. 125 to 128. It should be understood that a preferred embodiment also includes a processor diametrically opposed to a speaker, but within the technical limitations of locating a processor in the corner of a mobile communication device.

FIG. 126 shows a view of dimensional relationships a from a bottom side of casing 1752, b from left side 1754, c from right side 1756, and d from a top side of casing 1752 for offset or asymmetrically positioned antenna 1758 of FIG. 125 in accordance with an exemplary embodiment of the present disclosure. The relationships of these dimensions include a<b and c<d. Speaker 1762 is shown for orientation purposes only and is not located on the face or side shown.

FIG. 127 shows a mobile communication device, indicated generally at 1770, showing a relationship of an offset or asymmetrically positioned battery 1778 positioned in a casing 1772 toward a right side 1776 and away from a left side 1774 and diagonally from a speaker 1780 that is positioned near a top of a left side of casing 1772 in accordance with an exemplary embodiment of the present disclosure.

FIG. 128 shows a view of dimensional relationships a₁ from a bottom side of casing 1772, b₁ from left side 1774, c₁ from right side 1776, and d₁ from a top side of casing 1772 for offset or asymmetrically positioned battery 1778 of FIG. 127 in accordance with an exemplary embodiment of the present disclosure. The relationships of these dimensions include a₁<b₁ and c₁<d₁. Speaker 1780 is shown for orientation purposes only and is not located on the face or side shown.

FIG. 129 shows a perspective view of mobile communication device, indicated generally at 1790, and optional positions for a microphone 1808 in mobile communication device 1790 having an offset or asymmetrically positioned antenna 1804 and battery 1802 in accordance with an exemplary embodiment of the present disclosure. Device 1790 includes a casing 1792 that includes a front face 1794 on which is positioned a display 1810 and a speaker 1806 on an upper left hand corner; a right side 1794, a left side 1796, and a bottom side 1800. Microphone 1808 can be on left side 1796 or bottom side 1800 in any one of positions A, B, C, D, E, F, and G, preferably D when device 1790 is greater than or equal to 15 centimeters in length. However, position A, which is the farthest from speaker 1806 is a preferred position for distancing sources of radiation (e.g., battery 1802 and antenna 1804) from sensitive organs brain 1742, eye 1738, ear 1736, and parotid gland 1740. Antenna 1804 and battery 1802 are in the lower right corner of device 1790, offset toward right side 1798 and toward bottom side 1800. FIG. 130 shows a view of the upper left corner of mobile communication device 1790. FIG. 131 shows a view of mobile communication device 1790 positioned next to an ear of user 1748 with heat and RF radiation in a location that is spaced away from the brain and eye of the user 1748.

FIG. 132 shows a perspective view of mobile communication device, indicated generally at 1820, having an offset or asymmetrically positioned antenna 1828 in accordance with an exemplary embodiment of the present disclosure. Device 1820 includes a casing 1822, a left side 1824, a right side 1826, and a speaker 1832 positioned near a top of front face 1836, which also includes a display 1834. A diagonal line 1830 shows a preferred offset position of antenna 1828 that is toward right side 1826 and away from left side 1824.

FIG. 133 shows a perspective view of mobile communication device, indicated generally at 1840, and a diagonal position of an offset or asymmetrically positioned battery 1848 positioned in a casing 1842 toward a right side 1846 and away from a left side 1844 and diagonally from a speaker 1850 positioned on a front face 1852 of casing 1842 at a top left corner of front face 1852, which includes a display 1854, with respect to a speaker 1850 in accordance with an exemplary embodiment of the present disclosure.

FIG. 134 shows a view dimensional relationships g from a bottom side of casing 1822, h from left side 1824, e from right side 1826, and f from a top side of casing 1822 for offset or asymmetrically positioned antenna 1828 of FIG. 132 in accordance with an exemplary embodiment of the present disclosure. The relationships of these dimensions include g<h and e<f. Speaker 1832 positioned on front face 1852 is shown for orientation.

FIG. 135 shows a view of dimensional relationships g₁ from a bottom side of casing 1842, h₁ from left side 1844, i₁ from left side 1844, e₁ from right side 1846, and f₁ from a top side of casing 1842 for offset or asymmetrically positioned battery 1848, similarly to antenna 1778 of FIG. 127 in accordance with an exemplary embodiment of the present disclosure. The relationships of these dimensions include g₁<h₁ and e₁<f₁. It should be understood that g₁, i₁, and e₁ may have the same or similar dimensions for achieving a central middle position for battery 1848. A centrally positioned battery 1848 is desirable (as compared to the prior art) because a central location positions battery 1848 away from speaker 1850 and thus minimizes radiation exposure to sensitive organs. However, a centrally positioned battery and/or centrally positioned antenna is considered an alternative embodiment because a central position brings a source of radiation (or edge of the source of radiation) close to speaker 1850, and thus closer to sensitive organs, which may thus be exposed to radiation. Speaker 1850 positioned on front face 1852 is shown for orientation. Mobile communication device 1770 and 1790 of FIGS. 129 and 131 includes the configurations of FIGS. 132 to 135.

FIG. 136 shows a perspective view of a mobile communication device, indicated generally at 1860, having an offset or asymmetrically positioned battery in accordance with an exemplary embodiment of the present disclosure. Mobile communication device 1860 includes a casing 1862, which includes a right longitudinally extending side 1868, a left longitudinally extending side 1870, and a microphone 1876 positioned on a right side of a bottom side 1866. Positioned within housing or casing 1862 is a battery 1880 positioned closer to right longitudinally extending side or face 1868 than to a left longitudinally extending side or face 1870, and an antenna 1882 positioned closer to right longitudinally extending side or face 1868 than to left longitudinally extending side or face 1870. The configuration of mobile communication device 1860 moves heat generated by battery 1880 and RF radiation generated by antenna 1882 a spaced distance away from ear 1736, eye 1738, parotid gland 1740, and brain 1742. Mobile communication device 1860 of FIGS. 136 and 138 includes the configurations of FIGS. 139, 140, 141A, and 141B.

FIG. 137 shows a side view of a mobile communication device, indicated generally at 1890, in accordance with an exemplary embodiment of the present disclosure. This embodiment is similar to the embodiment of FIG. 136, but with speaker 1878 positioned on right side 1868 near bottom side 1866. FIG. 138 shows a perspective view of mobile communication device 1860 placed near a head of user 1748 for use in communication in accordance with an exemplary embodiment of the present disclosure, which positions heat and RF radiation a spaced distance perpendicularly away from user 1748, and particularly eye 1738, ear 1736, parotid gland 1740, brain 1742, and a thyroid 1884.

FIG. 139 shows a perspective view of a mobile communication device, indicated generally at 1890, having an offset or asymmetrically positioned antenna 1892 in accordance with an exemplary embodiment of the present disclosure. Device 1890 includes a casing 1894, a left side 1896, a right side 1898, a bottom side 1902, and a speaker 1900 positioned on bottom side 1902 near an intersection of bottom side 1902 with left side 1896. A diagonal line 1904 shows a preferred offset position of antenna 1892 that is toward right side 1898 and away from left side 1896.

FIG. 140 shows a perspective view of a mobile communication device, indicated generally at 1910, showing a relationship of an offset or asymmetrically positioned battery 1912 positioned in a casing 1914 toward a right side 1916 and away from a left side 1918 and diagonally from a speaker 1920, which is positioned on a bottom side 1922 of casing 1914 near an intersection of bottom side 1922 and left side 1918, in accordance with an exemplary embodiment of the present disclosure.

FIG. 141A shows a view of dimensional relationships n from a top side of casing 1894, o from left side 1896, p from right side 1898, and q from a bottom side 1906 of casing 1894 for offset or asymmetrically positioned antenna 1892 of FIG. 139 in accordance with an exemplary embodiment of the present disclosure. The relationships of these dimensions include n<o and p<q. Speaker 1900 is shown for orientation purposes only and is not located on the face or side shown.

FIG. 141B shows a view of dimensional relationships n₁ from a top side of casing 1914, o₁ from left side 1918, p₁ from right side 1916, and q₁ from a bottom side of casing 1914 for offset or asymmetrically positioned battery 1912 of FIG. 140 in accordance with an exemplary embodiment of the present disclosure. The relationships of these dimensions include n₁<o₁ and p₁<q₁. Speaker 1920 is shown for orientation purposes only and is not located on the face or side shown.

FIG. 142A shows a view of a mobile communication device, indicated generally at 2170, including optional positions for a microphone 2172 in accordance with an exemplary embodiment of the present disclosure. Mobile communication device 2170 includes a housing or casing 2174 that includes a front face, side or surface 2176 on which is positioned a display 2178, and a back face, side, or surface 2180 located on an opposite side of housing or casing 2174 from front side 2176. Housing or casing 2174 includes a plurality of sides that extend from front side 2176 to back side 2180 to attach or connect front side 2176 and back side 2180 to each other, including, a right longitudinally extending side 2182, a left longitudinally extending side 2184, a lower or bottom transversely extending side 2186 that extends from right longitudinally extending side 2182 to left longitudinally extending side 2184, and an upper or top transversely extending side 1950 that is positioned on an opposite side of housing or casing 2174 from lower or bottom transversely extending side 2186 and which extends from right longitudinally extending side 2182 to left longitudinally extending side 2184. Microphone 2172 can be positioned on left longitudinally extending side 2184 in any one of positions A, B, C, and D, with position A being at, near, close, or adjacent to an intersection of left longitudinally extending side 2184 and upper or top transversely extending side 2188, and positions B, C, and D being increasingly farther from top transversely extending side 2188. Mobile communication device 2170 further includes an antenna 2190 and a battery 2192 positioned diagonally across housing or casing 2174 from microphone 2172 to corner formed by an intersection of front side or face 2176, right longitudinally extending side 2182, and lower or bottom transversely extending side or edge 2186. Thus, in the view of FIG. 142A, microphone 2172 is toward an upper left corner of housing or casing 2174 and antenna 2190 and battery 2192 are toward a lower right corner of housing or casing 2174. Mobile communication device 2170 also includes a speaker 2194 positioned on upper or top transversely extending side 2188 at, near, close or adjacent to an intersection of upper or top transversely extending side 2188 and left longitudinally extending side 2184.

As shown in FIGS. 142A and 142B, mobile communication device 2170 positions heat and RF radiation a spaced distance perpendicularly away from the user, and particularly eye 1735, ear 1727, parotid gland 1729, submandibular salivary gland 1731, sublingual salivary gland 1733, brain 1725, and thyroid 1737. Right longitudinally extending side 2182 is positioned behind the ear, as shown in FIG. 142B, which positions radiation sources (battery 2192 and antenna 2190) the farthest from sensitive organs. The embodiment of FIG. 142A is structured and positioned (triangle) as device 1741 in FIG. 149, which is a configuration that minimizes radiation exposure to all sensitive organs.

FIG. 142B shows a view of mobile communication device 2170 positioned in use adjacent to head 1721 of the user; see FIG. 120. FIG. 142B also shows a direction of thermal energy or radiation 2196 emitted from battery 2192 and radio frequency energy or radiation 2198 emitted from antenna 2190, which is oriented to reduce impingement on head 1721, and all sensitive organs, particularly eye 1735, ear 1727, parotid gland 1729, submandibular salivary gland 1731, sublingual salivary gland 1733, brain 1725, and thyroid 1737.

FIG. 142C shows a view of a mobile communication device, indicated generally at 2200, in accordance with another exemplary embodiment of the present disclosure. Mobile communication device 2200 is similar to mobile communication device 2170 and uses the same item numbers. The principal difference between device 2170 and device 2200 is placement of microphone 2172 on back side or surface 2180 in a location that is diagonally between the upper left corner of housing or casing 2174 and battery 2192 and antenna 2190, both of which are located near to the lower right corner of housing or casing 2174.

FIG. 143 shows a perspective view of a mobile communication device, indicated generally at 1930, and optional positions for a microphone 1932 in mobile communication device 1930 having an offset or asymmetrically positioned antenna 1934 and battery 1936 in accordance with an exemplary embodiment of the present disclosure. Device 1930 includes a casing 1938 that includes a front face 1940 on which is positioned a display 1942, a right side 1944, a left side 1946, a bottom side 1948, and a top side 1950. Microphone 1932 can be on bottom side 1948 in any one of positions A, B, C, and D, with position A being at, near, close, or adjacent to an intersection of bottom side 1948 and left side 1946, and positions B, C, and D being increasingly farther from left side 1946. Antenna 1934 and battery 1936 are in the upper right hand corner of mobile communication device 1930, offset toward right side 1944 and toward top side 1950. Mobile communication device 1930 also includes a speaker 1952 positioned on left side 1946 at, near, close or adjacent to an intersection of bottom side 1948 and left side 1946. FIG. 144 shows a view of the bottom right corner of mobile communication device 1930, depicting speaker 1952 positioned adjacent to edge or side 1948.

FIG. 145 shows a perspective view of mobile communication device 1930 positioned at, near, close, alongside, or adjacent to ear 1736 of user 1748 for use in communication in accordance with an exemplary embodiment of the present disclosure, which positions heat generated by battery 1936 and RF radiation emitted from antenna 1934 a spaced distance approximately perpendicularly away from user 1748, and particularly eye 1738, ear 1736, parotid gland 1740, brain 1742, and thyroid 1884, as well as a submandibular salivary gland and a sublingual salivary gland (not shown). In a similar manner as mobile communication devices 1860 and 2170 of FIGS. 138 and 142A, respectively, the front face 1940 (and display 1942) of mobile communication device 1930 of FIGS. 143 and 145 is positioned in a perpendicular position in relation to a side of the face and ear 1736, in contrast to device 10 of the prior art (shown in FIGS. 1 and 2) that is structured with speaker 16 and microphone 18 for positioning the front face (and screen 20) of the device 10 in a parallel position in relation to the side of the face and ear, with microphone 18 positioned in close proximity to the mouth.

FIG. 146 shows a perspective view of a mobile communication device, indicated generally at 1960, having an offset or asymmetrically positioned antenna 1962 in accordance with an exemplary embodiment of the present disclosure. Device 1960 includes a casing 1964, a left side 1966, a right side 1968, a bottom side 1970, a top side 1972, a front face 1974, and a back face 1976. Front face 1974 is connected to back face 1976 by left side 1966, right side 1968, bottom side 1970, and top side 1972. Mobile communication device 1960 also includes a speaker 1980 positioned on left side 1966 at, near, close, or adjacent to an intersection of left side 1966 and bottom side 1970. Antenna 1962 is positioned at, near, close, adjacent, or alongside an intersection of front face 1974 or back face 1976 and bottom side 1970. A diagonal line 1982 shows a preferred offset or asymmetric position of antenna 1962 with respect to housing or casing 1964 that is toward right side 1968 and away from left side 1966.

FIG. 147 shows a perspective view of a mobile communication device, indicated generally at 1990, having an offset or asymmetrically positioned battery 1992 in accordance with an exemplary embodiment of the present disclosure. Device 1990 includes a casing 1994, a left side 1996, a right side 1998, a bottom side 2000, a top side 2002, a front face 2004, and a back face 2006. Front face 2004 is connected to back face 2006 by left side 1996, right side 1998, bottom side 2000, and top side 2002. Mobile communication device 1990 also includes a speaker 2010 positioned on left side 1996 at, near, close, or adjacent to an intersection of left side 1996 and bottom side 2000. Battery 1992 is positioned at, near, close, adjacent, or alongside an intersection of front face 2004 or back face 2006 and bottom side 2000. A diagonal line 2012 shows a preferred offset or asymmetric position of battery 1992 with respect to housing or casing 1994 that is toward right side 1998 and away from left side 1996.

FIG. 148A shows a view of dimensional relationships t from top side 1972, u from left side 1966, r from right side 1968, and s from bottom side 1970 of casing 1894 for offset or asymmetrically positioned antenna 1934 of FIG. 143 and antenna 1962 of FIG. 146 in accordance with an exemplary embodiment of the present disclosure. The relationships of these dimensions include t<u and r<s.

FIG. 148B shows a view of dimensional relationships t₁ from top side 2002, u₁ from left side 1996, r₁ from right side 1998, and s₁ from bottom side 2000 of casing 1994 for offset or asymmetrically positioned battery 1992 of FIG. 147 in accordance with an exemplary embodiment of the present disclosure. The relationships of these dimensions include t₁<u₁ and r₁<s₁. Speaker 2010 is shown for orientation purposes only and is not located on the face or side shown.

FIG. 150 shows a view of a mobile communication device 2020 having a casing or housing 2022. Housing 2022 includes a plurality of sides, including a transversely extending top side 2024, a transversely extending bottom side 2026, a longitudinally extending left side 2028, and a longitudinally extending right side 2030. The plurality of sides connect a first face 2032, which can be a front face or a back face, to a second face (not shown) on an opposite side of housing 2022 from first face 2032. The second face can be the other of the back face and the front face. Mobile communication device 2020 also includes a speaker 2034 positioned on first face 2032 at, near, close, or adjacent to top side 2024 approximately along a longitudinally extending centerline of mobile communication device 2020, which is also at, near, close, or adjacent to an intersection of top side 2024 and first face 2032. Speaker 2034 is approximately equidistant from left side 2028 and right side 2030. Mobile communication device 2020 further includes a microphone 2036 positioned along a longitudinally extending centerline of mobile communication device 2020. Thus, microphone 2036 is approximately equidistant from left side 2028 and right side 2030. Mobile communication device 2020 also includes a battery 2038 positioned offset or asymmetrically positioned with respect to casing 2022 to be toward bottom side 2026. In the exemplary embodiment of FIG. 150, battery 2038 is positioned at, near, close, or adjacent to an intersection of bottom side 2026 and first face 2032, along a longitudinally extending centerline of casing 2022. Thus, battery 2038 is positioned relatively near to bottom side 2026 and relatively far from top side 2024 and speaker 2034. The position of battery 2038 in FIG. 150 is a preferred position to minimize as much as possible transfer of heat generated by battery 2038 to organs of a user, such as ear 1736, eye 1738, salivary gland 1740, and brain 1742; see FIG. 138.

FIG. 151 shows a view of a mobile communication device 2040 having a casing or housing 2042. Housing 2042 includes a plurality of sides, including a transversely extending top side 2044, a transversely extending bottom side 2046, a longitudinally extending left side 2048, and a longitudinally extending right side 2050. The plurality of sides connect a first face 2052, which can be a front face or a back face, to a second face (not shown) on an opposite side of housing 2042 from first face 2052. The second face can be the other of the back face and the front face. Mobile communication device 2040 also includes a speaker 2054 positioned on first face 2052 at, near, close, or adjacent to top side 2044 approximately along a longitudinally extending centerline of mobile communication device 2040, which is also at, near, close, or adjacent to an intersection of top side 2044 and first face 2052. Speaker 2054 is approximately equidistant from left side 2048 and right side 2050. Mobile communication device 2040 further includes a microphone 2056 positioned along a longitudinally extending centerline of mobile communication device 2040. Thus, microphone 2056 is approximately equidistant from left side 2048 and right side 2050. Mobile communication device 2040 also includes a battery 2058 positioned offset or asymmetrically positioned with respect to casing 2042 to be toward bottom side 2046 and offset or asymmetrically positioned with respect to casing 2042 to be closer to right side 2050 and farther from left side 2048 as compared to right side 2050. Thus, if a user positions mobile communication device 2040 adjacent to a left side of a face from the user's perspective and angles mobile communication device 2040 such that microphone 2056 is positioned in proximity to a mouth (not shown), battery 2058 can be positioned farther from sensitive organs of the user, such as eye 1738, than is possible when battery 2058 is located closer to speaker 2054. In the exemplary embodiment of FIG. 151, battery 2058 is positioned at, near, close, or adjacent to an intersection of bottom side 2046 and first face 2052, and at, near, close, or adjacent to an intersection of bottom side 2046 and right side 2050. Thus, battery 2058 is positioned relatively near to bottom side 2046 and relatively far from top side 2044 and speaker 2054. The position of battery 2058 in FIG. 151 is a preferred position to minimize as much as possible transfer of heat generated by battery 2058 to organs of a user, such as ear 1736, eye 1738, salivary gland 1740, and brain 1742; see FIG. 138.

FIG. 152 shows a view of a mobile communication device 2060 having a casing or housing 2062. Housing 2062 includes a plurality of sides, including a transversely extending top side 2064, a transversely extending bottom side 2066, a longitudinally extending left side 2068, and a longitudinally extending right side 2070. The plurality of sides connect a first face 2072, which can be a front face or a back face, to a second face (not shown) on an opposite side of housing 2062 from first face 2072. The second face can be the other of the back face and the front face. Mobile communication device 2060 also includes a speaker 2074 positioned on first face 2072 at, near, close, or adjacent to top side 2064 approximately along a longitudinally extending centerline of mobile communication device 2060, which is also at, near, close, or adjacent to an intersection of top side 2064 and first face 2072. Speaker 2074 is approximately equidistant from left side 2068 and right side 2070. Mobile communication device 2060 further includes a microphone 2076 positioned along a longitudinally extending centerline of mobile communication device 2060. Thus, microphone 2076 is approximately equidistant from left side 2068 and right side 2070. Mobile communication device 2060 also includes a battery 2078 positioned offset or asymmetrically positioned with respect to casing 2062 to be toward bottom side 2066 and offset or asymmetrically positioned with respect to casing 2062 to be closer to right side 2070 and farther from left side 2068 as compared to right side 2070. Thus, if a user positions mobile communication device 2060 adjacent to a right side of a face from the user's perspective and angles mobile communication device 2060 such that microphone 2076 is positioned in proximity to a mouth (not shown), battery 2078 can be positioned farther from sensitive organs of the user, such as eye 1738, than is possible when a battery is centrally located or located relatively close to speaker 2074. In the exemplary embodiment of FIG. 152, battery 2078 is positioned at, near, close, or adjacent to an intersection of bottom side 2066 and first face 2072, and at, near, close, or adjacent to an intersection of bottom side 2066 and right side 2070. Thus, battery 2078 is positioned relatively near to bottom side 2066 and relatively far from top side 2064 and speaker 2074. The position of battery 2078 in FIG. 152 is a preferred position to minimize as much as possible transfer of heat generated by battery 2078 to organs of a user, such as ear 1736, eye 1738, salivary gland 1740, and brain 1742; see FIG. 138.

FIG. 153 shows a side view of a conventional cell phone, indicated generally at 2080, which includes a casing having a side face 2082. As can be seen from FIG. 153, relatively thin side face 2082 has relatively little room for a speaker to be positioned therein as described in some presently disclosed embodiments. Accordingly, FIG. 154 shows a side view of a mobile communication device, indicated generally at 2090, in accordance with an exemplary embodiment of the present disclosure. Mobile communication device 2090 includes a casing or housing 2092, which includes a first face 2094, which can be a front face including a display or a back face, a second face 2096, and a plurality of sides connecting or attaching first face 2094 to second face 2096. One such side is longitudinally extending side face 2098. Longitudinally extending side face 2098 includes at least one protrusion that extends above (or perpendicularly away from) a plane parallel to first face 2094 that extends at least partially through first face 2094 or extends above (or perpendicularly away from) a plane parallel to second face 2096 that extends at least partially through second face 2096. It should be understood that an exemplary embodiment can include one protrusion from first face 2094, one protrusion from second face 2096, or protrusions from both faces.

FIG. 155 shows a perspective view of a mobile communication device, indicated generally at 2110, in accordance with an exemplary embodiment of the present disclosure. Mobile communication device 2110 includes a housing or casing 2112 that includes a front face 2114 that includes a display 2116, a back side or face 2118 that is opposite to front face 2114, and a plurality of sides connecting front face 2114 to back face 2118, including a top transversely extending side or edge 2120, a bottom transversely extending side or edge 2122 opposite to top transversely extending side or edge 2120, a left longitudinally extending side or edge 2124, and a right longitudinally extending side or edge 2126 that is opposite to left longitudinally extending side or edge 2124. Mobile communication device 2110 also includes a speaker positioned on or in casing 2112 that emits, generates, or produces sound by way of an audio port or outlet 2128, i.e., a sound producing device, positioned on left longitudinally extending side 2124 at, near, adjacent, or close to a first intersection of back side or face 2118, left longitudinally extending side, and upper or top transversely extending side 2120 as compared to a second intersection of front side or face 2114, right longitudinally extending side 2126, and lower or bottom transversely extending side or edge 2122. Mobile communication device 2110 can also include a charging port 2132 positioned in lower or bottom transversely extending side 2122, and a microphone 2138 positioned on left longitudinally extending side 2124 at a location that is on an opposite end of longitudinally extending side 2124 from speaker/audio port 2128. Thus, microphone 2138 is positioned at, near, adjacent, or close to an intersection of back face 2118, left longitudinally extending side 2124, and bottom or lower transversely extending side 2122.

Mobile communication device 2110 can include an imaginary line 2130 that represents a maximum distance between two exterior points of housing or casing 2112. Speaker/audio port 2128 is positioned closer to a first end of imaginary line 2130 than to a second end of imaginary line 2130. In addition, mobile communication device 2110 includes an antenna positioned in right longitudinally extending side 2126 at a location that is close to the second intersection, which is also closer to the second end of imaginary line 2130 than to the first end of imaginary line 2130. In an exemplary, preferred embodiment, a separation distance between speaker/audio port 2128 and antenna 2134 is at least 70% of the total length of imaginary line 2130. In an exemplary example, imaginary line 2130 can be 14 centimeters in length. At least 70% of imaginary line 2130 is 9.8 centimeters. Thus, a separation distance 2136 between speaker/audio port 2128 and antenna 2134 should be at least 9.8 centimeters. In the embodiment of FIG. 155, separation distance 2136 is about 10.3 centimeters, which is greater than 70% of the total length of imaginary line 2130. Similar to the position of antenna 2134, mobile communication device 2110 can include a battery at the location of antenna 2134, and a preferred separation distance 2136 between the battery and speaker/audio port 2128 is also 70% of imaginary line 2130. Depending on the dimensions of a battery or antenna 2134, alternative separation distance 2136 between the battery and/or speaker/audio port 2128 is preferably 60% of the imaginary line, or most preferably 50% of the imaginary line, in particular for a large size battery, as disclosed herein. Alternatively, speaker/audio port 2128 is located on the bottom side, or on one of the left side, the right side, the front side, and the back side at a distance spaced from the bottom side that is less than or equal to 15% of the length. In addition, antenna 2134 is located at a distance spaced from the top side that is less than or equal to 15% of the length.

FIG. 156 shows a perspective view of a mobile communication device, indicated generally at 2140, in accordance with an exemplary embodiment of the present disclosure. Mobile communication device 2140 includes a casing 2142, which includes a front face (or side) 2144, on or in which is positioned a display 2146, a back face (or side) 2148, and a plurality of sides connecting front face 2144 to back face 2148, including an upper or top transversely extending side 2150, a lower or bottom transversely extending side 2152, which includes a speaker 2154, a left longitudinally extending side or edge 2156 that also connects upper or top transversely extending side 2150 to lower or bottom transversely extending side 2152, and a right longitudinally extending side or edge that also connects upper or top transversely extending side 2150 to lower or bottom transversely extending side 2152. Mobile communication device 2140 also includes a charging port 2158 positioned on a side that is away from lower or bottom transversely extending side or edge 2152. In the embodiment of FIG. 156, charging port 2158 is positioned on left longitudinally extending side or edge 2156, in a location that is closer to upper or top transversely extending side 2150 than to lower or bottom transversely extending side 2152. In some mobile communication devices, charging port 2158 can be a location where heat is concentrate. Accordingly, it can be advantageous to position charging port 2158 in location on housing or casing 2142 that is away from speaker 2154.

It should be noted that the position of a speaker and a microphone in the mobile communication device embodiments disclosed herein, forces a user to hold such mobile communication device in the manner shown in FIGS. 124, 131, 138, 142B, and 145, which reduces impingement of radiation, such as thermal and RF or electromagnetic radiation, on sensitive tissues and organs as compared to the levels of radiation experienced from conventional mobile communication devices. However, to maximize the reduction in exposure to radiation, the positions of an antenna and/or a battery in the embodiments disclosed herein provides additional reduction in radiation exposure, such as the positions of the antenna and/or the battery shown, for example, in FIGS. 124, 131, 138, 142B, and 145.

FIG. 157 shows a comparison of the relative benefit of various mobile communication device configurations disclosed herein. The leftmost bar (1) shows the relative temperature at a phone-skin interface for a conventional phone. Bar (2) shows a relative temperature by moving positions of the speaker and/or microphone such that at least one of the antenna, battery, and processor are positioned away from the face, according to the embodiments disclosed herein. Just by moving the position of the battery from having contact with the face leads to a substantial reduction of radiation, as shown herein, which can be accomplished by the speaker configurations of the present disclosure, in particular the speaker-microphone configuration of embodiments shown in FIGS. 79, 80, and 121 to 148B. It should be understood that the embodiments of the present disclosure that include only specialized positions on the side face (not on the front face or back face) for a speaker and microphone that allows proper use of a mobile communication device, even without any change in position of the battery or antenna or other components, reduces radiation exposure, particularly thermal radiation, and thus provides a great advantage in comparison to the prior art, and such embodiments are within the scope of the present disclosure. Accordingly, it is also an object of the present disclosure to disclose speaker and microphone configurations that reduce radiation exposure to sensitive organs without changing the position of internal components including battery, processor, and antenna or other components that emit radiation. However, in the most preferred embodiment to achieve optimal protection the antenna and/or battery and/or processor should be positioned diametrically opposed to the speaker. Accordingly, as the processor is moved further from a position that would be closer to the user's face during operation, or the speaker/audio port, to a distance as far as a mobile communication device permits, the temperature at the user's face can decrease to the level shown at bar (3). As the battery is moved further from a position that would be closer to the user's face during operation, or the speaker/audio port, to a distance as far as a mobile communication device permits, the temperature at the user's face can decrease from a level 1782 to a level 1784 on bar (4). By combining positions of the speaker/audio port, microphone, battery, and processor according to the embodiments shown herein, a temperature level that is near to skin temperature, as shown in bar (5) can be achieved, accomplishing a substantial reduction in potentially injurious heat impinging upon sensitive tissues of the user's head, face, and neck, as compared to a conventional mobile device. In an optimum embodiment, such reduction is such that the thermal radiation effects or temperature at the device/skin interface can be considered negligible. This reduction of thermal radiation effects is of great significance since reports have shown potential damage to the eye, retina, and optic nerve with development of cataracts and blindness in the eye that was associated with the ear used for placement of mobile communication devices of the prior art. The eye can absorb electromagnetic radiation quickly and the wavelength used for cell phone signals can be absorbed by ocular tissues. Blood carries away heat, but several ocular structures are avascular including the lens and vitreous humor, thus the heat absorbed by the eye is “trapped” inside these ocular tissues, and the heat absorbed by the eye does not get transmitted out of the eye. Furthermore, reports show increased risk of eye cancer, in particular uveal melanoma due to exposure to radiation of mobile communication devices of the prior art, published in the journal Epidemiology [Stang A, et al. The possible role of radiofrequency radiation in the development of uveal melanoma. Epidemiology 2001 January; 12(1):7-12]. When radio waves or heat from antenna and/or battery of devices of prior art (e.g., FIG. 1) pass through biological tissue they can alter the biological tissues. Published reports of increased risk for eye damage, cataracts, retinal degeneration, eye cancer, and blindness [Vignal R, et al., Effects of mobile phones and radar radiofrequencies on the eye. Pathol Biol (Paris). 2009 September; 57(6):503-8. doi: 110.1016/j.patbio.2008.09. 003. Epub 2008 Nov. 25] are aligned with the personal clinical experience of the applicant, who is an ophthalmologist and eye surgeon. Eye damage and risk of blindness are protected by the multiple embodiments of the present disclosure.

Embodiments of the present disclosure protect all sensitive organs that are associated with damage due to use of mobile communication devices of the prior art, including devices of FIGS. 1 and 2. Studies have shown an association of use of mobile communication devices of the prior art and development of brain cancer and gliomas [Grell K, et al., The Intracranial Distribution of Gliomas in Relation to Exposure from Mobile Phones: Analyses from the INTERPHONE Study. Am J Epidemiol. 2016 Dec. 1; 184(11):818-828. Epub 2016 Nov. 3]. Moreover, investigations showed that the side of the cancer was associated with the reported side of placement of the mobile communication device of the prior art, and the association was independent of the cumulative call time and cumulative number of calls, indicating increased risk even during short term use of devices of the prior art. Large population studies also have shown an association of use of mobile communication devices of the prior art and development of salivary gland cancer [Sadetzki S, et al. Cellular phone use and risk of benign and malignant parotid gland tumors—a nationwide case-control study. Am J Epidemiol. 2008 Feb. 15; 167(4):457-67. Epub 2007 Dec. 6].

FIGS. 3-7 show a mobile communication device, indicated generally at 50, in accordance with an exemplary embodiment of the present disclosure. Mobile communication device 50 includes a casing or housing 52 configured to contain various internal elements of mobile communication device 50. Housing 52 includes a front face 54, and located on or in front face 54 is a speaker 56, a microphone 58, and a display 60 positioned longitudinally between speaker 56 and microphone 58. Generally, the end or location of mobile communication device 50 where speaker 56 is located is considered a top 62 of mobile communication device 50, and thus is also the top of housing 52, and the end or location of mobile communication device 50 where microphone 58 is located is considered a bottom 64 of mobile communication device 50, and thus is also the bottom of housing 52. Mobile communication device 50 further includes an antenna for wireless communication. Antennas, such as an antenna 66 shown in FIGS. 3-27, and other antennas disclosed herein, can be configured as a conventional dipole antenna. In FIGS. 3-7, antenna 66 is shown as being positioned at or near bottom 64, with at least a portion of antenna 66 being internal to housing 12 of mobile communication device 10. It should be understood that the entirety of antenna 66 can be positioned internal to housing 52, as shown in FIG. 3.

It should further be understood that a mobile communication device can include a plurality of antennas. Such antennas include antennas configured for communication with base stations 38 of a cellular network and antennas configured for communication via Wi-Fi, Bluetooth, and RFID frequencies. It should also be understood that antennas configured for communication with base stations emit significantly greater power as compared to antennas for communication at Wi-Fi, Bluetooth, and RFID frequencies, which are configured to communicate with, for example, a Wi-Fi router positioned within 150 feet or less of the antenna, an earpiece positioned on an ear or other Bluetooth enabled device within 328 feet or less, and an RFID tag positioned within 8 inches or less, respectively. Accordingly, the antennas described herein are considered cellular frequency antennas configured to transmit and receive at one or more cellular frequencies, including 710-716 MHz, 740-757 MHz, 776-787 MHz, 806-960 MHz, 1710-1785 MHz; 1805-1990 MHz; 2110-2170 MHz, and 2.5-2.7 GHz. Alternatively, it should be understood that the mobile communication device antennas described herein provide sufficient output power for communication at a range of at least one mile depending on terrain and proximity to buildings, etc. A more typical output range of a mobile communication device without interference from terrain and buildings is in the range of 3 miles to 45 miles. It should be understood that any antenna, currently used or to be developed in the future, described as cellular frequency antennas are within the scope of the disclosure. It should be understood that any frequency currently used or to be used in the future, described as cellular frequency are within the scope of the disclosure.

Housing 52 further includes a back face 68. Extending between back face 68 and front face 54 are a plurality of side faces, including a top side face 70, a bottom side face 72, a left side face 74, and a right side face 76. In the embodiment of FIGS. 3-7, left side face 74 is configured to include a left speaker 78 and a left microphone 80, and right side face 76 is configured to include a right speaker 82 and a right microphone 84. It should be understood that in another embodiment, only left speaker 78 and left microphone 80 might be present, in yet another embodiment, only right speaker 82 and right microphone 84 might be present, and in yet a further embodiment, any combination of speaker 56, left speaker 78, and right speaker 82 might be present as long as at least one left speaker 78 or one right speaker 82 is present and any combination of microphone 58, left microphone 80, and right microphone 84 might be present as long as at least one left microphone 80 or one right microphone 84 is present.

Mobile communication device 50 is configured to be held or supported such that one of front face 54, left side face 74, or right side face 76 is positioned directly adjacent (as a closest surface) to a face 86 of a user 88, thus positioning at least a portion of antenna 66, which extends across bottom 64 of mobile communication device 50, as shown in FIG. 7, away from user 88. It should be understood that communication device 50, for the purposes of the present disclosure, can include any device configured to be held adjacent to an ear, head, or face of a user that includes an RF transmitter, which may include a cellular phone, a telephone, a music player, a media device, a medical device, GPS systems, a military device, any wireless device, and the like.

FIG. 6 shows a preferred embodiment being utilized by user 88 during operation, in which right side face 76 of mobile communication device 50 is the only portion of mobile communication device 50 in contact with face 86 of user 88 (or adjacent to face 86 of user 88), and speaker 82 is positioned on, near, at, adjacent, alongside, or in proximity to an ear of user 88 and microphone 84 is positioned adjacent to a mouth of user 88. Although FIG. 6 shows left speaker 78 and left microphone 80, centrally positioned speaker 56 and centrally positioned microphone 58, it should be understood that mobile communication device 50 may include only speaker 82 and microphone 84.

FIG. 7 shows the approximate position of certain internal elements of mobile communication device 50 in a stylized manner. Note that left side face 74 and right side face 76 are delineated by dashed lines 90 and 92, respectively. In addition to speaker 56, microphone 58, left speaker 78, right speaker 82, left microphone 80, and right microphone 84, mobile communication device 50 includes an analog-to-digital (A/D) converter 94, a processor 96, a sim card 98, a non-transient memory 100, and a transceiver 102. Though not shown, it should be understood that mobile communication device 50 can include a power source or a power supply, such as a battery, that is connected to internal elements, devices, or components of mobile communication device, as appropriate to the device. It should be understood that while a single A/D converter 94 is shown, a plurality of individual A/D converters can be used in place of A/D converter 94. Similarly, while a single non-transient memory 100 is shown, mobile communication device 50 can include a plurality of non-transient memories. Furthermore, while a single display 60 is shown, mobile communication device 50 can include a plurality of displays.

A/D converter 94 converts digital signals from processor 96 to analog signals to drive speaker 56, left speaker 78, and right speaker 82. A/D converter 64 further converts analog signals from microphone 58, left microphone 80, and right microphone 84 to digital signals for input into processor 96. Though not shown, mobile communication device 50 can include amplifiers to amplify the analog signals to and from A/D converter 94 and filters to clean up the analog signals transmitted to A/D converter 94. It should be understood that left side face 74 and right side face 76 can include a side display, and in this embodiment speaker and microphone would be disposed adjacent to the side display or as part of the side display. It should also be understood that a speaker and a microphone can be disposed as part of frontal display.

Processor 96 receives data from sim card 98 and non-transient memory 100 that enables mobile communication device 50 to communicate via transceiver 102 with a cell phone network and perform a variety of functions. Processor 96 further communicates with display 60, including receiving touch and/or force information from display 60 or a sensor 61 associated with display 60.

FIGS. 8-10 show views of a mobile communication device, indicated generally at 150, in accordance with an exemplary embodiment of the present disclosure. In FIGS. 8-10, elements that are configured similarly to elements previously disclosed hereinabove are provided with the number assigned in the previous embodiment disclosed hereinabove for the sake of brevity.

Mobile communication device 150 includes a casing or housing 152 configured to contain various internal elements of mobile communication device 150. Housing 152 includes a front face 154, and located in front face 154 is a speaker 156, a microphone 158, and a display 160 positioned longitudinally between speaker 156 and microphone 158. Generally, the end or location of mobile communication device 150 where speaker 156 is located is considered a top 162 of mobile communication device 150, and thus is also the top of housing 152, and the end or location of mobile communication device 150 where microphone 158 is located is considered a bottom 164 of mobile communication device 150, and thus is also the bottom of housing 152. Mobile communication device 150 further includes antenna 66, similar to mobile communication device 50.

Housing 152 further includes a back face 168. Extending between back face 168 and front face 154 are a plurality of side faces, including a top side face 170, a bottom side face 172, a left side face 174, and a right side face 176. In the embodiment of FIGS. 8-10, bottom side face 172 is configured to include a bottom speaker 178 and a bottom microphone 180.

Mobile communication device 150 is configured to be held such that one of front face 154 or bottom side face 172 is positioned immediately adjacent to face 86 of user 88, thus positioning antenna 66, and radiation 182 emitted by antenna 66, a furthest possible distance away from user 88 while using mobile communication device 150 without being in a speakerphone mode, such as by using a loud speaker.

FIG. 9 shows a preferred embodiment being utilized by user 88 during operation, in which bottom side face 172 of mobile communication device 150 is the only portion of mobile communication device 150 in contact with face 86 of user 88 (or adjacent to face 86 of user 88), and bottom speaker 178 is positioned on an ear of user 88 and bottom microphone 180 is positioned adjacent to the mouth of user 88. Although FIG. 9 shows centrally positioned speaker 156 and centrally positioned microphone 158, it should be understood that mobile communication device 150 may include only bottom speaker 178 and bottom microphone 180.

FIG. 10 shows the approximate position of certain internal elements of mobile communication device 150 in a stylized manner. Note that bottom side face 172 is delineated by dashed line 184. In addition to speaker 156, microphone 158, bottom speaker 178, and bottom microphone 180, mobile communication device 150 includes analog-to-digital (A/D) converter 94, processor 96, sim card 98, non-transient memory 100, and transceiver 102, each of which function as disclosed hereinabove. This embodiment shows antenna 66 being positioned the furthest possible distance from bottom microphone 180 and bottom speaker 178, and thus when speaker 178 is in contact with the user's head results in antenna 66 being located the furthest distance from the user's head, as shown in FIG. 9, in accordance with the teachings and methods of the present disclosure. Although FIG. 10 shows centrally positioned speaker 156 and centrally positioned microphone 158, it should be understood that mobile communication device 150 may include only bottom speaker 178 and bottom microphone 180.

FIG. 11 shows a perspective view of a mobile communication device, indicated generally at 200, in accordance with an exemplary embodiment of the present disclosure. Mobile communication device 200 includes a casing or housing 202 configured to contain various internal elements of mobile communication device 200. Housing 202 includes a front face 204, and located on or in front face 204 is a left speaker 206, a left microphone 208, a right speaker 210, and a right microphone 212, and a display 214 positioned longitudinally between left speaker 206 and left microphone 208, and longitudinally between right speaker 210 and right microphone 212. In this embodiment, there is no speaker along the longitudinally extending centerline of mobile communication device 200.

Generally, the end or location of mobile communication device 200 where speakers 206 and 210 are located is considered a top 216 of mobile communication device 200, and thus is also the top of housing 202, and the end or location of mobile communication device 200 where microphones 208 and 212 are located is considered a bottom 218 of mobile communication device 200, and thus is also the bottom of housing 202. Mobile communication device 200 further includes antenna 66, configured in a manner that is similar to that shown for mobile communication device 50.

Housing 202 further includes a left side face 220, a right side face 222, a top side face 224, and a bottom side face 226. Left speaker 206 and left microphone 208 are positioned a spaced distance D from left side face 220 or an edge formed at a junction of front face 204 and left side face 220. Right speaker 210 and right microphone 212 are positioned a spaced distance D from right side face 222 or an edge formed at a junction of front face 204 and right side face 222. In an exemplary embodiment, a preferred spaced distance between left speaker 206 and an edge formed at the junction of front face 204 and left side face 220 is less than or equal to about 16 millimeters, is preferably less than or equal to about 8 millimeters, is more preferably less than or equal to about 5 millimeters, and is most preferably less than or equal to about 3 millimeters. In another exemplary embodiment, the preferred spaced distance between right speaker 210 and an edge formed at the junction of front face 204 and right side face 222 is less than or equal to about 14 millimeters, is preferably less than or equal to about 6 millimeters, is more preferably less than or equal to about 4 millimeters, and is most preferably less than or equal to about 1.5 millimeters. In another exemplary embodiment, the preferred spaced distance between left speaker 206 and edge formed at the junction of front face 204 and top side face 224 is less than or equal to about 16 millimeters, is preferably less than or equal to about 8 millimeters, is more preferably less than or equal to about 5 millimeters, and is most preferably less than or equal to about 3 millimeters. In another exemplary embodiment, the preferred spaced distance between right speaker 210 and edge formed at the junction of front face 204 and top side face 224 is less than or equal to about 10 millimeters, is preferably less than or equal to about 6 millimeters, is more preferably less than or equal to about 4 millimeters, is most preferably less than or equal to about 2 millimeters. For brevity sake, it should be understood that the same distances disclosed for left speaker 206 apply to left microphone 208 in relation to bottom side face 226. For brevity sake, it should be understood that the same distances disclosed for right speaker 210 apply to right microphone 212 in relation to bottom side face 226. It should be understood that any distance described herein or combination of distances described herein can be used for positioning a speaker or microphone in relation to any face disclosed herein of mobile communication device, and all resulting embodiments are within the scope of the present disclosure.

In addition, speakers 206 and 210 are positioned a spaced distance D from top side face 224, and microphones 208 and 212 are positioned a spaced distance D from bottom side face 226. In view of the description hereinabove, it should be apparent that left speaker 206 is adjacent to left side face 220 and top side face 224, right speaker 210 is adjacent to right side face 222 and top side face 224, left microphone 208 is adjacent to left side face 220 and bottom side face 226, and right microphone 212 is adjacent to right side face 222 and bottom side face 226.

A preferred distance between speaker 206 and an edge formed at a junction of front face 204 and left side face 220 is less than or equal to 23% of the width measured from left side face 220 to right side face 222, is preferably less than or equal to about 12%, is more preferably less than or equal to about 9.5%, is even more preferably less than or equal to about 6%, and is yet most preferably less than or equal to 3.8%. A preferred distance between speaker 210 and an edge formed at a junction of front face 204 and right side face 222 is less than or equal to 23% of the width measured from left side face 220 to right side face 222, is preferably less than or equal to about 12%, is more preferably less than or equal to about 9.5%, is even more preferably less than or equal to about 6%, and is most preferably less than or equal to 3.8%. For brevity's sake, it should be understood that the same percentages (%) disclosed for speaker 206 apply to microphone 208 in relation to bottom side face 226 and the same percentages disclosed for speaker 210 apply to microphone 212 in relation to bottom side face 226. It should be also understood that alternative percentages can be used and are within the scope of the disclosure, and include a preferred alternative distance between speaker 206 and an edge formed at a junction of front face 204 and left side face 220 is less than or equal to 30% of the width measured from left side face 220 to right side face 222, is preferably less than or equal to about 18%, is more preferably less than or equal to about 12%, is even more preferably less than or equal to about 6%, and is yet most preferably less than or equal to 6%. It should be also understood that other alternative percentages can be used and are within the scope of the disclosure, and include a preferred alternative distance between speaker 206 and an edge formed at a junction of front face 204 and left side face 220 is less than or equal to 20% of the width measured from left side face 220 to right side face 222, is preferably less than or equal to about 10%, is more preferably less than or equal to about 4%, is even more preferably less than or equal to about 6%, and is yet most preferably less than or equal to 2%. It should be further understood that any percentages described herein or combination of percentages described herein can be used and all resulting embodiments are within the scope of the present disclosure.

FIG. 12A shows a simplified block diagram of a mobile communication device, indicated generally at 250, in accordance with another exemplary embodiment of the present disclosure. Except for those features specific to the embodiment of FIG. 12A, features internal to mobile communication device 250, which can be similar to features disclosed hereinabove, are removed for the sake of brevity.

Mobile communication device 250 includes a casing or housing 252 configured to contain various internal elements of mobile communication device 250. Housing 252 includes a front face 254, and located on or in front face 254 is a display 256. Housing 252 further includes a back face 258. Extending between back face 258 and front face 254 are a plurality of side faces, including a top side face 260, a bottom side face 262, a left side face 264, which is delineated by a dashed line 266 in the block diagram view of FIG. 12A, and a right side face 268, which is delineated by a dashed line 270 in the block diagram of FIG. 12A. In the embodiment of FIG. 12A, left side face 264 is configured to include a left speaker 272, positioned at or near a top of left side face 264, and a left microphone 274, positioned at or near a bottom of left side face 264, and right side face 268 is configured to include a right speaker 276, positioned at or near a top of right side face 268, and a right microphone 278, positioned at or near a bottom of right side face 268. In this embodiment, front face 254 does not include a microphone or a speaker.

FIG. 12B shows a simplified block diagram of a mobile communication device, indicated generally at 290, in accordance with another exemplary embodiment of the present disclosure. Except for those features specific to the embodiment of FIG. 12B, features internal to mobile communication device 290, which can be similar to features disclosed hereinabove, are removed for the sake of brevity. In addition, mobile communication device 290 includes certain features in common with FIG. 12A, and such features are similarly labelled to those features of FIG. 12A.

Mobile communication device 290 includes a casing or housing 253 configured to contain various internal elements of mobile communication device 290. Housing 253 includes front face 254, and located on or in front face 254 is display 256. Housing 253 further includes back face 258. Extending between back face 258 and front face 254 are a plurality of side faces, including top side face 260, bottom side face 262, a left side face 265, and a right side face 269.

FIG. 12B also shows a transversely extending centerline 292 that divides mobile communication device 290 into two halves. In other words, mobile communication device 290 is divided into two halves by positioning of transversely extending centerline 292 at a longitudinal midpoint of mobile communication device 290.

In the embodiment of FIG. 12B, mobile communication device 290 includes a left speaker 273 positioned on or in left side face 265 at a location that is longitudinally between transversely extending centerline 292 and bottom side face 262. Mobile communication device 290 also includes a left microphone 275, positioned at or near a bottom of left side face 265. Such bottom location of left microphone 275 can be a longitudinal distance from bottom side face 262 that is less than a longitudinal distance of left speaker 273 to transversely extending centerline 292. However, it should be understood that left speaker 273 can be a longitudinal distance from transversely extending centerline 292 that is less than any possible longitudinal distance that left microphone 275 can be from bottom side face 262 because left speaker 273 can partially overlap transversely extending centerline 292 as long as a center of speaker 273 is between transversely extending centerline 292 and bottom side face 262.

Mobile communication device 290 also includes a right speaker 277 positioned on or in a right side face 269 at a location that is longitudinally between transversely extending centerline 292 and bottom side face 262. Mobile communication device 290 also includes a right microphone 279, positioned at or near a bottom of right side face 269. Such bottom location of right microphone 279 can be a longitudinal distance from bottom side face 262 that is less than a longitudinal distance of right speaker 277 to transversely extending centerline 292. However, it should be understood that right speaker 277 can be a longitudinal distance from transversely extending centerline 292 that is less than any possible longitudinal distance that right microphone 279 can be from bottom side face 262 because right speaker 277 can partially overlap transversely extending centerline 292 as long as a center of speaker 277 is between transversely extending centerline 292 and bottom side face 262. In this embodiment, front face 254 does not include a microphone or a speaker.

FIG. 13A shows a simplified block diagram of a mobile communication device, indicated generally at 300, in accordance with yet another exemplary embodiment of the present disclosure. Except for those features specific to the embodiment of FIG. 13A, features internal to mobile communication device 300, which can be similar to features disclosed hereinabove, are removed for the sake of brevity.

Mobile communication device 300 includes a casing or housing 302 configured to contain various internal elements of mobile communication device 300. Housing 302 includes a front face 304, and located on or in front face 304 is a display 306. Housing 302 further includes a back face 308. Extending between back face 308 and front face 304 are a plurality of side faces, including a top side face 310, a bottom side face 312, delineated in FIG. 13A by a dashed line 314, a left side face 316, and a right side face 318. In the embodiment of FIG. 13A, bottom side face 312 is configured to include a bottom speaker 320 and a bottom microphone 322, and no other speaker or microphone on any other portion of mobile communication device 300, including front face 304. In addition, the configuration of mobile communication device 300 is such that a user automatically knows that bottom speaker 320 and bottom microphone 322 are on an opposite end of mobile communication device 300 from antenna 66. Thus, antenna 66 can be disposed in a location that is diametrically opposed to bottom speaker 320 and bottom microphone 322. A method of manufacturing a mobile communication device within the scope of the present disclosure includes a first step of positioning an antenna in the mobile communication device in a position “A” and a second step of positioning a speaker in a position being the farthest possible distance from position “A.” Alternatively, the first step includes positioning a speaker in a position “B” in a mobile communication device and a second step of positioning an antenna in a position being the farthest possible distance from position “B.” It should be apparent that while bottom microphone 322 is shown positioned adjacent or alongside left side face 316 and bottom speaker 320 is shown positioned adjacent or alongside right side face 318, the position of bottom speaker 320 and bottom microphone 322 can be reversed such that bottom speaker 320 is adjacent or alongside left side face 316 and bottom microphone 322 is adjacent or alongside right side face 318. A method of manufacturing a mobile communication device within the scope of the present disclosure further includes a first step of positioning a battery in the mobile communication device in a position “A” and a second step of positioning a speaker in a position being the farthest possible distance from position “A.” Alternatively, the first step includes positioning a speaker in a position “B” in a mobile communication and a second step of positioning a battery in a position being the farthest possible distance from position “B.” It should be understood that an alternative method for manufacturing within the scope of the present disclosure includes a first step of positioning an antenna and a battery in the mobile communication device in a position “A” and a second step of positioning a speaker in a position being the farthest possible distance from position “A.” Alternatively, the first step includes positioning a speaker in a position “B” in a mobile communication and a second step of positioning an antenna and a battery in a position being the farthest possible distance from position “B.” It should be understood that the method of the present disclosure includes any combination of positioning an antenna and/or a battery including the antenna and/or the battery being positioned during manufacturing in a position being the farthest possible distance from the speaker.

As with mobile communication device 150 shown in FIG. 10, mobile communication device 300 is configured to be held such that bottom side face 312 is positioned adjacent to face 86 of user 88, thus positioning antenna 66, and radiation 182 emitted by antenna 66, away from user 88.

FIG. 84 shows another view of mobile communication device 300, showing an exemplary position of a heat emitting battery 332 and a heat emitting processor 334. As disclosed elsewhere herein, the position of battery 332 and processor 334 is such that thermal or heat energy is principally emitted in a direction that is parallel to the user's face.

FIG. 13B shows a perspective view of a mobile communication device, indicated generally at 336, in accordance with yet another exemplary embodiment of the present disclosure. Mobile communication device 336 is similar to mobile communication device 300 shown in FIGS. 13A and 84 except that the position of bottom speaker 320 and bottom microphone 322 is reversed from the position shown in FIGS. 13A and 84. Thus, bottom speaker 320 is adjacent, near, or close to an intersection of back face 308, bottom side face 312, and left side face 316, and bottom microphone 322 is adjacent, near, or close to an intersection of back face 308, bottom side face 312, and right side face 318.

FIG. 14A shows a perspective view of a mobile communication device, indicated generally at 350, in accordance with a further exemplary embodiment of the present disclosure. Mobile communication device 350 includes a casing or housing 352 configured to contain various internal elements of mobile communication device 350, a portion of which is removed to show antenna 66. Housing 352 includes a front face 354, and located on or in front face 354 is a display 356. Housing 352 further includes a back face 358. Extending between back face 358 and front face 354 are a plurality of side faces, including a top side face 360, a bottom side face 362, a left side face 364, and a right side face 366. In the embodiment of FIG. 14A, bottom side face 362 is configured to include a bottom speaker 368 and a bottom microphone 370. In addition, front face 354 includes a front face speaker 372 positioned on front face 354 longitudinally between display 356 and bottom speaker 368, and a front face microphone 374 positioned on front face 354 longitudinally between display 356 and bottom microphone 370. Thus, front face speaker 372 and front face microphone 374 are positioned along a bottom portion of front face 354 that is adjacent to bottom side face 362. The configuration of mobile communication device 350 is such that a user automatically knows that bottom speaker 368 and bottom microphone 370 are on an opposite end of mobile communication device 350 from antenna 66. Thus, antenna 66 can be disposed in a location that is diametrically opposed to bottom speaker 368 and bottom microphone 370. In addition, front face speaker 372 and front face microphone 374 are positioned on front face 354 in a location that is spaced as far from antenna 66 as possible.

It should be apparent that while bottom speaker 368 and front face speaker 372 are positioned adjacent to left side face 364, and bottom microphone 370 and front face microphone 374 are positioned adjacent to right side face 366, the positions of these features can be reversed such that bottom speaker 368 and front face speaker 372 are positioned adjacent to right side face 366 and bottom microphone 370 and front face microphone 374 are positioned adjacent to left side face 364.

Mobile communication device 350 is further configured so that the length or long dimension of top side face 360, bottom side face 362, left side face 364, and right side face 366 are approximately equal. Thus, mobile communication device 350 is configured as a square. It should be understood that mobile communication devices of the present disclosure can include other shapes and dimensions of the communication mobile devices including round, triangular, octagonal, pentagonal, circular, rectangular, and multi-faceted as well as shapes and configurations including hinges, flip-phone, foldable parts (including foldable screen), flexible parts (including flexible screen), and the like.

FIG. 14B shows a perspective view of a mobile communication device, indicated generally at 376, in accordance with a yet further exemplary embodiment of the present disclosure. Mobile communication device 376 is similar to mobile communication device 350 shown in FIG. 14A. However, device 376 includes a rectangular housing or casing 378 in place of the square housing or casing 352 shown in FIG. 14A. The numbering of FIG. 14A is used in FIG. 14B for similar elements. It should be understand that while the same numbering is used, there will be dimensional differences between certain features of device 350 and device 376. For example, front face 354 is square in FIG. 14A and rectangular in FIG. 14B.

While mobile communication device 350 includes bottom speaker 368, bottom microphone 370, front face speaker 372, and front face microphone 374, mobile communication device 376 only includes front face speaker 372 and bottom microphone 370. In other words, mobile communication device 350 does not include a front face microphone and a bottom speaker. It should be understood that front face speaker 372 can be positioned anywhere along front face 354 that is adjacent, near, or close to an intersection between front face 354 and bottom side face 362, and bottom microphone 370 can be similarly positioned on bottom side face 362. Thus, the positions of front face speaker 372 and bottom microphone 370 can be reversed left and right from the position shown in FIG. 14B.

FIG. 14C shows a perspective view of a mobile communication device, indicated generally at 380, in accordance with a still yet further exemplary embodiment of the present disclosure. Mobile communication device 380 is similar to mobile communication device 376 of FIG. 14B, and the same numbering is used for similar items. Mobile communication device 380 is different from mobile communication device 376 of FIG. 14B and mobile communication device 350 of FIG. 14A in that mobile communication device 380 includes front face speaker 372 and front face microphone 374, positioned as disclosed hereinabove, and does not include any bottom speaker or microphone. It should be understood that the positions of front face speaker 372 and front face microphone 374 can be reversed such that front face speaker 372 is closer to right side face 366 of mobile communication device 380 than left side face 364 of mobile communication device 380, and front face microphone is close to left side face 364 than right side face 366 of mobile communication device 380.

Using the general teachings presented hereinabove, additional embodiments of mobile communication devices are presented in FIGS. 15-25.

FIG. 15 shows a view of a mobile communication device, shown generally at 400, in accordance with another exemplary embodiment of the present disclosure being operated by a user. Mobile communication device 400 includes a speaker and microphone configuration similar to that of mobile communication device 350 shown in FIG. 14A, and reference numbers in FIG. 15 that are the same as those of FIG. 14A denote the same elements. Mobile communication device 400 includes an antenna 402 positioned in a location that is similar to antenna 66 in FIG. 15, and a display 404. Antenna 402 generates a radiation pattern 406 that is positioned away from a head 408 of a user by virtue of the location of speaker 368 and microphone 370, and the orientation of mobile communication device 400 with respect to head 408. Furthermore, axis of rotation 34 of radiation pattern 406 is perpendicular to head 408 and plane 36, which is perpendicular to axis of rotation 34 and bisects radiation pattern 406, does not intersect the brain located in head 408 when speaker 368 is positioned near, at, close, along, adjacent, or in proximity to the user's ear. It should be understood that the orientation of mobile communication device 400 with respect to head 408 can be described as away from, transverse to, or perpendicular to head 408.

FIGS. 16 and 17 show views of a mobile communication device, indicated generally at 420, in accordance with yet another exemplary embodiment of the present disclosure. Mobile communication device 420 is nearly identical with mobile communication device 250 shown in FIG. 12A, and the elements thereof are similarly numbered. However, mobile communication device 420 includes only right speaker 276 and right microphone 278, and no other speaker or microphones.

FIGS. 18-19 are additional exemplary embodiments, showing various positions of a speaker and a microphone. FIG. 18 shows a mobile communication device, indicated generally at 430, that is nearly identical to mobile communication device 200, shown in FIG. 11, and elements with the same number are identical to those in FIG. 11. The only difference with FIG. 11 is that right speaker 210 and right microphone 212 are the only speaker and microphone on mobile communication device 430. FIG. 19 shows a mobile communication device, indicated generally at 440, having a speaker 442 in an eccentric position, and a microphone 444 positioned near a center or centerline of a housing 446.

FIGS. 20-22 show views of a mobile communication device, indicated generally at 450, in accordance with an exemplary embodiment of the present disclosure. Mobile communication device 450 includes a casing or housing 452 having a first side edge 458 and a second, opposite side edge 460. A speaker 454 and a microphone 456 are positioned on first side edge 458, and an antenna 462 is positioned closer to second side edge 460.

FIGS. 23 and 24 show views of a mobile communication device, indicated generally at 470, in accordance with a further exemplary embodiment of the present disclosure. Mobile communication device 470 includes a housing or casing 472, which further includes a bottom side or edge 474, a top side or edge 476, and a right side or edge 478. Mobile communication device 470 further includes a speaker 480 and a microphone 482, each of which is positioned at an intersection of two sides or edges of mobile communication device 470. In the embodiment of FIGS. 23 and 24, speaker 480 is positioned at a corner or intersection between top side 476 and right side 478, and microphone 482 is positioned at a corner or intersection between bottom side 474 and right side 478. It should be understood that intersections between a left side 484 of housing or casing 472 and top side 476 and between a left side 484 of housing or casing 472 and bottom side 474 may be used instead of intersections with right side 478.

In a preferred embodiment, to reduce manufacturing cost mobile communication device 470 comprises only a speaker 480 and microphone 482, the speaker 480 being located at a top corner 483 consisting of a junction of top side face 476 and right side face 478, and microphone 482 being located at a bottom corner 485 consisting of a junction of bottom side face 474 and left side face 484, as shown in FIG. 24. It should be understood that any of the embodiments can include a microphone or speaker positioned at the top corner and bottom corner, on the left side and/or the right side.

FIGS. 25-27 show views of a mobile communication device, indicated generally at 490, in accordance with still a further embodiment of the present disclosure. Mobile communication device 490 includes a housing or casing 492, which supports a curved or wrap around display 494. Mobile communication device 490 further includes a speaker 496 positioned at a bottom corner 502 of housing or casing 492, a first microphone 500 positioned at a diametrically opposite corner 504, and a second microphone 498 positioned along a corner 506 that is along a side or edge 508 that includes first microphone 500, and is thus positioned at a location that is transversely on an opposite side of mobile communication device 490 from speaker 546.

FIGS. 28-30 show views of a mobile communication device, indicated generally at 540, in accordance with still a further embodiment of the present disclosure. Mobile communication device 540 includes a housing or casing 542, which supports a curved or wrap around display 544 which is configured slightly differently from the embodiment of FIGS. 25-27. Mobile communication device 540 further includes a speaker 546 positioned at a bottom corner 552 of housing or casing 542, a microphone 550 positioned at a diametrically opposite corner 554, and a microphone 548 positioned along a corner 556 that is along a side or edge 558 that includes microphone 550, and is thus positioned at a location that is transversely on the opposite side of mobile communication device 540 from speaker 546.

Thermal effects of mobile communication devices can cause thermal damage to the user, and harmful thermal effects by mobile communication devices have been associated with thermal damage to the eye and head of the user. The eye is sensitive to heating and local temperature increase has been associated with development of cataracts and blindness. In a personal experience, a young patient of the applicant developed a rare tumor of the salivary glands at the side of contact of the phone with his skin, and unfortunately this patient, who used his phone continuously and complained that his phone as always hot, lost half of his face during surgical removal of the cancer, and required a hemi facial reconstruction. However, despite all efforts and medical therapies the patient perished. This example shows the significance of minute after minute of exposure of the head, eye, and ear to microwave radiation pulsing at thousands of pulses per second, and the need to avoid such harmful exposure, as provided by the present disclosure. Moreover, other reports identified degenerative changes of ocular tissues such as retina and lens when exposed to pulsed microwaves at levels that did not cause significant heating, showing that preventive measures, even in a “relatively cold” mobile communication device may offer little or no protection against tissue damage, such as provided by the methods and apparatus of the present disclosure. Sources of heating in mobile communication devices can include a battery, a processor, and even a charging port. Parts that can increase temperature and cause thermal damage such as the battery, processor, display, and the like are disposed away from the head of the user, with speaker and microphone positioned accordingly for optimal function in accordance with the principles of the present disclosure. A charge port, which may also increase in temperature and cause thermal damage, is positioned away from the face, thus when speaker and/or microphone are on one side face of mobile communication device, the charge port is located in another face.

Accordingly, a method of manufacturing a mobile communication device within the scope of the present disclosure further includes a first step of positioning a charging port in the mobile communication device in a position “A” and a second step of positioning a speaker in a position being the farthest possible distance from position “A.” Alternatively, the first step includes positioning a speaker in a position “B” in a mobile communication and a second step of positioning a charging port in a position being the farthest possible distance from position “B.” Yet another method of manufacturing a mobile communication device within the scope of the present disclosure further includes a first step of positioning a charging port in the mobile communication device in a position “A” and a second step of positioning a microphone in a position being the farthest possible distance from position “A.” Alternatively, the first step includes positioning a microphone in a position “B” in a mobile communication and a second step of positioning a charging port in a position being the farthest possible distance from position “B.” Since the present disclosure teaches new configurations that include a speaker positioned on a side face of the mobile communication device, (which includes a top side face, bottom side face, right side face and left side face, herein referred to as a “side face”) it should be also understood that method of manufacturing of the present disclosure further includes a first step of positioning a charging port in the mobile communication device in one first side face “A” and a second step of positioning a speaker in a second side face “B”, the side face “B” being different that the side face “A”. Alternatively, the first step includes positioning a speaker in a side face “B” in a mobile communication and a second step of positioning a charging port in a second side face “A.” It should be understood that the method of the present disclosure includes any combination of positioning an antenna and/or a battery and/or a charging port including an antenna being positioned during manufacturing in a position being the farthest possible distance from the speaker and the charging port being positioned the farthest possible distance from the speaker, and the battery being positioned the farthest possible distance from the speaker, or any combination thereof.

FIGS. 31 and 32 show a conventional mobile communication device, indicated generally at 570, which includes a display 572 and a battery 574. Internal elements of mobile communication device 570, such as battery 574 and a processor (not shown), generate thermal energy, heat, and/radiation. The generated heat is emitted or transmitted from the surfaces of mobile communication device 570 as thermal energy 576. When conventional mobile communication device 570 is positioned at or on a face 578 or head 580 of a user 582, thermal energy 576 is transmitted to face 578 and head 580. Such thermal energy can potentially damage the tissues of face 578 and/or head 580, including the tissues of an eye 584, ear 586, or a brain located in head 580.

FIG. 37 shows a view of mobile communication device 300 positioned such that bottom speaker 320 is adjacent, close, near, or alongside an ear 324 of user 326. By positioning bottom speaker 320 and bottom microphone 322 along bottom side face 312, the majority of thermal energy 328, i.e., heat or infrared radiation, generated by mobile communication device 300 is emitted in a direction that is away from a head 330 of user 326, which includes being away from the skin of user 326. Such heat generation is from, for example, display 306, battery 332, and processor 334. As shown in FIG. 37, an optimal orientation of mobile communication device 300 with respect to the face and skin of user 326 is such that display 306 is approximately perpendicular to the face and skin of user 326 when mobile communication device 300 is held in a single hand, including a palm of the hand, to position speaker 320 at, near, adjacent, alongside, on, in proximity, or close to ear 324.

It should be understood that embodiments of mobile communication devices shown herein that position a speaker and/or a microphone in a position along a side or edge of the corresponding mobile communication devices, i.e., not on a front or back face, reduce the amount of heat or thermal energy transmitted to a user's head. For example, FIG. 38 shows a view of mobile communication device 420 in use or operation by a user 280. Heat or thermal energy 282, which can be generated by, for example, a battery 284 or a processor or electronics 286, is radiated principally in a direction that is alongside a head 288 of user 280 rather than radiated toward head 288 when speaker 276 is positioned close to an ear 290.

FIG. 33 shows a view of a mobile communication device, indicated generally at 600, in accordance with an exemplary embodiment of the present disclosure. Mobile communication device 600 includes a housing or casing 602, which includes a back face 604, a front face 606, and at least one longitudinal side 608 extending between back face 604 and front face 606. Housing or casing 602 contains an internal antenna 610 that generates RF radiation 612. Mobile communication device 600 further includes a first speaker 614 and a first microphone 616 positioned on longitudinal side 608, both of which are closer to an end of mobile communication device 600 that is opposite an end of mobile communication that includes antenna 610. Mobile communication device 600 is elongated in a longitudinal direction such that antenna 610 is positioned a spaced distance 618 from an ear 620 of a user 622. Such distance can be inches to reduce the amount of RF radiation 612 that impinges upon a head 624 of user 622. Mobile communication device 600 can further include a second speaker 626 and a second microphone 628 positioned on back face 604 adjacent or alongside longitudinal side 608, closer to the end of mobile communication device 600 that is the furthest location on mobile communication device 600 from antenna 610. Thus, first speaker 614 and first microphone 616 are positioned such that first speaker 614 is positioned offset from any corner or end of mobile communication device 600. Mobile communication device 600 can also include a third speaker 630 positioned in a location that is near, close, or adjacent to antenna 610, which is commonly used in handsets of the prior art, and is included herein as part of a combination of embodiment that includes a speaker in the center on the front face of a mobile communication device. However, it is understood that positioning of antenna in the vicinity of a speaker exposes the brain and other organ to the risk of injury due to the radiation.

FIG. 34 shows a view of a mobile communication device, indicated generally at 650, in accordance with an exemplary embodiment of the present disclosure. Mobile communication device 650 includes a housing or casing 652, which includes a back face 654 and a front face 656. Though not shown, it should be apparent that front face 656 includes a display, such as is shown in other embodiments of the present disclosure. Housing or casing 652 contains an internal antenna 660 that generates RF radiation 662. Mobile communication device 650 further includes a first speaker 664 and a first microphone 666 positioned on front face 656, both of which are positioned along a bottom or lower end 680 of mobile communication device 650 that is opposite an end of mobile communication device 650 that includes antenna 660. Mobile communication device 650 is elongated in a longitudinal direction such that antenna 660 is positioned a spaced distance 668 from an ear 670 of a user 672. Such distance can be inches to reduce the amount of RF radiation 662 that impinges upon a head 674 of user 672. Mobile communication device 650 can further include a second speaker 676 and a second microphone 678 positioned on back face 654 adjacent or alongside bottom end 680 that is diametrically opposed to the end of mobile communication device 650 that locates antenna 660, thus positioning second speaker 676 and second microphone 678 at a furthest location on mobile communication device 600 from antenna 660. Mobile communication device 650 can also include a third speaker 682 positioned in a location that is nearer to antenna 660 than to bottom end 680.

FIG. 35 shows a view of a mobile communication device, indicated generally at 690, in accordance with an exemplary embodiment of the present disclosure. Mobile communication device 690 includes a housing or casing 692, which includes a back face 694 and a front face 696. Though not shown, it should be apparent that front face 696 includes a display, such as is shown in other embodiments of the present disclosure. A top or upper end 720 of housing or casing 692 contains an internal antenna 698 that generates RF radiation 700. Mobile communication device 690 further includes a first speaker 702 and a microphone 704 positioned on back face 694, both of which are positioned on back face 694 closer to a bottom or lower end 718 of mobile communication device 690 than upper or top end 720. Mobile communication device 690 is elongated in a longitudinal direction such that antenna 720 is positioned a spaced distance 706 from an ear 708 of a user 710 when first speaker 702 is positioned adjacent, close, or alongside ear 708. Such distance can be inches to reduce the amount of RF radiation 700 that impinges upon a head 712 of user 710. Mobile communication device 690 can further include a second speaker 714 positioned on front face 696 in an area that is near, close, or adjacent to antenna 698, and is closer to top or upper end 720 than to bottom or lower end 718. However, it is understood that positioning of antenna in the vicinity of a speaker exposes the brain and other organ to the risk of injury due to the radiation.

FIG. 36 shows a view of a mobile communication device, indicated generally at 730, in accordance with an exemplary embodiment of the present disclosure. Mobile communication device 730 includes a housing or casing 732, which includes a front face 734. Front face 734 includes a display 736. A top or upper end 738 of housing or casing 732 contains an internal antenna 740 that generates RF radiation. Mobile communication device 730 further includes a speaker 742 positioned between display 736 and a longitudinal edge 744 of housing or casing 732, as opposed to between display 736 and a transverse edge 746 located at upper or top end 738 or between display 736 and a transverse edge 748 located at a bottom or lower end 750 of casing or housing 732. Mobile communication device 730 further includes a microphone 752 located near a junction or corner of longitudinal edge 744 and transverse edge 748. Both speaker 742 and microphone 752 are positioned on front face 734 closer to bottom or lower end 750 of mobile communication device 730 than upper or top end 738. Mobile communication device 730 is elongated in a longitudinal direction such that antenna 720 is positioned a spaced distance from an ear of a user when speaker 742 is positioned adjacent, close, or alongside the user's ear, similar to the embodiment of FIG. 35. It should be understood that speaker 742 and microphone 752 can be located on a right side face (not shown) or left side face (not shown) at exactly the same position on front face 734, but now on a side face, instead of the front face 734, thereby allowing a larger screen to be placed on front face 734.

Considering anatomic dimensions of the body and that the distance of a line parallel to the sagittal axis between the orifice of the ear canal and the top of the head of an adult measure between 10 and 16 cm, with an average of 13 cm, and further considering that an antenna needs to be located an average of 5 cm or about 3 to 4 cm (depending on the antenna) from the top of the head, the height of a cellular telephone to avoid exposure to radiation is an average of 16 to 17 cm. It should be understood that an antenna located 2 cm above the top of the head also reduces the amount of radiation and therefore a cellular phone with height of 15 cm reduces the amount of RF radiation impinging upon the head of a user, which can be achieved with the biologically compatible configurations of mobile communication devices disclosed herein. It should also be understood that, although not preferred embodiment, an antenna located 1 cm above the top of the head also reduces the amount of radiation and therefore a cellular phone with an average height of 14 cm reduces the amount of RF radiation impinging upon the head of a user, which can be achieved with the biologically compatible configurations of mobile communication devices disclosed herein, and considering the variation for man and woman of different sizes, a height of cellular phone between 11 cm and 15 cm reduces radiation effect on the head. Considering that the distance of a horizontal line perpendicular to the sagittal axis between the orifice of the ear canal and the back of the head of an adult measure between 9 and 14 cm, with an average of 11.5 cm, and further considering that an antenna needs to be located an average of 3 to 4 cm from the back of the head, the height of a cellular telephone to avoid exposure to radiation is an average of 14.5 to 15.5 cm. It should be understood that an antenna located 2 cm away from the back of the head also reduces the amount of radiation and therefore a cellular phone with height of 13.5 cm reduces the amount of RF radiation impinging upon the head of a user, which can be achieved with the biologically fit configuration of mobile communication devices disclosed herein. Without the new biologically compatible configuration disclosed herein, the sizes (height) of mobile communication devices would need to be so large that would be impractical and it would not be possible to achieve useful communication since speaker would be away from target organ (ear) and/or microphones would be away from the target organ (mouth).

FIG. 39 shows a view of a mobile communication device, indicated generally at 760, in accordance with an exemplary embodiment of the present disclosure. Mobile communication device 760 includes a housing or casing 762, which includes a front face 764. Front face 764 includes a display 766. A top or upper end 768 of housing or casing 762 contains an internal antenna 770 that generates RF radiation. Mobile communication device 760 further includes a speaker 772 positioned between display 766 and a longitudinal edge 774 of housing or casing 762, as opposed to between display 766 and a transverse edge 776 located at upper or top end 768 or between display 766 and a transverse edge 778 located at a bottom or lower end 780 of casing or housing 762. Mobile communication device 760 further includes a microphone 782 located near a junction or corner of longitudinal edge 774 and transverse edge 778. The location of speaker 772 and microphone 782 can also be described as being along a longitudinal periphery of mobile communication device 760. Both speaker 772 and microphone 782 are positioned on front face 764 closer to bottom or lower end 780 of mobile communication device 760 than upper or top end 768. Mobile communication device 760 further includes a battery 784 positioned between speaker 772 and top or upper end 768. Mobile communication device 760 is elongated in a longitudinal direction such that antenna 770 is positioned a spaced distance from an ear of a user when speaker 772 is positioned adjacent, close, or alongside the user's ear, similar to the embodiment of FIG. 35. Such distance can be inches to reduce the amount of RF radiation that impinges upon a head of the user. In addition, in accordance with the present disclosure, heat from battery 784 is emitted away from the user's ear. It should be understood that speaker 772 and microphone 782 can be located on a right side face (not shown) or left side face (not shown) at exactly the same position on front face 764, but now on a side face, instead of the front face 764, thereby allowing a larger screen to be placed on front face 764. It should be understood that this side positioning of speaker and microphones is applicable to any embodiment in which a speaker and/or microphone are positioned on a front face of a mobile communication device.

FIG. 40 shows another view of mobile communication device 760, showing a position of a processor 786. Processor 786 is positioned at least partially longitudinally between speaker 772 and transverse edge 776 located at top or upper end 768. As with the position of battery 784, the position of processor 786 is such that much of the heat generated by processor 786 is emitted away from the user's head. The present disclosure describes preferred locations of battery and processor to reduce or avoid harm by radiation.

FIGS. 41 and 42 show views of a mobile communication device, indicated generally at 800, in accordance with an exemplary embodiment of the present disclosure having a longer housing or casing to position the antenna and heat generating elements farther from the user's head than is possible with a shorter housing or casing. Mobile communication device 800 includes a housing or casing 802, which includes a front face 804. Front face 804 includes a display 806. A top or upper end 808 of housing or casing 802 contains an internal antenna 810 that generates RF radiation. Mobile communication device 800 further includes a speaker 812 positioned between display 806 and a longitudinal edge 814 of housing or casing 802, as opposed to between display 806 and a transverse edge 816 located at upper or top end 808 or between display 806 and a transverse edge 818 located at a bottom or lower end 820 of casing or housing 802. Mobile communication device 800 further includes a microphone 822 located near a junction or corner of longitudinal edge 814 and transverse edge 818. The location of speaker 812 and microphone 822 can also be described as being along a longitudinal periphery of mobile communication device 800. Both speaker 812 and microphone 822 are positioned on front face 804 closer to bottom or lower end 820 of mobile communication device 800 than upper or top end 808. Mobile communication device 800 further includes a battery 824 and a processor 826 positioned between speaker 812 and top or upper end 808. Mobile communication device 800 is elongated in a longitudinal direction such that antenna 810 is positioned a spaced distance from an ear of a user when speaker 812 is positioned adjacent, close, or alongside the user's ear, similar to the embodiment of FIG. 35. Such distance can be inches to reduce the amount of RF radiation that impinges upon a head of the user. In addition, heat from battery 824 and processor 826 is emitted away from the user's ear. It should be understood that speaker 812 and microphone 822 can be located on a right side face (not shown) or left side face (not shown) at exactly the same position on front face 804, but now on a side face, instead of the front face 804, thereby allowing a larger screen to be placed on front face 804.

FIG. 43 shows a view of a mobile communication device, indicated generally at 830, in accordance with an exemplary embodiment of the present disclosure. Mobile communication device 830 is similar to mobile communication device 760. Accordingly, elements that are similar to mobile communication device 760 are given the same element number as those of mobile communication device 760. Mobile communication device 830 is different from mobile communication device 760 in that mobile communication device 830 positions speaker 772 and microphone 782 on a back face 832 of mobile communication device 830 in about the same position as speaker 772 and microphone 782 on mobile communication device 760. It should be understood that speaker 772 and microphone 782 can be located on a right side face (not shown) or left side face (not shown) at exactly the same position on back face 832, but now on a side face, instead of the back face 832, however in those embodiments since the speaker 772 and microphone 782 are positioned on the back face 832, a large full face screen can be positioned on the front face. It should be understood that this side positioning of speaker and microphones is applicable to any embodiment in which a speaker and/or microphone are positioned on a front face of a mobile communication device.

FIG. 44 shows a view of a mobile communication device, indicated generally at 840, in accordance with an exemplary embodiment of the present disclosure. Mobile communication device 840 includes a housing or casing 842, which includes a back face 844. A bottom or lower end 846 of housing or casing 842 contains an internal antenna 848 that generates RF radiation. Mobile communication device 840 further includes a speaker 850 positioned at or near a bottom end 852 of housing or casing 842 along a centerline of mobile communication device 840, and thus speaker 850 is at an opposite end of housing or casing 842 from internal antenna 848. Mobile communication device 840 further includes a microphone 854 located near a junction or corner of housing or casing 842 near, alongside, or close to internal antenna 848. Mobile communication device 840 further includes a battery 856 and a processor 858 positioned closer to microphone 854 than to speaker 850, thus reducing the amount of heat from batter 856 and processor 858 transmitted to the head of the user in the region of the user's ear, which is also closer to the user's brain than is the region around microphone 854.

FIG. 45 shows a view of a mobile communication device, indicated generally at 870, in accordance with an exemplary embodiment of the present disclosure. Mobile communication device 870 includes a housing or casing 872. Housing or casing 872 includes a front face 874, in which is positioned a display 876. Housing or casing 872 includes a top or upper end 878 and a bottom or lower end 880. A speaker 882 is positioned on front face 874 between display 876 and an upper transverse edge 884 of housing or casing 872. Also positioned on front face 874 is a microphone 886 between display 876 and a longitudinal edge 888 that is perpendicular to upper transverse edge 884. Microphone 886 is positioned closer to top or upper end 878 than to bottom or lower end 880. Mobile communication device 870 further includes an antenna 890 positioned closer to bottom or lower end 880 than top or upper end 878. Mobile communication device 870 further yet includes a battery 892 and a processor 894 positioned closer to top or upper end 878 than to bottom or lower end 880. When in use, RF radiation emitted by antenna 890 is positioned away from the user's brain, at a location that is at or below the level of the user's mouth.

FIG. 46 shows a view of a mobile communication device, indicated generally at 900, in accordance with an exemplary embodiment of the present disclosure. Mobile communication device 900 includes some features that are similar to mobile communication device 870, and similar elements are similarly numbered. However, the longitudinal length of mobile communication device 900 is less than the longitudinal length of mobile communication device 870. Furthermore, speaker 882 is positioned along a centerline of mobile communication device 900 between a display 904 and an upper transverse edge 906 of mobile communication device 900. In addition, microphone 886 is positioned at a junction of a longitudinal side 908 and a bottom transverse edge 910 at a position near, at, or closer to antenna 880. As with mobile communication device 870, RF radiation emitted by antenna 880 is away from the user's brain, at a location that is closer to the user's mouth than the user's brain.

FIG. 47 shows a view of a mobile communication device, indicated generally at 930, in accordance with an exemplary embodiment of the present disclosure. Mobile communication device 930 includes a housing or casing 932. Housing or casing 932 is configured to include an upper portion 934, which includes an upper transverse side or edge 936, a lower portion 938, which includes a lower transverse side or edge 940, a left longitudinal side or edge 942 that extends from upper transverse side or edge 936 to lower transverse side or edge 940, and a right longitudinal side or edge 944 that extends from upper transverse side or edge 936 to lower transverse side or edge 940. Housing or casing 932 further includes a front face 946 and a rear or back face approximately parallel to and opposite from front face 946. Mobile communication device 930 further includes a display 948 positioned on or in front face 946. Further yet, mobile communication device 930 includes a speaker 950 positioned at or near a corner or junction of upper transverse side or edge 936 and left longitudinal side or edge 942, and a microphone 952 positioned between display 948 and right longitudinal side or edge 944 in a position that is closer to a junction of upper transverse side or edge 936 and right longitudinal side or edge 944 than to a junction of lower transverse side or edge 940 and right longitudinal side or edge 944. Mobile communication device 930 also includes an antenna 954 positioned alongside or near to lower transverse side or edge 940, which thus positions antenna 954 in a location that would be away from the user's brain when the user positions speaker 950 at or near an ear. Mobile communication device 930 additionally includes a battery 956 and a processor 958 positioned such that most of battery 956 is positioned in a location that is longitudinally between microphone 952 and lower transverse side or edge 940 and processor 958 is positioned closer to lower transverse side or edge 940 than to upper transverse side or edge 936. When the user positions mobile communication device 930 such that speaker 950 is near an ear, and microphone 952 is as close as possible to the user's mouth, antenna 938 is positioned as far as mobile communication device 930 permits from the user's brain, and much of battery 956 and processor 958 are positioned away from the user's face and head. Thus, at least a portion of RF energy or radiation and thermal energy or radiation emitted by mobile communication device 930 will emit in a location that is away from the user's brain, minimizing heating of and interaction with the user's brain.

FIG. 48 shows a view of a mobile communication device, indicated generally at 970, in accordance with an exemplary embodiment of the present disclosure. Mobile communication device 970 includes a housing or casing 972. Housing or casing 972 is configured to include an upper portion 974, which includes an upper transverse side or edge 976, a lower portion 978, which includes a lower transverse side or edge 980, a left longitudinal side or edge 982 that extends from upper transverse side or edge 976 to lower transverse side or edge 980, and a right longitudinal side or edge 984 that extends from upper transverse side or edge 976 to lower transverse side or edge 980. Housing or casing 972 further includes a front face 986 and a rear or back face approximately parallel to and opposite from front face 986. Mobile communication device 970 further includes a display 988 positioned on or in front face 986. Further yet, mobile communication device 970 includes a speaker 990 positioned at or near a corner or junction of upper transverse side or edge 976 and right longitudinal side or edge 984, and a microphone 992 positioned at or near a corner or junction between lower transverse side or edge 980 and right longitudinal side or edge 984. Mobile communication device 970 also includes an antenna 994 positioned alongside, adjacent, or near to left longitudinal side or edge 982 in a location that can be closer to lower transverse side or edge 980 than to upper transverse side or edge 976, which thus positions antenna 984 in a location that would be away from the user's brain when the user positions speaker 990 at or near an ear. Mobile communication device 970 additionally includes a battery 996 and a processor 998 positioned such that battery 996 and processor 998 are positioned in a location that is transversely between speaker 990 and left longitudinal side or edge 982 and transversely between microphone 992 and left longitudinal side or edge 982. When the user positions mobile communication device 970 such that speaker 990 is near an ear, and microphone 992 is as close as possible to the user's mouth, antenna 994 is positioned a spaced distance from the user's brain, and much of battery 996 and processor 998 are positioned away from the users face and head. Thus, at least a portion of RF energy or radiation and thermal energy or radiation emitted by mobile communication device 970 will emit in a location that is away from the user's brain, minimizing heating of the brain.

FIG. 49 shows a view of a mobile communication device, indicated generally at 1010, in accordance with an exemplary embodiment of the present disclosure. Mobile communication device 1010 includes a housing or casing 1012. Housing or casing 1012 is configured to include an upper portion 1014, which includes an upper transverse side or edge 1016, a lower portion 1018, which includes a lower transverse side or edge 1020, a left longitudinal side or edge 1022 that extends from upper transverse side or edge 1016 to lower transverse side or edge 1020, and a right longitudinal side or edge 1024 that extends from upper transverse side or edge 1016 to lower transverse side or edge 1020. Housing or casing 1012 further includes a front face 1026 and a rear or back face approximately parallel to and opposite from front face 1026. Mobile communication device 1010 further includes a display 1028 positioned on or in front face 1026. Further yet, mobile communication device 1010 includes a speaker 1030 positioned at or near a corner or junction of lower transverse side or edge 1020 and left longitudinal side or edge 1022, and a microphone 1032 positioned at or near a corner or junction between lower transverse side or edge 1020 and right longitudinal side or edge 1024. Mobile communication device 1010 also includes an antenna 1034 positioned alongside, adjacent, or near to upper transverse edge or side 1016, which thus positions antenna 1034 in a location that would be away from the user's brain when the user positions speaker 1030 at or near an ear. Mobile communication device 1010 additionally includes a battery 1036 positioned in a location that is closer to upper transverse side or edge 1016 than to lower transverse side or edge 1020. When the user positions mobile communication device 1010 such that speaker 1030 is near an ear, and microphone 1032 is as close as possible to the user's mouth, antenna 1034 is positioned a spaced distance from the user's brain. Thus, at least a portion of RF energy or radiation emitted by mobile communication device 1010 will emit in a location that is away from the user's brain, minimizing heating of and interaction with the user's brain.

FIG. 50 shows a view of a conventional mobile communication device, indicated generally at 1040. Mobile communication device 1040 includes a display 1042, a speaker 1044 positioned longitudinally between display 1042 and a top of mobile communication device 1040, and a microphone 1046 positioned longitudinally between display 1042 and a bottom of mobile communication device 1040. Display 1042, speaker 1044, and microphone 1046 are conventionally arranged along a longitudinally extending centerline 1048 of mobile communication device 1040.

FIGS. 51, 56, 59, and 60 show views of a mobile communication device, indicated generally at 1060, in accordance with an exemplary embodiment of the present disclosure. Mobile communication device 1060 includes a housing or casing 1062. Housing or casing 1062 is configured to include an upper portion 1064, which includes an upper transverse side or edge 1066, a lower portion 1068, which includes a lower transverse side or edge 1070, a left longitudinal side or edge 1072 that extends from upper transverse side or edge 1066 to lower transverse side or edge 1070, and a right longitudinal side or edge 1074 that extends from upper transverse side or edge 1066 to lower transverse side or edge 1070. Housing or casing 1062 further includes a front face 1076 and a rear or back face 1078 approximately parallel to and opposite from front face 1076. Mobile communication device 1060 further includes a display 1080 positioned on or in front face 1076. Further yet, mobile communication device 1060 includes a speaker 1082 positioned a distance Y from upper transverse side or edge 1066 that can be at or near a longitudinal center 1088 of right longitudinal side or edge 1074, as shown in FIG. 51, or can be at various locations between longitudinal center 1088 and lower transverse side or edge 1070, as shown in FIGS. 56, 59, and 60. Mobile communication device 1060 further includes a microphone 1084 positioned on lower transverse side or edge 1070 in a location that is near, at, or close to a junction or corner between lower transverse side or edge 1070 and right longitudinal side or edge 1074. Mobile communication device 1060 also includes an antenna 1086 positioned alongside or near to upper transverse side or edge 1066, which thus positions antenna 1086 in a location that would be away from the user's brain when the user positions speaker 1082 at or near an ear. When the user positions mobile communication device 1060 such that speaker 1082 is near an ear, and microphone 1084 is as close as possible to the user's mouth, antenna 1086 is positioned as far as mobile communication device 1060 permits from the user's brain. Thus, at least a portion of RF energy or radiation emitted by mobile communication device 1060 will emit in a location that is away from the user's brain, minimizing heating of and interaction with the brain. Although the embodiments of FIGS. 51, 56, and 59 reduce the amount of radiation impinging upon the brain (as compared to the prior art shown in FIG. 1), the least amount of radio waves impinging upon a user's brain and eye is accomplished with the embodiment later shown in FIG. 60, which positions the speaker 1082 farthest from the antenna 1086.

FIG. 52 shows a view of another mobile communication device, indicated generally at 1090, in accordance with an exemplary embodiment of the present disclosure. Mobile communication device 1090 includes many features of mobile communication device 1060 shown in FIG. 51, and similar elements are similarly labeled for simplicity. Mobile communication device 1090 includes a housing or casing 1092, which includes an upper portion 1094, which includes an upper transverse side or edge 1096, a lower portion 1098, which includes a lower transverse side or edge 1100, and a right longitudinal side or edge 1102 that extends from upper transverse side or edge 1096 to lower transverse side or edge 1100. Speaker 1082 is positioned on right longitudinal side or edge 1102 at a location that is near a longitudinal center of right longitudinal side or edge 1102, closer to lower transverse side or edge 1100 than to upper transverse side or edge 1096. Microphone 1084 is positioned on right longitudinal side or edge 1102 at a location that is near, close, or adjacent to a junction or corner between right longitudinal side or edge 1102 and lower transverse side or edge 1100. As with mobile communication device 1060, the configuration of mobile communication device 1090 is such that when speaker 1082 is positioned at, on, or near the user's ear, and microphone 1084 is oriented to be as close as possible to the user's mouth, antenna 1086 is positioned such that the intensity of RF radiation emitted by antenna 1086 is reduced as compared to a conventional mobile communication device.

One potential issue that can arise when speaker 1082 is very close to microphone 1084 is feedback. However, there are conventional electronic and mechanical solutions to reducing the risk of feedback when speaker 1082 and microphone 1084 are very close or adjacent to each other, and such solutions may need to be implemented.

FIG. 57 shows a view of an even further mobile communication device, indicated generally at 1190, in accordance with an exemplary embodiment of the present disclosure. Mobile communication device 1190 contains features similar to mobile communication device 1090, shown in FIG. 52, and when such similar features are disclosed, the same element numbers as those of mobile communication device 1090 are used. Mobile communication device 1190 includes a housing or casing 1192, and housing or casing 1192 includes a right longitudinal side or edge 1194. Speaker 1082 is positioned on right longitudinal side or edge 1194 at or along a transversely extending centerline 1196 positioned at a longitudinal center of mobile communication device 1190.

FIG. 58 shows a view of still yet another mobile communication device, indicated generally at 1200, in accordance with an exemplary embodiment of the present disclosure. Mobile communication device 1200 contains features similar to mobile communication device 1090, shown in FIG. 52, and when such similar features are disclosed, the same element numbers as those of mobile communication device 1090 are used. Mobile communication device 1200 includes a housing or casing 1202, and housing or casing 1202 includes a right longitudinal side or edge 1204. Speaker 1082 is positioned on right longitudinal side or edge 1204 at a first spaced distance 1206 from a transversely extending centerline 1208 positioned at a longitudinal center of mobile communication device 1200. Microphone 1084 is positioned a second spaced distance 1210 from speaker 1082. As can be seen by comparing mobile communication device 1200 to mobile communication device 1090 shown in FIG. 52 and mobile communication device 1190 shown in FIG. 57, mobile communication device 1200 is physically longer than either mobile communication device 1090 or mobile communication device 1190. Furthermore, since second spaced distance 1210 is approximately the same for mobile communication device 1090, mobile communication device 1190, and mobile communication device 1200, the result of increasing first spaced distance 1206 is to position antenna 1086 farther from the user's brain than an antenna is positioned in a conventional mobile communication device. The embodiment of FIG. 58 showing an elongated case allows positioning speaker 1082 in the middle between transversely extending centerline 1208 and microphone 1084, allowing thereby a more ergonomic holding position that places or positions microphone 1084 closer to the mouth.

FIGS. 53 and 54 show views of a further mobile communication device, indicated generally at 1110, in accordance with an exemplary embodiment of the present disclosure. Mobile communication device 1110 includes a housing or casing 1112. Housing or casing 1112 is configured to include an upper portion 1114, which includes an upper transverse side or edge 1116, a lower portion 1118, which includes a lower transverse side or edge 1120, a left longitudinal side or edge 1122 that extends from upper transverse side or edge 1116 to lower transverse side or edge 1120, and a right longitudinal side or edge 1124 that extends from upper transverse side or edge 1116 to lower transverse side or edge 1120. Housing or casing 1112 further includes a front face 1126 and a rear or back face 1128 approximately parallel to and opposite from front face 1126. Mobile communication device 1110 further includes a display 1130 positioned on or in front face 1126. Further yet, mobile communication device 1110 includes a speaker 1132 positioned on back face 1128 at or near an intersection of a vertical or longitudinal centerline 1134 of mobile communication device 1110 and a horizontal or transverse centerline 1136 of mobile communication device 1110. Mobile communication device 1110 also includes a microphone 1138 positioned on back face 1128 along vertical or longitudinal centerline 1134 in a location that is longitudinally between speaker 1132 and lower transverse side or edge 1120. Microphone 1138 is also positioned a spaced distance from an edge formed between back face 1128 and lower transverse side or edge 1120. Mobile communication device 1110 also includes an antenna 1140 positioned alongside or near to upper transverse side or edge 1116, which thus positions antenna 1140 in a location that would be away from the user's brain when the user positions speaker 1132 at or near an ear. When the user positions mobile communication device 1110 such that speaker 1132 is near an ear, and microphone 1138 is as close as possible to the user's mouth, antenna 1140 is positioned as far as mobile communication device 1110 permits from the user's brain. Thus, at least a portion of RF energy or radiation emitted by mobile communication device 1110 will emit in a location that is away from the user's brain, minimizing heating of and interaction with the brain. This embodiment of FIG. 53 includes an elongated case that allows positioning speaker 1132 in the middle between lower transverse side 1120 and upper transverse side 1116 and microphone 1084 while positioning antenna 1140 away from the brain.

FIG. 55 shows a view of yet another mobile communication device, indicated generally at 1150, in accordance with an exemplary embodiment of the present disclosure. Mobile communication device 1150 includes a housing or casing 1152. Housing or casing 1152 is configured to include an upper portion 1154, which includes an upper transverse side or edge 1156, a lower portion 1158, which includes a lower transverse side or edge 1160, a left longitudinal side or edge 1162 that extends from upper transverse side or edge 1156 to lower transverse side or edge 1160, and a right longitudinal side or edge 1164 that extends from upper transverse side or edge 1156 to lower transverse side or edge 1160. Housing or casing 1152 further includes a front face 1166 and a rear or back face 1168 approximately parallel to and opposite from front face 1166. Mobile communication device 1150 further includes a display 1170 positioned on or in front face 1166. It should be apparent that display 1170 covers nearly the entirety of front face 1166. Further yet, mobile communication device 1150 includes a speaker 1172 positioned on back face 1168 in a location that is closer to a corner or junction of right longitudinal side or edge 1164 and lower transverse side or edge 1160 than an intersection of a vertical or longitudinal centerline 1174 of mobile communication device 1150 and a horizontal or transverse centerline 1176 of mobile communication device 1150. Mobile communication device 1150 also includes a microphone 1178 positioned on back face 1168 at, near, or close to a corner or junction of right longitudinal side or edge 1164 and lower transverse side or edge 1160. Microphone 1178 is also positioned between speaker 1172 and the corner or junction of right longitudinal side or edge 1164 and lower transverse side or edge 1160. Mobile communication device 1150 also includes an antenna 1180 positioned alongside or near to upper transverse side or edge 1156, which thus positions antenna 1180 in a location that would be away from the user's brain when the user positions speaker 1172 at or near an ear. When the user positions mobile communication device 1150 such that speaker 1172 is near an ear, and microphone 1178 is as close as possible to the user's mouth, antenna 1180 is positioned as far as mobile communication device 1150 permits from the user's brain. Thus, at least a portion of RF energy or radiation 1182 emitted by mobile communication device 1150 that would otherwise enter the user's brain will emit in a location that is away from the user's brain, minimizing heating of and interaction with the brain. It should be understood that microphone 1178 can be positioned on lower transverse side 1160.

FIGS. 61 and 62 show views of a mobile communication device, indicated generally at 1220, which can be, for example, any one of mobile communication device 600 shown in FIG. 33, mobile communication device 1060 shown in FIGS. 51, 56, 59, and 60, mobile communication device 1090 shown in FIG. 52, mobile communication device 1190 shown in FIG. 57, and mobile communication device 1200 shown in FIG. 58. Mobile communication device 1220 includes an antenna 1222, various sources of heat generation, such as a processor 1224 and a battery 1226, a speaker 1228, and a microphone 1230. By positioning speaker 1228 and microphone 1230 generally as shown in FIGS. 61 and 62 along a side or edge of mobile communication device 1220, and also as shown in FIGS. 51, 56, 59, and 60, thermal or heat energy 1232 generated by various sources of heat generation, for example processor 1224 and battery 1226, is emitted principally in a direction that is approximately parallel or along a face 1236 of a user 1238, and not in a direction that is toward the brain of user 1238. In addition, because of the length of mobile communication device 1220 and the position of antenna 1222, RF radiation 1234 generated by mobile communication device 1220 is positioned in a location that reduces impingement of RF radiation 1234 on the brain of user 1238 as well as other sensitive tissues such as the eye, parotid gland, and thyroid gland beside the ear itself.

In contrast to, for example, mobile communication device 400 in FIG. 15, mobile communication device 600 in FIG. 33, mobile communication device 300 in FIG. 37, and mobile communication device 1220 in FIGS. 61 and 62 of the present disclosure, a conventional, i.e., prior art, mobile communication device 1240, shown in FIG. 63, generates thermal or heat energy or radiation 1242 that is emitted directly onto a face 1244 of a user 1246. Mobile communication device 1240 also emits RF energy or radiation 1248 that interacts with a head 1250 of user 1246, and thus RF energy or radiation 1248 interacts with the brain of user 1246. Interaction of portions of head 1250, including an eye 1252 and the brain, with thermal or heat energy or radiation 1242 and RF energy or radiation 1248 may cause unhealthy effects on the tissues of head 1250, including the brain and eye 1252.

The interaction of conventional mobile communication device 1240 is also contrasted with a mobile communication device, indicated generally at 1260 in FIG. 64, in accordance with an exemplary embodiment of the present disclosure. Mobile communication device 1260 can be similar to, for example, mobile communication device 150 shown in FIGS. 8-10, mobile communication device 300 shown in FIGS. 13 and 37, mobile communication device 350 shown in FIG. 14A, and mobile communication device 400 shown in FIG. 15. Mobile communication device 1260 includes a speaker 1262 and a microphone 1264 along a bottom peripheral side or edge. When user 1246 positions speaker 1262 near an ear 1270 and microphone 1264 in a direction toward a mouth 1272, approximately as shown in FIG. 64, thermal or heat energy or radiation 1266 and RF radiation or energy 1268 are located such that interaction between thermal or heat energy or radiation 1266 and RF radiation or energy 1268 and head 1250 and eye 1252 is reduced as compared to a conventional mobile communication device, such as device 1240 shown in FIG. 63.

FIG. 65 shows a view of another mobile communication device, indicated generally at 1280, in accordance with an exemplary embodiment of the present disclosure. Mobile communication device 1280 can be similar to, for example, mobile communication device 600 shown in FIG. 33, mobile communication device 690 shown in FIG. 35, mobile communication device 730 shown in FIG. 36, mobile communication device 760 shown in FIGS. 39 and 40, mobile communication device 800 shown in FIGS. 41 and 42, mobile communication device 830 shown in FIG. 43, and mobile communication device 1150 shown in FIG. 55. Mobile communication device 1280 includes a speaker 1282 and a microphone 1284 position in a face 1286, which can be a front face containing a display or a rear or back face, of mobile communication device 1280. As with other exemplary mobile communication devices of the present disclosure, when user 1246 positions speaker 1282 near ear 1270 and microphone 1284 in a direction toward mouth 1272, approximately as shown in FIG. 65, thermal or heat energy or radiation 1288 and RF radiation or energy 1290 are located such that interaction between thermal or heat energy or radiation 1288 and RF radiation or energy 1290 and head 1250 and eye 1252 is reduced as compared to a conventional mobile communication device, such as device 1240 shown in FIG. 63.

FIG. 66 shows a view of yet another mobile communication device, indicated generally at 1300a, in accordance with an exemplary embodiment of the present disclosure. Mobile communication device 1300a can be similar to, for example, mobile communication device 1060 shown in FIGS. 56, 59, and 60. Mobile communication 1300a includes a housing or casing 1302a. Housing or casing 1302a is configured to include an upper portion 1304, which includes an upper transverse side or edge 1306, a lower portion 1308a, which includes a lower transverse side or edge 1310a, a left longitudinal side or edge 1312 that extends from upper transverse side or edge 1306 to lower transverse side or edge 1310a, and a right longitudinal side or edge 1314a that extends from upper transverse side or edge 1306 to lower transverse side or edge 1310a. Housing or casing 1302a further includes a front face 1316 and a rear or back face 1318 approximately parallel to and opposite from front face 1316. Mobile communication device 1300a further includes a display 1320 positioned on or in front face 1316. Further yet, mobile communication device 1300a includes a speaker 1322 positioned a distance Y from upper transverse side or edge 1306 that can be at or near a longitudinal center, or a transversely extending centerline 1328 mobile communication device 1300b as well as right longitudinal side or edge 1314a, such as is shown in FIG. 51, or can be at various locations between longitudinal center 1328 and lower transverse side or edge 1310a, such as is shown in FIGS. 56, 59, and 60. Mobile communication device 1300a further includes a microphone 1324 positioned on lower transverse side or edge 1310a in a location that is near, at, or close to a junction or corner between lower transverse side or edge 1310a and left longitudinal side or edge 1312. Mobile communication device 1300a also includes an antenna 1266 positioned alongside or near to upper transverse side or edge 1306, which thus positions antenna 1306 in a location that would be away from the user's brain when the user positions speaker 1322 at or near an ear. When the user positions mobile communication device 1300a such that speaker 1322 is near an ear, and microphone 1324 is as close as possible to the user's mouth, antenna 1306 is positioned as far as mobile communication device 1300a permits from the user's brain. Thus, at least a portion of RF energy or radiation emitted by mobile communication device 1300a will emit in a location that is away from the user's brain, minimizing heating of and interaction with the brain. However, microphone 1324 is not optimally positioned for receiving vocal input from a mouth.

FIG. 67A shows a view of still another mobile communication device, indicated generally at 1300b, in accordance with an exemplary embodiment of the present disclosure. Mobile communication device 1300b is similar to mobile communication device 1300a shown in FIG. 66, and is thus similarly labelled. However, microphone 1324 is positioned closer to a junction of a lower transverse side or edge 1310a and right longitudinal side or edge 1314a than is microphone 1324 in mobile communication device 1300a, such as along a longitudinally extending centerline of mobile communication device 1300b. Thus, the position of microphone 1324 in mobile communication device 1300b is preferred for better vocal input into microphone 1324 as compared to the position of microphone 1324 in mobile communication device 1300a.

FIG. 67B shows another view of mobile communication device 1300b of FIG. 67A showing battery 1226. Battery 1226 is positioned at a location that is in the upper half of housing 1302b. In other words, battery 1226 is positioned between transversely extending centerline 1328 and top or upper transverses side or edge 1306.

FIGS. 68, 79, and 80 show views of still another mobile communication device, indicated generally at 1300c, in accordance with an exemplary embodiment of the present disclosure. Mobile communication device 1300c is similar to mobile communication device 1300a shown in FIG. 66, and mobile communication device 1300b shown in FIG. 67A, and is thus similarly labelled. However, microphone 1324 is positioned close, near, at, or adjacent to a junction of a lower transverse side or edge 1310a and right longitudinal side or edge 1314a, which is much closer to right longitudinal side or edge 1314a than is microphone 1324 in either mobile communication device 1300a or 1300b. Thus, the offset position of microphone 1324 toward right longitudinal side or edge 1314a in mobile communication device 1300c is preferred for better vocal input into microphone 1324 as compared to the position of microphone 1324 in mobile communication devices 1300a and 1300b. Mobile communication device 1300c can also include a camera, light, or other accessory 1362 positioned on back face 1348, as shown in FIG. 79. FIG. 80 shows stylized RF energy or radiation pattern 1364 emitted by mobile communication device 1300c.

FIGS. 69 and 70 show views of a mobile communication device, indicated generally at 1330, in accordance with an exemplary embodiment of the present disclosure. Mobile communication device 1330 includes a housing or casing 1332. Housing or casing 1332 is configured to include an upper portion 1334, which includes an upper transverse side or edge 1336, a lower portion 1338, which includes a lower transverse side or edge 1340, a left longitudinal side or edge 1342 that extends from upper transverse side or edge 1336 to lower transverse side or edge 1340, and a right longitudinal side or edge 1344 that extends from upper transverse side or edge 1336 to lower transverse side or edge 1340. Housing or casing 1332 further includes a front face 1346 and a rear or back face 1348 approximately parallel to and opposite from front face 1346. Mobile communication device 1330 further includes a display 1348 positioned on or in front face 1346. Display 1348 substantially covers front face 1346. In the context of this disclosure, substantially can mean the entirety of front face 1346 with a small boundary or border between display 1348 and the peripheral edges of a mobile communication device, which such boundary insufficient in width to allow positioning of a microphone or speaker.

Mobile communication device 1330 further includes a speaker 1352 positioned on back face 1348 along a longitudinally extending centerline 1358 of mobile communication device 1330. Speaker 1352 can be positioned a distance Y from upper transverse side or edge 1336. Such position is also offset from a transversely extending centerline 1360 of mobile communication device 1330. Mobile communication device 1330 further yet includes a microphone 1354 positioned between speaker 1352 and lower transverse side or edge 1340. Thus, microphone 1354 is also offset with respect to transversely extending centerline 1360. Mobile communication device 1330 also includes an antenna 1356 positioned alongside or near to upper transverse side or edge 1336. Thus, antenna 1356 is positioned in a location that is offset from longitudinally extending centerline 1358 and transversely extending centerline 1360, though in directions that are opposite from the offset of speaker 1352 and microphone 1354. When the user positions mobile communication device 1330 such that speaker 1352 is near an ear, and microphone 1354 is as close as possible to the user's mouth, antenna 1356 is positioned as far as mobile communication device 1330 permits from the user's brain. Such positioning is made possible by the placement of speaker 1352 at distance Y from upper transverse side or edge 1336. Thus, at least a portion of RF energy or radiation emitted by mobile communication device 1330 will emit in a location that is away from the user's brain, minimizing heating of and interaction with the user's brain.

FIGS. 71, 72A, and 72B show views of a mobile communication device, indicated generally at 1370, in accordance with an exemplary embodiment of the present disclosure. Mobile communication device 1370 includes a housing or casing 1372. Housing or casing 1372 is configured to include an upper portion 1374, which includes an upper transverse side or edge 1376, a lower portion 1378, which includes a lower transverse side or edge 1380, a left longitudinal side or edge 1382 that extends from upper transverse side or edge 1376 to lower transverse side or edge 1380, and a right longitudinal side or edge 1384 that extends from upper transverse side or edge 1376 to lower transverse side or edge 1380. Housing or casing 1372 further includes a front face 1386 and a rear or back face 1388 approximately parallel to and opposite from front face 1386. Mobile communication device 1370 further includes a display 1390 positioned on or in front face 1386. Display 1390 substantially covers front face 1386.

Mobile communication device 1370 further includes a speaker 1392 positioned on back face 1388 at, near, or alongside a longitudinal side or edge, such as left longitudinal side or edge 1382 a distance Y from upper transverse side or edge 1376. Speaker 1392 is thus located offset from a transversely extending centerline 1400 of mobile communication device 1370 and offset from a longitudinally extending centerline 1398 of mobile communication device 1370. Furthermore, speaker 1392 is positioned longitudinally between transversely extending centerline 1400 and lower transverse side or edge 1380.

Mobile communication device 1370 further yet includes a microphone 1394 positioned between speaker 1392 and lower transverse side or edge 1380. Thus, microphone 1394 is also offset with respect to transversely extending centerline 1400 and longitudinally extending centerline 1398. Mobile communication device 1370 also includes an antenna 1396 positioned at, alongside, or near to right longitudinal side or edge 1384, extending in a longitudinal direction. Thus, antenna 1396 is transversely positioned on an opposite side of housing or casing 1372 from speaker 1392 and microphone 1394, as well as being diagonally opposite from speaker 1392 and microphone 1394.

When the user positions mobile communication device 1370 such that speaker 1392 is near an ear, and microphone 1394 is as close as possible to the user's mouth, antenna 1396 is positioned a spaced distance away from both speaker 1392 and microphone 1394. Such positioning is made possible by the placement of speaker 1392 at distance Y from upper transverse side or edge 1376 and alongside left longitudinal side or edge 1382. Thus, at least a portion of RF energy or radiation emitted by mobile communication device 1370 will emit in a location that is away from the user's brain, minimizing heating of and interaction with the user's brain. A longer distance Y positions speaker 1392 further away from antenna 1396, thereby further reducing radiation reaching the brain or other organs.

FIG. 72B is a further illustration of a position of speaker 1392 being a greater distance Y from upper transverse side or edge 1376 as the distance shown in FIG. 72A. The position of speaker 1392 and microphone 1394 can be described as adjacent, alongside, near, or close to each other, and both are positioned near or close to an intersection of left longitudinal side or edge 1382, lower transverse side or edge 1380, and back face 1388, which can also be described as a lower right hand corner of back face 1388. The positions of speaker 1392 and microphone 1394 can also be described as being longitudinally or vertically stacked since speaker 1392 and microphone 1394 are positioned along a line that is approximately parallel to longitudinally extending centerline 1398.

FIG. 73 shows a view of still another mobile communication device, indicated generally at 1300d, in accordance with an exemplary embodiment of the present disclosure. Mobile communication device 1300b is similar to mobile communication device 1300a shown in FIG. 66, and is thus similarly labelled. However, speaker 1322 is positioned along transversely extending centerline 1328 of mobile communication device 1300d.

FIG. 74 shows a view of still another mobile communication device, indicated generally at 1300e, in accordance with an exemplary embodiment of the present disclosure. Mobile communication device 1300e is similar in some ways to mobile communication device 1300b shown in FIG. 67A, and is thus similarly labelled. However, microphone 1324 is positioned closer to a junction of a lower transverse side or edge 1310a and right longitudinal side or edge 1314d than is microphone 1324 in mobile communication device 1300a, such as along a longitudinally extending centerline of mobile communication device 1300e. Thus, the position of microphone 1324 in mobile communication device 1300e is preferred for better vocal input into microphone 1324 as compared to the position of microphone 1324 in mobile communication device 1300d.

FIG. 75 shows a view of still another mobile communication device, indicated generally at 1300f, in accordance with an exemplary embodiment of the present disclosure. Mobile communication device 1300f is similar to mobile communication device 1300c shown in FIG. 68 and to mobile communication device 1300d shown in FIG. 73, and is thus similarly labelled. Similar to FIG. 68, microphone 1324 is positioned close, near, at, or adjacent to a junction of a lower transverse side or edge 1310c and right longitudinal side or edge 1314e, and speaker 1322 is positioned along transversely extending centerline 1328, similar to FIG. 73.

FIG. 76 shows a view of an even further mobile communication device, indicated generally at 1300g, in accordance with an exemplary embodiment of the present disclosure. Mobile communication device 1300g is similar to mobile communication device 1300b shown in FIG. 67A, and is thus similarly labelled. However, speaker 1322 is closer to transversely extending centerline 1328 than is speaker 1322 in FIG. 67A.

FIGS. 77 and 78 show views of still yet another mobile communication device, indicated generally at 1420, in accordance with an exemplary embodiment of the present disclosure. Mobile communication device 1420 is similar to mobile communication device 1330 shown in FIGS. 69 and 70. However, speaker 1352 of mobile communication device 1420 is positioned at an intersection of longitudinally extending centerline 1358 and transversely extending centerline 1360 at a distance X below upper transverse side or edge 1340. As in FIGS. 69 and 70, microphone 1354 is positioned along longitudinally extending centerline 1358 close to an edge formed between back face 1348 and lower transverse side 1340.

FIG. 81 shows a view of a mobile communication device, indicated generally at 1300h, in accordance with an exemplary embodiment of the present disclosure. Mobile communication device 1300h includes a position of microphone 1324 that is similar to the position of microphone 1324 in FIG. 68 and a position of speaker 1322 that is similar to the position of speaker 1322 in FIG. 76.

FIG. 82A shows a view of a mobile communication device, indicated generally at 1440, in accordance with an exemplary embodiment of the present disclosure. Mobile communication device 1440 is similar to mobile communication device 300, and is labeled similarly. Mobile communication device 1440 indicates a position of a battery 1432 with respect to speaker 320 and microphone 322.

FIG. 82B shows a view of a mobile communication device, indicated generally at 1442, in accordance with another exemplary embodiment of the present disclosure. Device 1442 is similar to mobile communication device 1440. However, the positions of speaker 320 and microphone 322 are reversed left and right in device 1442 as compared to device 1440. This embodiment includes a full display on a front face of the casing or housing.

FIG. 83A shows a view of another mobile communication device, indicated generally at 1450, in accordance with an exemplary embodiment of the present disclosure. Mobile communication device 1450 includes a housing or casing 1452. Housing or casing 1452 includes a front face 1454, in which is positioned a display 1456. Housing or casing 1452 includes a top or upper end 1458, and a bottom or lower end 1460. Top or upper end 1458 includes an upper transverse side or edge 1464, and bottom or lower end 1460 includes a lower transverse side or edge 1476. Housing or casing 1452 further includes a longitudinal edge or side 1468 that extends from upper transverse side or edge 1464 and lower transverse side or edge 1476. A speaker 1462 is positioned longitudinal edge or side 1468 at, near, or adjacent to a corner or junction between upper transverse side or edge 1464 and longitudinal side or edge 1468. Also positioned on longitudinal edge or side 1464 at, near, or adjacent to a corner or junction between longitudinal edge or side 1464 and lower transverse side or edge 1476 is a microphone 1466. Mobile communication device 1450 further includes an antenna 1470 positioned closer to bottom or lower end 1460 than top or upper end 1458. In the exemplary embodiment of FIG. 83A, antenna 1470 is positioned at, near, adjacent, or close to lower transverse edge 1476. Mobile communication device 1450 further yet includes a battery 1472 positioned closer to top or upper end 1458 than to bottom or lower end 1460. Mobile communication device 1450 further includes a processor 1474 positioned near to battery 1472 in a location that is longitudinally near a center of mobile communication device 1450. When in use, RF radiation emitted by antenna 1470 is positioned away from the user's brain, at a location that is at or below the level of the user's mouth.

FIG. 83B shows a view of a further mobile communication device, indicated generally at 1478, in accordance with an exemplary embodiment of the present disclosure. Device 1478 is similar to mobile communication device 1450 shown in FIG. 83A, with a difference being that device 1478 includes speakers 1462 and microphones 1466 on both longitudinal edges or sides 1468.

FIG. 85A shows a view of a further mobile communication device, indicated generally at 1480, in accordance with an exemplary embodiment of the present disclosure. Mobile communication device 1480 includes a housing or casing 1482. Housing or casing 1482 is configured to include an upper portion 1484, which includes an upper transverse side or edge 1486, a lower portion 1488, which includes a lower transverse side or edge 1490, a left longitudinal side or edge 1492 that extends from upper transverse side or edge 1486 to lower transverse side or edge 1490, and a right longitudinal side or edge 1494 that extends from upper transverse side or edge 1486 to lower transverse side or edge 1490. Housing or casing 1482 further includes a front face 1496 and a rear or back face approximately parallel to and opposite from front face 1496. Mobile communication device 1480 further includes a display 1498 positioned on or in front face 1480. Display 1498 substantially covers the entirety of front face 1480. Further yet, mobile communication device 1480 includes a speaker 1500 positioned on right longitudinal side or edge 1494 at or near a corner or junction of upper transverse side or edge 1486 and right longitudinal side or edge 1494, and a microphone 1502 positioned on right longitudinal side or edge 1494 at or near a corner or junction between lower transverse side or edge 1490 and right longitudinal side or edge 1502. Mobile communication device 1480 also includes an antenna 1504 positioned alongside, adjacent, or near to left longitudinal side or edge 1492 in a location that can be closer to lower transverse side or edge 1490 than to upper transverse side or edge 1486, which thus positions antenna 1504 in a location that would be away from the user's brain when the user positions speaker 1500 at or near an ear. Mobile communication device 1480 additionally includes a battery 1506 and a processor 1508 positioned such that battery 1506 and processor 1508 are positioned in a location that is transversely between speaker 1500 and left longitudinal side or edge 1492 and transversely between microphone 1502 and left longitudinal side or edge 1492. When the user positions mobile communication device 1480 such that speaker 1500 is near an ear, and microphone 1502 is as close as possible to the user's mouth, antenna 1504 is positioned a spaced distance from the user's brain, and much of battery 1506 and processor 1508 are positioned away from the users face and head. Thus, at least a portion of RF energy or radiation and thermal energy or radiation emitted by mobile communication device 1480 will emit in a location that is away from the user's brain, minimizing heating of the brain.

FIG. 85B shows a view of a yet further mobile communication device, indicated generally at 1510, in accordance with an exemplary embodiment of the present disclosure. Device 1510 is similar to mobile communication device 1480 shown in FIG. 85A, and thus the item numbers in FIG. 85B represent the items disclosed in FIG. 85A. The difference between mobile communication device 1480 and mobile communication device 1510 is that speaker 1500 is positioned on a transversely extending centerline or centerline plane 1512 that divides device 1510 into two equal halves.

FIG. 86 shows a view of an even further mobile communication device, indicated generally at 1520, in accordance with an exemplary embodiment of the present disclosure. Mobile communication device 1520 includes a housing or casing 1522. Housing or casing 1522 includes a front face 1524, in which is positioned a display 1526 that covers substantially the entirety of front face 1524. Housing or casing 1522 includes a top or upper end 1528 and a bottom or lower end 1530. Top or upper end 1528 includes an upper transverse side or edge 1534. Housing or casing 1522 further includes a left longitudinal side or edge 1539 and a right longitudinal side or edge 1538. Mobile communication device 1520 includes a speaker 1532 positioned on upper transverse side or edge 1534 at, near, close, or adjacent to a junction or corner of upper transverse side or edge 1534 and left longitudinal side or edge 1539. Mobile communication device 1520 further includes a microphone 1536 positioned on right longitudinal side or edge 1538 in a location that is closer to a corner or junction between right longitudinal side or edge 1538 and upper transverse side or edge 1534. Mobile communication device 1520 further includes an antenna 1540 positioned closer to bottom or lower end 1530 than top or upper end 1528. Mobile communication device 1520 further yet includes a battery 1542 positioned closer to top or upper end 1528 than to bottom or lower end 1530. Mobile communication device 1520 also includes a processor 1544 positioned closer to battery 1542 than bottom or lower end 1530. When in use, RF radiation emitted by antenna 1540 is positioned away from the user's brain.

FIGS. 87 and 88A show views of still another mobile communication device, indicated generally at 1550, in accordance with an exemplary embodiment of the present disclosure. Mobile communication device 1550 is similar to mobile communication device 1300a shown in FIG. 66, and like elements are labeled with like numbers. As compared to mobile communication device 1300a, mobile communication device 1550 has a longer longitudinal length, and the Y length is increased to a maximum, and the positions of speaker and microphone are reversed. FIG. 88A shows a stylized RF energy or radiation 1552 emitted by mobile communication device 1550.

FIG. 88B shows a view of a mobile communication device, indicated generally at 1570, in accordance with an exemplary embodiment of the present disclosure. The speaker and microphone configuration of device 1570 is similar to the configuration of mobile communication device 1550. However, the positions of speaker 1322 and microphone 1324 on or in mobile communication device 1570 are reversed from the positions on mobile communication device 1550. More specifically, speaker 1322 is on a bottom side or edge of a casing or housing 1572 of mobile communication device 1570 and microphone 1324 is positioned on a longitudinal side or edge of cashing or housing 1572 of device 1570.

FIGS. 89 and 90 show views of a mobile communication device, indicated generally at 1560, in accordance with an exemplary embodiment of the present disclosure. Mobile communication device 1560 is similar to mobile communication device 1200 shown in FIG. 58, and like elements are provided with like numbers. However, the longitudinal length of mobile communication device 1560 is longer than mobile communication device 1200, putting antenna 1086 farther from the user's brain than is possible in a conventional mobile communication device. Mobile communication device 1560 includes a display 1562 that extends over substantially the entirety of the front face of mobile communication device 1560. Mobile communication device further includes a battery 1564 and a processor 1566 positioned as shown.

FIGS. 91, 92, and 93 show views of mobile communication devices 1580, 1582, and 1584 in accordance with exemplary embodiments of the present disclosure. Mobile communication devices 1580, 1582, and 1584 are similar to mobile communication device 1200 shown in FIG. 58 and illustrate some of the many positions where speaker 1082 can be positioned with respect to other features of a mobile communication device, including microphone 1084, antenna 1086, battery 1542, and processor 1544. FIG. 91 shows a preferred position for speaker 1082, which is located the farthest from heat emitting components, namely battery 1542 and processor 1544 as well as farthest away from antenna 1086.

In view of the teachings of the embodiments disclosed hereinabove, FIGS. 94-118B disclose additional embodiments of the present disclosure. In each of the presented embodiments, common element numbers from FIGS. 14C, 69, 70, 83A, and 85A, as appropriate, are used for the sake of brevity.

FIG. 94 shows a view of a mobile communication device, indicated generally at 1590, in accordance with an exemplary embodiment of the present disclosure. Device 1590 includes speaker 1352 positioned on or in back face 1348 at a location that is offset from a longitudinal center of device 1590 toward one of the longitudinally extending side faces, and toward a right longitudinal side or edge of casing 1332. Device 1590 also includes microphone 1354 positioned at a transverse center of lower transverse side or edge 1340, which can also be described as bottom side 1340.

FIG. 95 shows a view of another mobile communication device, indicated generally at 1592, in accordance with an exemplary embodiment of the present disclosure. Device 1590 includes speaker 1352 positioned on back face 358 and microphone 1354 positioned on front face 354. Front face 354 can also include display 356 positioned thereon. Each of speaker 1352 and microphone 1354 is close to an intersection of a longitudinally extending side face and a respective face on which speaker 1352 and microphone 1354 is positioned, which each of speaker 1352 and microphone 1354 positioned close to a different one of the longitudinally extending side faces, such as left side face 364 and right side face of 366 shown in FIG. 14c.

FIG. 96 shows a view of yet another mobile communication device, indicated generally at 1594, in accordance with an exemplary embodiment of the present disclosure. Mobile communication device 1594 includes speaker 1352 positioned on back face 358 at a location that is closer to bottom or lower transverse side or edge 1340 than to top or upper transverse side or edge 1336 and closer to right longitudinal side or edge 1344 than to left longitudinal side or edge 1342. Mobile communication device 1594 also includes microphone 1354 positioned on bottom or lower transverse side or edge 1340 at a location that is closer to left longitudinal side or edge 1342 than to right longitudinal side or edge 1344.

FIG. 97 shows a view of still yet another mobile communication device, indicated generally at 1596, in accordance with an exemplary embodiment of the present disclosure. Mobile communication device 1596 includes two speakers, namely, one speaker 1352 positioned on each longitudinally extending side face, such as left side face 364 and right side face 366 shown in FIG. 14C, at a location that is between transversely extending centerline 1360 and bottom side face 362. Mobile communication device 1596 also includes two microphones 1354 positioned on one of front face 354 and back face 358 at a location that is close to bottom side face 362 than to transversely extending centerline 1360. Further, each microphone 1354 is positioned close to a different one of, for example, left side face 364 and right side face 366 shown in FIG. 14c. If microphones 1354 are positioned on back face 358, a full face display such as display 1350 of FIG. 69 can be positioned on the front face of mobile communication device 1596. Alternatively, if microphones 1354 are positioned on front face 354, display 356 can be positioned on front face 354.

FIG. 98 shows a view of even yet another mobile communication device, indicated generally at 1598, in accordance with an exemplary embodiment of the present disclosure. Mobile communication device 1598 includes speaker 1352 positioned on one of front face 354 and back face 358 at a location that is near, close, or adjacent to an intersection of one of front face 354 and back face 358, bottom side face 362, and one of the longitudinally extending side faces, such as left side face 364 and right side face 366 shown in FIG. 14c. On the adjacent longitudinally extending side face, such as left side face 364 and right side face 366 shown in FIG. 14c, is another speaker 1352 positioned near, close, or adjacent to the same intersection as to speaker 1352 positioned on the one of front face 354 and back face 358. If microphone 1354 is positioned on back face 358, a full face display such as display 1350 of FIG. 69 can be positioned on the front face of mobile communication device 1598. Alternatively, if microphone 1354 is positioned on front face 354, display 356 can be positioned on front face 354.

FIG. 99 shows a view of a further mobile communication device, indicated generally at 1600, in accordance with an exemplary embodiment of the present disclosure. Mobile communication device 1600 includes microphone 1354 one of front face 354 and back face 358 at a location that is on longitudinal centerline 1358 near, close, or adjacent to an intersection of one of front face 354 and back face 358 and bottom side face 362. On one longitudinally extending side face of mobile communication device 1600, such as left side face 364 and right side face 366 shown in FIG. 14c, is speaker 1352 positioned away from an intersection of the longitudinally extending side face and bottom side or face 363. If microphone 1354 is positioned on back face 358, a full face display such as display 1350 of FIG. 69 can be positioned on the front face of mobile communication device 1600. Alternatively, if microphone 1354 is positioned on front face 354, display 356 can be positioned on front face 354.

FIG. 100 shows a view of a yet further mobile communication, indicated generally at 1602, in accordance with an exemplary embodiment of the present disclosure. Mobile communication device 1602 includes microphone 1354 positioned on bottom side face 1340 at or on longitudinally extending centerline 1358. Mobile communication device 1602 further includes speaker 1352 positioned on right longitudinal side or edge 1344 at a location between transversely extending centerline 1360 and bottom side face 1340. Speaker 1352 can be positioned closer to transversely extending centerline 1360 than to bottom side face 1340.

FIG. 101 shows a view of a still further mobile communication device, indicated generally at 1604, in accordance with an exemplary embodiment of the present disclosure. Mobile communication device 1604 includes speaker 1352 positioned on right longitudinal side or edge 1344. It should be understood that speaker 1352 can also be positioned on left longitudinal side or edge 1342. Speaker 1352 is positioned a spaced distance from an intersection of right longitudinal side or edge 1344 and bottom or lower transverse side or edge 1340, but such spaced distance positions speaker 1352 in the lower half of mobile communication device 1604. Mobile communication device 1604 also includes microphone 1354 positioned on bottom or lower transverse side or edge 1340 at a location that is adjacent, close, or near to an intersection of right longitudinal side or edge 1344 and bottom or lower transverse side or edge 1340. As with some other mobile communication devices disclosed herein, antenna 1356 and battery 1542 are positioned in the upper half of mobile communication device 1604.

FIG. 102 shows a view of a mobile communication device, indicated generally at 1606, in accordance with an exemplary embodiment of the present disclosure. Mobile communication device 1606 includes speaker 1352 positioned on right longitudinal side or edge 1344 at or on transversely extending centerline 1360. Mobile communication device 1606 includes antenna 1356 extending longitudinally along left longitudinal side or edge 1342, which thus positions antenna 1356 on an opposite side of mobile communication device 1606 from speaker 1352. Mobile communication device 1606 also includes microphone 1354 positioned on bottom or lower transverse side or edge 1340 at a location that is adjacent, close, or near to the intersection of right longitudinal side or edge 1344 and bottom or lower transverse side or edge 1340.

FIG. 103 shows a view of another mobile communication device, indicated generally at 1608, in accordance with an exemplary embodiment of the present disclosure. Mobile communication device 1608 includes speaker 1352 positioned on right longitudinal side or edge 1344. It should be understood that speaker 1352 can also be positioned on left longitudinal side or edge 1342. Speaker 1352 is positioned a spaced distance from the intersection of right longitudinal side or edge 1344 and bottom or lower transverse side or edge 1340, but such spaced distance positions speaker 1352 in the lower half of mobile communication device 1604. It should also be noted that speaker 1352 is farther from bottom or lower transverse side or edge 1340 than speaker 1352 is on mobile communication device 1604 shown in FIG. 101. Mobile communication device 1604 also includes microphone 1354 positioned on bottom or lower transverse side or edge 1340 at a location that is adjacent, close, or near to the intersection of right longitudinal side or edge 1344 and bottom or lower transverse side or edge 1340.

FIG. 104 shows a view of yet another mobile communication device, indicated generally at 1610, in accordance with an exemplary embodiment of the present disclosure. Mobile communication device 1610 includes speaker 1352 positioned on right longitudinal side or edge 1344 at a location on a lower half of mobile communication device 1610. Mobile communication device 1606 includes antenna 1356 extending longitudinally along left longitudinal side or edge 1342, which thus positions antenna 1356 on an opposite side of mobile communication device 1610 from speaker 1352. Mobile communication device 1610 also includes microphone 1354 positioned on bottom or lower transverse side or edge 1340 at a location that is adjacent, close, or near to the intersection of right longitudinal side or edge 1344 and bottom or lower transverse side or edge 1340.

FIG. 105 shows a view of still yet another mobile communication device, indicated generally at 1612, in accordance with an exemplary embodiment of the present disclosure. Mobile communication device 1612 includes speaker 1352 positioned on back face 1348 near an intersection of back face 1348, right longitudinal side or edge 1344, and bottom or lower transverse side or edge 1340. Mobile communication device 1612 also includes microphone 1354 positioned on left longitudinal side or edge 1342 near an intersection of left longitudinal side or edge 1342 and bottom or lower transverse side or edge 1340. As with some other mobile communication devices disclosed herein, antenna 1356 and battery 1542 are positioned in the upper half of mobile communication device 1604.

FIG. 106 shows a view of even yet another mobile communication device, indicated generally at 1614, in accordance with an exemplary embodiment of the present disclosure. Mobile communication device 1614 includes speaker 1352 positioned on back face 1348 at a location that is adjacent, near, or close to an intersection of top or upper transverse side or edge 1336, right longitudinal side or edge 1344, and back face 1348. Mobile communication device 1614 includes antenna 1356 extending longitudinally along bottom or lower transverse side or edge 1340, which thus positions antenna 1356 on an opposite side of mobile communication device 1614 from speaker 1352. Mobile communication device 1606 also includes microphone 1354 positioned on left longitudinal side or edge 1342 at a location that is between transversely extending centerline 1358 and an intersection between top or upper transverse side or edge 1336 and left longitudinal side or edge 1342. Display 1350 is positioned on front face 1346.

FIG. 107 shows a view of a further mobile communication device, indicated generally at 1616, in accordance with an exemplary embodiment of the present disclosure. Similar to mobile communication device 1480 shown in FIG. 85A, mobile communication device 1616 includes speaker 1500 positioned on right longitudinal side or edge 1494 at or near a corner or junction of top or upper transverse side or edge 1486 and right longitudinal side or edge 1494. Mobile communication device 1616 includes microphone 1502 positioned on right longitudinal side or edge 1494 at or on transversely extending centerline 1360.

FIG. 108 shows a view of a yet further mobile communication device, indicated generally at 1618, in accordance with an exemplary embodiment of the present disclosure. Mobile communication device 1618 includes some features similar to mobile communication device 1330 shown in FIGS. 69 and 70. Mobile communication device 1618 also includes speaker 1352 positioned on back face 1348 at a location that is close, near, or adjacent to an intersection of back face 1348, left longitudinal side or edge 1342, and top or upper transverse side or edge 1336. Mobile communication device 1618 further yet includes microphone 1354 positioned close, near, or adjacent to an intersection of back face 1348, right longitudinal side or edge 1344, and top or upper transverse side or edge 1336. Mobile communication device 1618 also includes antenna 1356 positioned alongside or near to bottom or lower transverse side or edge 1340. Thus, antenna 1356 is positioned in a location that is on an opposite end of housing or casing 1332 from speaker 1352 and microphone 1354.

FIG. 109 shows a view of a still further mobile communication device, indicated generally at 1620, in accordance with an exemplary embodiment of the present disclosure. Mobile communication device 1620 includes speaker 1500 positioned on left longitudinal side or edge 1492 at or near a corner or junction of upper transverse side or edge 1486 and left longitudinal side or edge 1492, and microphone 1502 positioned on a back face 1497 of housing or casing 1482. Microphone 1502 is positioned along transversely extending centerline 1360 at a location that is near, adjacent, or close to an intersection between back face 1497 and left longitudinal side or edge 1492.

FIG. 110 shows a view of a mobile communication device, indicated generally at 1622, in accordance with an exemplary embodiment of the present disclosure. Mobile communication device 1622 includes speaker 1352 positioned on back face 1348 at, near, close, or adjacent to the intersection of back face 1348, left longitudinal side or edge 1342, and bottom or lower transverse side or edge 1340. Mobile communication device 1622 further includes microphone 1354 positioned on top or upper transverse side or edge 1336 at, near, close, or adjacent to the intersection of back face 1348, top or upper transverse side or edge 1336, and left longitudinal side or edge 1342. Mobile communication device 1622 also includes antenna 1356 positioned alongside or near to top or upper transverse side or edge 1336. Thus, antenna 1356 is positioned in a location that is at an opposite end of housing or casing 1332 from speaker 1352.

FIGS. 111 and 112 show views of another mobile communication device, indicated generally at 1624, in accordance with an exemplary embodiment of the present disclosure. Mobile communication device 1330 includes speaker 1352 positioned on back face 1348 along transversely extending centerline 1360 at a position or location that is at, near, close, or adjacent to an intersection between back face 1348 and right longitudinal side or edge 1344. Mobile communication device 1330 further includes microphone 1354 positioned along longitudinally extending centerline 1358 at a location that is at, near, close, or adjacent to an intersection between back face 1348 and bottom or lower transverse side or edge 1340. Mobile communication device 1330 also includes an antenna 1626 positioned at, near, close, or adjacent to an intersection of back face 1348, left longitudinal side or edge 1342, and top or upper transverse side or edge 1340. When the user positions mobile communication device 1624 such that speaker 1352 is near an ear, and microphone 1354 is as close as possible to the user's mouth, antenna 1626 is positioned in a location that is somewhat away from the user's brain. It should be understood that antenna 1626 should preferably be located next to display 1350 and a battery (not shown) and processor (not shown) should also be located preferably to display 1350, thus radiation emitting elements such as processor, battery, and antenna are disposed away from the speaker 1352.

FIG. 113 shows a view of still yet another mobile communication device, indicated generally at 1628, in accordance with an exemplary embodiment of the present disclosure. Mobile communication device 1628 includes speaker 1352 positioned on bottom or lower transverse side or edge 1340 near the intersection of back face 1348, right longitudinal side or edge 1344, and bottom or lower transverse side or edge 1340. Mobile communication device 1628 also includes microphone 1354 positioned on back face 1348 at, near, adjacent, or close to the intersection of back face 1348, left longitudinal side or edge 1342, and bottom or lower transverse side or edge 1340. As with some other mobile communication devices disclosed herein, antenna 1356 and battery 1542 are positioned in the upper half of mobile communication device 1604.

FIG. 114 shows a view of a further mobile communication device, indicated generally at 1630, in accordance with an exemplary embodiment of the present disclosure. Mobile communication device 1630 includes speaker 1352 positioned on back face 1348 at, near, adjacent, or close to the intersection of back face 1348, right longitudinal side or edge 1344, and top or upper transverse side or edge 1336. Mobile communication device 1630 further includes microphone 1354 positioned on back face 1348 at, near, adjacent, close, or alongside to the intersection of back face 1348 and left longitudinal side or edge 1342, at a position that is between transversely extending centerline 1360 and bottom or lower transverse side or edge 1340. Mobile communication device 1630 also includes antenna 1356 positioned alongside or near to bottom or lower transverse side or edge 1340. When the user positions mobile communication device 1630 such that speaker 1352 is near an ear, and microphone 1354 is as close as possible to the user's mouth, antenna 1356 is positioned as far as mobile communication device 1330 permits from the user's brain.

FIG. 115 shows a view of a yet further mobile communication device in accordance with an exemplary embodiment of the present disclosure, indicated generally at 1632, in accordance with an exemplary embodiment of the present disclosure. Mobile communication device 1632 includes speaker 1352 positioned on back face 1348 at, near, adjacent, or close to the intersection of back face 1348 and bottom or lower transverse side or edge 1340, at a location that is on longitudinally extending centerline 1358. Mobile communication device 1632 further includes microphone 1354 positioned on left longitudinal side or edge 1342 at, near, adjacent, or close to the intersection of left longitudinal side or edge 1342 and top or upper transverse side or edge 1336. Mobile communication device 1630 also includes antenna 1356 positioned alongside or near to top or upper transverse side or edge 1336. When the user positions mobile communication device 1630 such that speaker 1352 is near an ear, and microphone 1354 is as close as possible to the user's mouth, antenna 1356 is positioned as far as mobile communication device 1330 permits from the user's brain.

FIG. 116 shows a view of a still further mobile communication device, indicated generally at 1634, in accordance with an exemplary embodiment of the present disclosure. Mobile communication device 1634 includes speaker 1352 positioned on back face 1348 at, near, adjacent, or close to the intersection of back face 1348, right longitudinal side or edge 1344, and top or upper transverse side or edge 1336. Mobile communication device 1632 further includes microphone 1354 positioned on back face 1348 at, near, adjacent, or close to the intersection of back face 1348, right longitudinal side or edge 1344, and bottom or lower transverse side or edge 1340. Mobile communication device 1634 also includes antenna 1626 positioned at, near, close, or adjacent to the intersection of back face 1348, left longitudinal side or edge 1342, and bottom or lower transverse side or edge 1342, thus positioning speaker 1352 as far as possible from antenna 1626.

FIG. 117 shows a view of a mobile communication device, indicated generally at 1636, in accordance with an exemplary embodiment of the present disclosure. Mobile communication device 1636 includes speaker 1352 positioned on left longitudinal side or edge 1342 at a location that is at, near, adjacent, or close to the intersection of left longitudinal side or edge 1342, and top or upper transverse side or edge 1336. Mobile communication device 1636 further includes microphone 1354 positioned on back face 1348 at, near, adjacent, or close to the intersection of back face 1348, left longitudinal side or edge 1342, and bottom or lower transverse side or edge 1340. Mobile communication device 1634 also includes antenna 1356 positioned at, near, close, adjacent, or alongside the intersection of back face 1348 and right longitudinal side or edge 1344, thus positioning antenna 1356 as far as possible from speaker 1352.

FIG. 118A shows a perspective view of one more mobile communication device mobile, indicated generally at 1640, in accordance with an exemplary embodiment of the present disclosure. Mobile communication device 1640 includes a casing or housing 1644, a first antenna 1646 positioned on or in casing or housing 1644, and a second antenna 1648 positioned on or in casing or housing 1644. First antenna 1646 can be, for example, an antenna for communication with a cellular network. Second antenna 1648 can be, for example, a Wi-Fi antenna, which emits lower power than relatively higher power first antenna 1646. Mobile communication device 1640 also includes a speaker 1652 positioned at a location between a transversely extending centerline 1650 and second antenna 1648, the location being closer to transversely extending centerline 1650 than to second antenna 1648, thus positioning the ear and brain of the user a spaced distance from both first antenna 1646 and second antenna 1648, but farther from higher power output first antenna 1646.

FIG. 118B shows a perspective view of a mobile communication device, indicated generally at 1660, which is similar to, but different from, the mobile communication device of FIG. 118A in accordance with an exemplary embodiment of the present disclosure. Mobile communication device 1660 includes a casing 162 that includes a longitudinally extending side or edge 1664 on which is positioned a speaker 1666. The purpose of this figure is to show that a speaker can be positioned on either of the longitudinally extending sides or edges connecting a front and back face, one of which includes a display (not shown in this figure), which can include a left side and a right side.

FIG. 119 shows a view of a mobile communication device, indicated generally at 1670, which is similar to, but different from, the mobile communication devices of FIGS. 118A and 118B in accordance with an exemplary embodiment of the present disclosure. Mobile communication device 1670 includes a casing 1672 that includes a back face 1678, a left longitudinally extending face, side, or edge 1674, a right longitudinally extending face, side, or edge 1676, and an unseen front face that is opposite to back face 1678 that includes a display. Mobile communication device further includes a left speaker 1680 and a right speaker 1682, each of which can be positioned on back face 1678 adjacent to an intersection between back face 1678 and a respective longitudinally extending side. Alternatively, left speaker 1680 can be positioned on left longitudinally extending side 1674 and right speaker 1682 can be positioned on right longitudinally extending side 1676. An exemplary position for each of left speaker 1680 and right speaker 1682 is twice a distance from first antenna 1646 in a direction toward second antenna 1648 as compared to a distance from second antenna 1648 toward first antenna 1646. In other words, a ratio of the distance from first antenna 1646 to one of speakers 1680 and 1682 to the distance from second antenna 1648 to the same one of speakers 1680 and 1682 is 2:1, thus positioning each one of speaker 1680 and 1682 two-thirds of the way between first antenna 1646 and second antenna 1648, closer to second antenna 1648. It should be understood that the referenced distances are longitudinal distances that are measured in parallel to longitudinally extending sides of mobile communication device that extending generally in a same direction as a direction from first antenna 1646 to second antenna 1648.

It should be understood that any of the embodiments disclosed herein can be augmented by an insulator, such as an insulator 2084 shown in FIG. 150, which includes a thermal insulator and/or a radiofrequency (RF) insulator, in the area around the speaker/audio port. However, when a mobile communication device includes an RF insulator, such needs to be relatively small to minimize signal loss when communicating with cell phone towers. Thus, an RF insulator can limit the ability to transmit in certain directions, or can be too small to provide more than minimal protection.

It should also be understood that the embodiments disclosed herein can be applied to a flip phone, a foldable phone, a roll-over phone, or any new phone shape that may be developed in the future. It should also be understood that although embodiments disclose a speaker and a microphone disposed as close to a periphery at a corner of the device, alternative embodiments include a speaker at a corner with a microphone positioned along a centerline or near a centerline of a mobile communication device, and any other configuration that allows the user to orient the phone such that the user is exposed to the least or minimum amount of radiation possible based on orientation. It should also be understood that any parts of any embodiments can be combined to form a new embodiment and that any combinations of embodiments can be used, and all are within the scope of the present disclosure.

While various embodiments of the disclosure have been shown and described, it should be understood that these embodiments are not limited thereto. The embodiments may be changed, modified, and further applied by those skilled in the art. Therefore, these embodiments are not limited to the detail shown and described previously, but also include all such changes and modifications.

I claim:

1. A biologically compatible mobile communication device configured to minimize exposing one or more of a user's organs to radiation emitted from one or more components of the biologically compatible mobile communication device, the biologically compatible mobile communication device comprising:
a housing;
an audio port of the housing, wherein the audio port is configured to be in contact with or in close proximity to one of the ears of the user, and wherein the audio port is configured to transmit sound from a sound producing device positioned inside the housing; and
an antenna positioned inside the housing,
wherein the housing includes at least one imaginary line that represents a maximum distance between two exterior points of the housing,
wherein the audio port is located closer to a first end of the at least one imaginary line than a second end of the at least one imaginary line,
wherein the antenna is located closer to the second end of the at least one imaginary line than the first end of the at least one imaginary line.

2. The biologically compatible mobile communication device of claim 1, wherein the housing has a top side, a bottom side, a left side, a right side, a front side, and a back side, wherein the audio port is on the left side, wherein the audio port is located closer to the bottom side than the top side, wherein the antenna is located closer to the right side than the left side, and wherein the antenna is located closer to the top side than the bottom side.

3. The biologically compatible mobile communication device of claim 2, wherein the biologically compatible mobile communication device further includes a battery, and wherein the battery is located closer to the right side than the left side, and wherein the battery is located closer to the top side than the bottom side.

4. A biologically compatible mobile communication device configured to minimize exposing one or more of a user's organs to radiation emitted from one or more components of the biologically compatible mobile communication device, the biologically compatible mobile communication device comprising:
a housing;
an audio port of the housing, wherein the audio port is configured to be in contact with or in close proximity to one of the ears of the user, and wherein the audio port is configured to transmit sound from a sound producing device positioned inside the housing; and
an antenna positioned inside the housing,
wherein the housing includes at least one imaginary line that represents a maximum distance between two exterior points of the housing,
wherein the audio port is located closer to a first end of the at least one imaginary line than a second end of the at least one imaginary line,
wherein the antenna is located closer to the second end of the at least one imaginary line than the first end of the at least one imaginary line, and
wherein a separation distance between the audio port and the antenna is at least 70% of a total length of the at least one imaginary line.

5. The biologically compatible mobile communication device of claim 4, wherein the biologically compatible mobile communication device further includes a battery, wherein a separation distance between the audio port and the battery is at least 70% of a total length of the at least one imaginary line.

6. The biologically compatible mobile communication device of claim 4, wherein the housing has a top side, a bottom side, a left side, a right side, a front side, and a back side, wherein the audio port is on the left side, wherein the audio port is located closer to the bottom side than the top side, wherein the antenna is located closer to the right side than the left side, and wherein the antenna is located closer to the top side than the bottom side.

7. The biologically compatible mobile communication device of claim 6, wherein the biologically compatible mobile communication device further includes a battery, and wherein the battery is located closer to the right side than the left side, and wherein the battery is located closer to the top side than the bottom side.

8. The biologically compatible mobile communication device of claim 4, wherein the housing has a top side, a bottom side, a left side, a right side, a front side, and a back side, wherein the audio port is on the bottom side, wherein the audio port is located closer to the right side than the left side, wherein the antenna is located closer to the top side than the bottom side.

9. The biologically compatible mobile communication device of claim 8, wherein the biologically compatible mobile communication device further includes a battery, and wherein the battery is located closer to the top side than the bottom side.

10. The biologically compatible mobile communication device of claim 4, wherein the housing has a top side, a bottom side, a left side, a right side, a front side, and a back side, wherein the audio port is on the front side, wherein the audio port is located closer to the left side than the right side, and wherein the antenna is located closer to the top side than the bottom side.

11. The biologically compatible mobile communication device of claim 10, wherein the biologically compatible mobile communication device further includes a battery, and wherein the battery is located closer to the top side than the bottom side.

12. The biologically compatible mobile communication device of claim 4, wherein the housing has a top side, a bottom side, a left side, a right side, a front side, and a back side, wherein the audio port is on the bottom side, wherein the audio port is located closer to the left side than the right side, wherein the antenna is located closer to the top side than the bottom side, and wherein the antenna is located closer to the right side than the left side.

13. The biologically compatible mobile communication device of claim 12, wherein the biologically compatible mobile communication device further includes a battery, wherein the battery is located closer to the top side than the bottom side, and wherein the battery is located closer to the right side than the left side.

14. The biologically compatible mobile communication device of claim 4, wherein the housing has a top side, a bottom side, a left side, a right side, a front side, and a back side, wherein the audio port is on the back side, wherein the audio port is located closer to the right side than the left side, and wherein the antenna is located closer to the top side than the bottom side.

15. The biologically compatible mobile communication device of claim 14, wherein the biologically compatible mobile communication device further includes a battery, and wherein the battery is located closer to the top side than the bottom side.

16. The biologically compatible mobile communication device of claim 6, wherein the biologically compatible mobile communication device further includes a microphone, wherein the microphone is on the bottom side, and wherein the microphone is located closer to the left side than the right side.

17. The biologically compatible mobile communication device of claim 8, wherein the biologically compatible mobile communication device further includes a microphone, wherein the microphone is on the bottom side, and wherein the microphone is located closer to the left side than the right side.

18. The biologically compatible mobile communication device of claim 10, wherein the biologically compatible mobile communication device further includes a microphone, wherein the microphone is on the front side, and wherein the microphone is located closer to the right side than the left side.

19. The biologically compatible mobile communication device of claim 12, wherein the biologically compatible mobile communication device further includes a microphone, wherein the microphone is on the bottom side, and wherein the microphone is located closer to the right side than the left side.

20. The biologically compatible mobile communication device of claim 14, wherein the biologically compatible mobile communication device further includes a microphone, wherein the microphone is on the right side, and wherein the microphone is located closer to the bottom side than the top side.

21. A biologically compatible mobile communication device configured to minimize exposing one or more of a user's organs to radiation emitted from one or more components of the biologically compatible mobile communication device, the biologically compatible mobile communication device comprising:
a housing having a top side, a bottom side, a left side, a right side, a front side, and a back side, wherein each of the top side and the bottom side has a width less than a length of each of the left side, the right side, the front side and the back side;
an audio port of the housing, wherein the audio port is configured to be in contact with or in close proximity to one of the ears of the user, and wherein the audio port is configured to transmit sound from a sound producing device positioned inside the housing; and
an antenna positioned inside the housing,
wherein, the audio port is located on the top side, or on one of the left side, the right side, the front side, and the back side at a distance spaced from the top side that is less than or equal to 15% of the length, and
wherein the antenna is located at a distance spaced from the bottom side that is less than or equal to 15% of the length.

22. The biologically compatible mobile communication device of claim 21, wherein the biologically compatible mobile communication device further includes a battery and the battery is located at a distance spaced from the bottom side that is less than or equal to 20% of the length.

23. A biologically compatible mobile communication device configured to minimize exposing one or more of a user's organs to radiation emitted from one or more components of the biologically compatible mobile communication device, the biologically compatible mobile communication device comprising:
a housing having a top side, a bottom side, a left side, a right side, a front side, and a back side, wherein each of the top side and the bottom side has a width less than a length of each of the left side, the right side, the front side and the back side;
an audio port of the housing, wherein the audio port is configured to be in contact with or in close proximity to one of the ears of the user, and wherein the audio port is configured to transmit sound from a sound producing device positioned inside the housing; and
an antenna positioned inside the housing,
wherein, the audio port is located on the bottom side, or on one of the left side, the right side, the front side, and the back side at a distance spaced from the bottom side that is less than or equal to 15% of the length, and
wherein the antenna is located at a distance spaced from the top side that is less than or equal to 15% of the length.

24. The biologically compatible mobile communication device of claim 23, wherein the biologically compatible mobile communication device further includes a battery and the battery is located at a distance spaced from the top side that is less than or equal to 20% of the length.

25. The biologically compatible mobile communication device of claim 4, wherein the housing has a top side, a bottom side, a left side, a right side, a front side, and a back side, wherein the audio port is on the left side, wherein the audio port is located closer to the top side than the bottom side, and wherein the antenna is located closer to the bottom side than the top side.

26. The biologically compatible mobile communication device of claim 25, wherein the biologically compatible mobile communication device further includes a battery, and wherein the battery is located closer to the right side than the left side.

27. The biologically compatible mobile communication device of claim 25, wherein the biologically compatible mobile communication device further includes a microphone, wherein the microphone is on the left side, and wherein the microphone is located closer to the bottom side than the top side.

28. The biologically compatible mobile communication device of claim 4, wherein the housing has a top side, a bottom side, a left side, a right side, a front side, and a back side, wherein the audio port is on the front side, wherein the audio port is located closer to the left side than the right side, and wherein the antenna is located closer to the bottom side than the top side.

29. The biologically compatible mobile communication device of claim 28, wherein the biologically compatible mobile communication device further includes a battery, wherein the battery is located closer to the bottom side than the top side, and wherein the battery is located closer to the right side than the left side.

30. The biologically compatible mobile communication device of claim 28, wherein the biologically compatible mobile communication device further includes a microphone, wherein the microphone is on the left side, and wherein the microphone is located closer to the bottom side than the top side.

31. The biologically compatible mobile communication device of claim 4, wherein the housing has a top side, a bottom side, a left side, a right side, a front side, and a back side, wherein the audio port is on the top side, wherein the audio port is located closer to the right side than the left side, wherein the antenna is located closer to the bottom side than the top side, and wherein the antenna is located closer to the left side than the right side.

32. The biologically compatible mobile communication device of claim 31, wherein the biologically compatible mobile communication device further includes a battery, wherein the battery is located closer to the bottom side than the top side, and wherein the battery is located closer to the left side than the right side.

33. The biologically compatible mobile communication device of claim 31, wherein the biologically compatible mobile communication device further includes a microphone, wherein the microphone is on the top side, and wherein the microphone is located closer to the left side than the right side.

34. A biologically compatible mobile communication device configured to minimize exposing one or more of a user's organs to radiation emitted from one or more components of the biologically compatible mobile communication device, the biologically compatible mobile communication device comprising:
a housing including an antenna; and
an audio port of the housing, wherein the audio port is configured to be in contact with or in close proximity to one of the ears of the user, and wherein the audio port is configured to transmit sound from a sound producing device positioned inside the housing; and
wherein the housing has a first side, a second side, a third side, a fourth side opposite the first side, a fifth side opposite the second side, and a sixth side opposite the third side,
wherein the audio port is located closer to a first intersection of the first side, the second side, and the third side, than to a second intersection of the fourth side, the fifth side, and the sixth side, and
wherein the antenna is located closer to the second intersection than the first intersection.

35. The biologically compatible mobile communication device of claim 34, wherein the biologically compatible mobile communication device further includes a battery, and wherein the battery is closer to the second intersection than the first intersection.

36. The biologically compatible mobile communication device of claim 34, wherein the biologically compatible mobile communication device further includes a microphone, wherein the microphone is on one of the first side, the second side, the third side, and the fourth side.

37. The biologically compatible mobile communication device of claim 36, wherein the audio port is on a side directly adjacent to the one of the first side, the second side, the third side, and the fourth side.

38. The biologically compatible mobile communication device of claim 36, wherein the audio port is on the one of the first side, the second side, the third side, and the fourth side.

39. The biologically compatible mobile communication device of claim 4, wherein the housing has a top side, a bottom side, a left side, a right side, a front side, and a back side, wherein the audio port is on the left side, wherein the audio port is located closer to the top side than the bottom side, wherein the biologically compatible mobile communication device further includes a microphone, wherein the microphone is on the left side, wherein the microphone is located closer to the bottom side than the top side, wherein the biologically compatible mobile communication device further includes a charging port, and wherein the charging port is located on the bottom side.

40. The biologically compatible mobile communication device of claim 4, wherein the housing has a top side, a bottom side, a left side, a right side, a front side, and a back side, wherein the audio port is on the bottom side, wherein the audio port is located closer to the left side than the right side, wherein the biologically compatible mobile communication device further includes a charging port, and wherein the charging port is located on the bottom side.

41. The biologically compatible mobile communication device of claim 4, wherein a separation distance between the audio port and the antenna is at least 80% of a total length of the at least one imaginary line.
